(19) United States
(12) Patent Application Publication
(10) Pub. No.: US 2023/0108774 A1
(43) Pub. Date: Apr. 6, 2023

(54) AI Augmented Digital Platform And User Interface

(71) Applicant: Andrew J. Archer, Wayzata, MN (US)

(72) Inventor: Andrew J. Archer, Wayzata, MN (US)

(21) Appl. No.: 17/905,140

(22) PCT Filed: Mar. 1, 2021
(86) PCT No.: PCT/US2021/020351

§ 371 Date: Aug. 26, 2022

Related U.S. Application Data
(60) Provisional application No. 62/982,685, filed on Feb. 27, 2020.
(60) Provisional application No. 63/066,748, filed on Aug. 17, 2020.

(51) Int. Cl. H04L 41/00; H04L 41/22; H04L 41/16

(52) U.S. Cl. CPC H04L 41/20; H04L 41/22; H04L 41/16

(57) ABSTRACT

A digital or computing platform for creating and implementing process automations that employees a distributed network of computing devices the optimization of which is augmented through machine learning/artificial intelligence nodes. The platform provides a no-code or low-code graphical user interface through which a user the desired process automations. This includes a method including receiving a graphical input to select one or more computing nodes; receiving a graphical input to form connections between certain of the selected computing nodes to form a process graph; and receiving a graphical input to configure parameters of the one or more computing nodes; and deploying the process graph to the one or more computing devices to perform the functional process.

### RELATED APPLICATIONS

This application claims priority to U.S. Provisional Application Ser. No. 63/066,748 filed Aug. 12, 2020, entitled AI Augmented Digital Platform and to U.S. Provisional Application Ser. No. 62/982,685 filed Feb. 27, 2020, entitled AI Augmented Digital Platform, both of which are hereby incorporated herein by reference.

### FIELD OF THE INVENTION

This invention pertains in general to the field of computing platforms and for creating and implementing business process automation. More particularly, the invention relates to computing systems, methods, and non-transitory computer-accessible storage mediums the functionality of which is augmented through the application of machine learning and artificial intelligence.

### BACKGROUND OF THE INVENTION

A computing or digital platform can be broadly defined as an environment in which a broad range of computer software and software services can be executed, for example business operation systems.

The phrase business operating system (BOS) has been used to describe a standard, enterprise-wide collection of business-related processes. More recently, the meaning or use of the phrase has evolved to include the common structures, principles and practices necessary to drive an organization. Various BOS share common features because the systems are derived from known systems and established methods and practices for business management, including: Hoshin Kanri; standard work methods and sequences; process improvement methodologies such as: Lean, Six Sigma, and Kaizen; just-in-time manufacturing; Gemba walks; Jidoka; visual control or management processes; and problem solving techniques such as root cause analysis. While these business operating systems may inform and be linked to an organization's technology platform, they more commonly describe ways in which an organization manages complex business processes across its different business portfolios and groups.

Even with current process automation, these systems ultimately conclude with a human controlling or implementing the output of the given system or systems, i.e. require a human to initiate and implement tasks directed by the system. In other words, there is a physical and mental gap between these systems and the implementation of tasks the system may indicate taking. This “gap” is ultimately filled by humans at the cost of time and work that could have been directed to the actual objective of the organization rather than implementing the operations of the organization.

What is needed in the field is a computing platform that represents an intelligence or collective intelligence dynamically directing not only a business' proceses and operational decisions but also the real time or near real time implementation of these processes and operational decisions, with little or no external input or required action from humans.

### OBJECTS AND SUMMARY OF THE INVENTION

A method of creating and deploying a functional process, comprising: performing, by one or more computing device: graphically selecting one or more computing nodes; graphically forming connections between certain of the selected computing nodes to form a process graph; and graphically configuring parameters of the computing nodes; and deploying the process graph to one or more computing device to perform the functional process.

A method of creating and deploying a functional process, comprising: performing, by one or more computing devices: receiving a graphical input to select one or more computing nodes; receiving a graphical input to form connections between certain of the selected computing nodes to form a process graph; and receiving a graphical input to configure parameters of the one or more computing nodes; and deploying the process graph to the one or more computing devices to perform the functional process. Wherein the one or more computing devices comprise a communication network employing weighted relationships between the one or more computing devices. Wherein the one or more computing devices comprise a distributed network of computing devices. Wherein the one or more computing nodes comprise a machine learning node. Wherein receiving a graphical input to form connections between certain of the selected computing nodes to form a process graph comprises receiving a graphical input to form connections between computing nodes employing different socket types. Wherein receiving graphical input to form connections comprises receiving graphical input to form a connection via a mapping node. Further comprising autonomously remapping the connections between certain of the selected computing nodes while performing the functional process. Further comprising autonomously remapping data within the connections between certain of the selected computing nodes while performing the functional process.

A system, comprising: one or more computing devices configured to: receive graphical input to select one or more computing nodes; receive graphical input to form connections between certain of the selected computing nodes to form a process graph; and receive graphical input to configure parameters of the one or more computing nodes; and deploy the process graph to one or more computing devices to perform the functional process. Wherein the one or more computing devices comprise a communication network employing weighted relationships between the one or more computing devices. Wherein the one or more computing nodes comprise a mapping node. Wherein the one or more computing nodes comprise a machine learning node. Wherein the one or more computing nodes comprise a robot nodes. Wherein the parameters of the one or more computing nodes comprises a defining a data socket type on the one or more nodes. Wherein the graphical input received is generated by dragging and dropping a graphical representation of a component of the process graph. Wherein the connections between certain of the selected computing nodes form a subgraph process. Wherein the connections between certain of the selected computing nodes is dynamically remapped while performing the functional process.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which:

FIG. 1 is a diagram of a process according to certain embodiments of the present invention.

FIG. 2 is an example of a graph.

FIG. 3 is a diagram of an illustrative computing device.

FIG. 4 is an image of a user interface according to certain embodiments of the present invention.

FIG. 5 is an image of a user interface according to certain embodiments of the present invention.

FIG. 6 is an image of a user interface according to certain embodiments of the present invention.

FIG. 7 is an image of a user interface according to certain embodiments of the present invention.

FIG. 8 is an image of a user interface according to certain embodiments of the present invention.

FIG. 9 is an image of a user interface according to certain embodiments of the present invention.

FIG. 10 is an image of a user interface according to certain embodiments of the present invention.

FIG. 11 is an image of a user interface according to certain embodiments of the present invention.

FIG. 12 is an image of a user interface according to certain embodiments of the present invention.

FIG. 13 is an image of a user interface according to certain embodiments of the present invention.

FIG. 14 is an image of a user interface according to certain embodiments of the present invention.

FIG. 15 is an image of a user interface according to certain embodiments of the present invention.

FIG. 16 is an image of a user interface according to certain embodiments of the present invention.

FIG. 17 is an image of a user interface according to certain embodiments of the present invention.

FIG. 18 is an image of a user interface according to certain embodiments of the present invention.

FIG. 19 is an image of a user interface according to certain embodiments of the present invention.

FIG. 20 is an image of a user interface according to certain embodiments of the present invention.

FIG. 21 is an image of a user interface according to certain embodiments of the present invention.

FIG. 22 is a flow diagram of a process according to certain embodiments of the present invention.

FIG. 23 is an image of a user interface according to certain embodiments of the present invention.

FIG. 24 is an image of a user interface according to certain embodiments of the present invention.

FIG. 25 is an image of a user interface according to certain embodiments of the present invention.

FIG. 26 is an image of a user interface according to certain embodiments of the present invention.

FIG. 27 is an image of a user interface according to certain embodiments of the present invention.

FIG. 28 is an image of a user interface according to certain embodiments of the present invention.

FIG. 29 is an image of a user interface according to certain embodiments of the present invention.

FIG. 30 is an image of a user interface according to certain embodiments of the present invention.

FIG. 31 is an image of a user interface according to certain embodiments of the present invention.

FIG. 32 is an image of a user interface according to certain embodiments of the present invention.

FIG. 33 is an image of a user interface according to certain embodiments of the present invention.

FIG. 34 is an image of a user interface according to certain embodiments of the present invention.

FIG. 35 is an image of a user interface according to certain embodiments of the present invention.

FIG. 36 is an image of a user interface according to certain embodiments of the present invention.

FIG. 37 is an image of a user interface according to certain embodiments of the present invention.

FIG. 38 is an image of a user interface according to certain embodiments of the present invention.

FIG. 39 is an image of a user interface according to certain embodiments of the present invention.

FIG. 40 is an image of a user interface according to certain embodiments of the present invention.

FIG. 41 is an image of a user interface according to certain embodiments of the present invention.

FIG. 42 is an image of a user interface according to certain embodiments of the present invention.

FIG. 43 is an image of a user interface according to certain embodiments of the present invention.

FIG. 44 is an image of a user interface according to certain embodiments of the present invention.

FIG. 45 is an image of a user interface according to certain embodiments of the present invention.

FIG. 46 is an image of a user interface according to certain embodiments of the present invention.

FIG. 47 is an image of a user interface according to certain embodiments of the present invention.

FIG. 48 is an image of a user interface according to certain embodiments of the present invention.

FIG. 49 is an image of a user interface according to certain embodiments of the present invention.

FIG. 50 is an image of a user interface according to certain embodiments of the present invention.

FIG. 51 is an image of a user interface according to certain embodiments of the present invention.

FIG. 52 is an image of a user interface according to certain embodiments of the present invention.

FIG. 53 is an image of a user interface according to certain embodiments of the present invention.

FIG. 54 is an image of a user interface according to certain embodiments of the present invention.

FIG. 55 is an image of a user interface according to certain embodiments of the present invention.

FIG. 56 is an image of a user interface according to certain embodiments of the present invention.

FIG. 57 is an image of a user interface according to certain embodiments of the present invention.

FIG. 58 is an image of a user interface according to certain embodiments of the present invention.

FIG. 59 is an image of a user interface according to certain embodiments of the present invention.

FIG. 60 is an image of a user interface according to certain embodiments of the present invention.

FIG. 61 is an image of a user interface according to certain embodiments of the present invention.

FIG. 62 is an image of a user interface according to certain embodiments of the present invention.

FIG. 63 is an image of a user interface according to certain embodiments of the present invention.

FIG. 64 is an image of a user interface according to certain embodiments of the present invention.

FIG. 65 is an image of a user interface according to certain embodiments of the present invention.

FIG. 66 is an image of a user interface according to certain embodiments of the present invention.

FIG. 67 is an image of a user interface according to certain embodiments of the present invention.

FIG. 68 is an image of a user interface according to certain embodiments of the present invention.

FIG. 69 is an image of a user interface according to certain embodiments of the present invention.

FIG. 70 is an image of a user interface according to certain embodiments of the present invention.

FIG. 71 is an image of a user interface according to certain embodiments of the present invention.

FIG. 72 is an image of a user interface according to certain embodiments of the present invention.

FIG. 73 is an image of a user interface according to certain embodiments of the present invention.

FIG. 74 is an image of a user interface according to certain embodiments of the present invention.

FIG. 75 is an image of a user interface according to certain embodiments of the present invention.

FIG. 76 is an image of a user interface according to certain embodiments of the present invention.

FIG. 77 is an image of a user interface according to certain embodiments of the present invention.

FIG. 78 is an image of a user interface according to certain embodiments of the present invention.

FIG. 79 is an image of a user interface according to certain embodiments of the present invention.

FIG. 80 is an image of a user interface according to certain embodiments of the present invention.

FIG. 81 is an image of a user interface according to certain embodiments of the present invention.

FIG. 82 is an image of a user interface according to certain embodiments of the present invention.

FIG. 83 is an image of a user interface according to certain embodiments of the present invention.

FIG. 84 is an image of a user interface according to certain embodiments of the present invention.

FIG. 85 is an image of a user interface according to certain embodiments of the present invention.

FIG. 86 is an image of a user interface according to certain embodiments of the present invention.

FIG. 87 is an image of a user interface according to certain embodiments of the present invention.

FIG. 88 is an image of a user interface according to certain embodiments of the present invention.

FIG. 89 is an image of a user interface according to certain embodiments of the present invention.

FIG. 90 is an image of a user interface according to certain embodiments of the present invention.

FIG. 91 is an image of a user interface according to certain embodiments of the present invention.

FIG. 92 is an image of a user interface according to certain embodiments of the present invention.

FIG. 93 is an image of a user interface according to certain embodiments of the present invention.

FIG. 94 is an image of a user interface according to certain embodiments of the present invention.

FIG. 95 is an image of a user interface according to certain embodiments of the present invention.

FIG. 96 is an image of a user interface according to certain embodiments of the present invention.

FIG. 97 is an image of a user interface according to certain embodiments of the present invention.

FIG. 98 is an image of a user interface according to certain embodiments of the present invention.

FIG. 99 is an image of a user interface according to certain embodiments of the present invention.

FIG. 100 is an image of a user interface according to certain embodiments of the present invention.

FIG. 101 is an image of a user interface according to certain embodiments of the present invention.

FIG. 102 is an image of a user interface according to certain embodiments of the present invention.

FIG. 103 is an image of a user interface according to certain embodiments of the present invention.

FIG. 104 is an image of a user interface according to certain embodiments of the present invention.

FIG. 105 is an image of a user interface according to certain embodiments of the present invention.

FIG. 106 is an image of a user interface according to certain embodiments of the present invention.

FIG. 107 is an image of a user interface according to certain embodiments of the present invention.

FIG. 108 is an image of a user interface according to certain embodiments of the present invention.

FIG. 109 is an image of a user interface according to certain embodiments of the present invention.

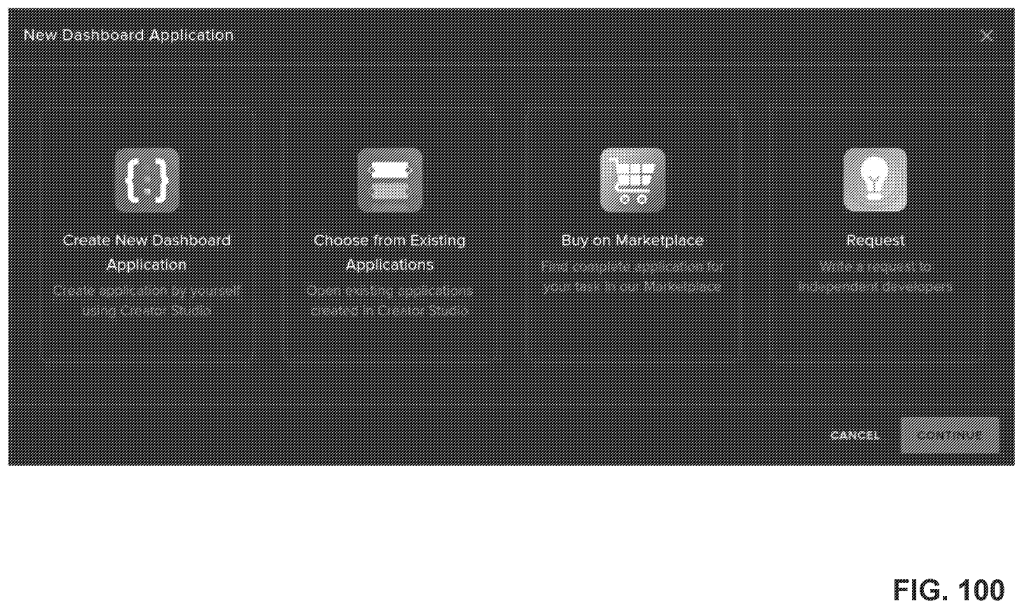

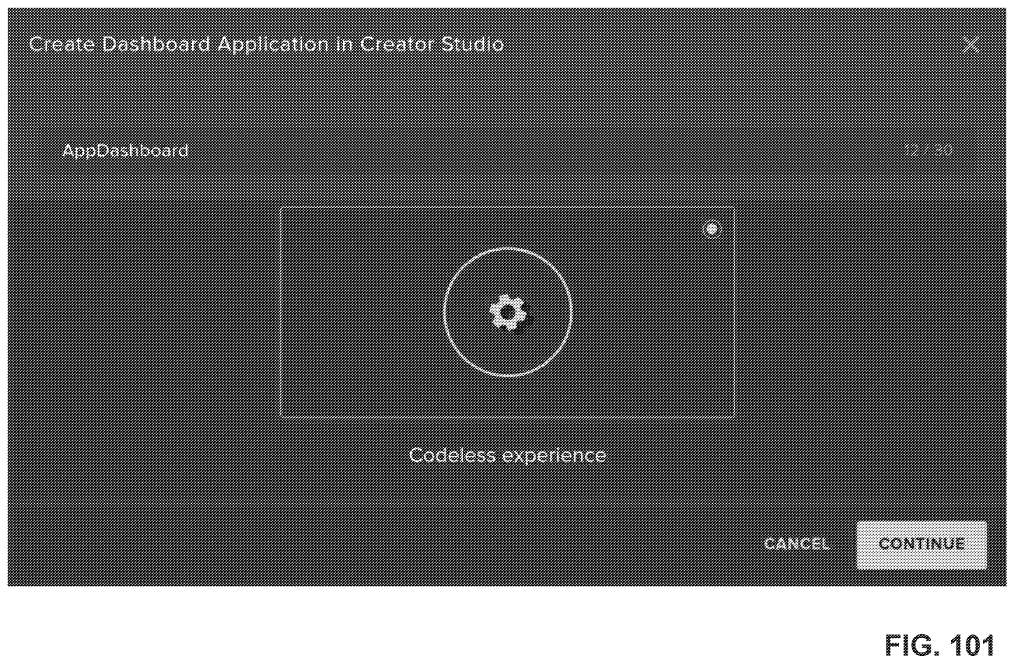

FIG. 100 is an image of a user interface according to certain embodiments of the present invention.

FIG. 101 is an image of a user interface according to certain embodiments of the present invention.

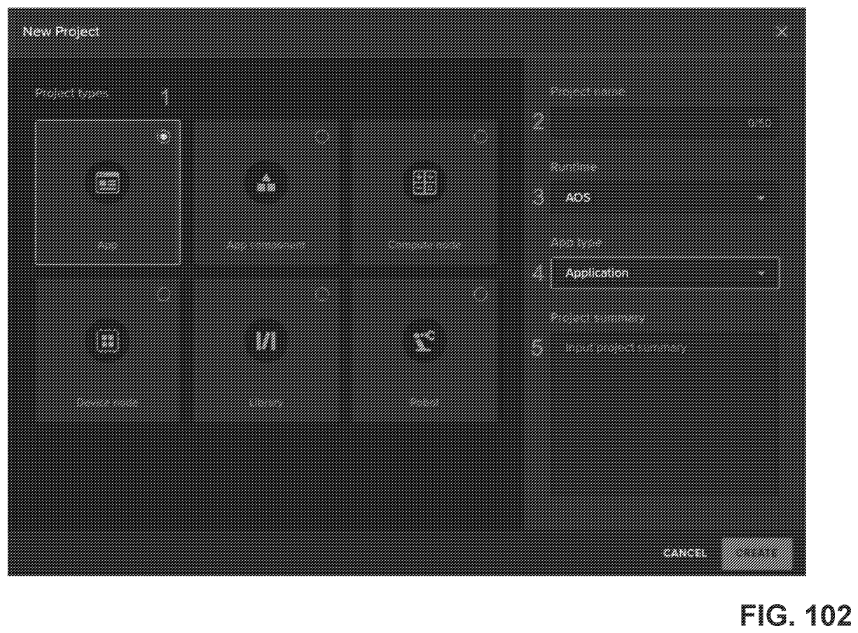

FIG. 102 is an image of a user interface according to certain embodiments of the present invention.

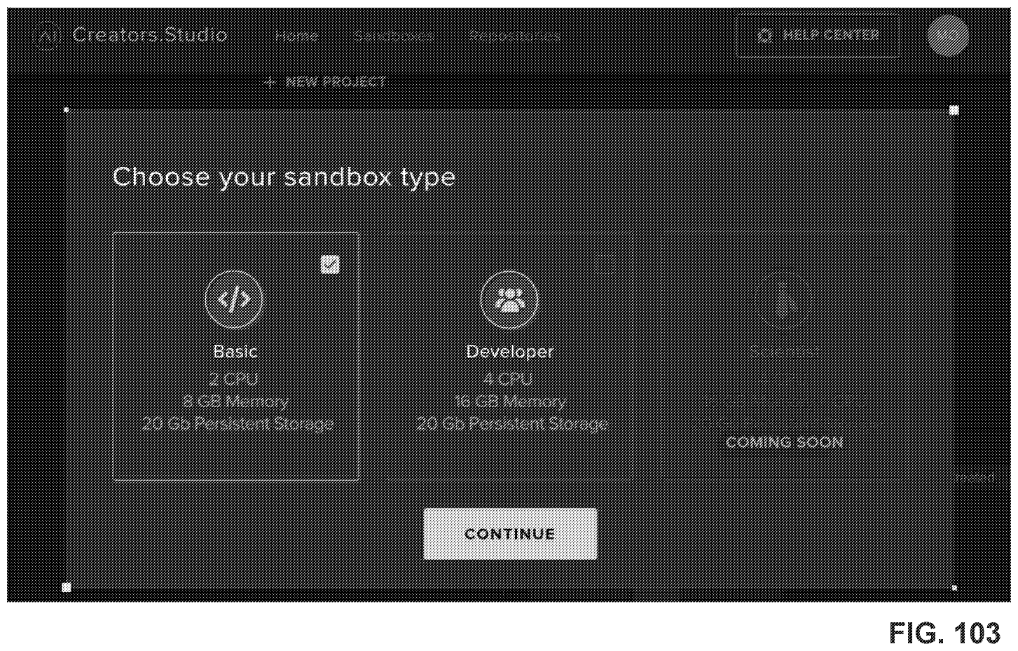

FIG. 103 is an image of a user interface according to certain embodiments of the present invention.

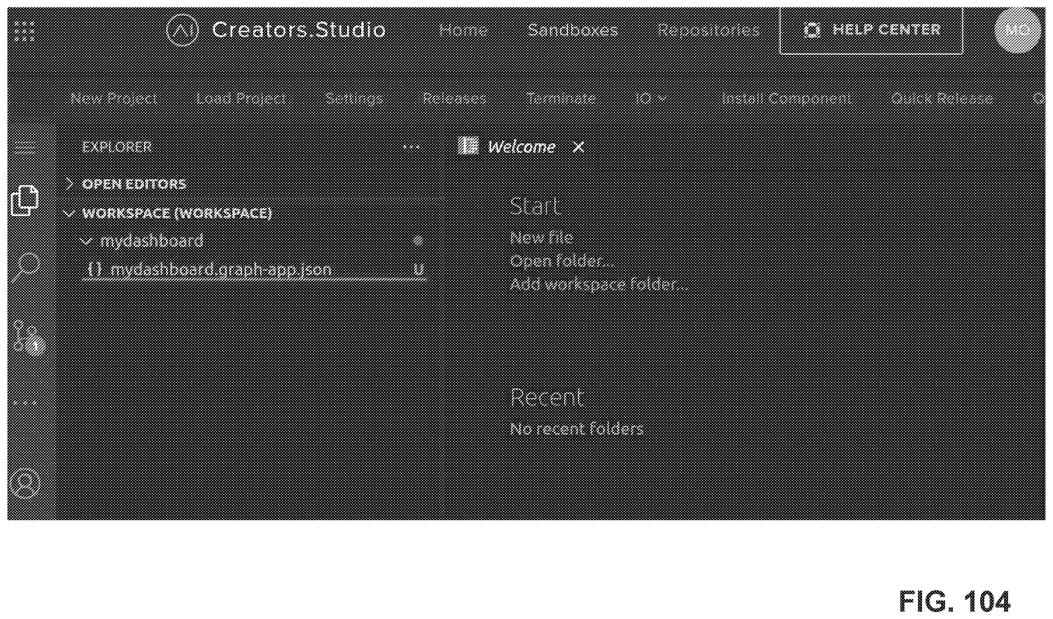

FIG. 104 is an image of a user interface according to certain embodiments of the present invention.

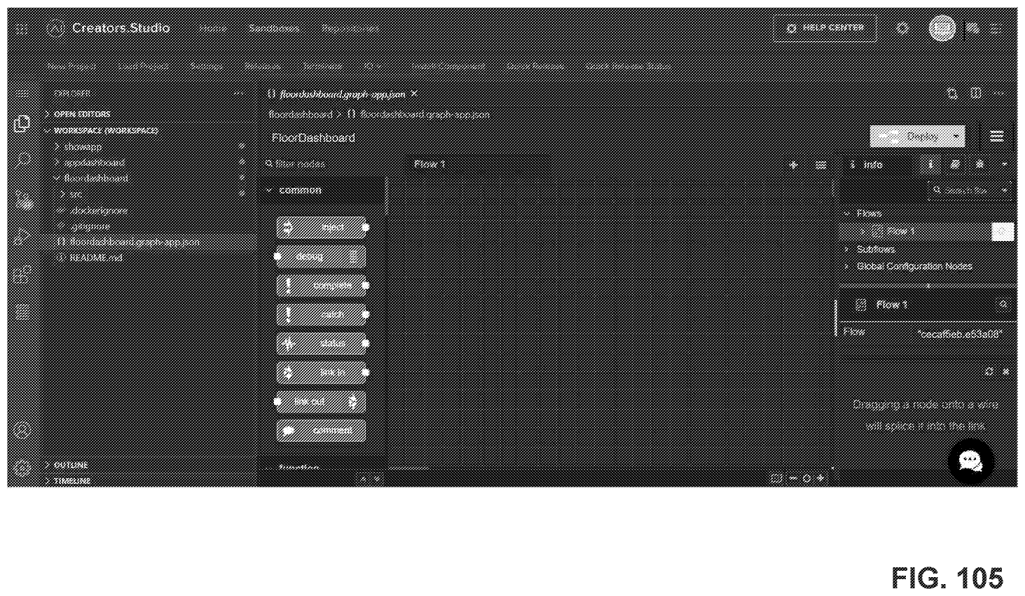

FIG. 105 is an image of a user interface according to certain embodiments of the present invention.

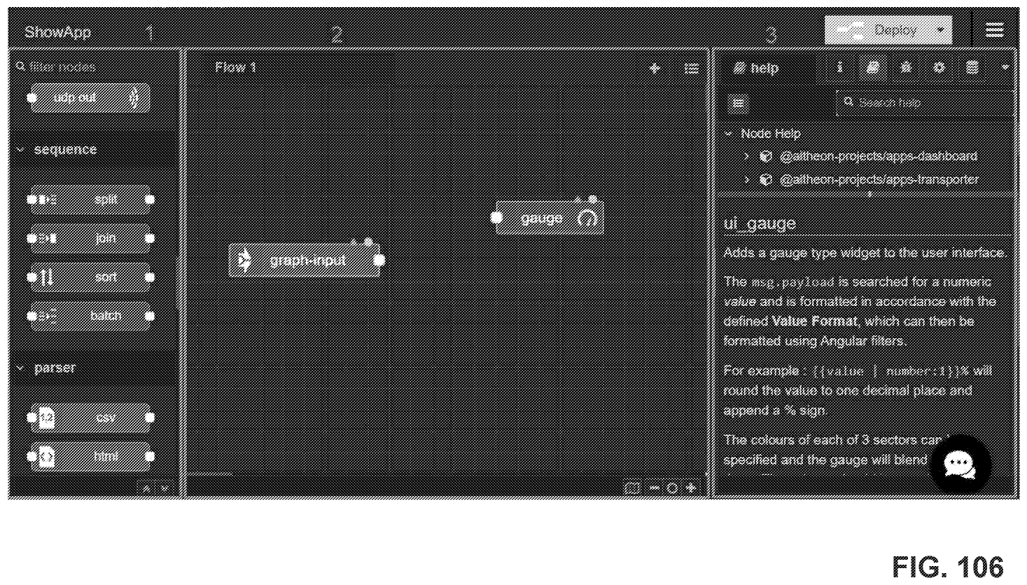

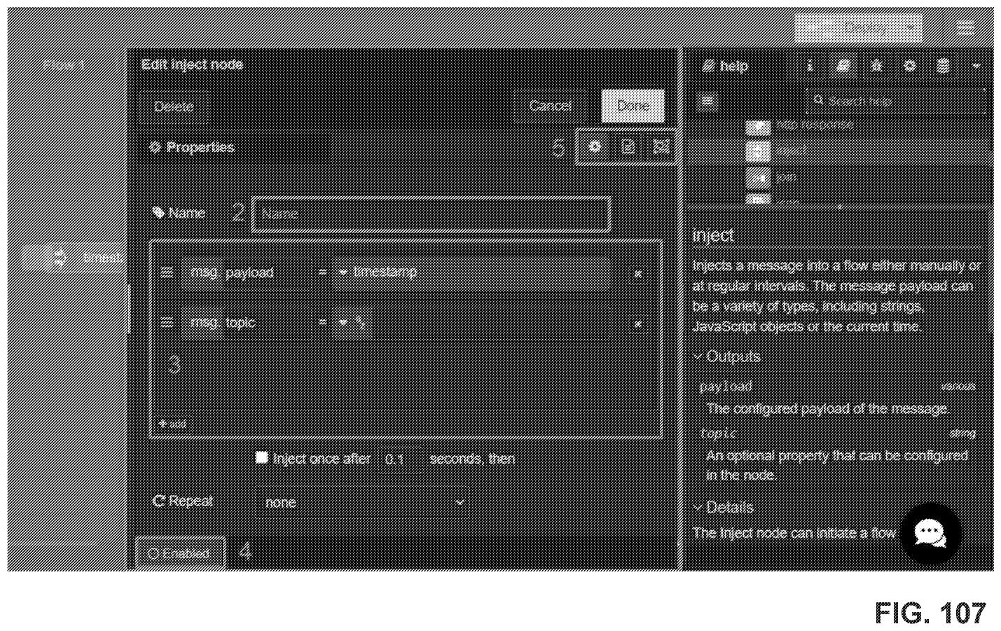

FIG. 106 is an image of a user interface according to certain embodiments of the present invention.

FIG. 107 is an image of a user interface according to certain embodiments of the present invention.

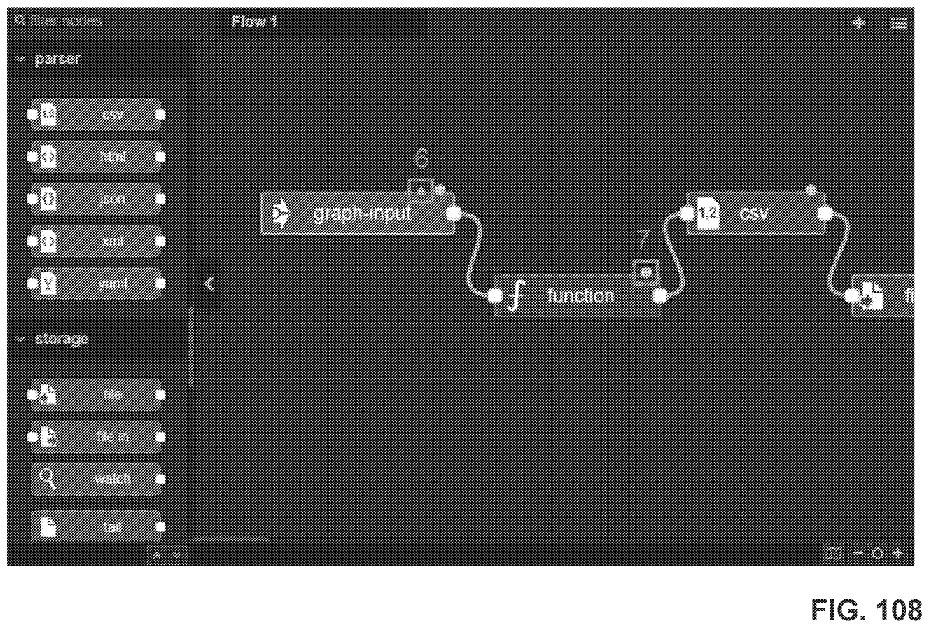

FIG. 108 is an image of a user interface according to certain embodiments of the present invention.

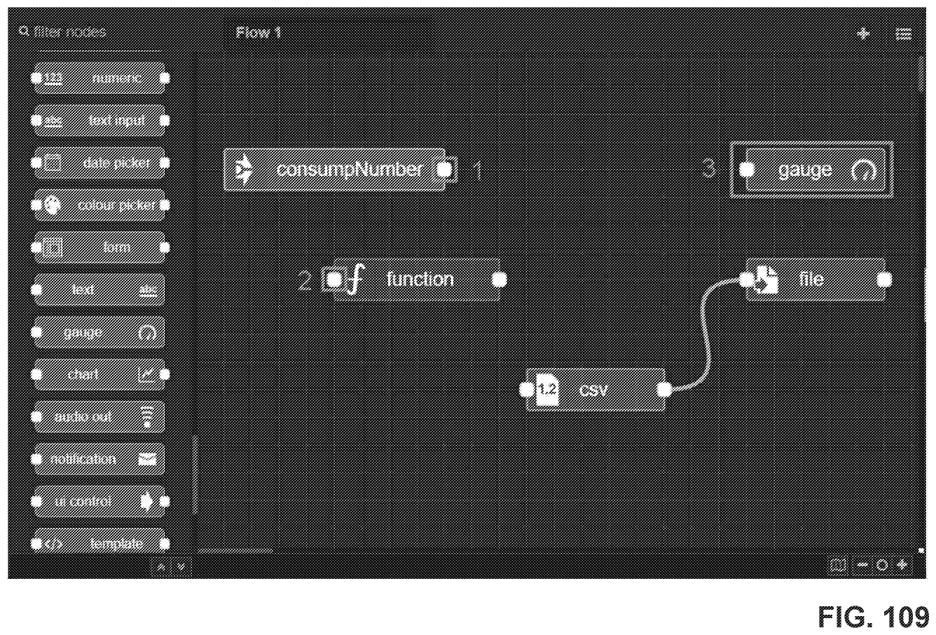

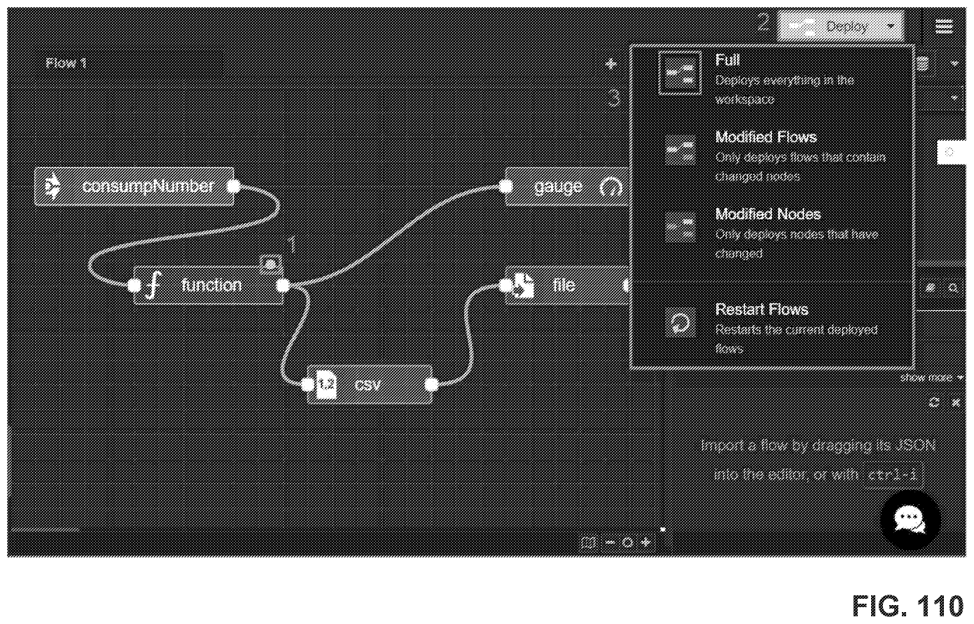

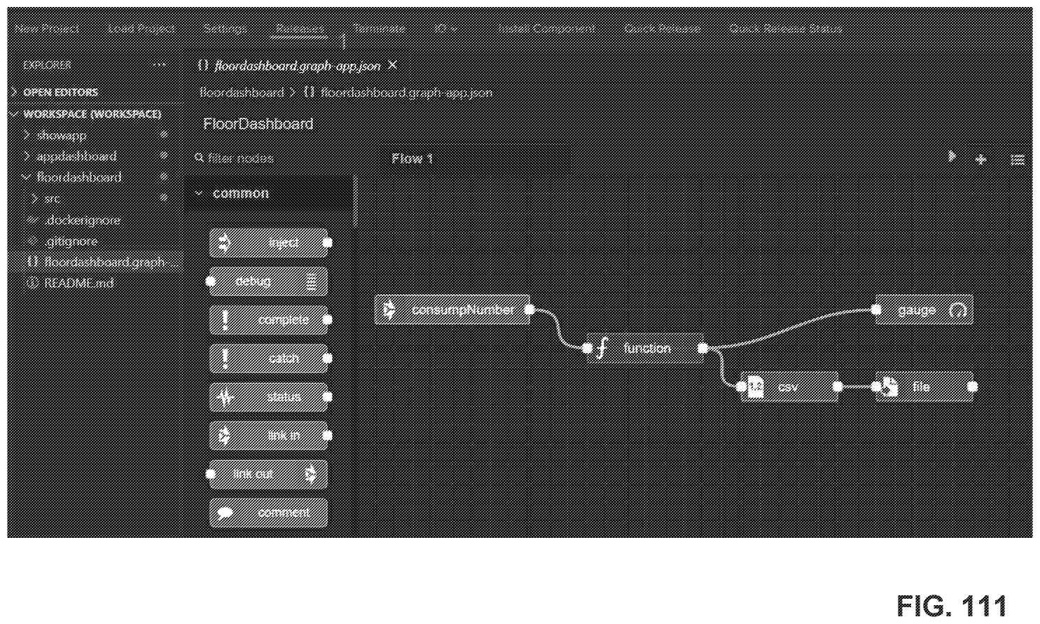

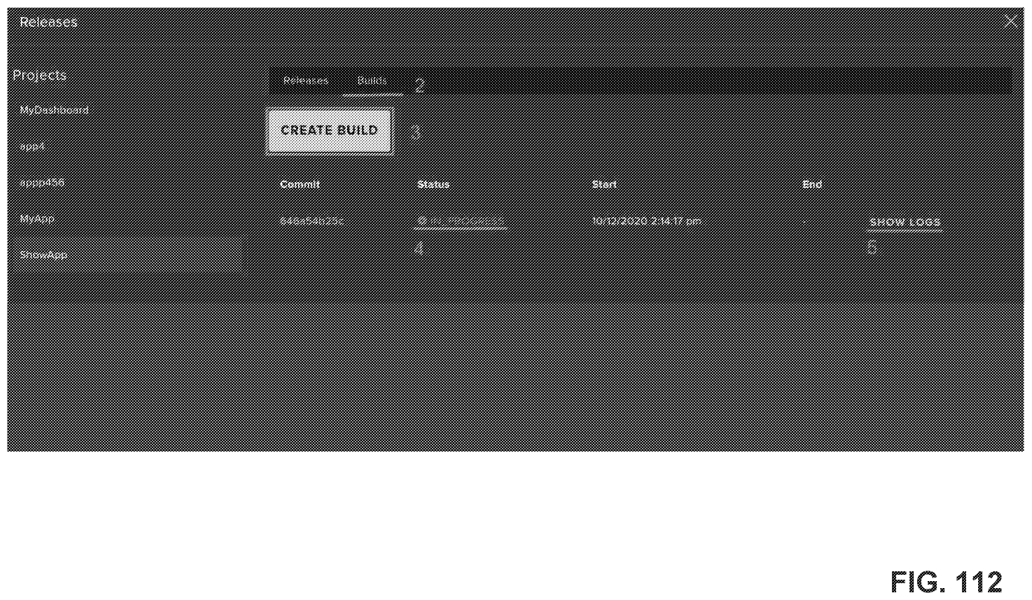

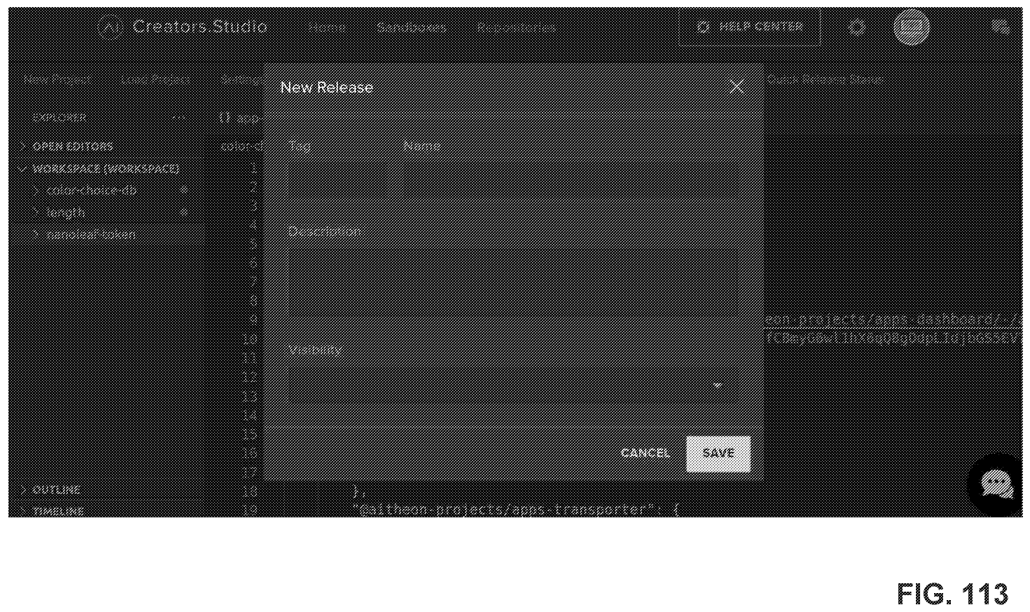

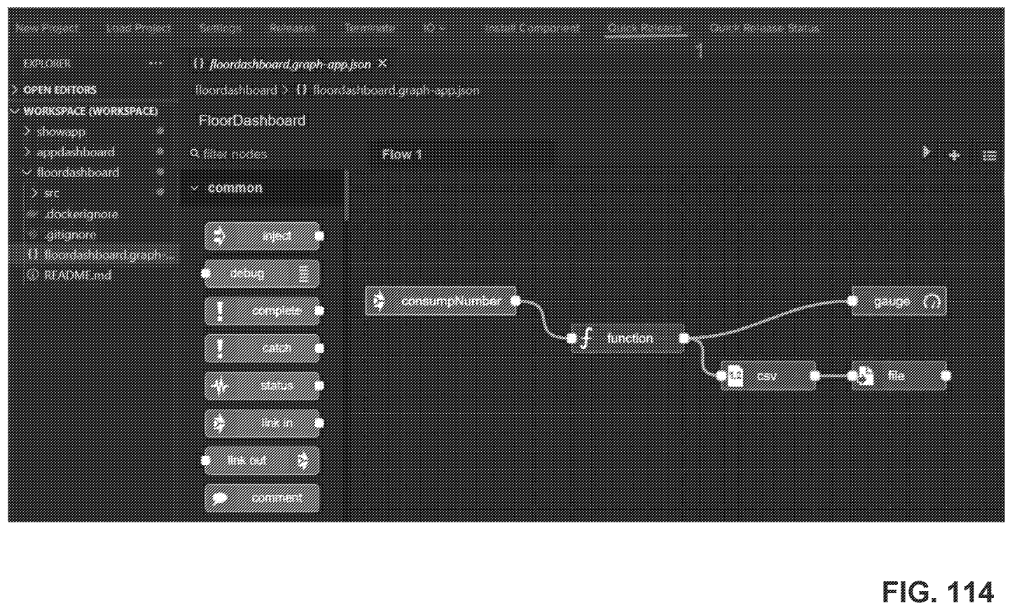

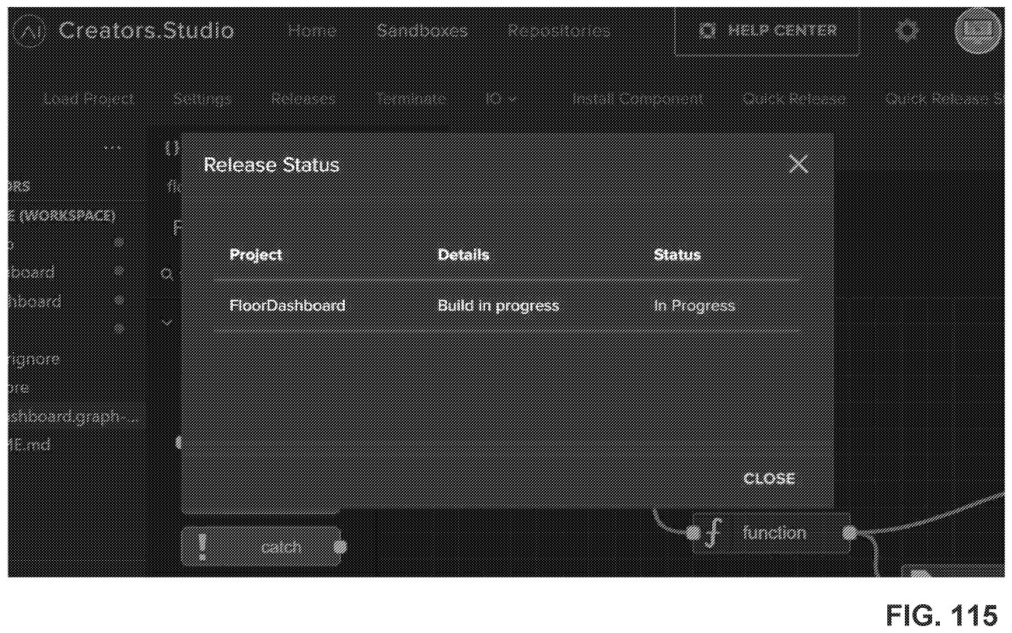

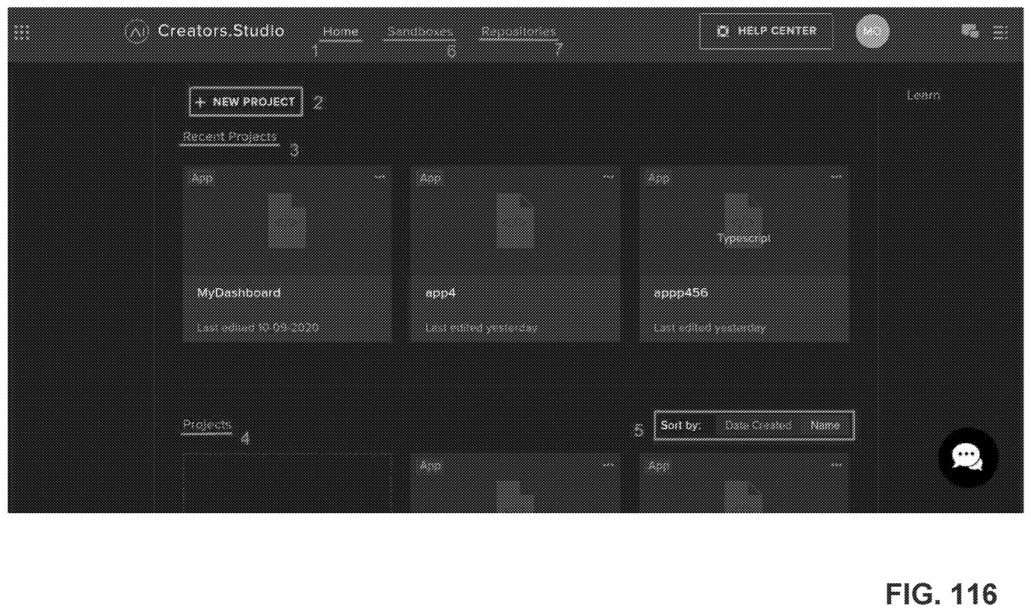

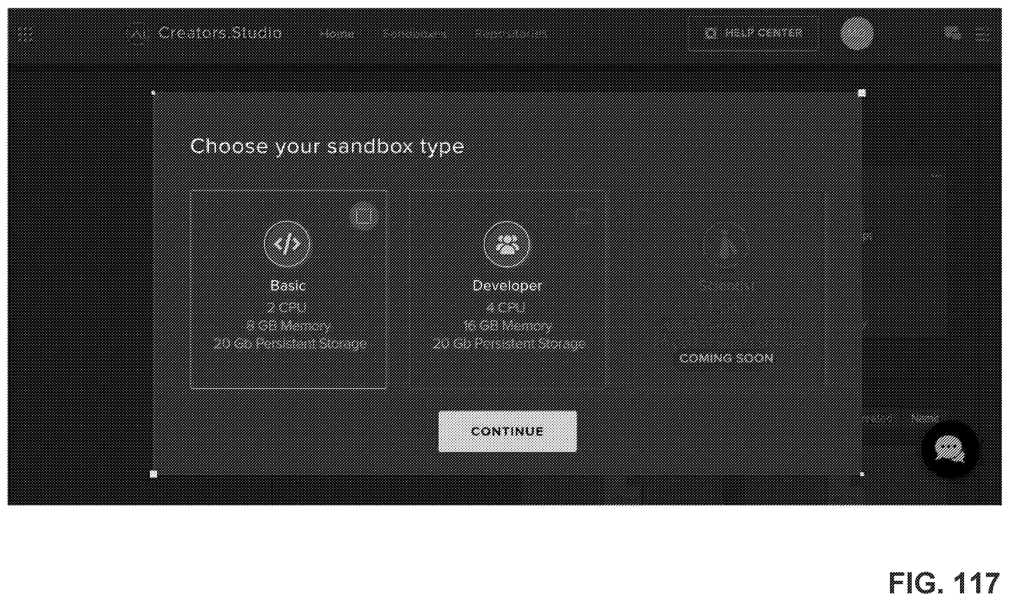

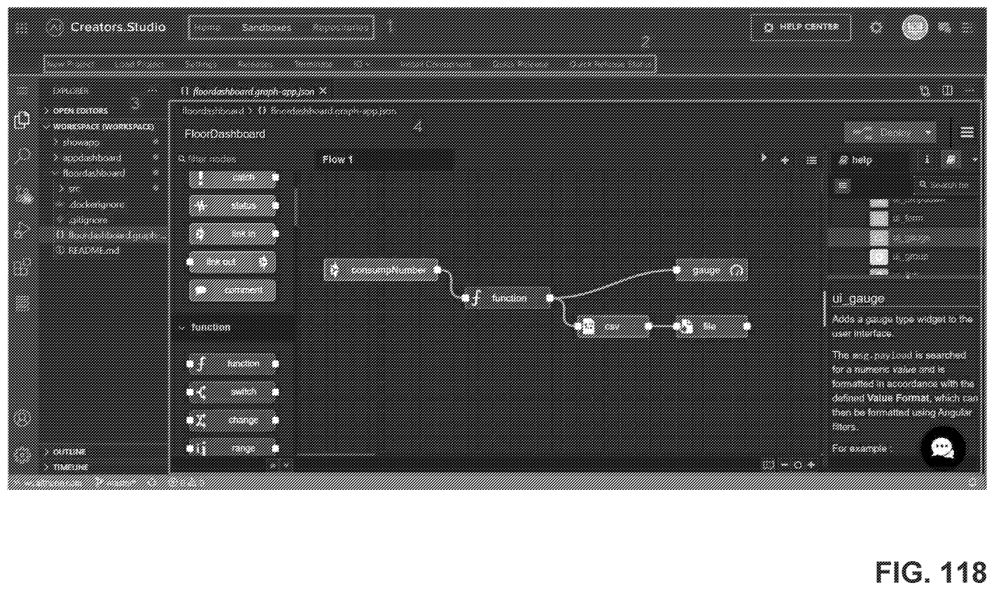

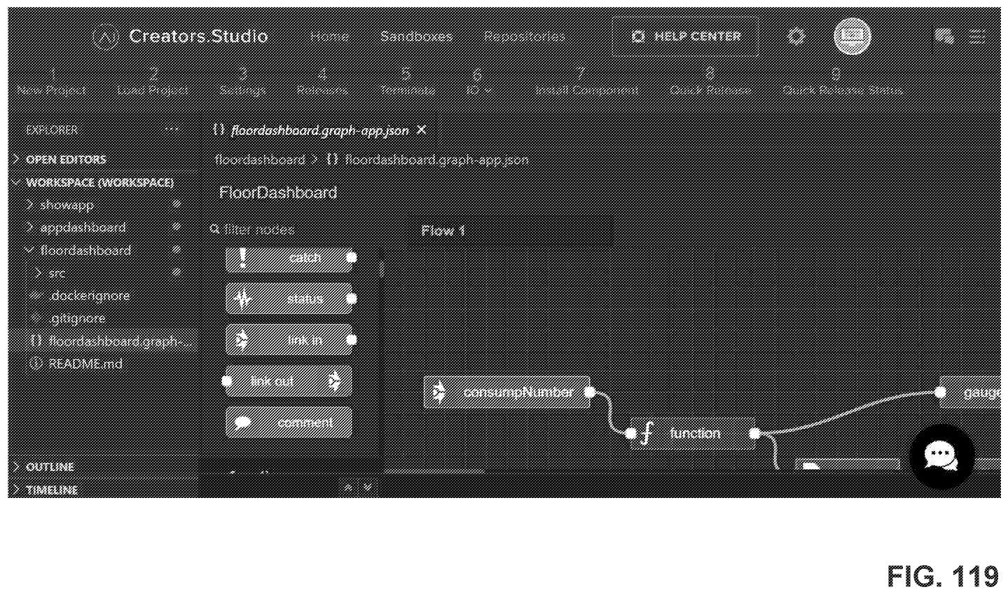

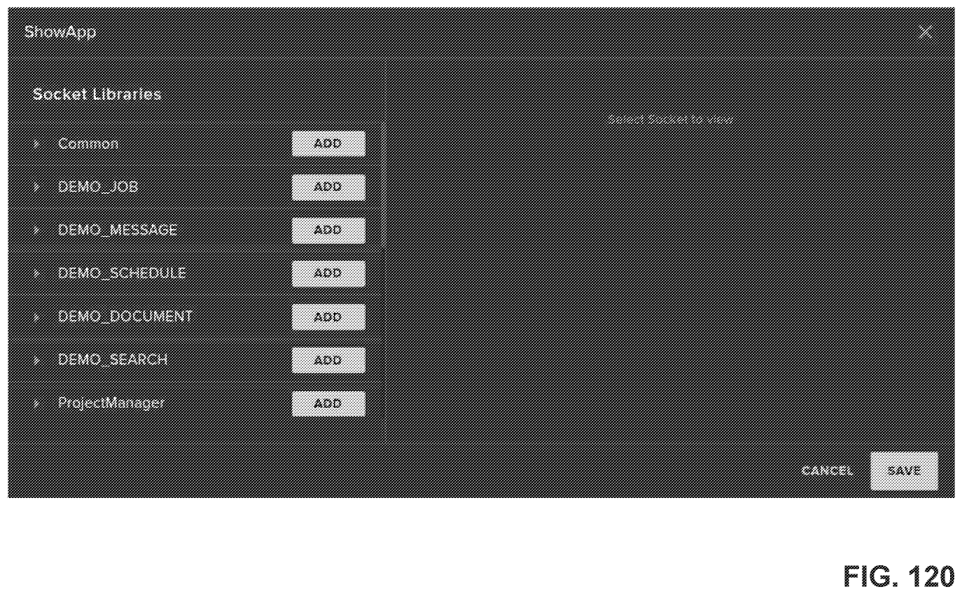

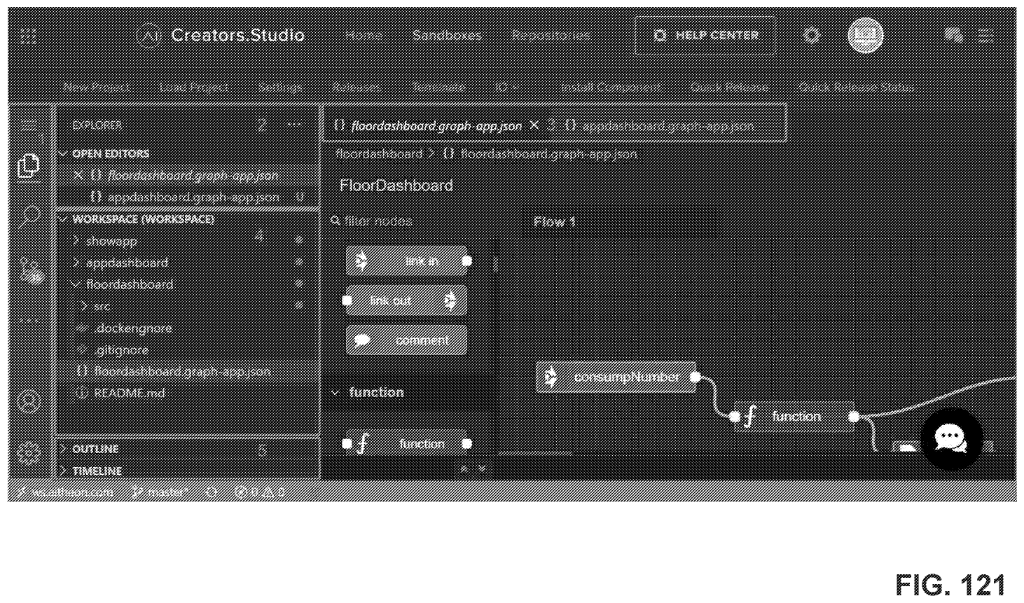

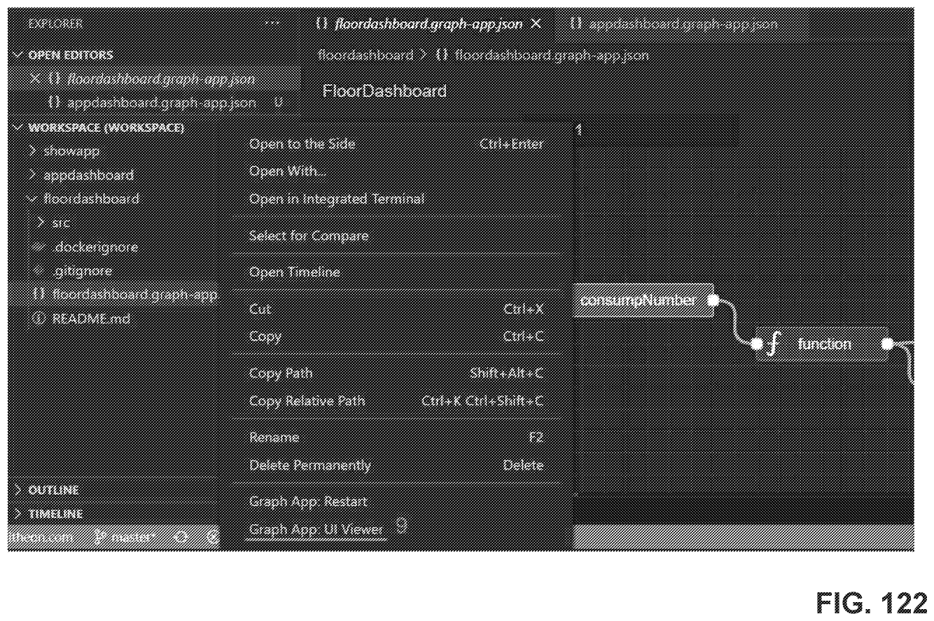

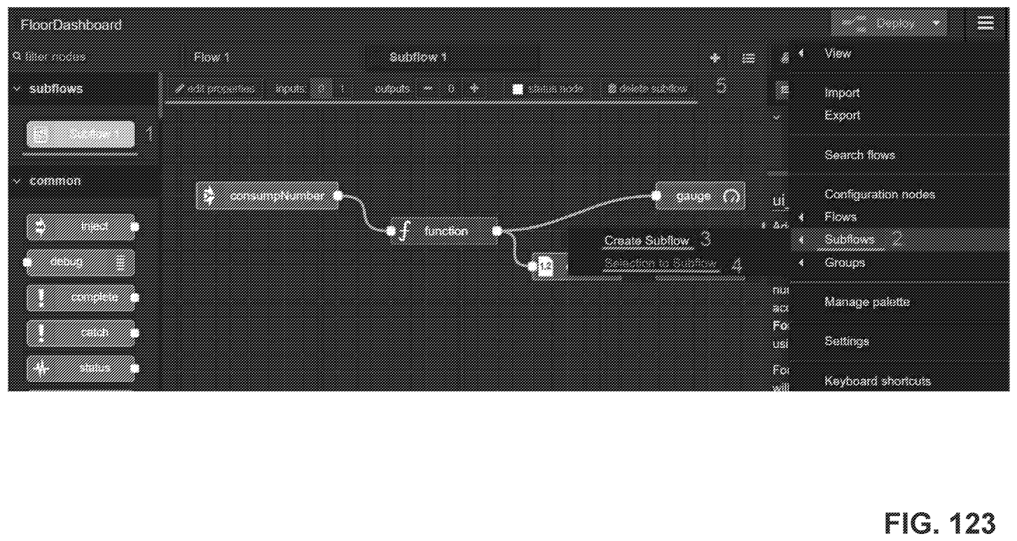

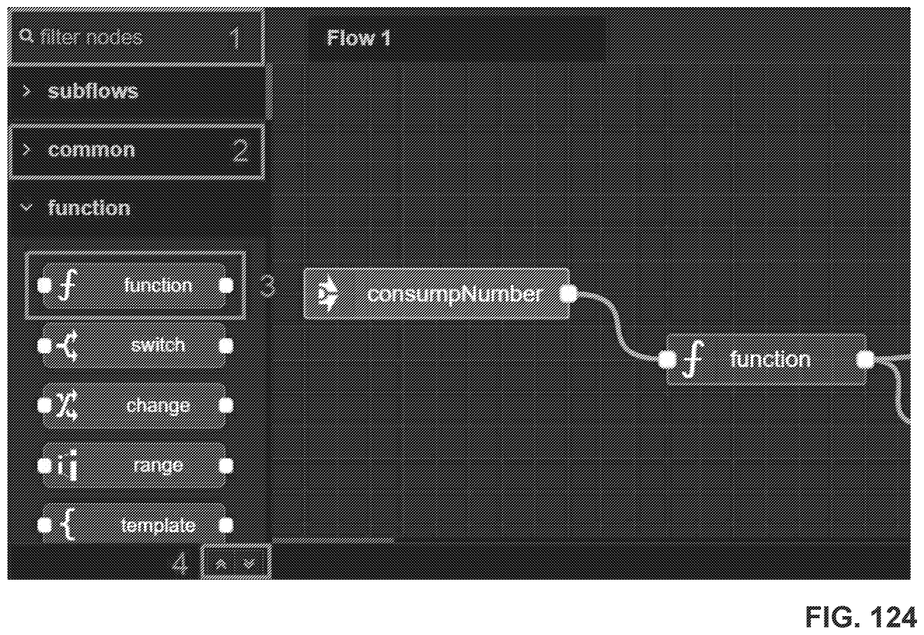

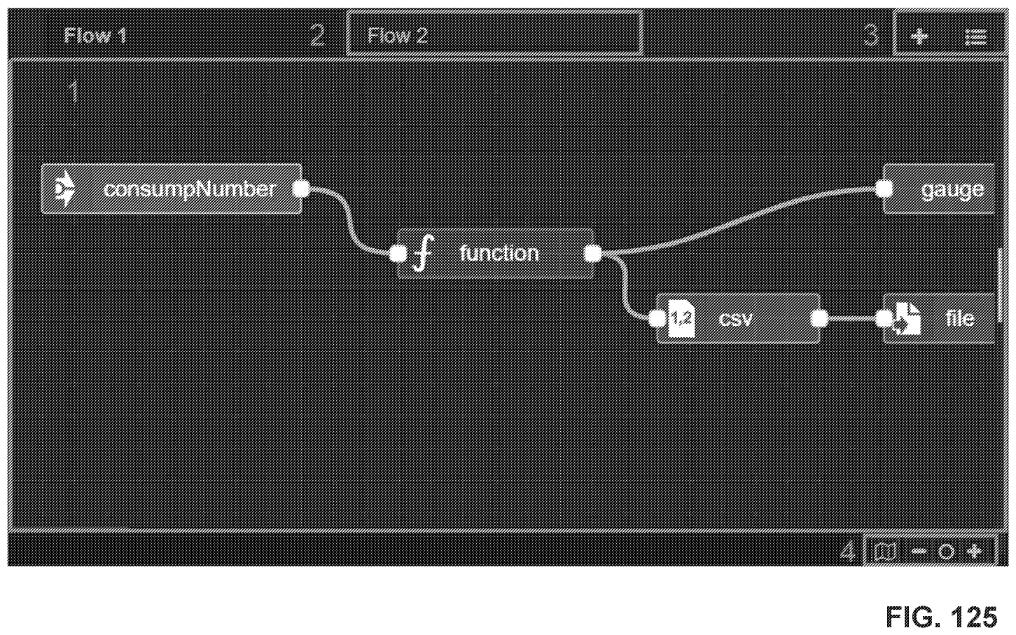

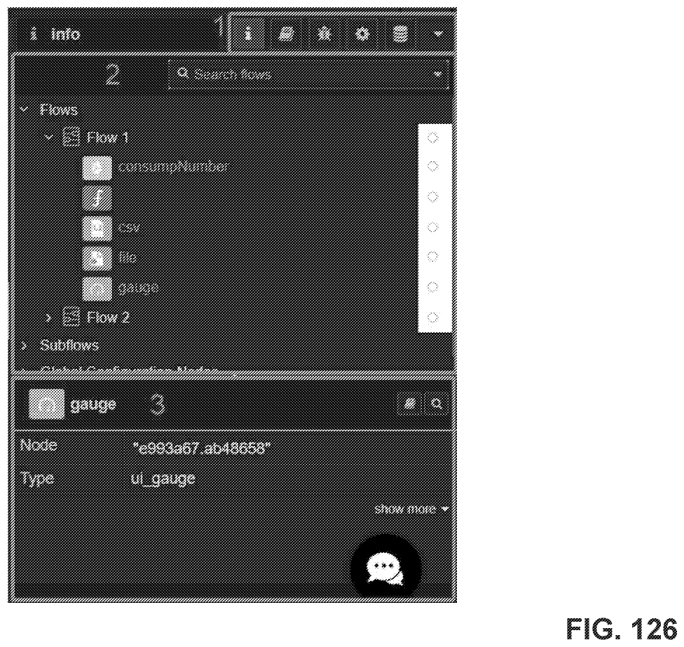

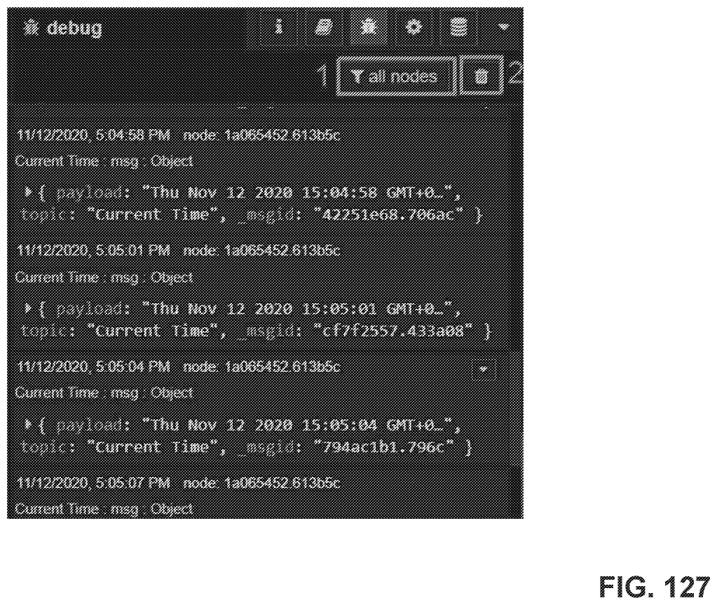

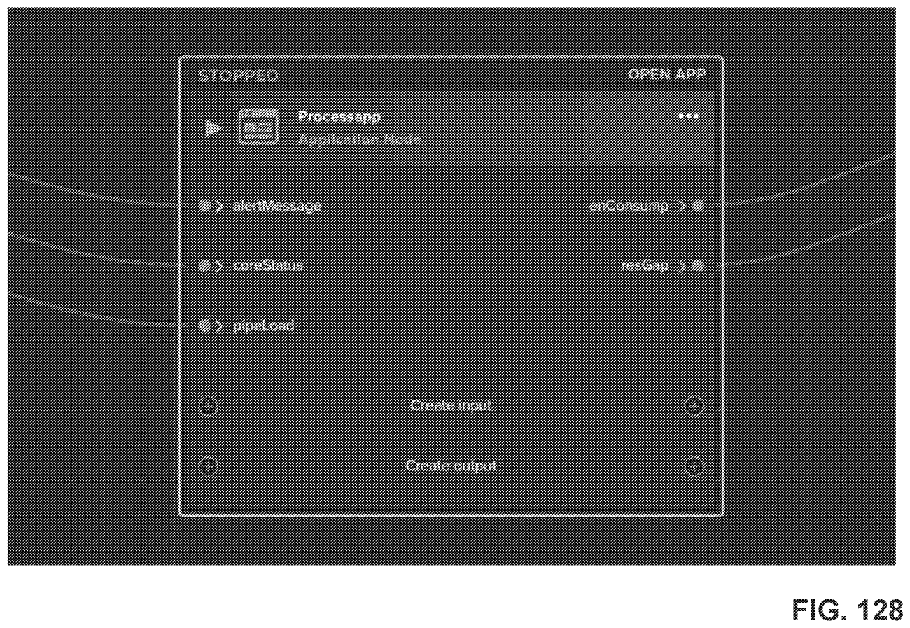

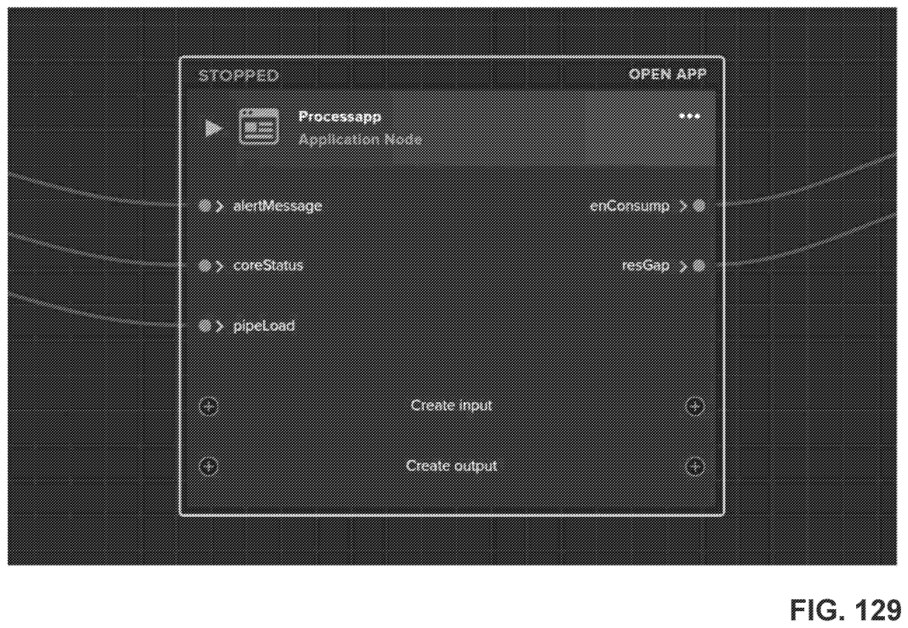

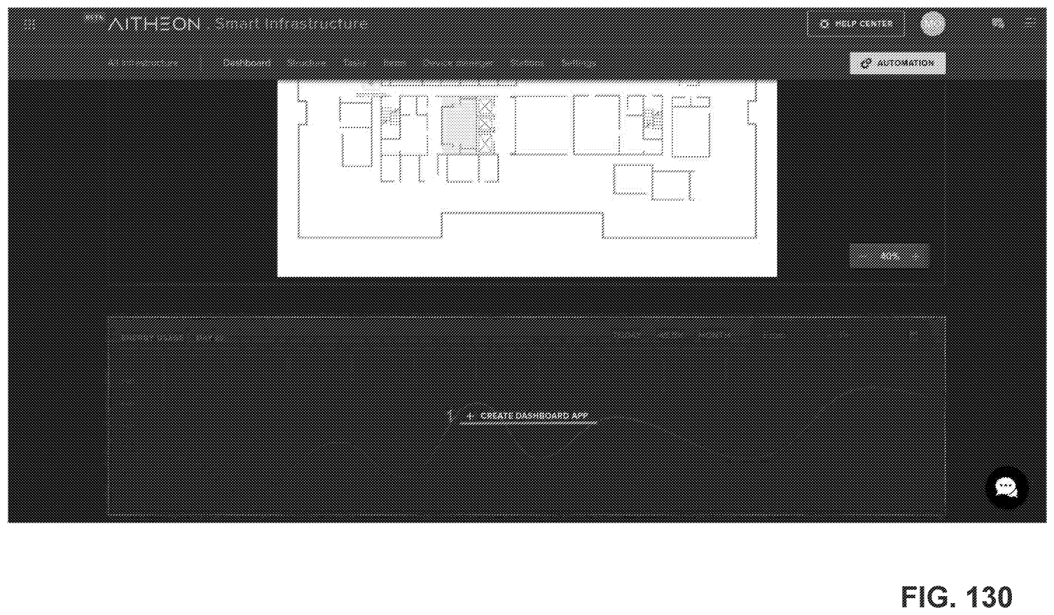

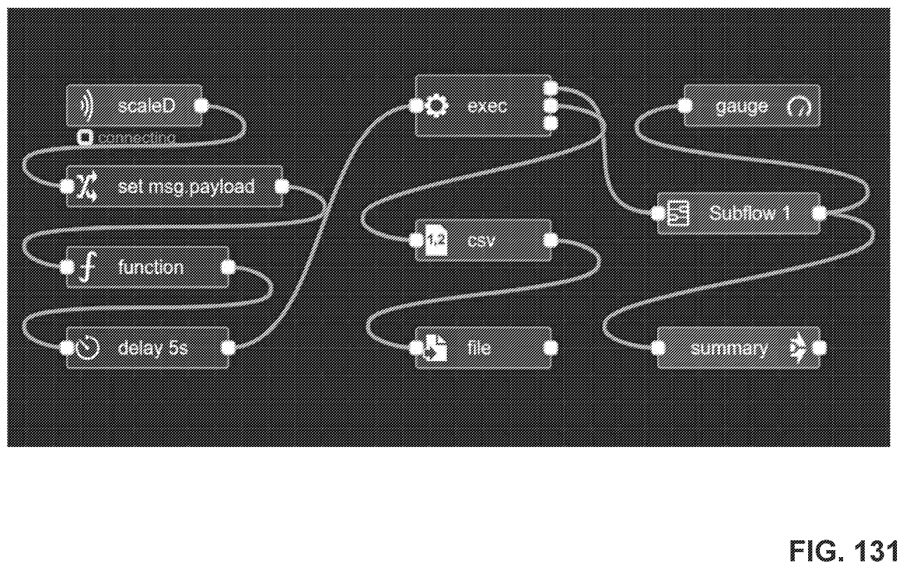

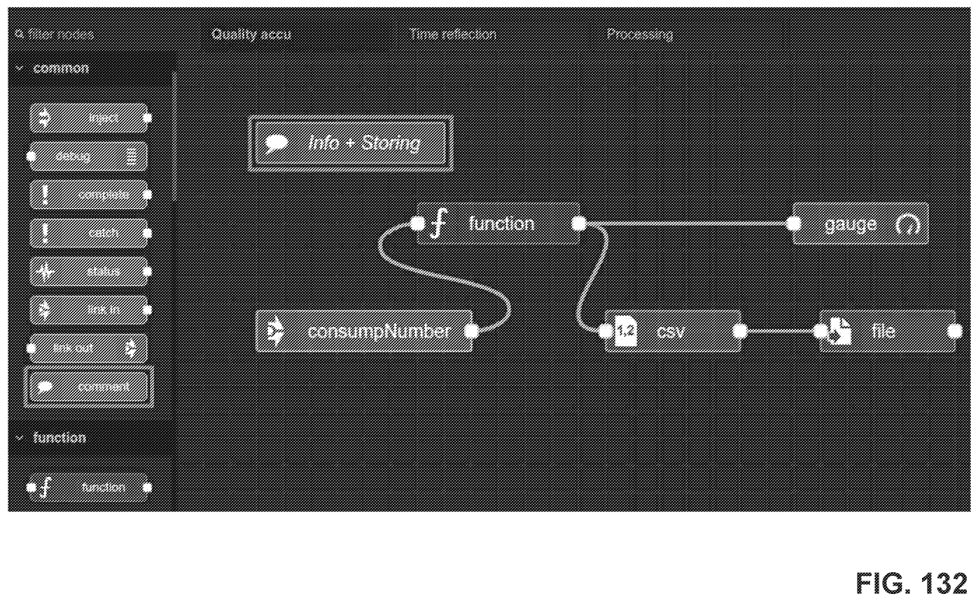

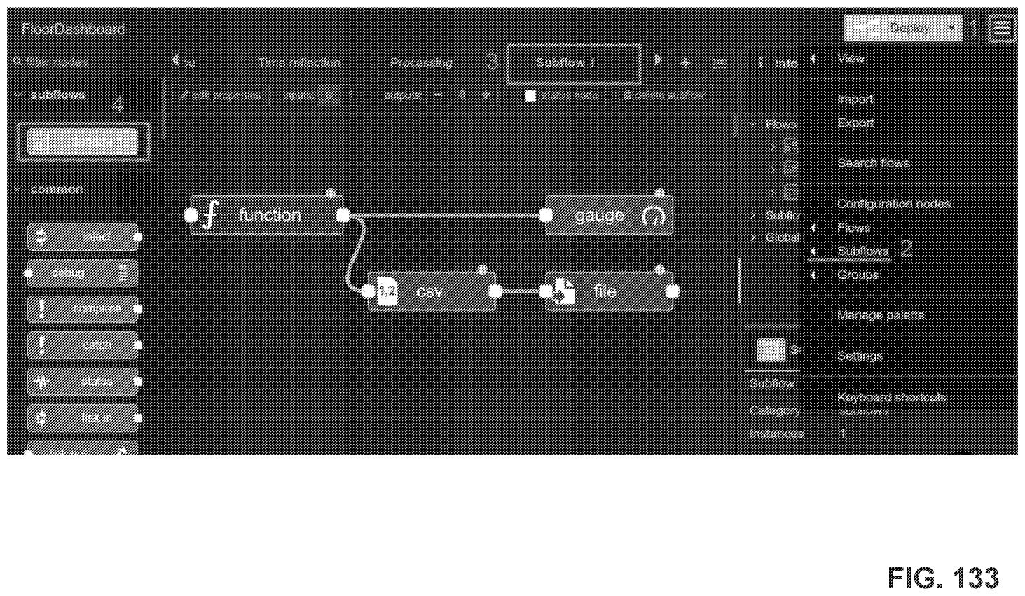

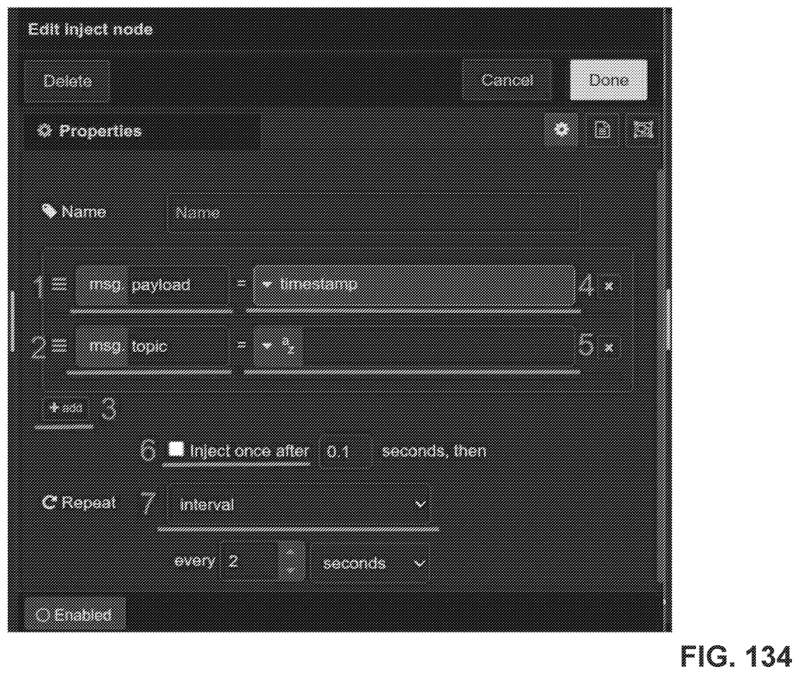

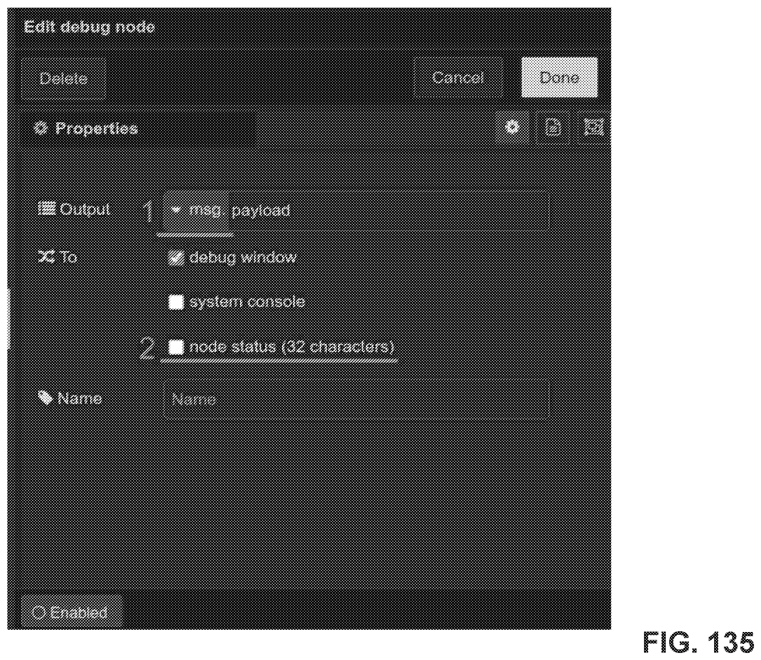

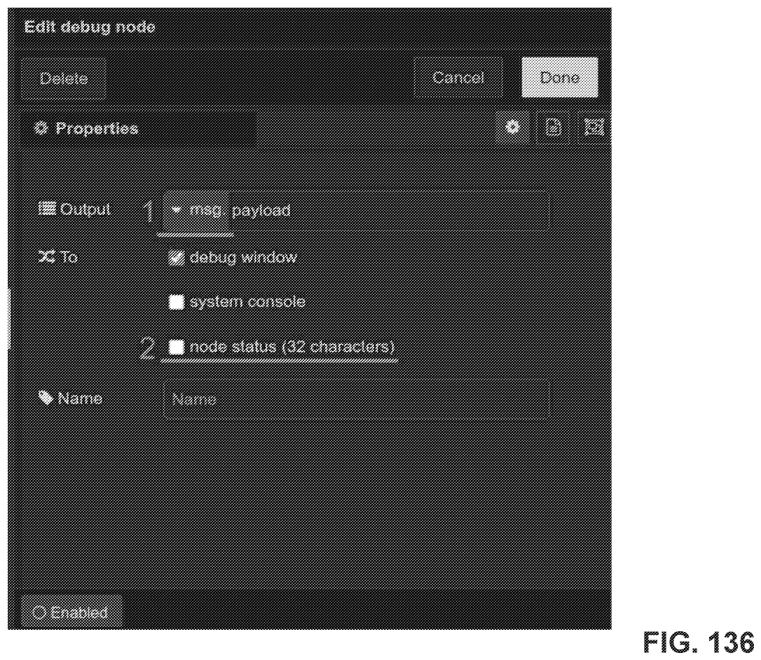

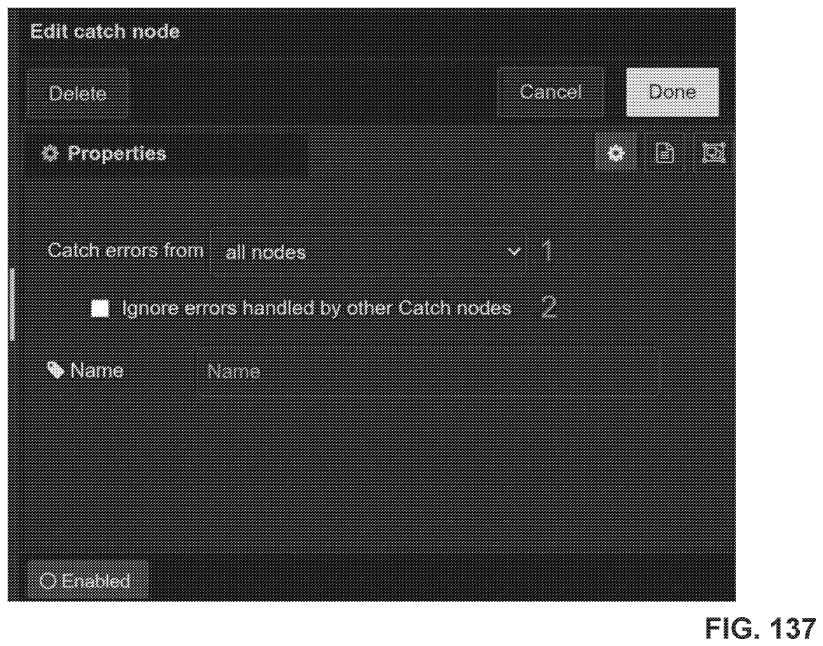

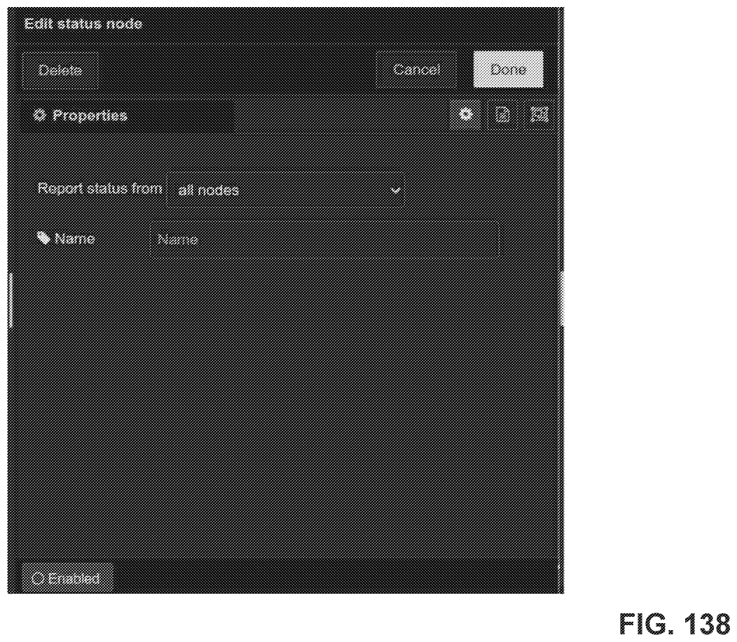

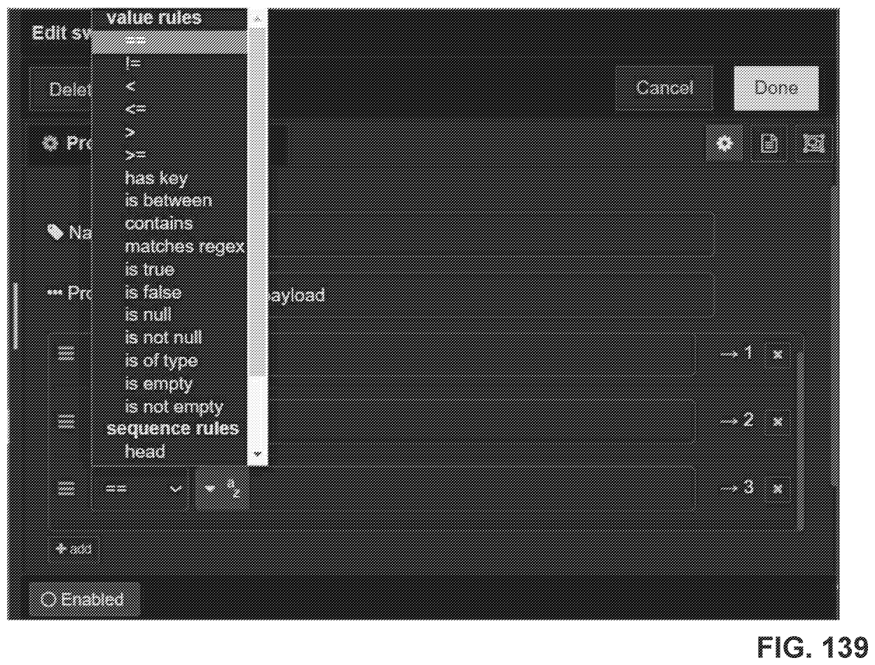

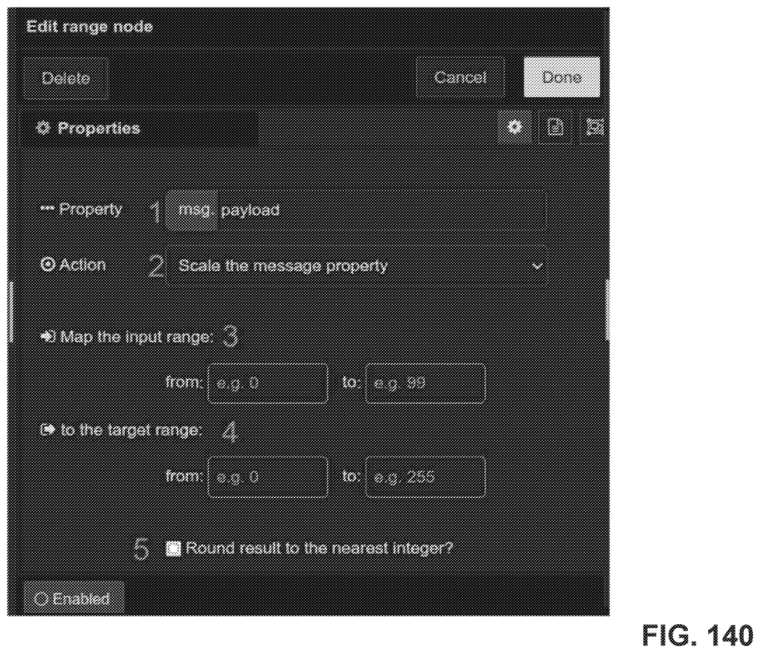

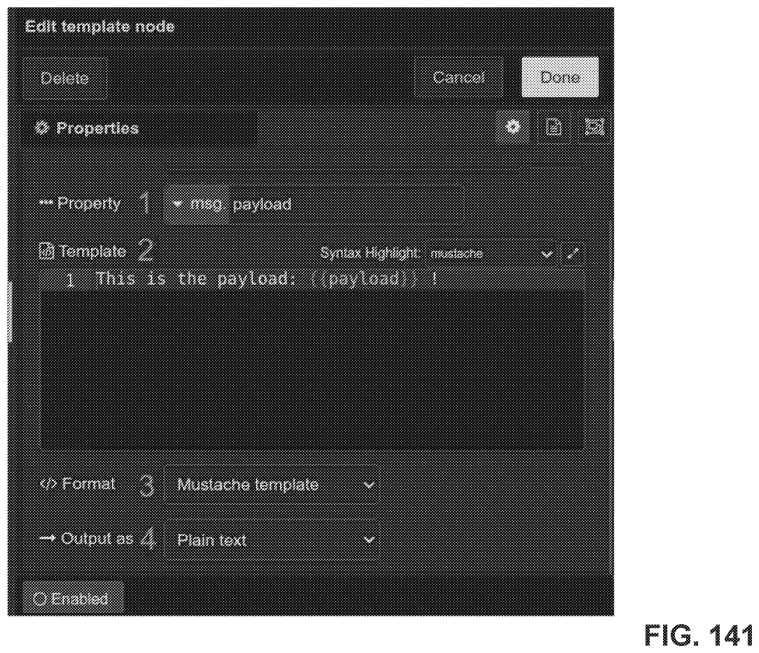

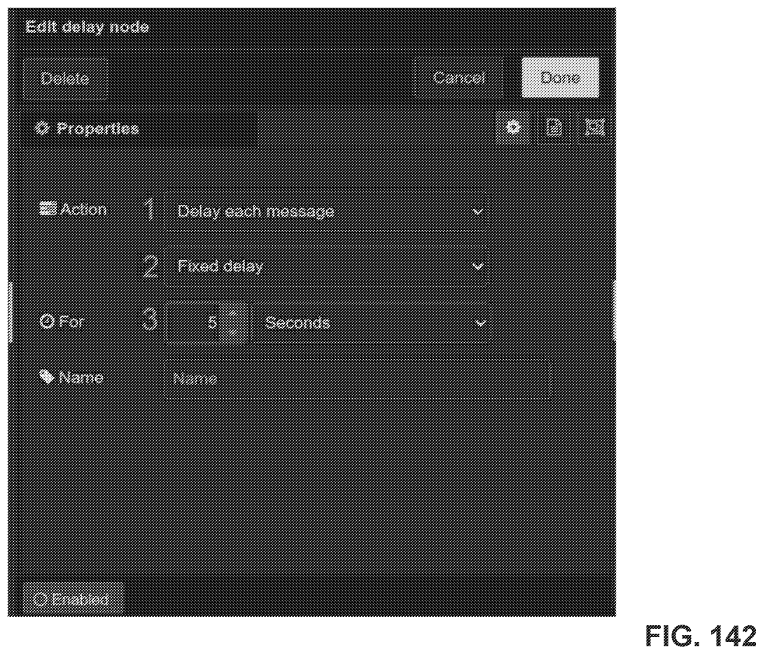

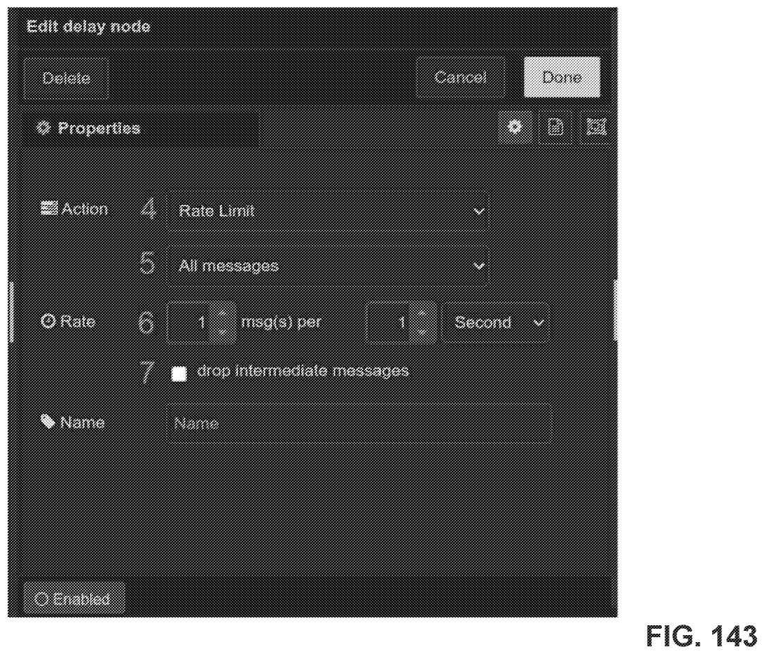

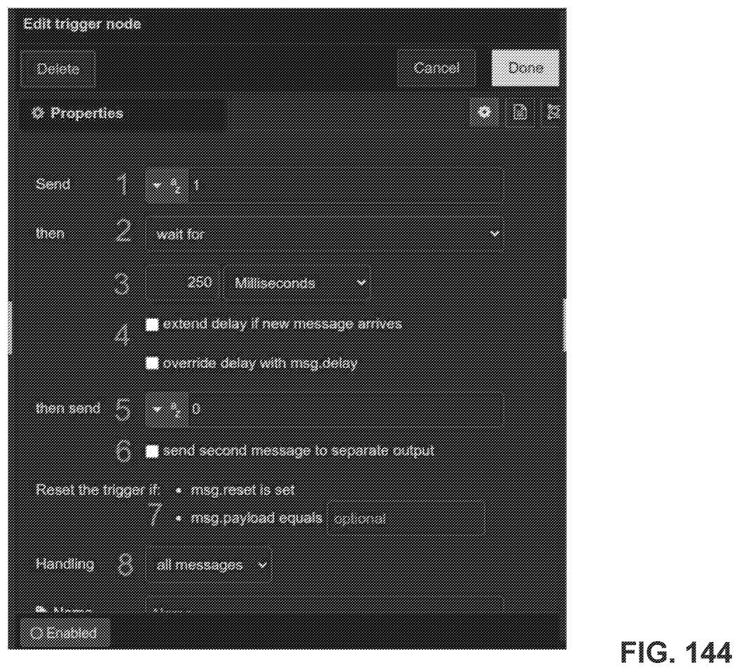

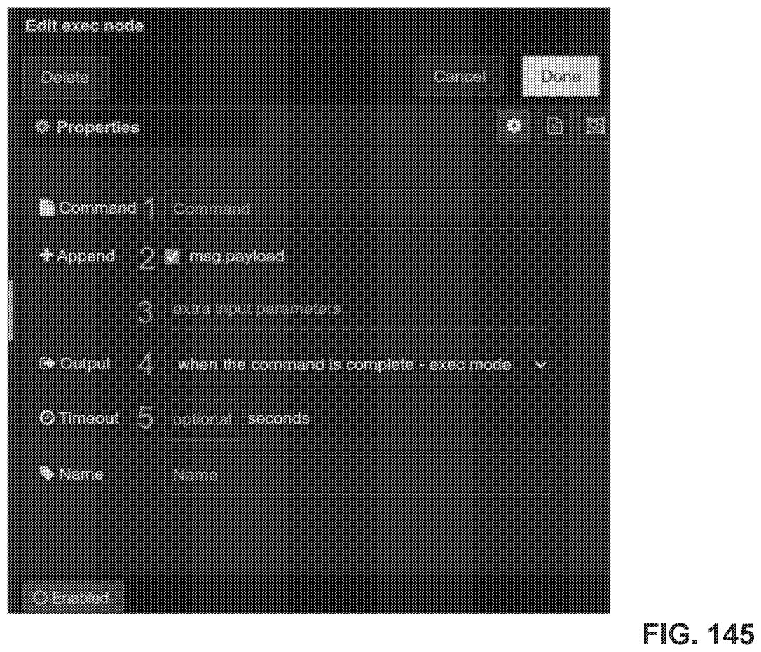

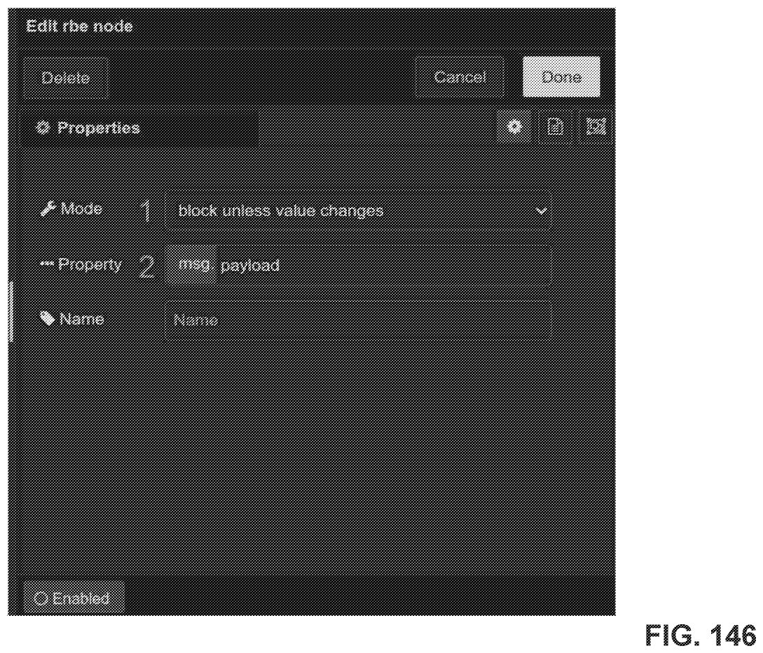

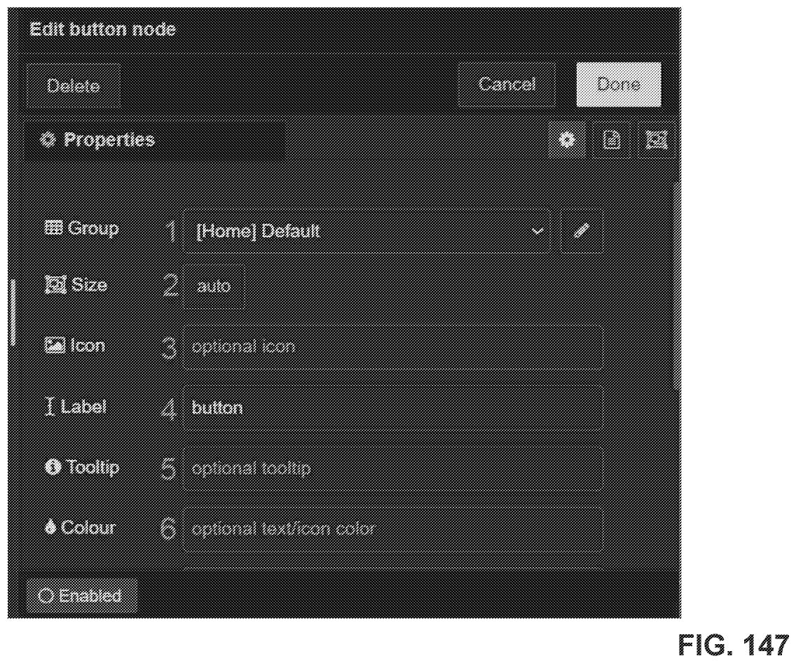

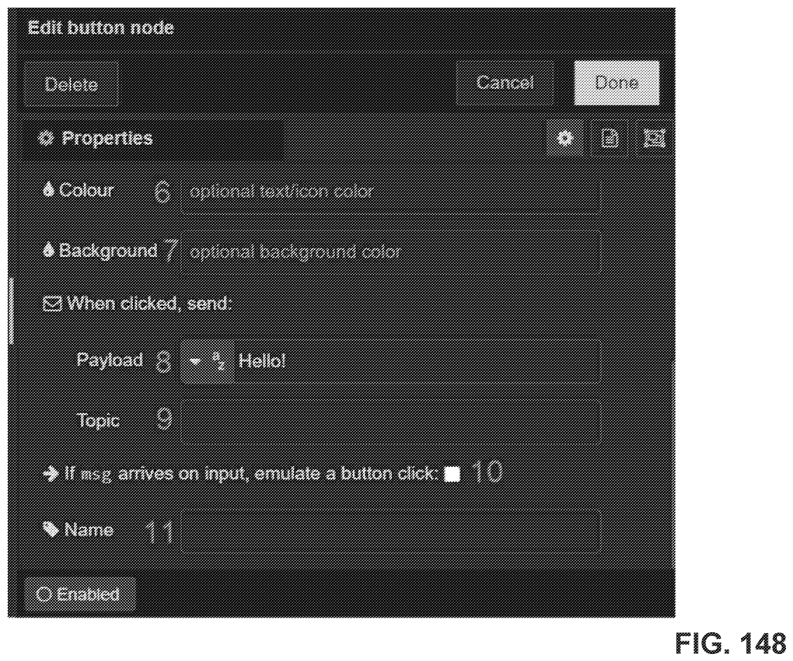

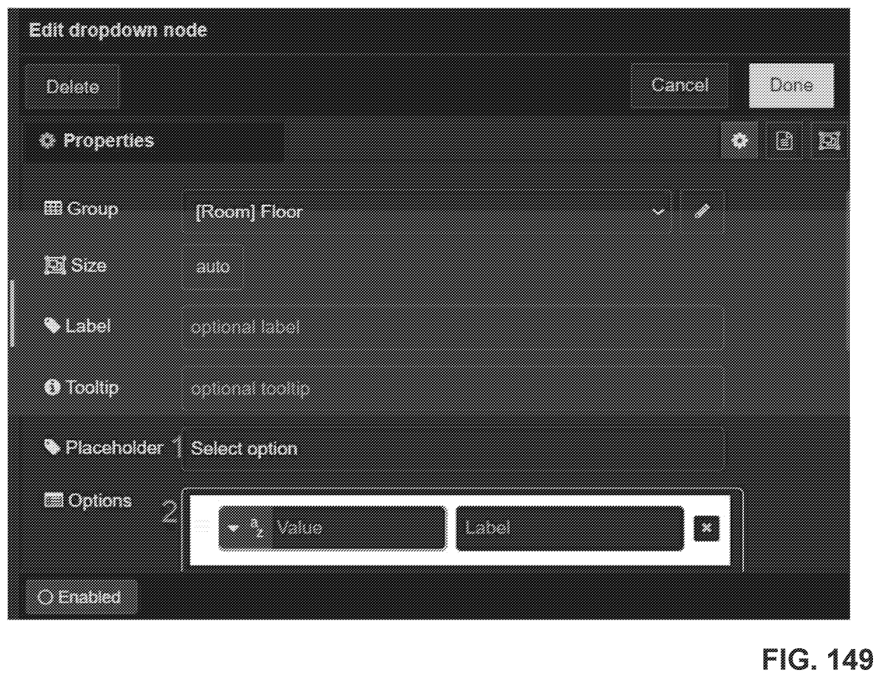

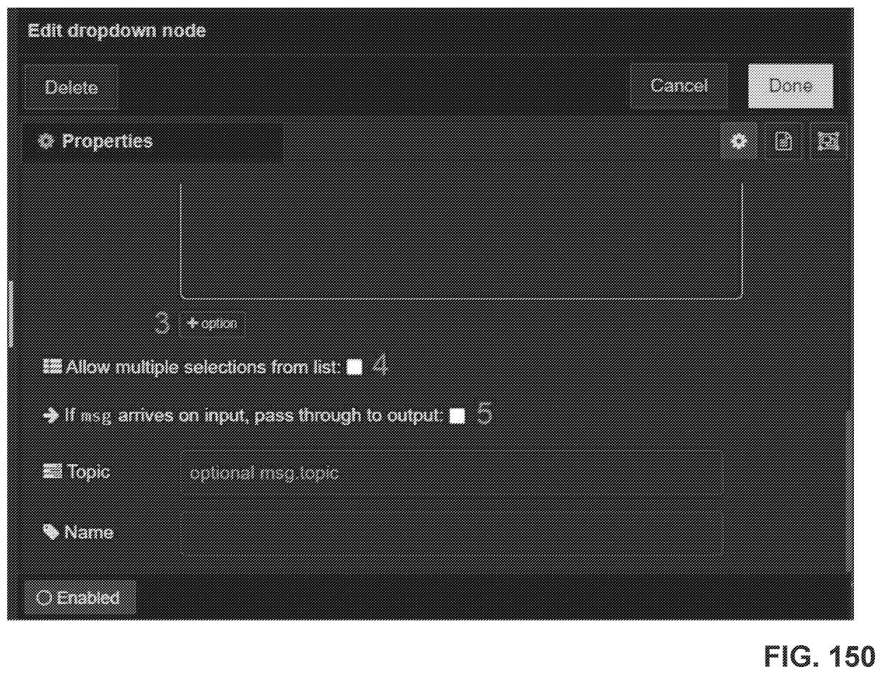

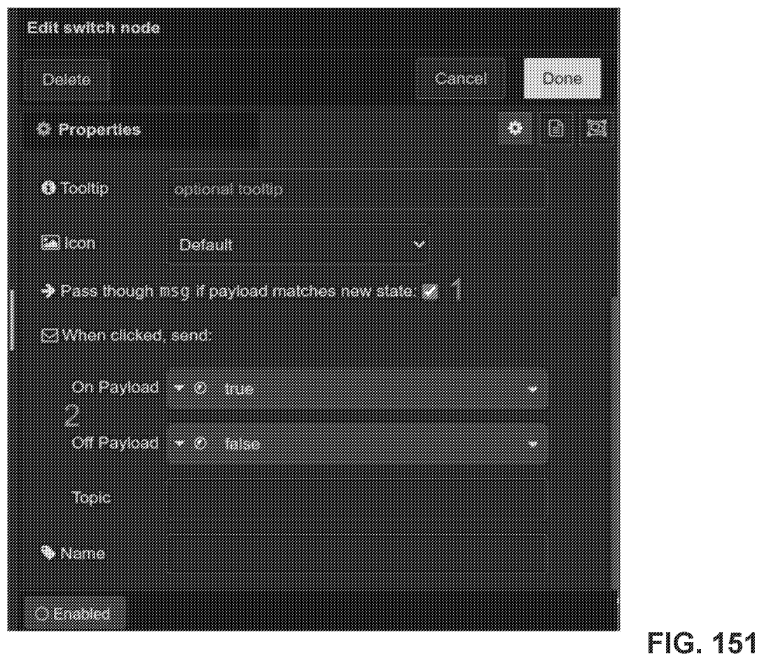

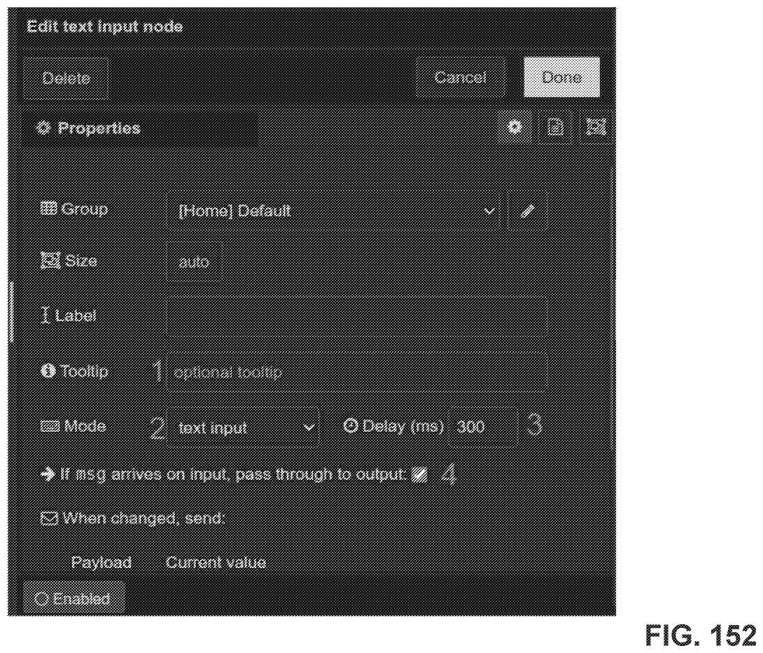

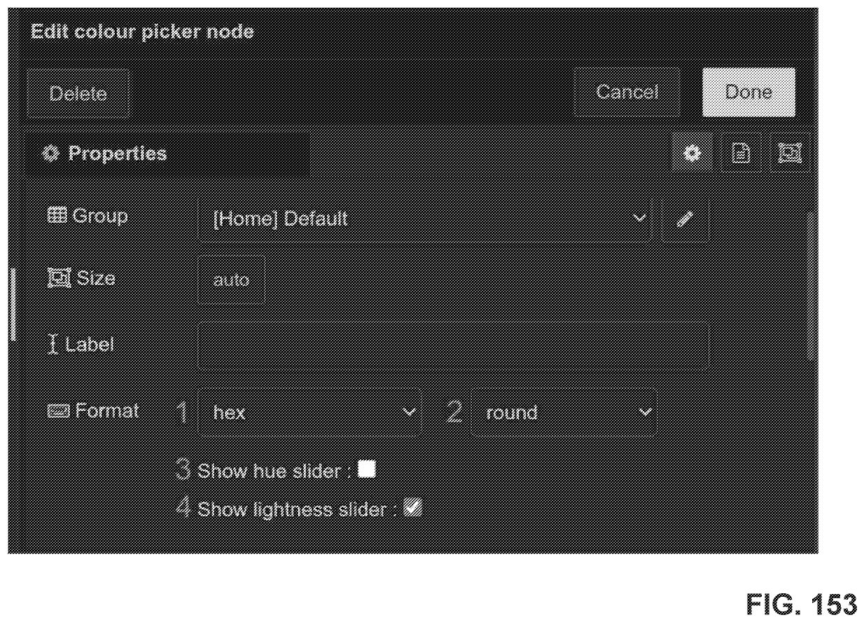

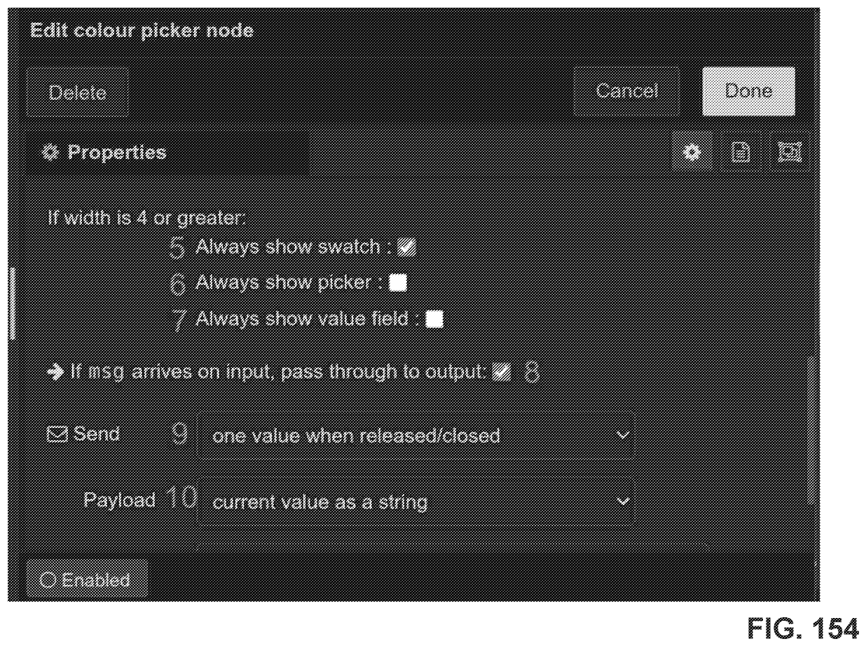

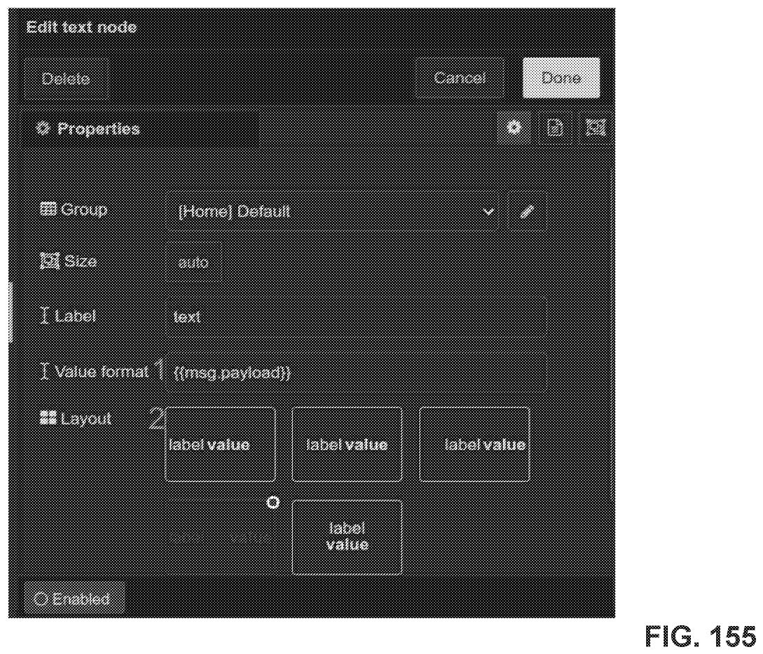

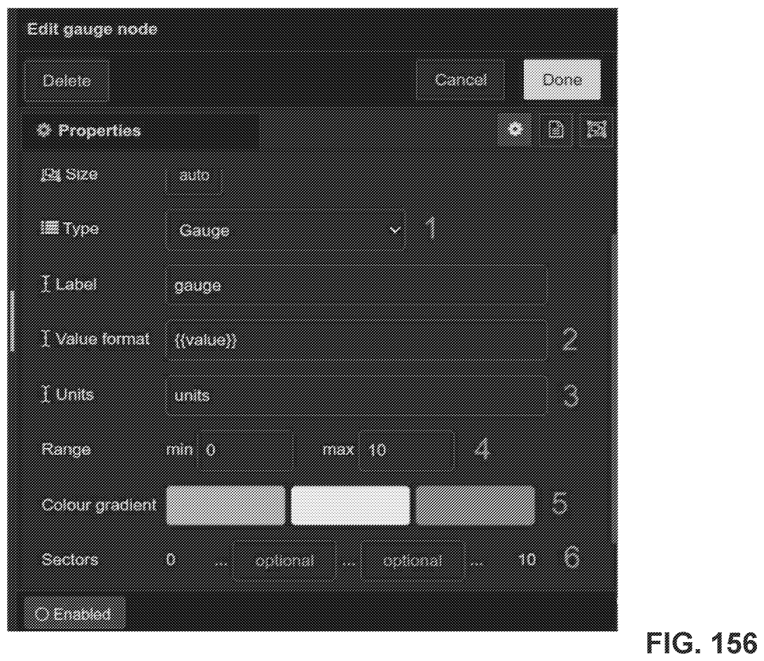

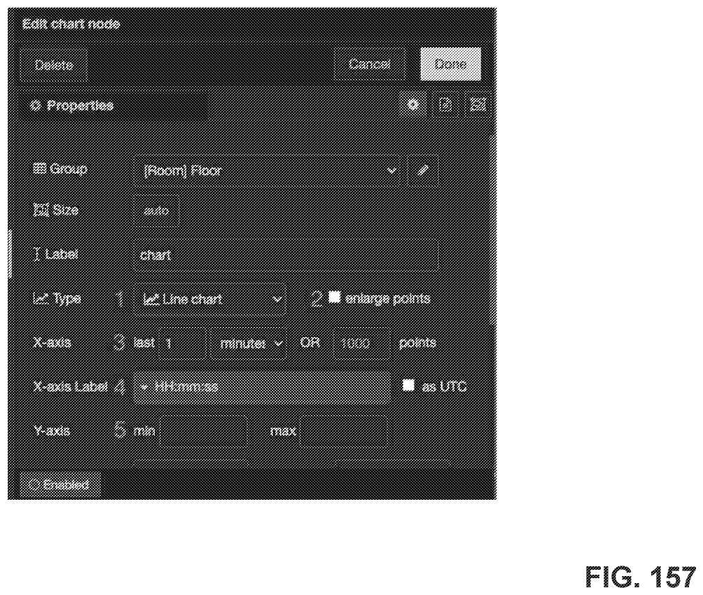

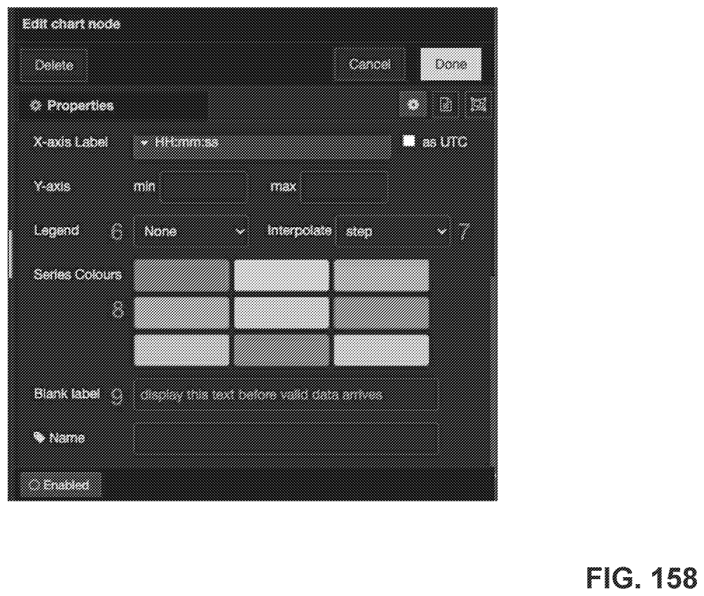

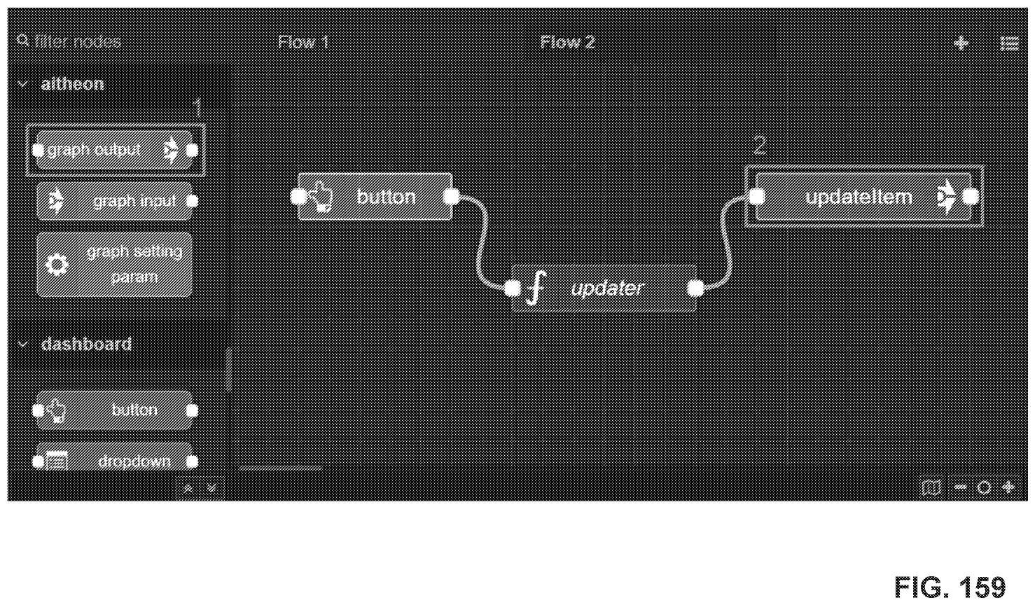

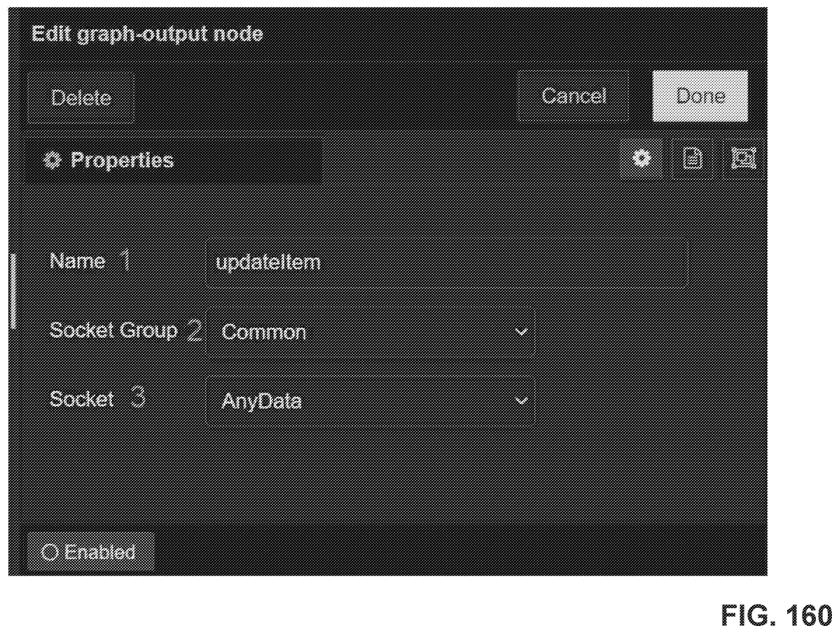

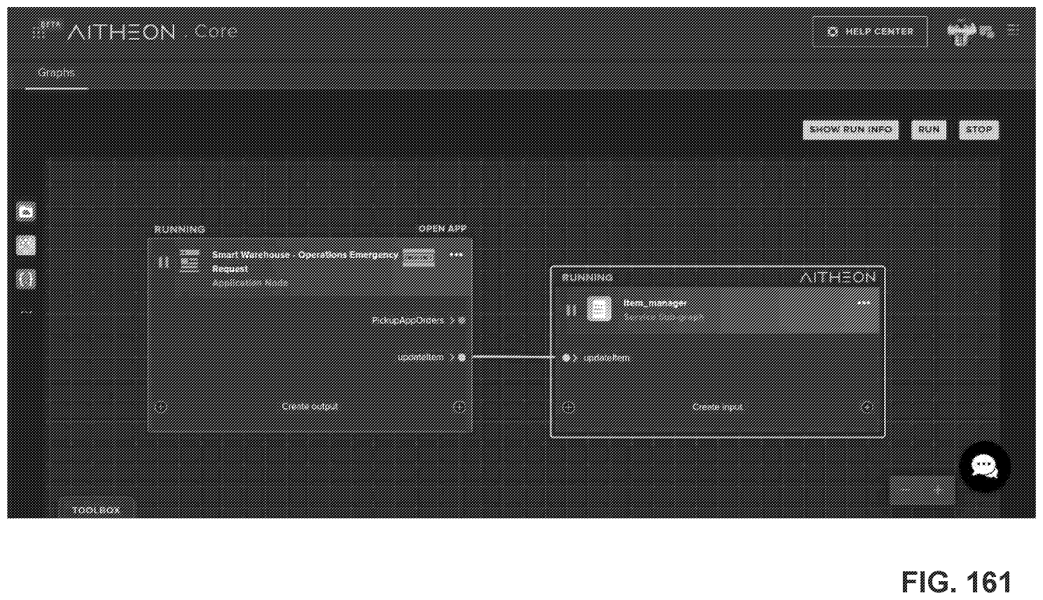

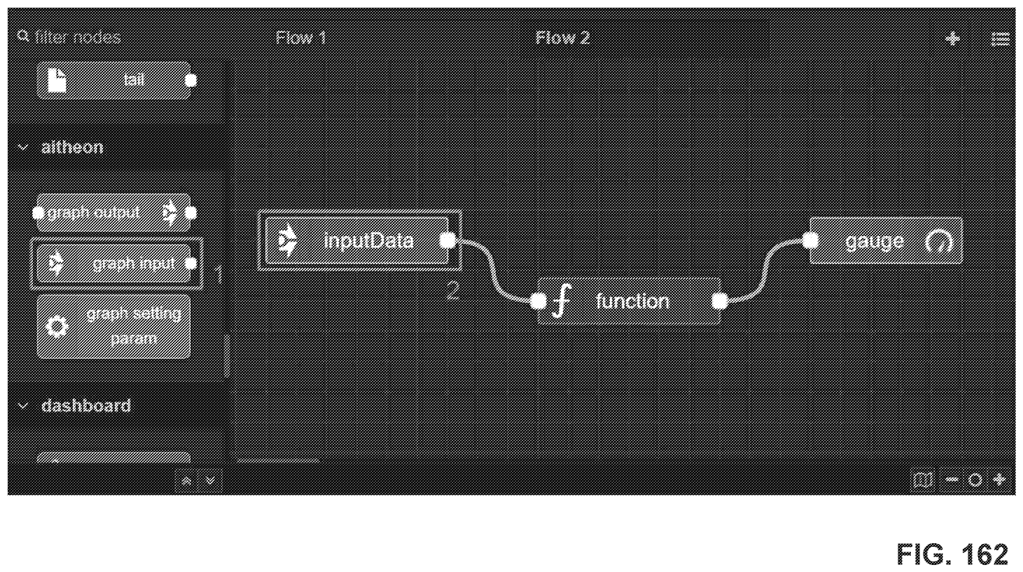

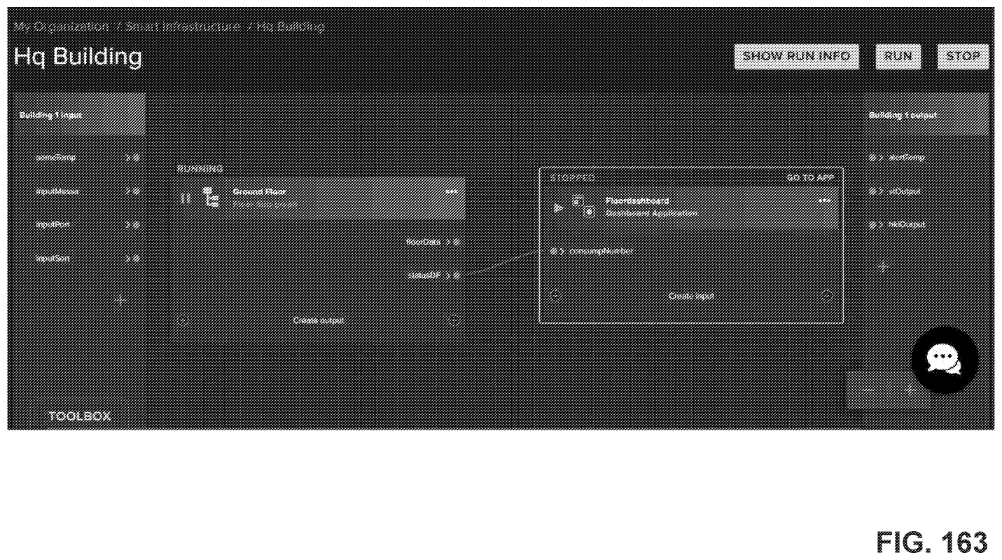

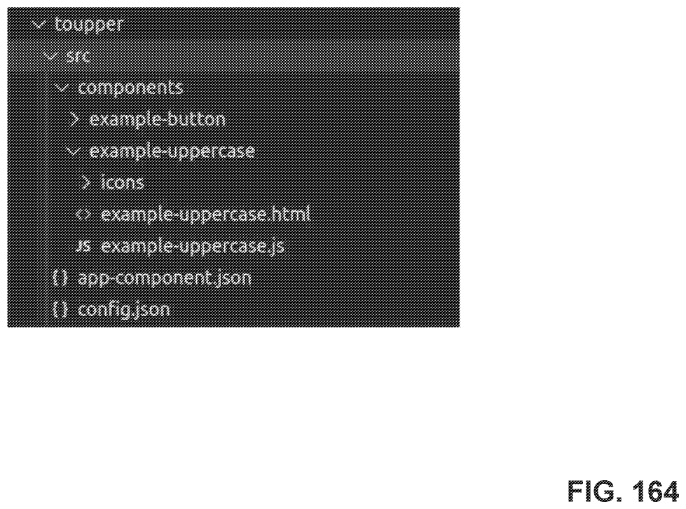

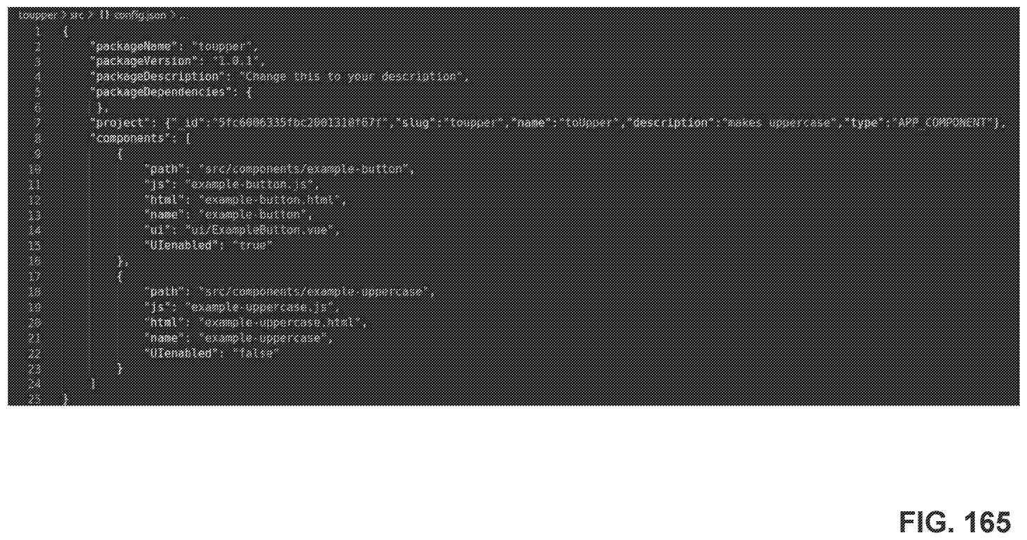

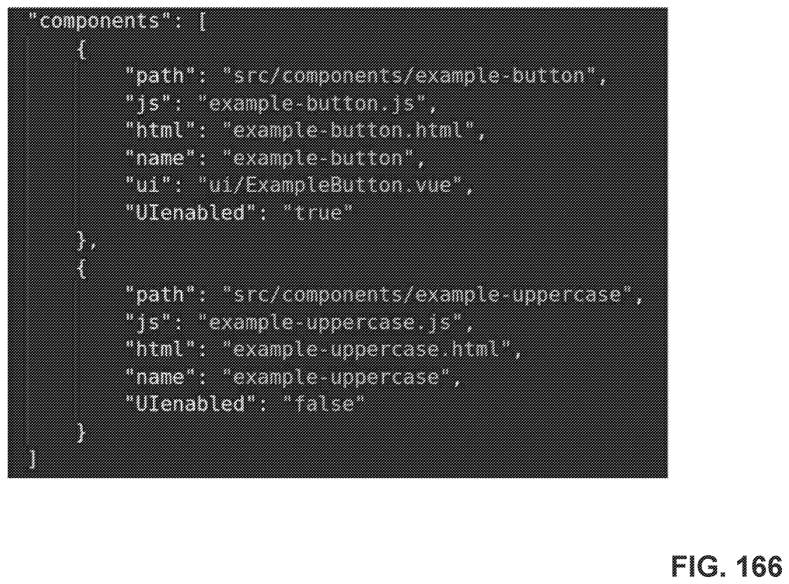

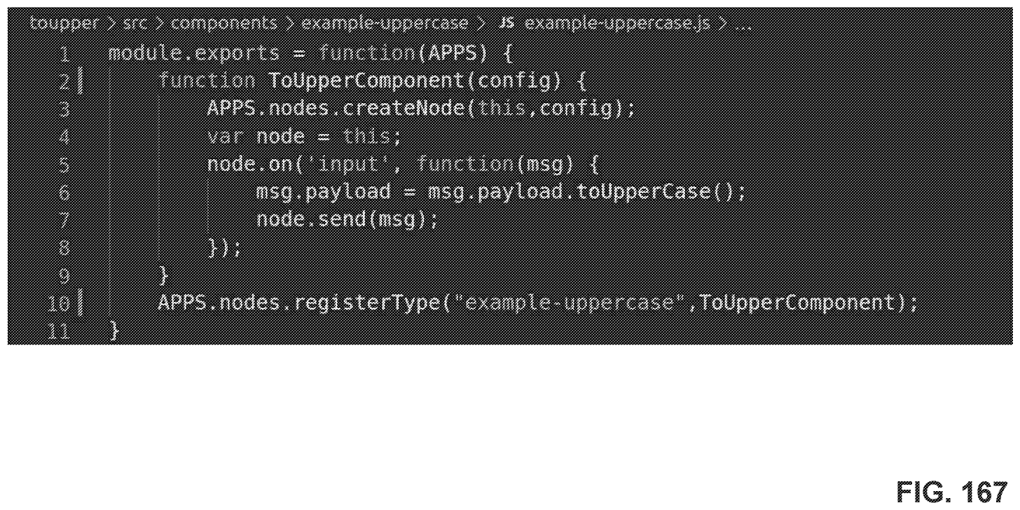

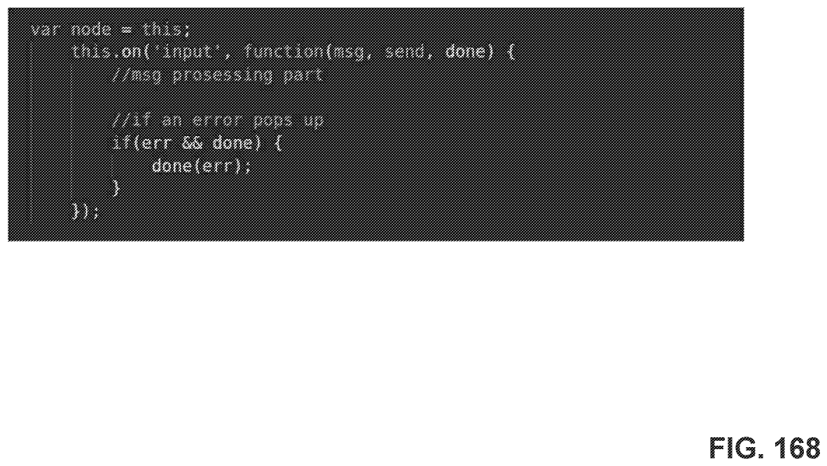

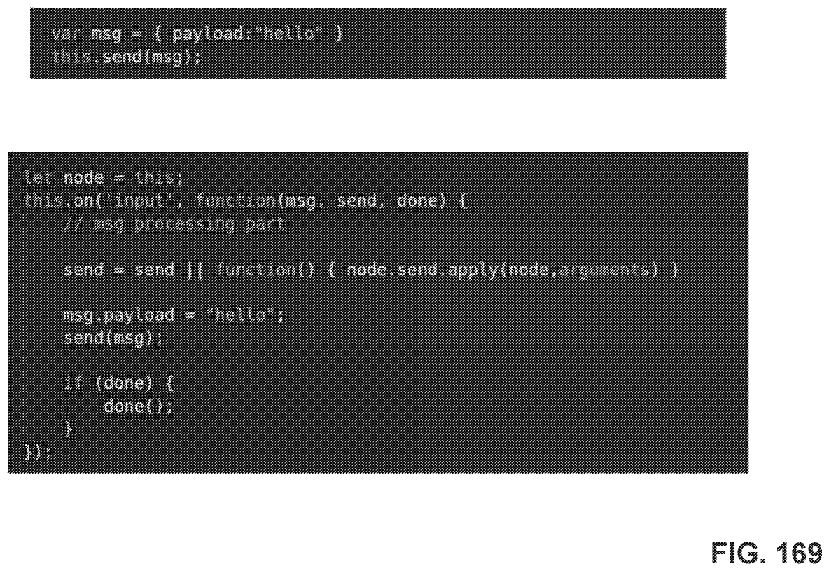

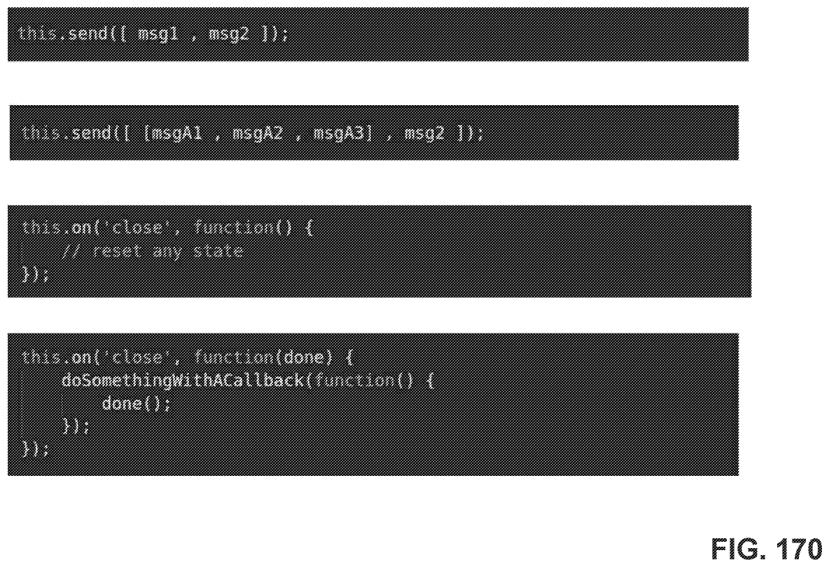

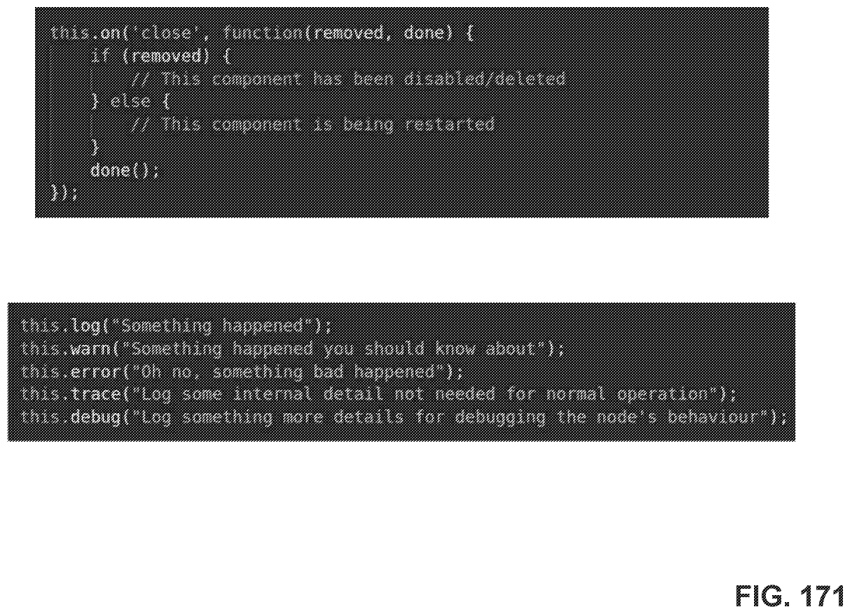

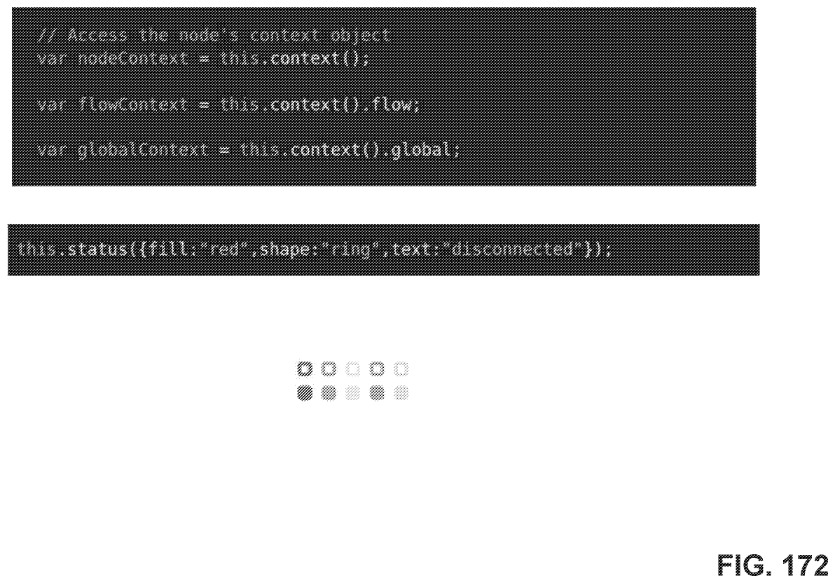

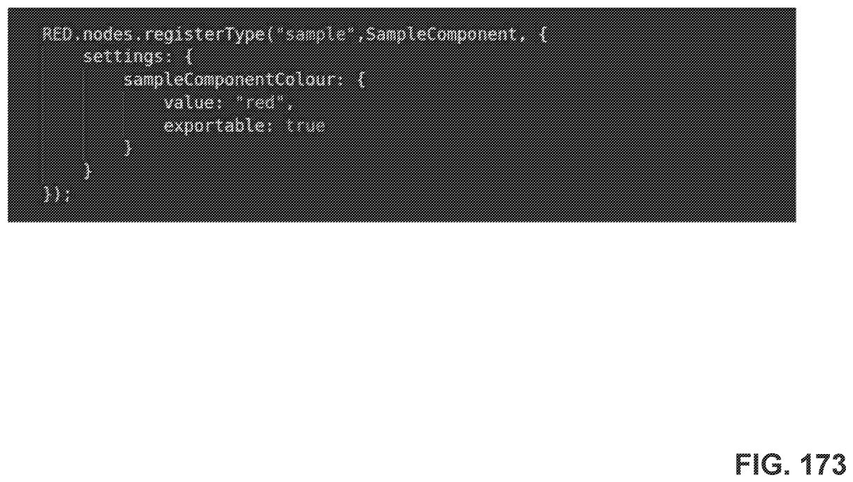

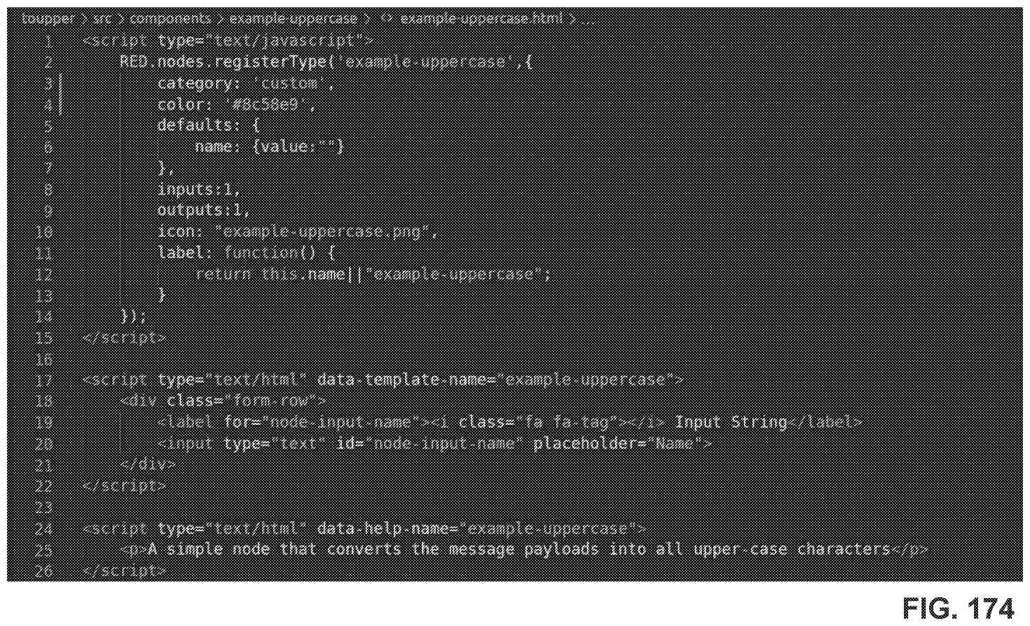

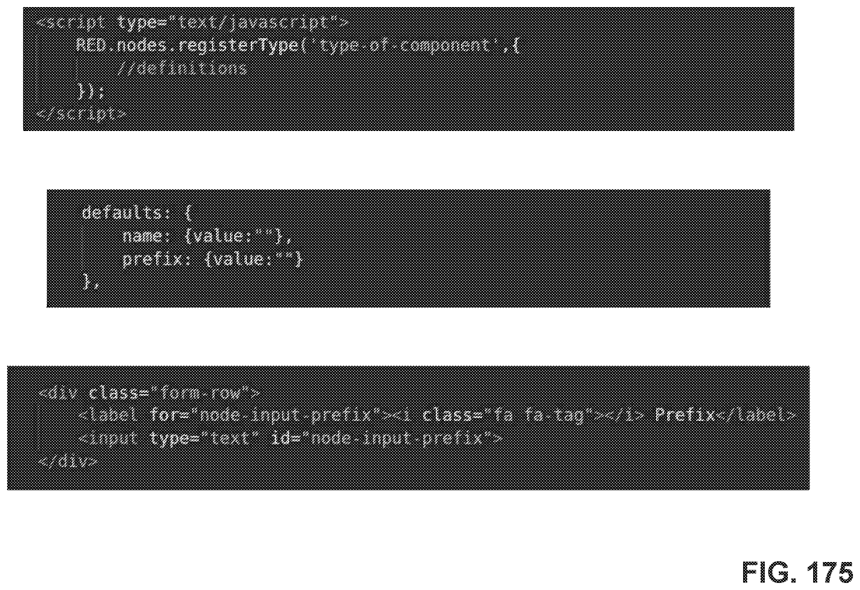

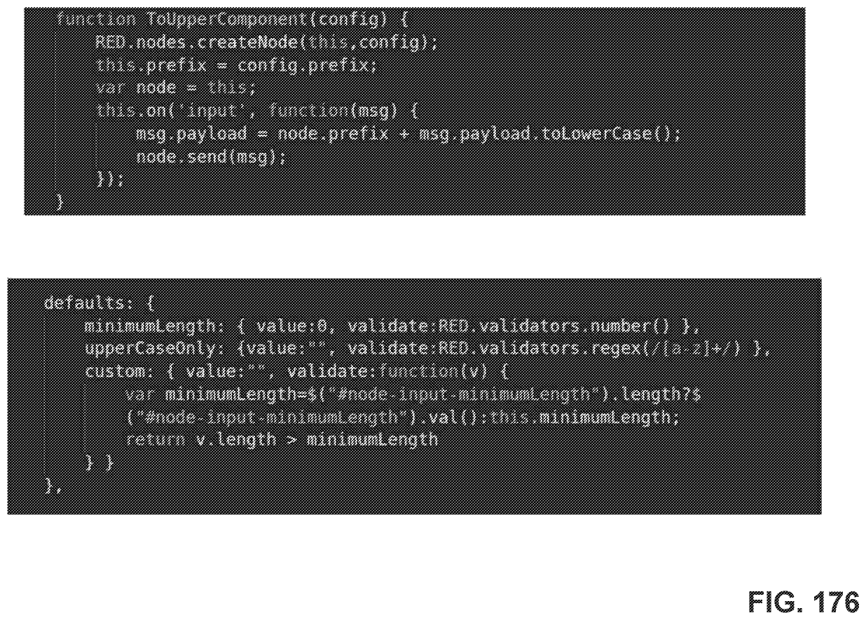

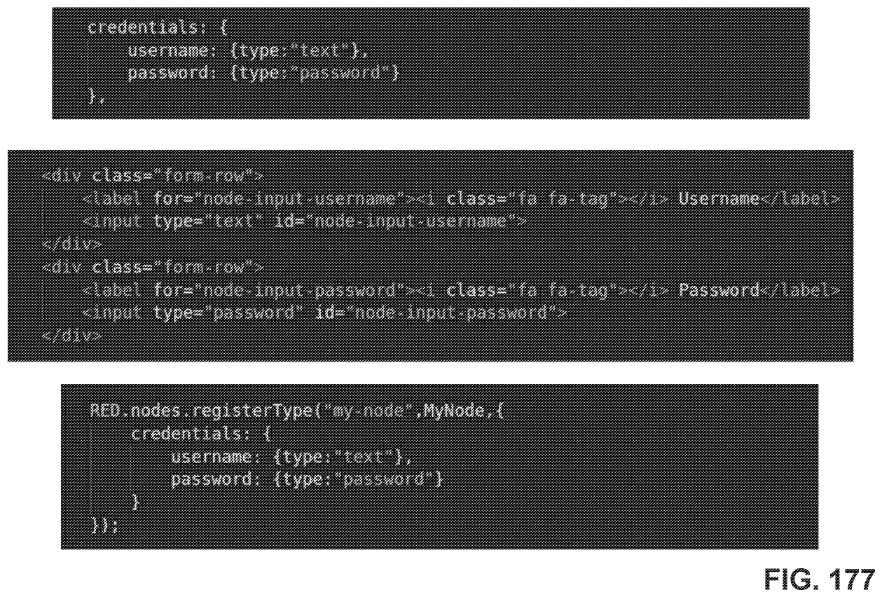

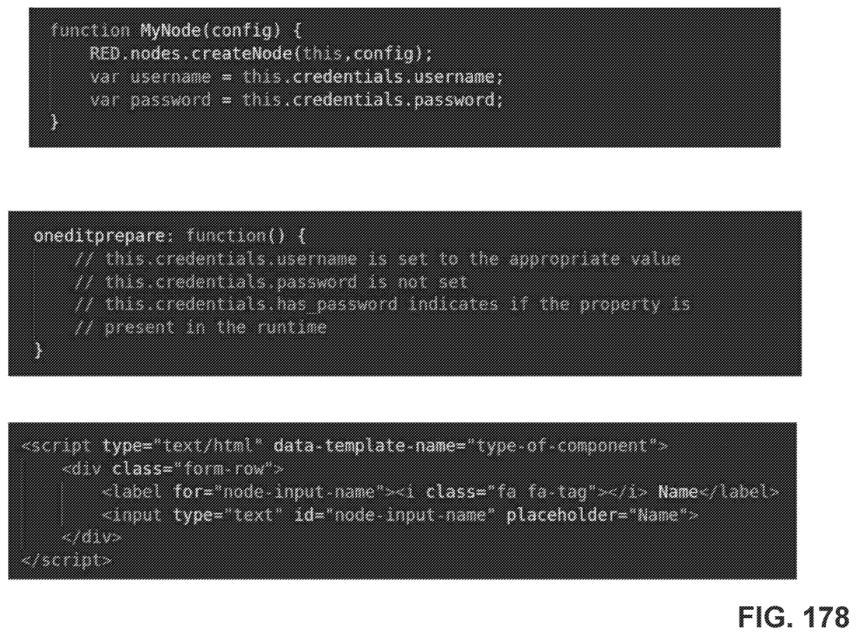

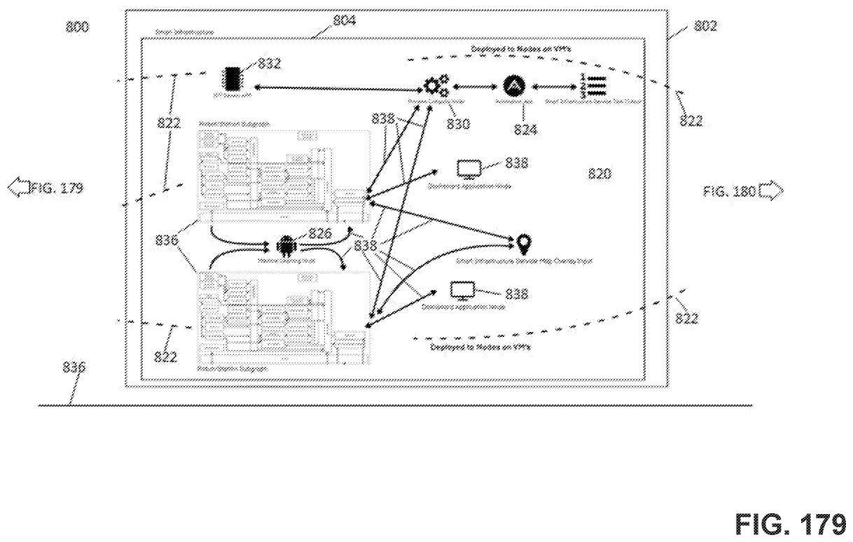

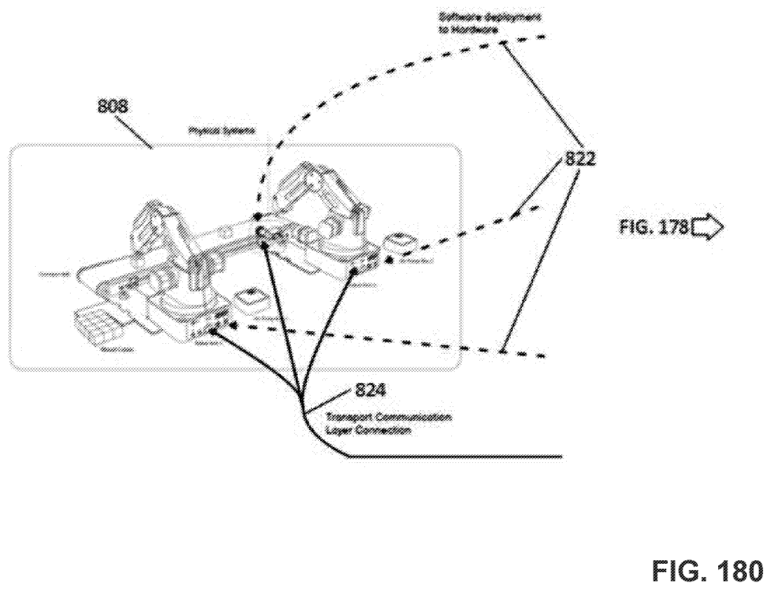

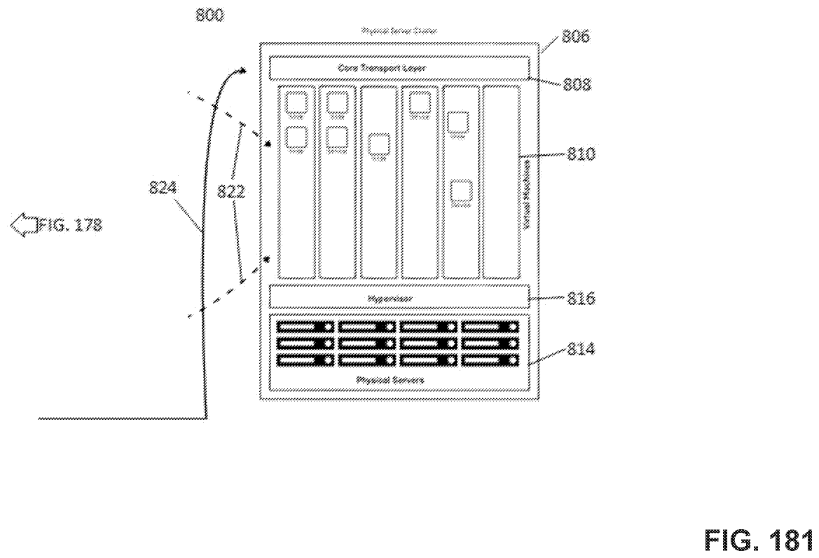

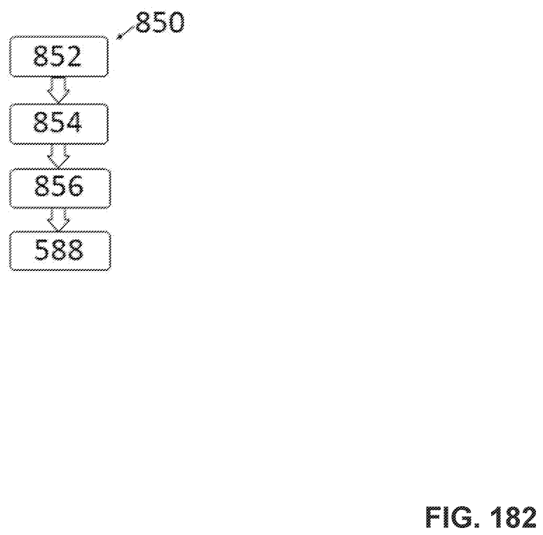

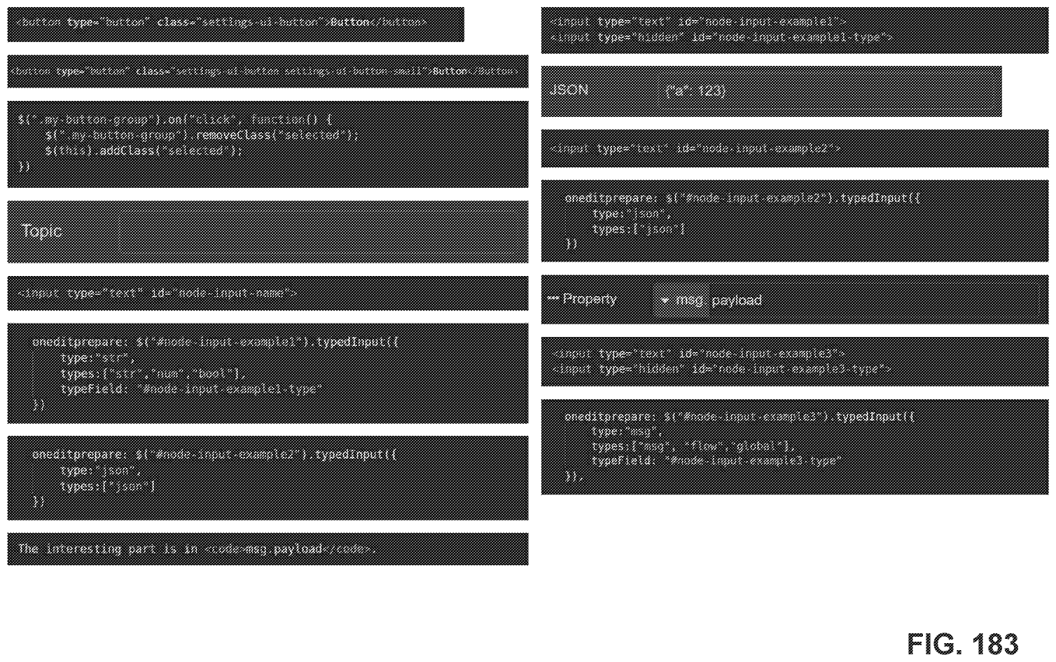

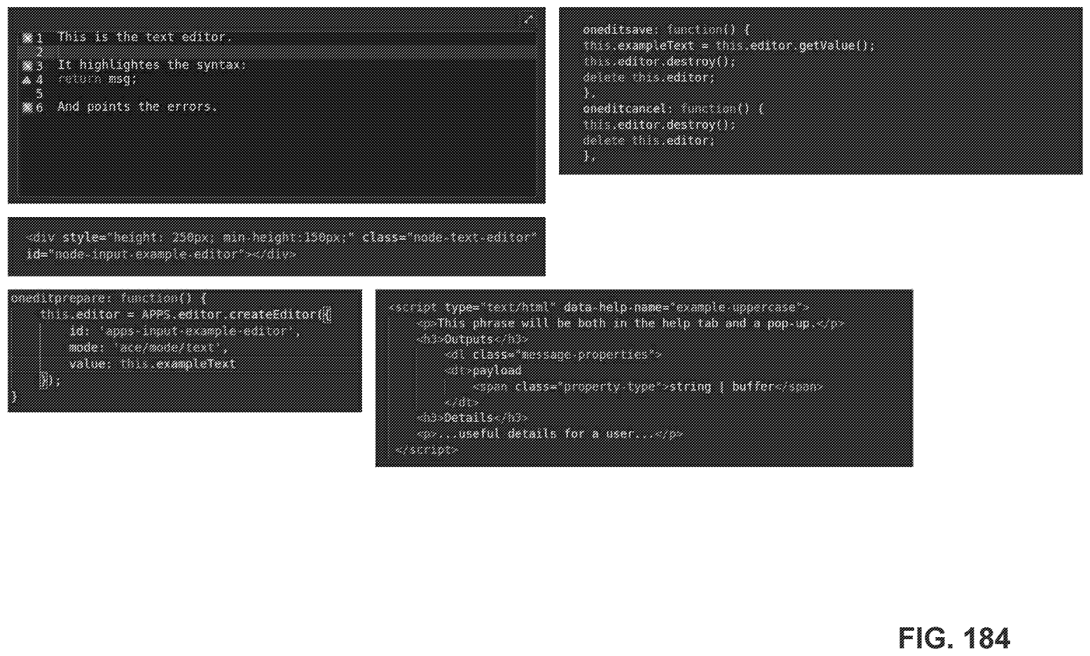

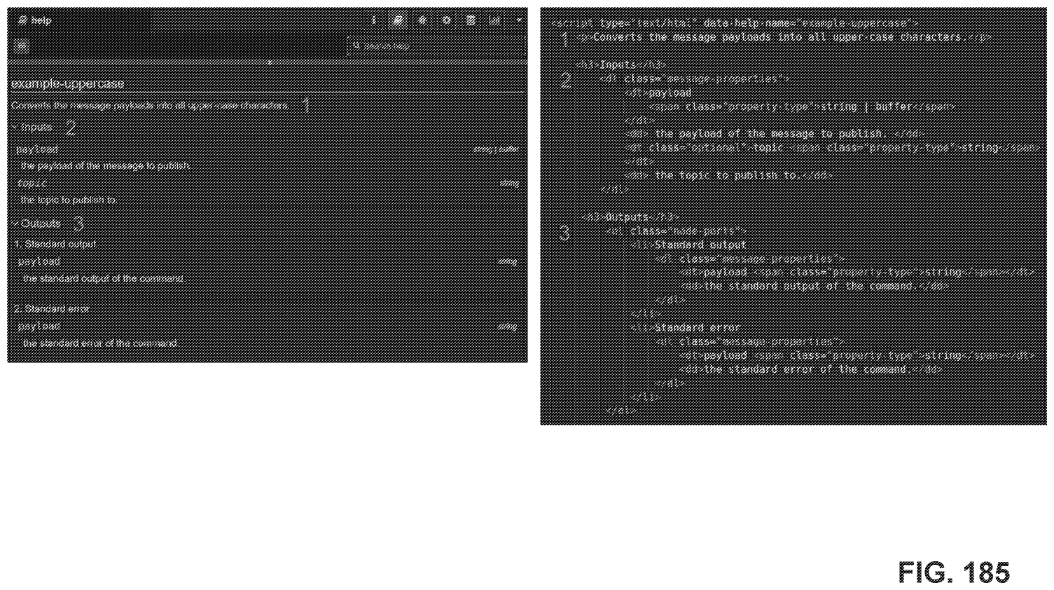

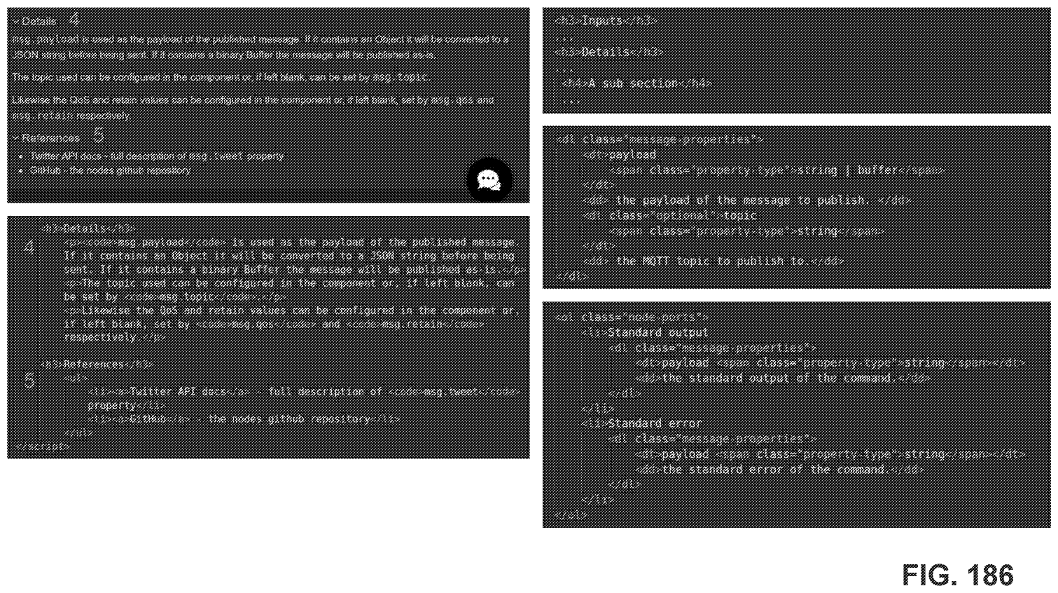

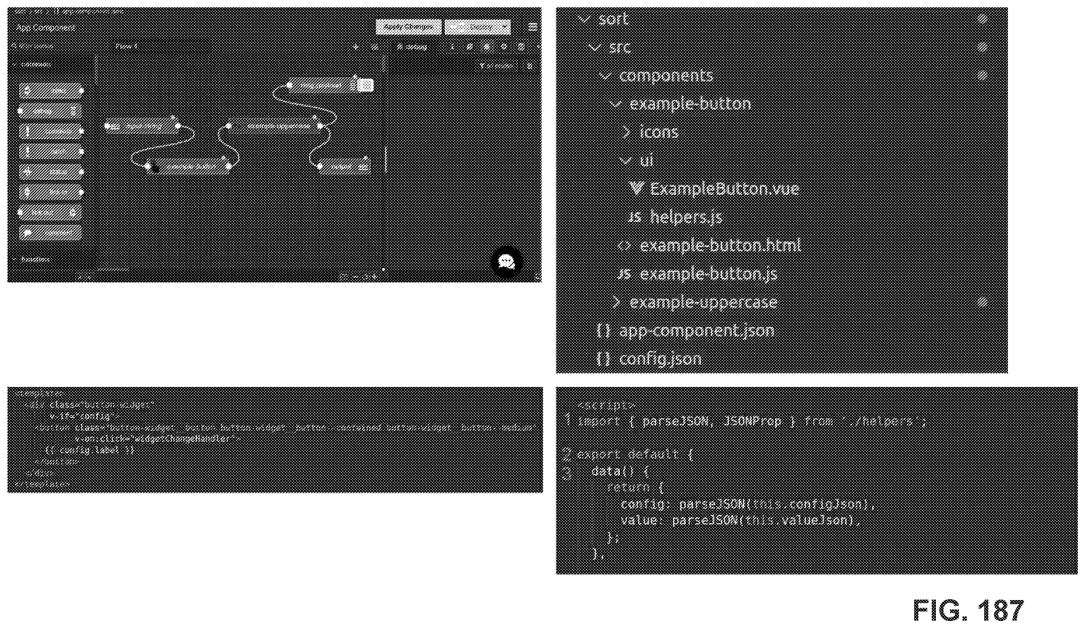

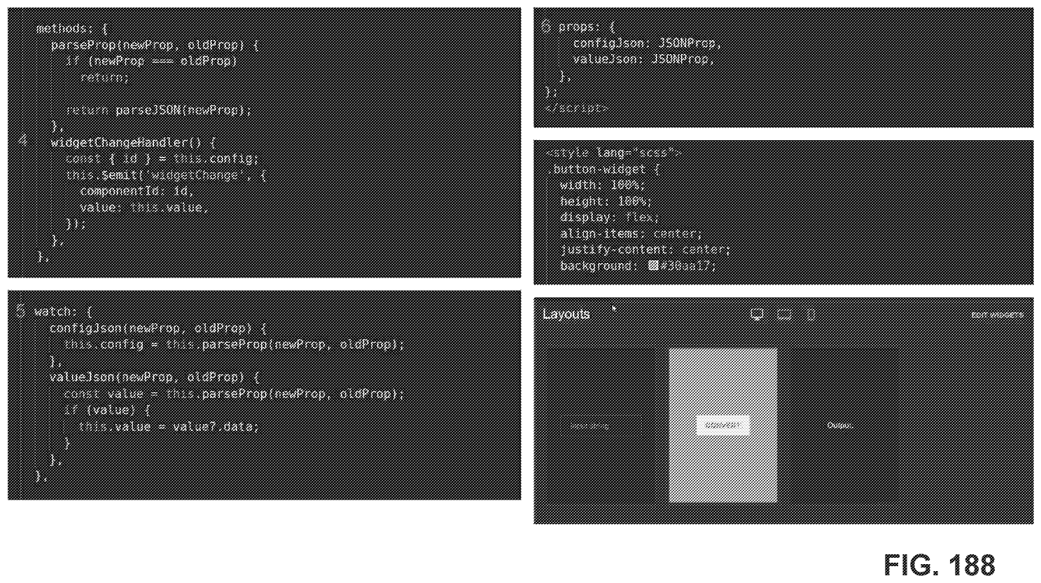

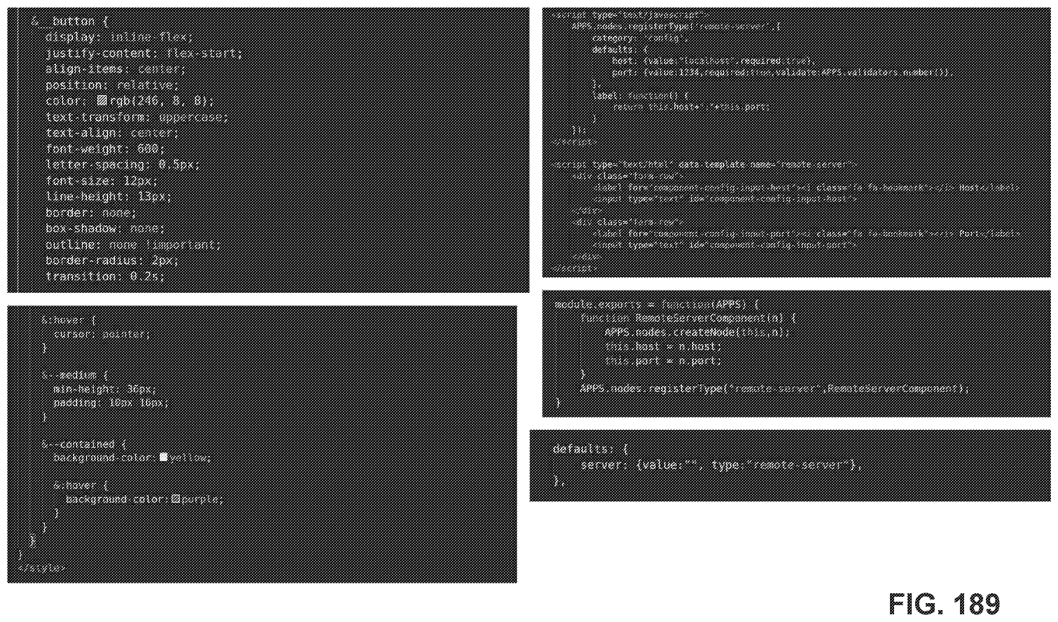

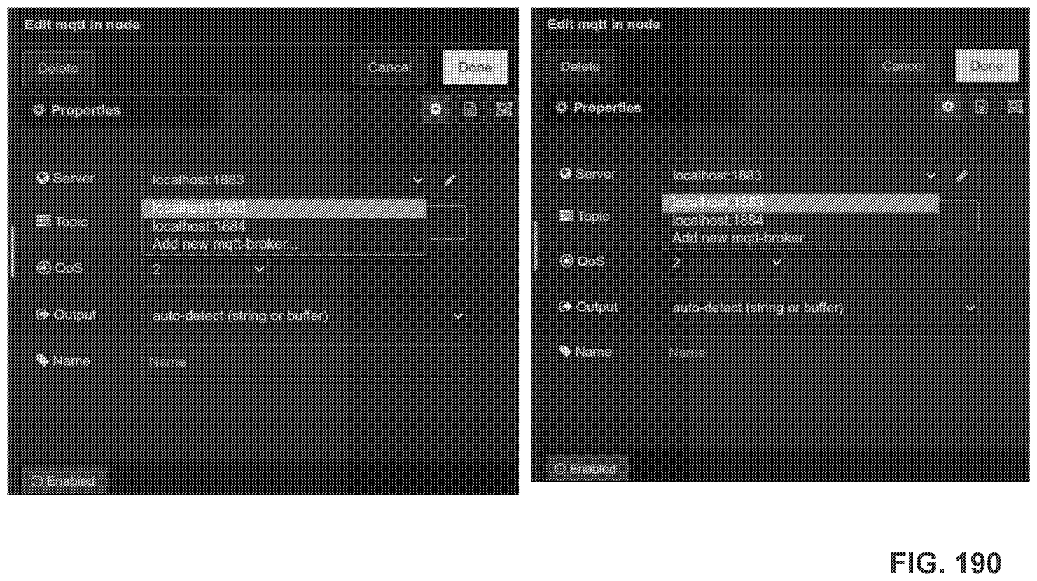

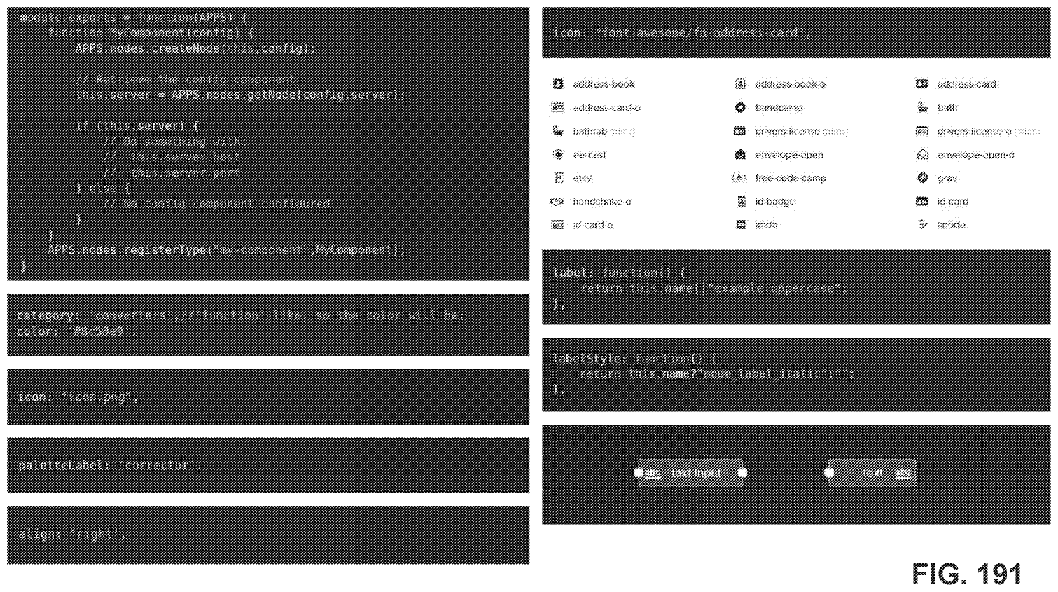

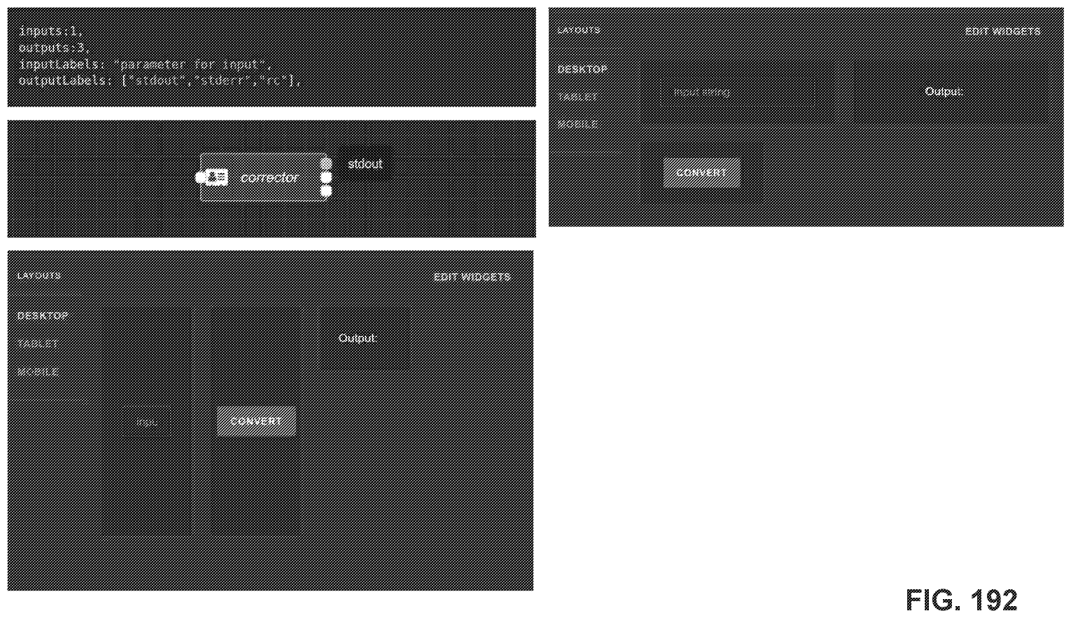

FIG. 109 is an image of a user interface according to certain embodiments of the present invention.

FIG. 100 is an image of a user interface according to certain embodiments of the present invention.

FIG. 111 is an image of a user interface according to certain embodiments of the present invention.

FIG. 112 is a flow diagram of a process according to certain embodiments of the present invention.

FIG. 113 is an image of a user interface according to certain embodiments of the present invention.

FIG. 114 is an image of a user interface according to certain embodiments of the present invention.

FIG. 115 is an image of a user interface according to certain embodiments of the present invention.

FIG. 116 is an image of a user interface according to certain embodiments of the present invention.

FIG. 117 is an image of a user interface according to certain embodiments of the present invention.

FIG. 118 is an image of a user interface according to certain embodiments of the present invention.

FIG. 119 is an image of a user interface according to certain embodiments of the present invention.

FIG. 120 is an image of a user interface according to certain embodiments of the present invention.

FIG. 121 is an image of a user interface according to certain embodiments of the present invention.

FIG. 122 is an image of a user interface according to certain embodiments of the present invention.

FIG. 123 is an image of a user interface according to certain embodiments of the present invention.

FIG. 124 is an image of a user interface according to certain embodiments of the present invention.

FIG. 125 is an image of a user interface according to certain embodiments of the present invention.

FIG. 126 is an image of a user interface according to certain embodiments of the present invention.

FIG. 127 is an image of a user interface according to certain embodiments of the present invention.

FIG. 128 is an image of a user interface according to certain embodiments of the present invention.

FIG. 129 is an image of a user interface according to certain embodiments of the present invention.

FIG. 130 is an image of a user interface according to certain embodiments of the present invention.

FIG. 131 is an image of a user interface according to certain embodiments of the present invention.

FIG. 132 is an image of a user interface according to certain embodiments of the present invention.

FIG. 133 is an image of a user interface according to certain embodiments of the present invention.

FIG. 134 is an image of a user interface according to certain embodiments of the present invention.

FIG. 135 is an image of a user interface according to certain embodiments of the present invention.

FIG. 136 is an image of a user interface according to certain embodiments of the present invention.

FIG. 137 is an image of a user interface according to certain embodiments of the present invention.

FIG. 138 is an image of a user interface according to certain embodiments of the present invention.

FIG. 139 is an image of a user interface according to certain embodiments of the present invention.

FIG. 140 is an image of a user interface according to certain embodiments of the present invention.

FIG. 141 is an image of a user interface according to certain embodiments of the present invention.

FIG. 142 is an image of a user interface according to certain embodiments of the present invention.

FIG. 143 is an image of a user interface according to certain embodiments of the present invention.

FIG. 144 is an image of a user interface according to certain embodiments of the present invention.

FIG. 145 is an image of a user interface according to certain embodiments of the present invention.

FIG. 146 is an image of a user interface according to certain embodiments of the present invention.

FIG. 147 is an image of a user interface according to certain embodiments of the present invention.

FIG. 148 is an image of a user interface according to certain embodiments of the present invention.

FIG. 149 is an image of a user interface according to certain embodiments of the present invention.

FIG. 150 is an image of a user interface according to certain embodiments of the present invention.

FIG. 151 is an image of a user interface according to certain embodiments of the present invention.

FIG. 152 is an image of a user interface according to certain embodiments of the present invention.

FIG. 153 is an image of a user interface according to certain embodiments of the present invention.

FIG. 154 is an image of a user interface according to certain embodiments of the present invention.

FIG. 155 is an image of a user interface according to certain embodiments of the present invention.

FIG. 156 is an image of a user interface according to certain embodiments of the present invention.

FIG. 157 is an image of a user interface according to certain embodiments of the present invention.

FIG. 158 is an image of a user interface according to certain embodiments of the present invention.

FIG. 159 is an image of a user interface according to certain embodiments of the present invention.

FIG. 160 is an image of a user interface according to certain embodiments of the present invention.

FIG. 161 is an image of a user interface according to certain embodiments of the present invention.

FIG. 162 is an image of a user interface according to certain embodiments of the present invention.

FIG. 163 is an image of a user interface according to certain embodiments of the present invention.

FIG. 164 is an image of a user interface according to certain embodiments of the present invention.

FIG. 165 is an image of a user interface according to certain embodiments of the present invention.

FIG. 166 is an image of a user interface according to certain embodiments of the present invention.

FIG. 167 is an image of a user interface according to certain embodiments of the present invention.

FIG. 168A, B is an image of a user interface according to certain embodiments of the present invention.

FIG. 169A-D is an image of a user interface according to certain embodiments of the present invention.

FIG. 170A, B is an image of a user interface according to certain embodiments of the present invention.

FIG. 171A, B is an image of a user interface according to certain embodiments of the present invention.

FIG. 172 is an image of a user interface according to certain embodiments of the present invention.

FIG. 173 is an image of a user interface according to certain embodiments of the present invention.

FIG. 174A-C is an image of a user interface according to certain embodiments of the present invention.

FIG. 175A, B is an image of a user interface according to certain embodiments of the present invention.

FIG. 176A-C is an image of a user interface according to certain embodiments of the present invention.

FIG. 177A-C is an image of a user interface according to certain embodiments of the present invention.

FIG. 178 is a portion of a diagram continued on FIGS. 179 and 180 of a process according to certain embodiments of the present invention.

FIG. 179 is a portion of a diagram continued on FIGS. 178 and 180 of a process according to certain embodiments of the present invention.

FIG. 180 is a portion of a diagram continued on FIGS. 178 and 179 of a process according to certain embodiments of the present invention.

FIG. 181 is a diagram of a method according to certain embodiments of the present invention.

FIG. 182A-O is an image of a user interface according to certain embodiments of the present invention.

FIG. 183A-D is an image of a user interface according to certain embodiments of the present invention.

FIG. 184A, B is an image of a user interface according to certain embodiments of the present invention.

FIG. 185A-E is an image of a user interface according to certain embodiments of the present invention.

FIG. 186A-D is an image of a user interface according to certain embodiments of the present invention.

FIG. 187A-E is an image of a user interface according to certain embodiments of the present invention.

FIG. 188A-E is an image of a user interface according to certain embodiments of the present invention.

FIG. 189A, B is an image of a user interface according to certain embodiments of the present invention.

FIG. 190A-H is an image of a user interface according to certain embodiments of the present invention.

FIG. 191A-D is an image of a user interface according to certain embodiments of the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements. While different embodiments are described, features of each embodiment can be used interchangeably with other described embodiments. In other words, any of the features of each of the embodiments can be mixed and matched with each other, and embodiments should not necessarily be rigidly interpreted to only include the features shown or described.

The present invention employs a computing platform within which various services are employed and integrated with one another. In the context of the present application, a service is broadly considered as software that, for example, performs automated functions, responds to hardware events, or receives and reacts to data requests from other software. The present invention employs a core service that functions to integrate the various other services within the platform with one another to create one or more integrated service environments. The integrated service environment of the present invention is easily formed and manipulated by a user in a completely graphical codeless manner or in a partially graphical semi-codeless manner. Hence, the present invention enables users having a wide range of technical expertise, for example, little to none or profound technical expertise, to create, manipulate, and optimize processes and automations.

The platform, system, and non-transitory computer readable storage media of the present invention provides a system of real time or near real time interactions between various nodes, for example, compute nodes, human agent nodes, artificial intelligence/machine learning nodes, robot nodes, and machine nodes, to form a decentralized self-aware or non-self-aware, self-enforcing and self-adapting cooperative intelligence to automate processes and drive organizational decision making and the initiating of tasks for implementation of such business operations. The platform of the present invention employs, concurrently or sequentially, a combination of models and theories including but not limited to combinatorial optimization, weighted network theory, cooperative game theory, and coordination game theory of Nash equilibrium in a collective frame or frames of subgraphs and brambles of the participating nodes. Accordingly, a cognitive architecture is created that dynamically makes and adjusts decisions and decision-making processes based on a current collective frame, an original context provided to the system, and an original objective provided to the system.

In application, the platform of the present invention not only determines or recommends organizational processes but also initiates and assigns the tasks required to implement the organizational processes to achieve the desired objective. In other words, the platform of the present invention is operable to automatically develop, optimize, and assign tasks in a manner that conventionally required human input in the form of time and work. Hence, human managers and workers may be alleviated of such business operation tasks and thereby be free to directly further the objective of the organization or business—not the operation of the organization or business.

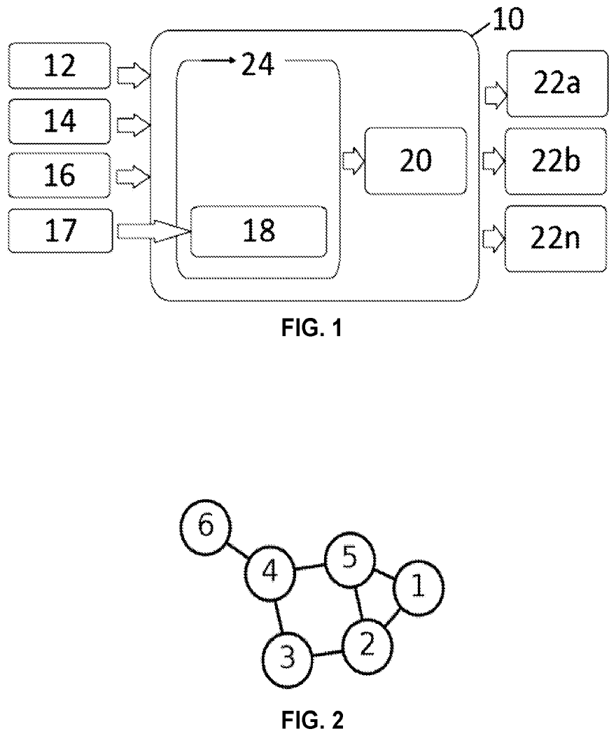

Generally speaking and by way of example only, in operation, the inventive system may be deployed in a manufacturing company to manage all or some of the operational aspects of the business. With reference to FIG. 1, the inventive system 10 is initially configured or supplied with data in the form of parameters 12 that define the context in which the system is to run. For example, the business can be an electronics manufacturer having a historic volume of components manufacture, facility location(s), historic cash flow, number of employees, qualifications of each employee, available equipment in facilities, component packaging capabilities, component shipping capabilities, vendor lists, vendor capabilities, account receivable and accounts payable terms of the business and the business' vendors, etc.

The inventive system 10 is also initially configured or supplied with the various business objectives 14 of the business, e.g. revenue goals, production goals, rates of desired annual growth, etc. The business objective configuration is, for example, accomplished through questions and responses with the business' employees and management and through incorporation of the activities of the business' owner accounts.

The inventive system 10 is also initially configured or supplied with the business' historic data 16. In certain embodiments, the business' historic data 16 is anonymized and shared or made accessible with all the anonymous system data 18 already present within the system 10, e.g. data of other companies and organizations already employing the inventive system. In certain other embodiments of the present invention, the business' historic data 16 is not shared or aggregated with the existing system date 18. Alternatively stated, businesses employing the inventive system may independently determine if they want to optimize processes based upon collective learning from other business' data or solely based upon the business' own data.

While incorporating the business' historic data 16 into the system 10, whether with all system data 18 or only the business' own historic data 16, the historic data is further assigned value weights.

By considering the business parameters 12, business objectives 14, and available data 18, the system 10 then determines a best course of action 20 to achieve the company's stated objectives. The course of action 20 is also determined, in part, through autonomous polling 17 of the business' employees and management by the system 10. The polling may be through issuance of tasks to individuals or by direct communication with individuals via chat and text using natural language processing to provide context to the communications' subject. The business parameters 12, business objectives 14, business' historic data 16, polling 17, and, when applicable, system data 18 are employed as inputs into one or more machine learning nodes of the system 10 that employs the various theories described above to create adversarial training of associated algorithms and to form an equilibrium that creates the best course of action 20.

Once the system 10 determines the desired course of action 20, the system assigns task(s) 22a, 22b through 22n to implement the course of action 20. For example, the system 10 either (a) assigns tasks to humans/employees of the company to implement the course(s) of action, e.g. to conduct a task not within or under the directly control of the inventive system, or (b) assigns a task to an inventive system component or adjunct to autonomously implement the course(s) of action, e.g. autonomously ordering components from a supplier or autonomously sending out pricing requests to multiple potential suppliers.

During each iteration or cycle 24 in which the course of action 20 is determined, the system 10 assesses the probability of achieving the desired overall objective and the various sub-objectives relating to the overall objective. If the probability is determined to be lower than a tolerance initially configured into the system 10 or if, for example, progress towards achieving the desired objective is determined to have plateaued or to have become stagnant, the inventive system 10 autonomously reevaluates, i.e. performs additional iterations or cycle 24 until the probability tolerance of the course of action 20 to meet the desired objective is obtained.

The platform or elements of the platform of the present invention employs network theory which is understood as the study of graphs as a representation of either symmetric relations or asymmetric relations between discrete objects. In turn, network theory is a part of graph theory: a network can be defined as a graph in which nodes and/or edges have distinct identifiers. As used herein, and shown in FIG. 2, a graph is a structure amounting to a set of objects in which some pairs of the objects are in some sense related. The objects correspond to mathematical abstractions called “vertices”, “nodes”, or “points” and each of the related pairs of vertices are referred to as an “edge”, “link”, or “line”. The term “connection” may also be used to describe a data transfer relationship between vertices or nodes. Typically, a graph is depicted in diagrammatic form as a set of objects, e.g. diagrammatically shown as dots or shape, representing the nodes, joined to one another by lines or curves representing the edges or connections.

The edges may be directed or undirected. For example, if the vertices represent people at a party, and there is an edge between two people if they shake hands, then this graph is undirected because any person A can shake hands with a person B only if B also shakes hands with A. In contrast, if any edge from a person A to a person B corresponds to A admiring B, then this graph is directed, because admiration is not necessarily reciprocated. The former type of graph is called an undirected graph while the latter type of graph is called a directed graph.

A weighted graph or a network is a graph in which a number (the weight) is assigned to each edge or connection. Such weights can represent for example costs, lengths or capacities, depending on the problem at hand. The present invention further employs the concepts of havens and brambles. By way of explanation, if G is an undirected graph, and X is a set of vertices, then an X-flap is a nonempty connected component of the subgraph of G formed by deleting X. A haven of order k in G is a function β that assigns an X-flap β(X) to every set X of fewer than k vertices. Havens with the so-called touching definition are related to brambles, which are families of connected subgraphs of a given graph that all touch each other. These concepts and various author's additional constraints are further detailed in the teaching of: Johnson, Thor.; Robertson, Neil.; Seymor, P. D.; Thomas, Robin (2001), “Directed Tree Width”, Journal of Combinatorial Theory, Series B, 82 (1): 138-155, doi:10.1006/jctb.2000.2031; Seymour, Paul D.; Thomas, Robin (1993), “Graph searching and a min-max theorem for tree-width”, Journal of Combinatorial Theory, Series B, 58 (1): 22-33, doi:10.1006/jctb.1993.1027; and Alon, Noga; Seymour, Paul; Thomas, Robin (1990), “A separator theorem for nonplanar graphs”, J. Amer. Math. Soc., 3 (4): 801-808, doi:10.1090/50894-0347-1990-1065053-0; which are herein incorporated by reference in their entireties.

The present invention further employs the concept of combinatorial optimization. Combinatorial optimization consists of identifying an optimal object from a finite set of objects. In such problems, brute-force search or exhaustive search readily easy to control or influence. It functions in the domain of those optimization problems in which the set of feasible solutions is discrete or can be reduced to discrete, and in which the goal is to find the best solution.

The present invention further employs the concept of distributed design or computing. As taught by Tanenbaum, Andrew S.; Steen, Maarten van (2002). Distributed systems: principles and paradigms. Upper Saddle River, N.J.: Pearson Prentice Hall; Andrews, Gregory R. (2000), Foundations of Multithreaded, Parallel, and Distributed Programming; Dolev, Shlomi (2000), Self-Stabilization, MIT Press; Ghosh, Sukumar (2007), Distributed Systems—An Algorithmic Approach, Chapman & Hall/CRC; Magnoni, L. (2015). “Modern Messaging for Distributed Sytems (sic)”. Journal of Physics: Conference Series. 608 (1); herein incorporated by reference in their entireties, a distributed system is a system employing components that are located on distinct networked computers, which communicate and coordinate their actions with one another by passing messages. The components of the system interact in order to achieve a common goal or objective. Distributed systems typically have three characteristics: concurrency of components, lack of a global clock, and independent failure of components. A computer program that runs within a distributed system is typically referred to as a distributed program, and distributed programming is the process of writing distributed programs. Message passing mechanism of distributed systems include, for example, pure HTTP, remote procedure call (RPC), and RPC-like or derivative connectors, such as gRCP, and message queues. Distributed computing also refers to the use of distributed systems to solve computational problems. In distributed computing, a problem is divided into many tasks, each of which is solved by one or more computers, which communicate with each other via message passing.

The present invention further employs the concept of cooperative game theory. As taught by Shor, Mike. “Non-Cooperative Game—Game Theory .net”. www.gametheory.net. Retrieved 2016 Sep. 15; Chandrasekaran, R. “Cooperative Game Theory” https://personal.utdallas.edu/-chandra/documents/6311/coopgames.pdf, retrieved 2020 Oct. 16; and Devlin, Keith J. (1979); Fundamentals of contemporary set theory; Universitext. Springer-Verlag, herein incorporated by reference in their entireties, a game is considered cooperative if the players are able to form binding commitments externally enforced (e.g. through contract law). A game is non-cooperative if players cannot form alliances or if all agreements need to be self-enforcing (e.g. through credible threats). Cooperative games are often analyzed through the framework of cooperative game theory, which focuses on predicting which coalitions will form, the joint actions that groups take, and the resulting collective payoffs. It is opposed to the traditional non-cooperative game theory which focuses on predicting individual players' actions and payoffs and analyzing Nash equilibria.

The present invention further employs the concept of Nash equilibrium. in game theory, as taught by Osborne, Martin J.; Rubinstein, Ariel (12 Jul. 1994). A Course in Game Theory. Cambridge, Mass.: MIT. p. 14, herein incorporated by reference in its entirety, Nash equilibrium is a proposed solution of a non-cooperative game involving two or more players in which each player is assumed to know the equilibrium strategies of the other players, and no player has anything to gain by changing only their own strategy. In terms of game theory, if each player has chosen a strategy, and no player can benefit by changing strategies while the other players keep theirs unchanged, then the current set of strategy choices and their corresponding payoffs constitutes a Nash equilibrium.

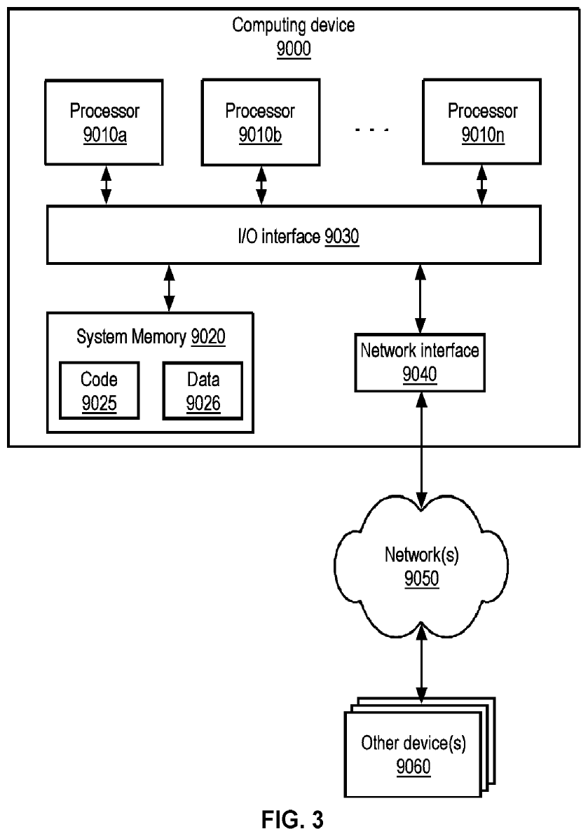

In at least some embodiments, a server that implements one or more of the components of inventive platform may include a general-purpose computer system that includes or is configured to access one or more computer-accessible media. FIG. 3 illustrates an example of a general-purpose computing device 9000. In the illustrated embodiment, computing device 9000 includes one or more processors 9010 coupled to a system memory 9020 (which may comprise both non-volatile and volatile memory modules) via an input/output (I/O) interface 9030. Computing device 9000 further includes a network interface 9040 coupled to I/O interface 9030.

Computing device 9000 may be a uniprocessor system including one processor 9010, or a multiprocessor system including several processors 9010 (e.g., two, four, eight, or another suitable number). Processors 9010 may be any suitable processors capable of executing instructions. For example, processors 9010 may be general-purpose or embedded processors implementing any of a variety of instruction set architectures (ISAs), such as the x86, PowerPC, SPARC, or MIPS ISAs, or any other suitable ISA. In multiprocessor systems, each of processors 9010 may commonly, but not necessarily, implement the same ISA. In some implementations, graphics processing units (GPUs) may be used instead of, or in addition to, conventional processors.

System memory 9020 may be configured to store instructions and data accessible by processor(s) 9010. In at least some embodiments, the system memory 9020 may comprise both volatile and non-volatile portions; in other embodiments, only volatile memory may be used. In various embodiments, the volatile portion of system memory 9020 may be implemented using any suitable memory technology, such as static random access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). Memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described herein, are shown stored within system memory 9020 as code 9025 and data 9026.

I/O interface 9030 may be configured to coordinate I/O traffic between processor 9010, system memory 9020, and any peripheral devices in the device, including network interface 9040 or other peripheral interfaces such as various types of persistent and/or volatile storage devices. In some embodiments, I/O interface 9030 may perform any necessary protocol, timing or other data transformations to convert data signals from one component (e.g., system memory 9020) into a format suitable for use by another component (e.g., processor 9010). In some embodiments, I/O interface 9030 may include support for devices attached through various types of peripheral buses, such as a variant of the Peripheral Component Interconnect (PCI) bus standard or the Universal Serial Bus (USB) standard, for example. In some embodiments, the function of I/O interface 9030 may be split into two or more separate components, such as a north bridge and a south bridge, for example. Also, in some embodiments some or all of the functionality of I/O interface 9030, such as an interface to system memory 9020, may be incorporated directly into processor 9010.

Network interface 9040 may be configured to allow data to be exchanged between computing device 9000 and other devices 9060 attached to a network or networks 9050. Network interface 9040 may support communication via any suitable wired or wireless general data networks, such as types of Ethernet network, for example. Additionally, network interface 9040 may support communication via telecommunications/telephony networks such as analog voice networks or digital fiber communications networks, via storage area networks such as Fibre Channel SANs, or via any other suitable type of network and/or protocol.

In some embodiments, system memory 9020 may be one embodiment of a computer-accessible medium configured to store program instructions and data as described herein for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 9000 via I/O interface 9030. A non-transitory computer-accessible storage medium may also include any volatile or non-volatile media such as RAM (e.g. SDRAM, DDR SDRAM, RDRAM, SRAM, etc.), ROM, etc., that may be included in some embodiments of computing device 9000 as system memory 9020 or another type of memory. Further, a computer-accessible medium may include transmission media or signals such as electrical, electromagnetic, or digital signals, conveyed via a communication medium such as a network and/or a wireless link, such as may be implemented via network interface 9040. Portions or all of multiple computing devices such as that illustrated in FIG. 3 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

In some embodiments, system memory 9020 may be one embodiment of a computer-accessible medium configured to store program instructions and data as described herein for implementing embodiments of the corresponding methods and apparatus. However, in other embodiments, program instructions and/or data may be received, sent or stored upon different types of computer-accessible media.

Generally speaking, a computer-accessible medium may include non-transitory storage media or memory media such as magnetic or optical media, e.g., disk or DVD/CD coupled to computing device 9000 via I/O interface 9030. A non-transitory computer-accessible storage medium may also include any volatile or non-volatile media such as RAM (e.g. SDRAM, DDR SDRAM, RDRAM, SRAM, etc.), ROM, etc., that may be included in some embodiments of computing device 9000 as system memory 9020 or another type of memory. Further, a computer-accessible medium may include transmission media or signals such as electrical, electromagnetic, or digital signals, conveyed via a communication medium such as a network and/or a wireless link, such as may be implemented via network interface 9040. Portions or all of multiple computing devices such as that illustrated in FIG. 3 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

The system of the present invention employs a combination of cloud computing and edge computing. In the present context, cloud computing is a model for enabling ubiquitous, convenient, on-demand network access to a shared pool of configurable computing resources (e.g., networks, servers, storage applications, and services) that can be rapidly provisioned and released with minimal management effort or service provider interaction (National Institute of Standards and Technology). In the present context, edge computing is a distributed computing paradigm that selectively locates computation and data storage resources closer to where such resources are needed, stored, and used.

The platform of the present invention employs a balance of interlinked distributed and non-distributed computing resources or computing systems that are connected over a digital communication fabric or network. Weighted relationships and mappings of data between distinct nodes is employed to form and facilitate operation of the communication fabric or network.

The services of the inventive platform may include, but need not be limited to, the core service; a marketplace service; a creators studio service; a smart infrastructure service; a project management service; a human resources service; a dashboard service (organizational and personal); a drive service; a customer support service; a items manager service; a billing service; a treasury service; an email or mailbox service; and a jobsite service.

For example, the marketplace service provides the user location or interface through which the user can find applications, services, or nodes that the user may need to organize and automate processes. Within the marketplace service, the user can both buy applications, services and nodes and sell applications, services and nodes that the user may have created. The marketplace service also allows the user to publish requests for the development of custom applications, services, and nodes.

The creators studio service provides the user with an interface through which the user can easily create, change and support logic of business processes that control software and hardware, through both a full-code and a graphical, low-code experience.

The smart infrastructure service provides the user with a graphical interface through which the user can easily set-up, operate and automate various devices connected to the inventive platform, e.g. robots, within a facility.

The project manager service combines project management tools and AI engine to increase staff productivity and accountability.

The human resources service simplifies and eliminates manual work by automating HR-related tasks, such as, paperless employee onboarding and electronic storage of all sensitive HR documents. It also provides a human resources dashboard that displays employee's costs, assigned tasks and deadlines, and reports.

The dashboard service provides a user with tools to manage tasks, notifications, and contains a set of widgets with descriptive statistics for other integrated services.

The drive service allows the user to save and store company information in a safe central graphical representation of location, while also providing team collaboration abilities.

The customer support service allows users to automate and improve customer support, e.g. through chat support, ticketing system, processes optimization.

The item manager service provides the user with a centralized location of items, related files, information, and inventory. These items are used throughout the platform eliminating duplications and can be enabled into a web shopping cart. The items are further connected to the warehouse allowing the user to easily identify where the needed item is stored as the system is instantly updating and maintaining information regarding the stock and inventory items.

The billing manager allows the user to easily manage payments for platform services usage; to set up permissions and access to platform services to members of the user's organization; and to receive invoices and unpaid bills reminders.

The treasury service provides automation to the user's bank and cryptocurrency accounts and provides real-time transaction history and payment systems allowing the user's organization to automate transaction data matching with accounting data and payments.

The mailbox service provides the user with an all-in-one email service that allows the user to use email, manage mailboxes, and automate routine email-related processes within the same platform.

The jobsite service provides the user with construction project management functionality that allows the user to control or monitor every part of a construction project from design to final commissioning. Simple interfaces allow the user to budget, monitor compliance with deadlines, manage building drawings, manage approval from project stakeholders, create tasks for workers, and follow the completion of each stage of the project.

The core service is the central component of the inventive platform. The core service functions as the primary user resource for all system automation, and node and graph configuration and management, as well as process deployment within the platform. The core service provides a graphical user interface in which the user can create, edit, organize, and run service processes and automations. The core service interface provides, in part, a graphical representation through which a user creates, manipulates, and visualizes processes represented as graphs; subgraphs; nodes; inputs and outputs of subgraphs and nodes (or vertices); connections between different subgraphs; connection between different nodes; and connection between different subgraphs and nodes.

In the context of the present invention, the term window means any of various distinct bordered shapes, for example a rectangular box, appearing on a user's visual interface, such as a device screen or computer screen or monitor, that display files or program output, that a user can, for example, move and resize, and that facilitate multitasking by the user. For the sake of clarity, a window may include one or more sub-windows and sub-window may include one or more additional sub-windows.

As used herein, the terms process or processes and automation or automations are employed interchangeably.

As used herein, the term graphical (graphically) means of or pertaining to visual images, diagrams, images and is not intended to encompass the direct use of coding or a program language by a user.

In the context of the present invention, a graph table or graph grid is a grid area visually presented to a user within a window. Within the graph grid, the user can create and edit a process or automation graph formed of nodes, subgraphs, and connections between the same that is a graphical representation of a desired functional process or automation.

In the functional sense, nodes and subgraphs (vertices) are different elements or components that connect to one another within the inventive platform to form a process. A node is a block of logic, e.g. a computer program, that processes input data received and returns output data. A subgraph is a distinct group of multiple nodes, a node and a subgraph, or multiple nodes and multiple subgraphs. Alternatively stated, a subgraph is a group of independent blocks of logic (computer programs) that processes input data received and returns output data. By way of analogy only, nodes could be conceptualized as a file on a computer drive and a subgraph could be conceptualized as a folder on a computer drive. The user may configure a subgraph to contain or employ multiple nodes (files) and other subgraphs (folder).

Nodes can be connected or linked to another node or to another subgraph. A subgraph can be connected to another subgraph or a node. Nodes and subgraphs may each be connected or links to multiple other nodes or subgraphs.

Within the user interface of the present invention, graphical representations of nodes and subgraphs are presented to the user so that the user can easily and visually identify a desired node or subgraph and introduce such nodes and subgraphs into a graph grid to form a new graph (automation). The user can alternatively add nodes and subgraphs into an existing graph already present on a grid graph. Through the graphical representation or user interface of the present invention, the user can create and edit connections between the nodes and subgraphs of the graph.

The term input refers to data (or a message) that is received by a node and the term output refers to data (or a messages) that is sent or transmitted from a node.

The term socket refers to node elements that receives an input or sends an output. Sockets are specific to the type or configuration of an input or an output that they can handle and, hence, are categorized into several different types based upon their function. The input received by a node socket and the output transmitted by a node socket are in the form of data transfer object, DTO, communicated along the connections or edges defined by pairs of independent nodes. The DTOs have a predefined structures that are recognized and specific to the node's socket(s). The predefined structure of the DTO allows for a node to employ an expectation of the data type or DTO structure to be received by the node. Accordingly, nodes and subgraphs having inputs and outputs of a same socket type can be readily connected as the respective nodes or subgraphs will meet the data type expectation that the node is capable of processing.

Otherwise, two nodes having different sockets types car only be connected to one another if at least the input socket of the pair of sockets is of an any-data-type. The any-data-type socket being operable to receive DTOs of different types. Alternatively, as discussed further herein, a user can connect nodes having socket of different types by employing a novel mapping node according to the present invention.

The above described expectation of the data type advantageously avoids the added work of the node having to identify a data type input. This, in turn, allows or facilitates the operability of the graph to dynamically and autonomously change connections between nodes sending and receiving same-kind DTOs in order to for the inventive platform to self-optimize to create the most optimal runtime and interactions while still maintaining a defined communication context.

As used herein, the term connection means a data link or communication path between an output socket of one node and an input socket of a different node.

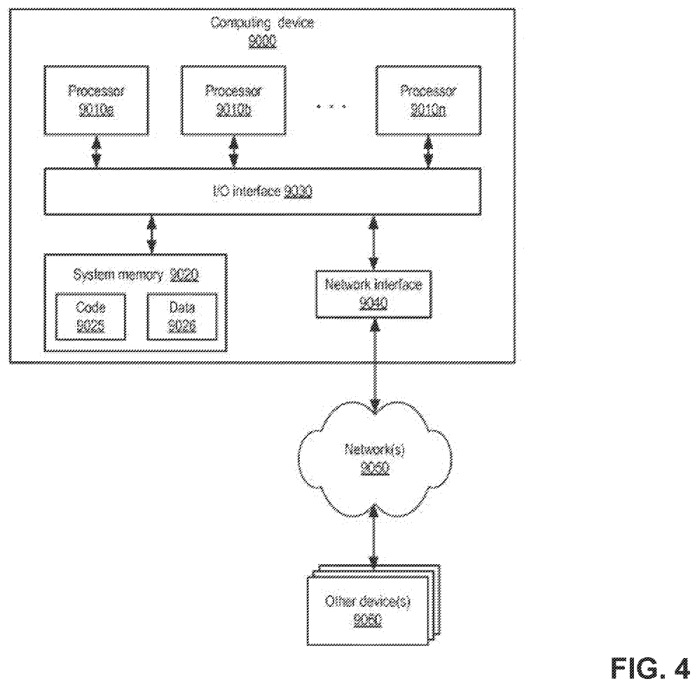

According to the present invention, a user accesses the inventive core service through, for example, a user dashboard service window of the inventive platform. As shown in FIG. 4, within a dashboard 100, among other task, the user can open a core service graph table via an open core function 102; view and select services 104, and automate a selected service or services via a automate service function 106.

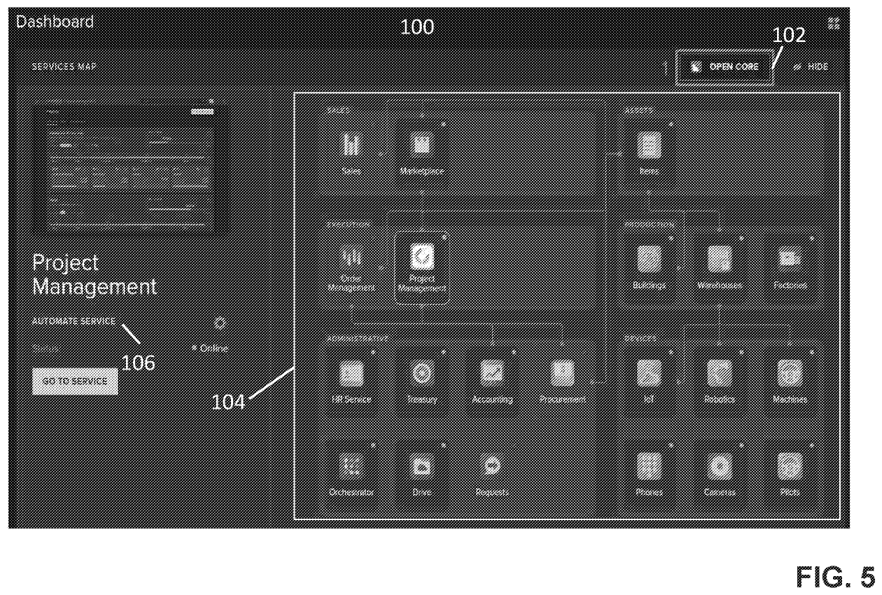

Selection by, for example, the user clicking or touching the open core function 102 (FIG. 4), opens a core service window 110 where various services 104 are displayed as subgraphs 112 within a graph table or grid 114 (FIG. 5).

Within the core service window 110, the user can access a toolbox function 116 view. Selection of the toolbox function 116 opens a toolbox window 130 (FIG. 5) from which the user can add nodes or subgraphs to graph table grid 114, for example, by the user dragging and dropping the node or subgraph into the graph table or by the user actuating select function that place the node or subgraph into the graph table. Within the core service window 110, the user can also show run information and run or stop the displayed process by actuating one of the show run info, run, stop functions 118. The show run info function allows a user to observe ongoing processes logs in real-time within a separate window.

Within the graph table grid 114, the user can view selected node or subgraph and create, edit, and configure connections between the inputs and outputs of different nodes and subgraphs to create the desired graph or automations. For example, by clicking on an output socket 120 of a subgraph and dragging the user's cursor to an input socket 122 of a different subgraph a line or connection 124 between two subgraphs is functionally created. Alternatively, the user can select or click an output socket 120 and sequentially select or click an input socket 122 and the core service will graphically and functionally create a connection between the selected output and input. The same ability to create connections exists between different nodes and between different nodes and subgraphs.

With reference to FIG. 5, after creating or editing a graphical representation of a process or automation on a graph grid 114 within the core service 110, the use selects the run function 118 to implement and create a run-time of the process represented in the graph.

In the present invention, nodes are categorized, for example, a provisional nodes; core nodes; service nodes; and application nodes.

A provisional node is a node a user determines is needed for a process created on the graph table but that does not already exist. The user can describe the desired node function and place a request for the node to be developed within the marketplace service.

A mapping node is a node that functions to connect inputs and outputs having different sockets types.

A core node performs common, often used tasks needed in creating processes and automations within the inventive platform. A core node is a node that already exists as an element within the core service and is accessed from within the core service toolbox function.

A service node is a node is employed within one or more of the inventive services, e.g. HR, Procurement, Treasure, etc.

An application node is a node that provides data processing under the user's control and to show the user real-time information regarding one or more processes and to allow the user to manage these processes with a user interface. For example, a user can add an application node to an existing service such as an industrial automation service to monitor energy consumption.

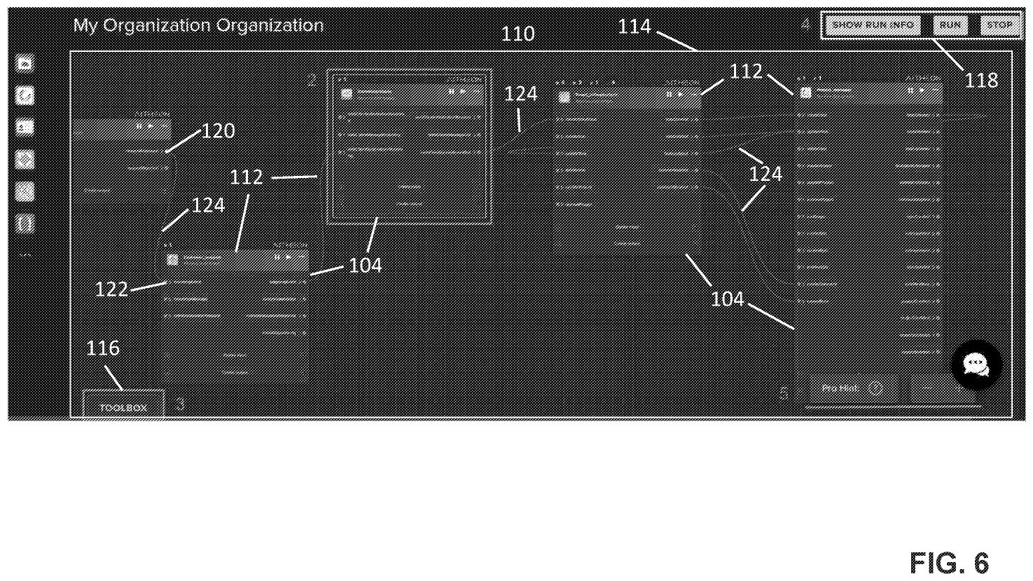

To add a node to the graph table 114, a user actuates the toolbox function 116 from the core service window 110 (FIG. 5) which opens or otherwise makes visible to the user the toolbox window 130, as shown in FIG. 6.

The toolbox window 130 presents the user with a browse nodes function 132 and sort and filter functions 134 for identifying available nodes 136 from repositories (1) of nodes previously used or created (within the creators studio service) by the user (My Nodes); (2) of node created by others and available to the user through the marketplace service, for example available for purchase by the user, (Marketplace Nodes); and (3) of core nodes (Core Nodes). Once the user identifies and selects the desired node for use in the user's functional process, the user is presented with an install node function through, for example, a dropdown menu presented by clicking the ellipses function 138 of the desired node 136, that will place the node within the user's graph table 114. Alternatively, the user may drag and drop the desired node into the graph table 114 from the toolbox window 130.

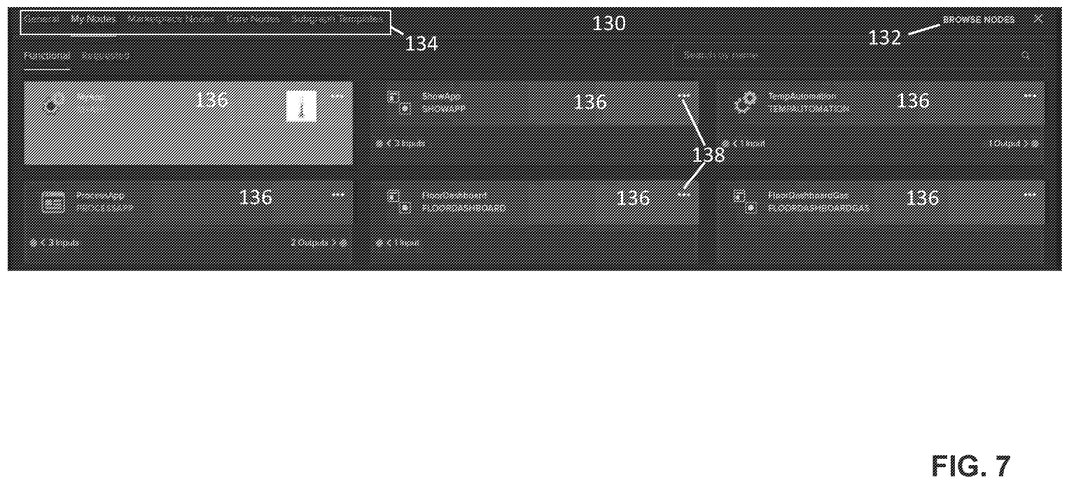

Also accessible to the user, for example from the dropdown menu presented by selecting the ellipses 138 of the node 136 (FIG. 6), are various user-customizable node configuration functions. As shown in FIG. 7, from within a node configuration window 140, the user can manipulate the nodes parameters and input and output settings. Within an input and output function 142, the user is presented with functions, for example, (1) to enable single or multiple inputs 144; (2) to select or enter an input and output name 146; (3) to select the visual placement of the inputs or output on the graphical representation of the node 148; and (4) to select a socket type for the inputs and outputs 147.

Within the node configuration window 140, the user can further access a node parameters function 143. The node parameters function allows the user to define the specific parameters that enable the node to execute the desire function. For example, if relevant node is a web client bot node, the user can indicate a specific robot to engage with the node or a user can employ two similar nodes in a single graph or process and set different parameters for the independent but like nodes in order to employ the nodes in different situations.

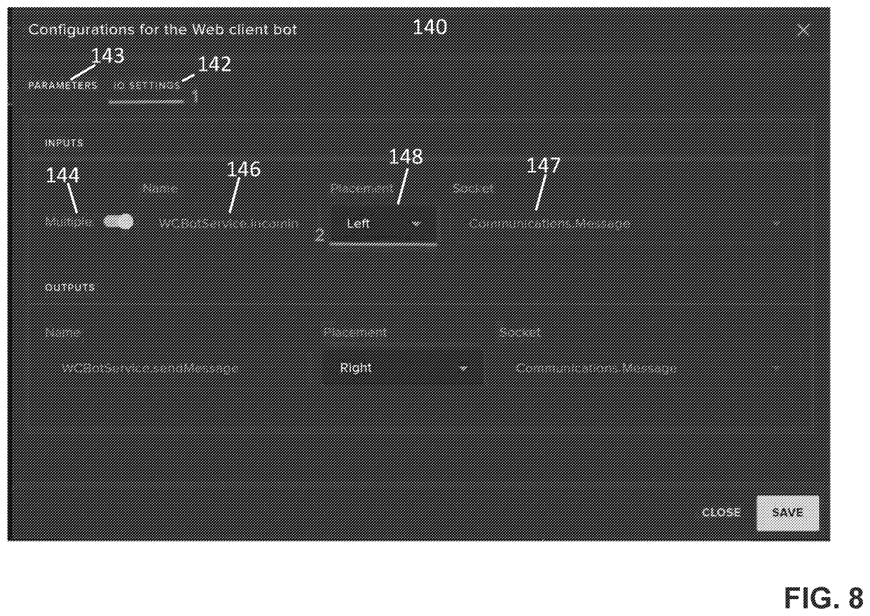

As shown in FIG. 8, in certain embodiments of the present invention, to configure individual sockets, the user is presented with a socket configuration function 150. Within the socket configuration function 150, the user, for example, defines a desired socket group 154; a socket name 152; a socket description 156; and a socket structure or field type 158.

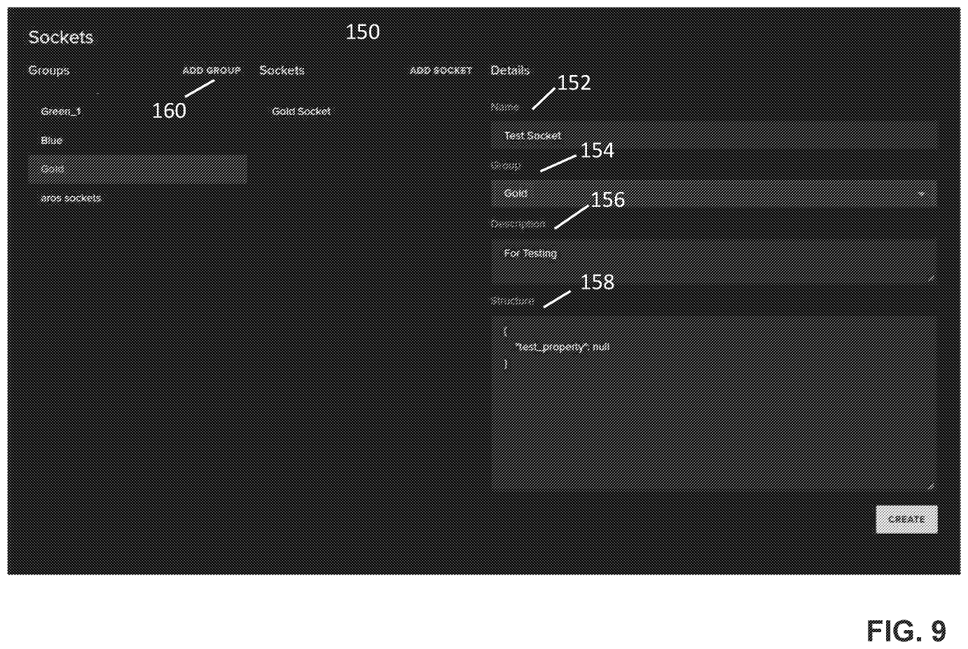

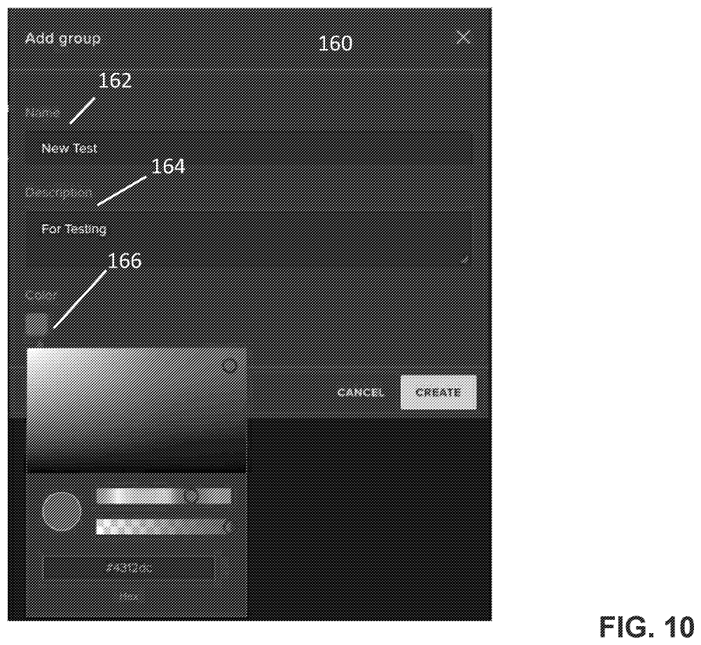

As shown in FIG. 9, to enhance the graphical presentation and functionality of a graph (automation), the user can create new socket types and visually distinguish socket groups through a socket add group function 160. Within the socket add group function 160, the user defines a socket group name 162, a socket group description 164, and a socket group color 166. The user accesses the socket add group function 160, for example from the socket configuration function 150 (FIG. 8).

Socket grouping is, for example, based upon the service they are employed within and level of usage. Example socket groups and types include: Common (Ping, Anydata, Numbesocket, URLsList, ErrorSocket); ProjectManager (ProjectTaskId, Project, ProjectId, Label, Epic, EpicId, Comment, Stage, ProjectTask); Communications (MemberInfo, Channel, ChannelMember, ChannelMemberMetadata, Message, ConnectionRequestAction, ConnectionRequest, TypingStatus, Ping); Marketplace (StoreRequest); Device (DevicePose); ItemManager (Item, DeleteBylD, Category); and SmartInfrastructure (CreateRob.

In certain embodiments or the present invention, developers may improve nodes previously obtained and employed in a user's process or automation. In such cases, as shown in FIG. 10, the user is visually presented with a release alert function 168 on or otherwise associated with the graphical representation of the relevant node 136. By selecting on the release alert function 168, a user can select which node release to employ in the user's graph (automation).

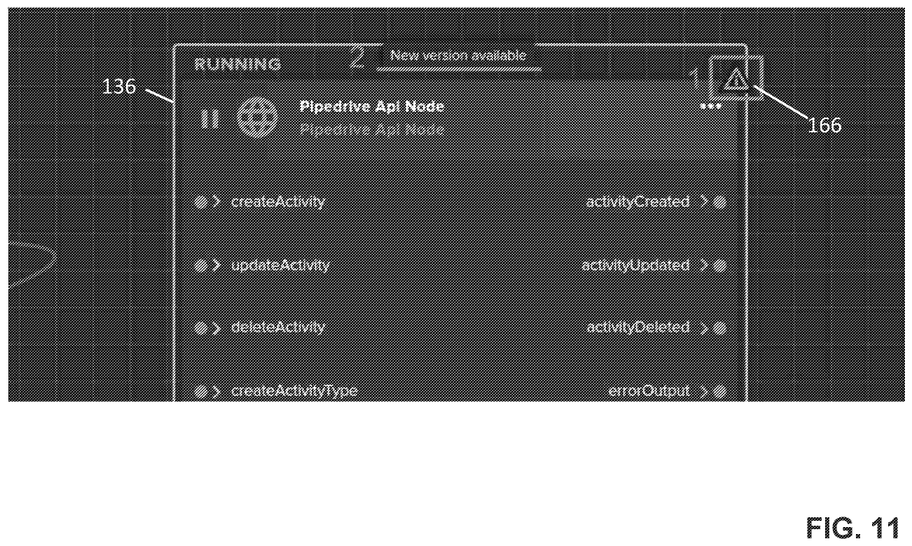

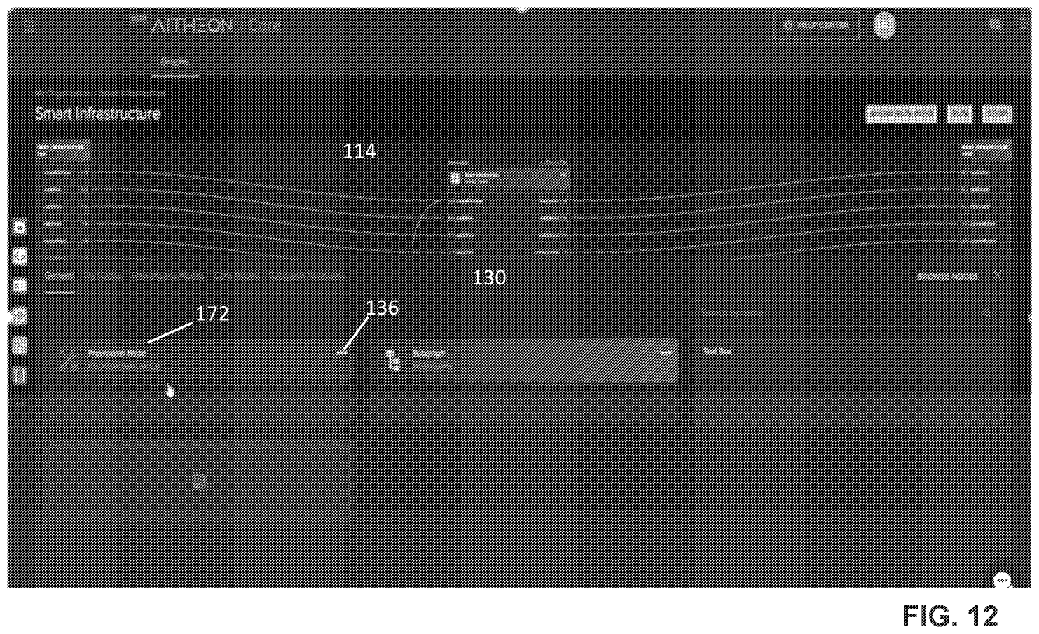

A provisional node is a node that a user determines is needed for a process created on the graph table but that is not already present within the inventive platform. In such case, the user can describe the needed function and place a request for the node to be developed within the marketplace service of the platform. The provisional node process starts with the user defining and describing the node that the user desires to be created. As shown in FIG. 11, the user identifies the provisional node 172 from within the toolbox function widow 130 or the toolbox function 116 (FIG. 5) and locates or installs the provisional node 172 within the user's graph grid 114, as described with respect to FIGS. 5 and 6. Once within the user's graph grid 114, the user can edit the name of the provisional node and begin defining the desired configuration of the provisional node.

To define the provisional node configuration, the user access a provisional node configuration function through, for example, a dropdown menu presented by selecting the ellipses 138 within the provisional node 172 (FIG. 11).

As shown in FIG. 12, from within a provisional node configuration window 180, the user can define and edit the provisional node parameters and setting through a parameter function 182 and a provisional settings function 184. Within the parameter function 182, the user can define a parameter name 186; define whether the parameter is mandatory 188; define a parameter values or conditions 190 for the node to execute 190; and add additional parameters as desired 192.

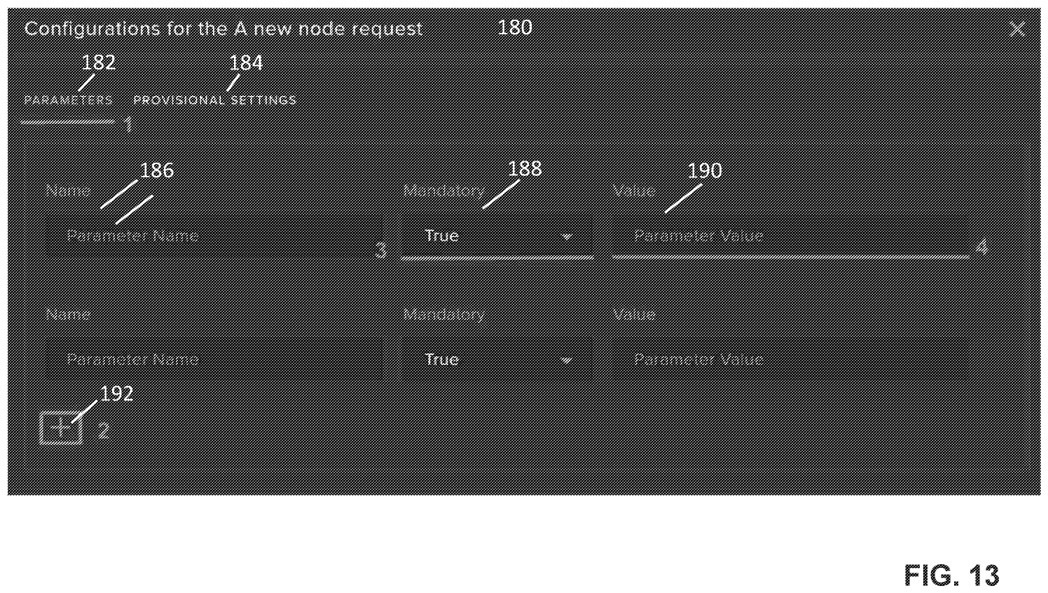

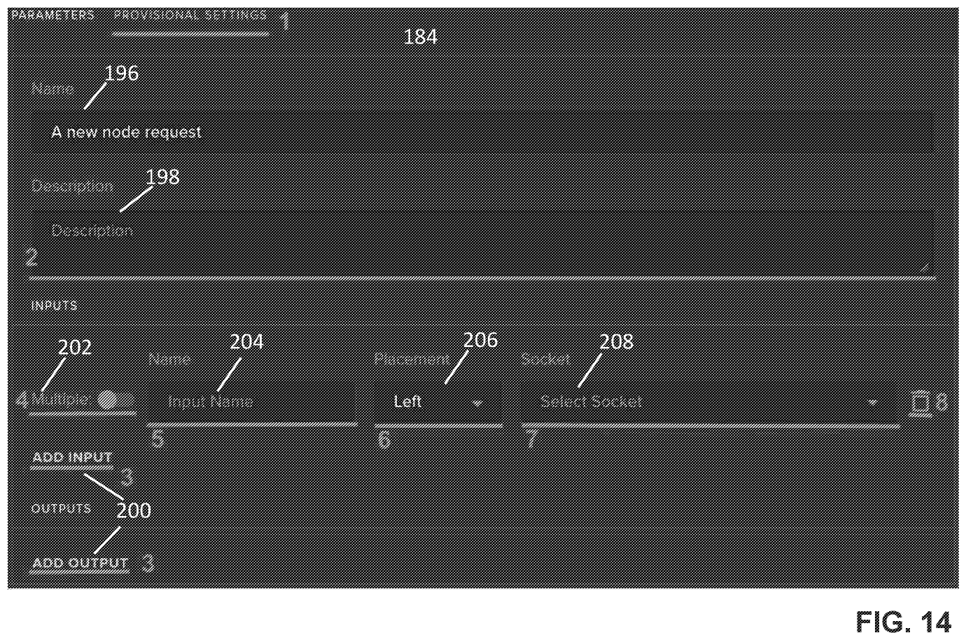

As shown in FIG. 13, within the provisional settings function 184 of the provisional node, the user can define a node name 196; provide a detailed description of the functionality of the desired node 198; define inputs and outputs 200; select a multiple function 202 to define more than one input and output for the node; define inputs and outputs names 204; select the visual placement 206 of the inputs or output on the graphical representation of the new node; and select the socket type 208 for the inputs and outputs of the provisional node.

In certain embodiments, if the user does not know what type of input or output sockets to use, the user can select am anydata socket type. In such case, once the provisional node is linked within the graph and the graph is run, the inventive core service will automatically revise the socket type according to the socket type to which the anytype socket is linked.

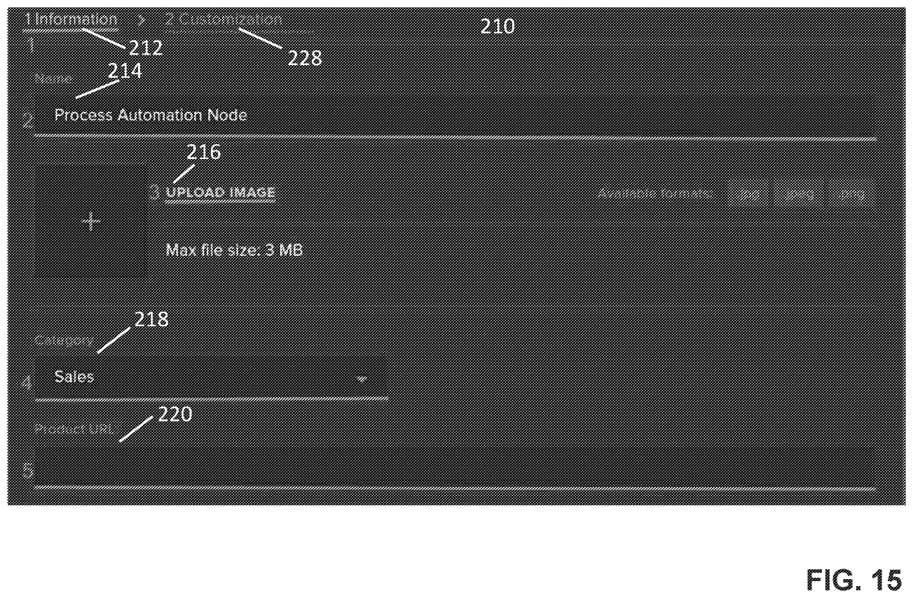

In order for the provisional node to be created or developed, the user must publish a provisional node request. As shown in FIGS. 14 and 15, the user can access a publish request function 210 through, for example, the dropdown menu presented by selecting the ellipses 138 of the provisional node 172 (FIG. 11). Within an information function 212 of the publish request function 210, the user defines a node name 214; uploads images 216 that will represent the node in the marketplace service; defines a node category 218; provides a node URL 220; provides a detailed description 222 of the desired node functionality, node purpose, node use cases, etc. of the desired provisional node to assist in developing the node; provides one or more screenshots 224 to show a particular process schemes to assist in developing the node; and defines a pricing amount and scheme 226.

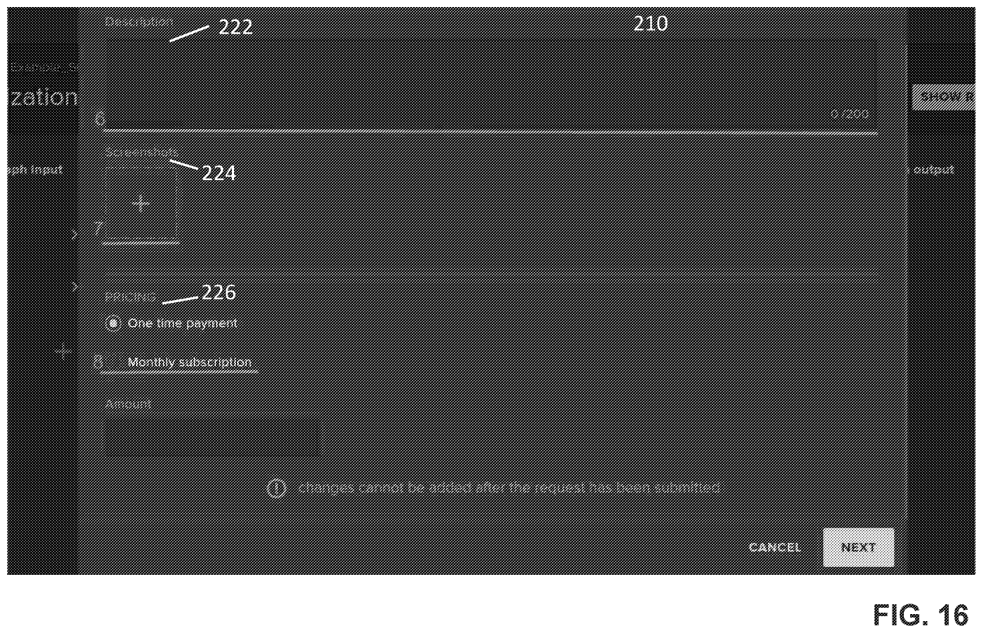

Within a customization function 228 of the publish request function 210, shown in FIG. 16, the user defines the visual and graphical appearance of the provisional node 172 within marketplace service by, for example, defining a logo 230; defining a background 232; and defining a boarder 234.

The user then actuates a save function and the provisional node is subject to review or moderation. Once approved, the request is posted within the marketplace service, thereby allowing developers to review and create the node for the user. Once the provisional node has been created, the user from which the node publish request originated is notified that the node is ready for use.

The present invention advantageously provides the user with a simple, nontechnical, graphical interface through which to perform the task of connecting or linking nodes and subgraphs with one another to create functional processes, regardless of whether the sockets of the relevant nodes and subgraphs handle output and inputs of same or different types.

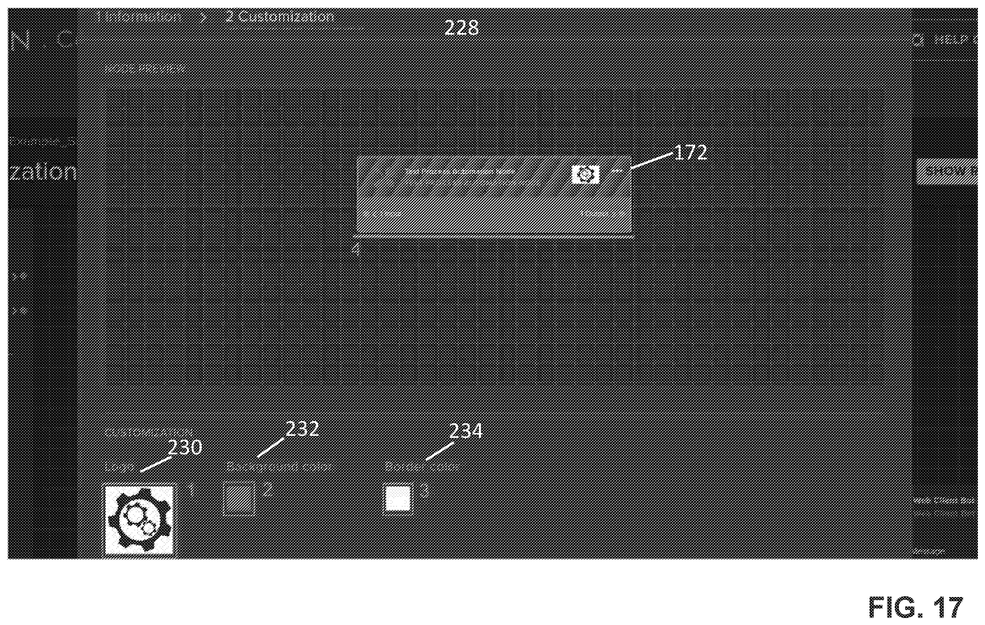

For example, with reference to FIG. 17, in certain embodiments of the present invention, by selecting the output socket 120 of the node 136 or the subgraph 112 within the graph grid 114, for example by clicking a cursor, the input sockets 122 of the different nodes or graphs within the graph grid 114 having corresponding or same type socket will present a visual indicator to the user, e.g. the same type input sockets within the graph grid 114 will appear highlighted or like colored. Accordingly, the user is conveniently presented with all of the same socket type input sockets options with which the previously selected output socket is compatible. To form the desired functional and graphical link or connection 124 between graph elements, the user simply selects or click the desired highlighted input socket of the node or graph to which a link is desired; knowing that such sockets are compatible. The newly created functional connection or link 124 is then presented to the user graphically as a line 124 between graphical representations of the nodes or subgraphs within the graph grid 113.

In certain embodiments, a user can view an input or output socket type of a node 136 or subgraph 112 by hovering or manipulating the cursor over the graphical representation relevant socket. As shown in FIG. 17, by way of example, output socket 120 is presented as a “sendMessage” type and input socket 122 is present as a “incomingMessage”. Hence both sockets are of a same type, i.e. a same type messenger or DTO. Alternatively, as described herein, user may further confirm such socket types through the node or subgraph configuration functions.

Within the graph grid of the core service, the user can graphically organize or otherwise manipulate the graphical representations of connections or links 124 between nodes 136 and subgraphs 112 by selecting the connection 124 or a point on the connection 124 and dragging such to a desired location within the graph grid 114 to facilitate user visualization of the process graph.

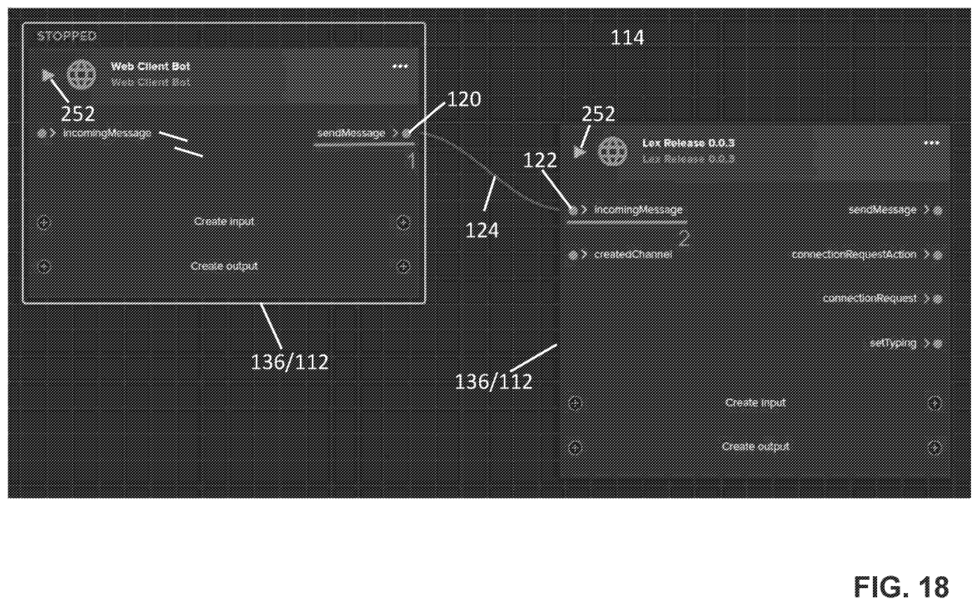

When a user attempts to link output and input sockets of different types, the user is presented with a prompt to create a mapping node according to the present invention. As shown in FIG. 18, when a user attempts to link output and input sockets of different types, the user is presented with a mapping node prompt 236 to connect the desired output and input sockets. A mapping node is a novel feature of the core service that functions to connect inputs and outputs having different sockets types. By default, or absent a mapping node, the core service allows connecting only sockets of same-type.

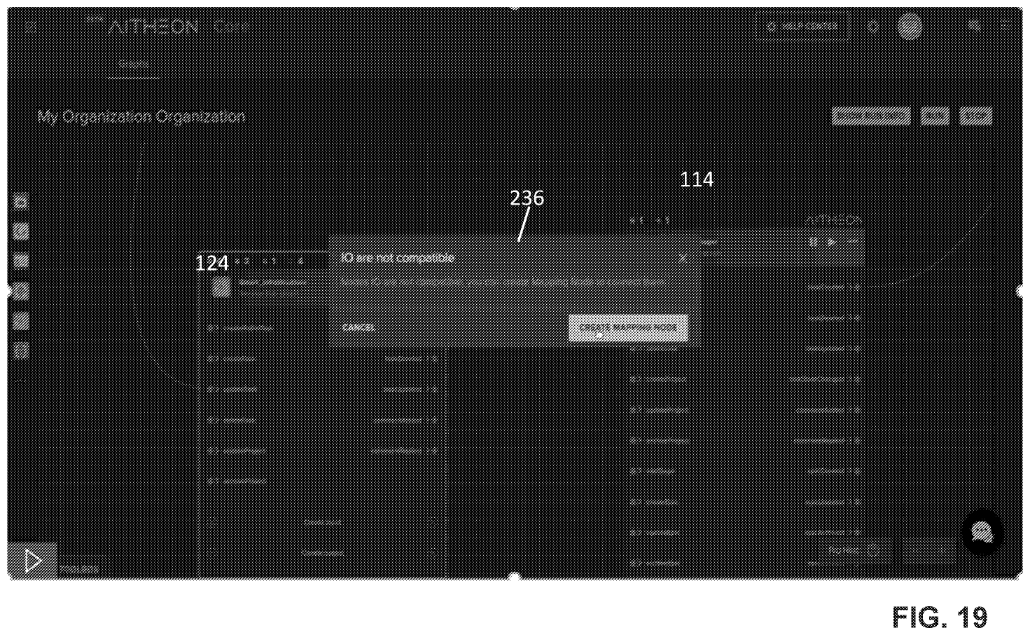

With reference to FIG. 19, selection of the prompt 236 present the user with graphical representations of each of the nodes or subgraphs 240 the user is attempting to connect and data fields 242. The user can link sockets with data same-type fields or can connect any output field with an input socket of a string type. In such case, the output or message will be converted to a string type.

If a node or subgraph input socket has a required configuration 244, the user has the option to select a static function 246 and define data that goes to input socket so that the connection will match. Alternatively, the use can select an add custom field 248.

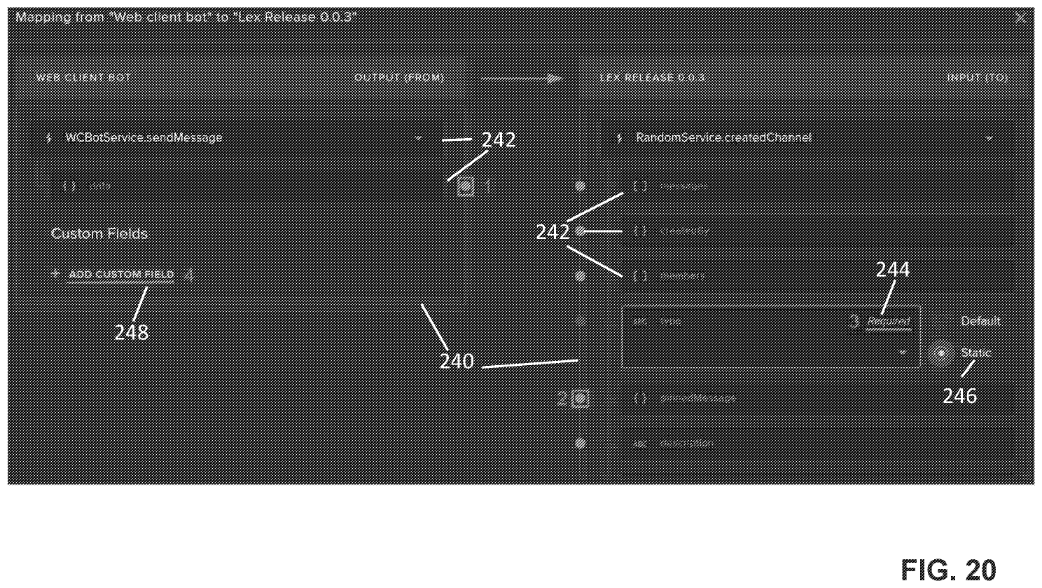

Once the user has saved or implemented the mapping node, the mapping node 250 will appear on the graph grid 114, as shown in FIG. 20.

The present invention provides for a user to connect a mapping node to one or more node or subgraph outputs sockets and one or more node or subgraph input sockets.

As described herein, machine learning, or ML, involves, in part, creating a model or models which are trained on a data set and then are operable to process different data to make, for example, predictions. In the present invention, during graph configuration, the user can define or employ specific nodes as machine learning nodes and then configure the machine learning node by dynamically dragging and dropping a model or models into the ML node.

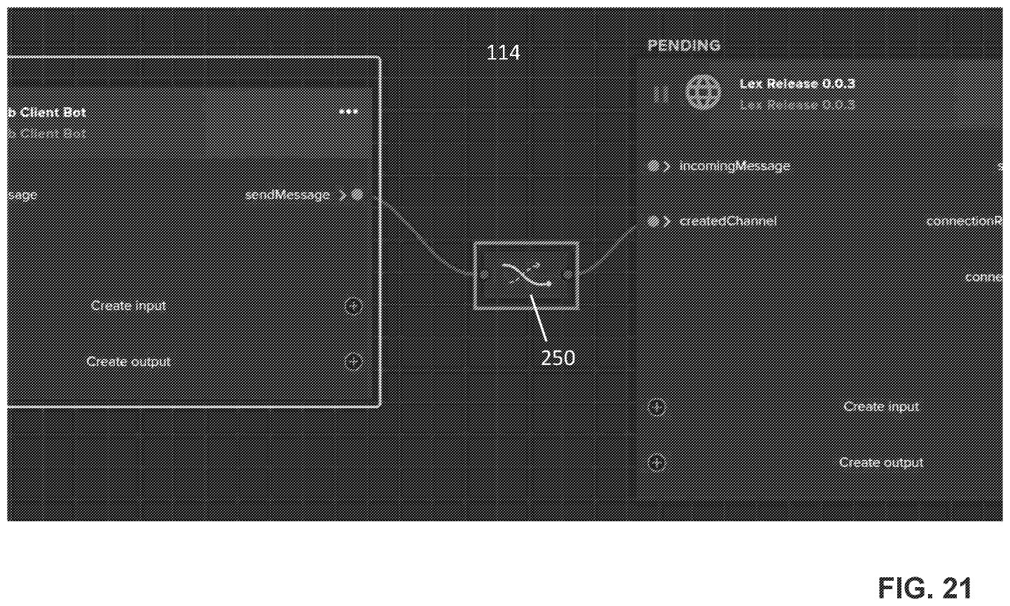

In the present invention, during graph configuration, as shown in FIG. 21, the user is presented a training setting function, page, screen or window 280 through which the user configures, for example: activation of node training 282; training intervals 284, i.e. the number data sets processed by the node before retraining; consensus confirmation or consensus pool minimum 286; consensus pool credentials or permissions 288; a confidence threshold; a consensus confidence; and options for dynamic intervals and dynamic consensus pool minimum.

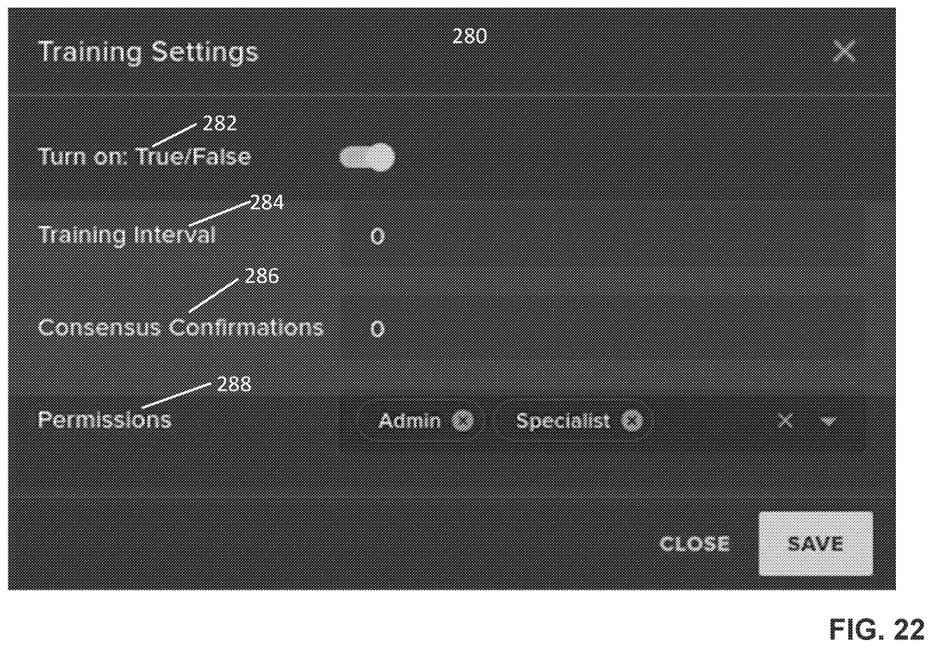

For example, in operation and with reference to FIG. 22, an ML node 302 of the process 300 is configured to perform facial recognition of humans entering an office space. If the ML node 302 detects an error (box 301), e.g. is incapable of achieving a sufficient level of confidence in identifying a specific individual in an image, the node 302 will autonomously initiate an internal error correction function (box 303). The error correction function will seek additional data to perform the required process (box 305). For example, the node 302 can request, via automated emails, that a consensus pool 304 of, for example, human agents independently confirm the identity of the individual in the image in question. Depending upon the above described user configuration of the ML node training settings, the ML node 302 may require training setting requirements to be satisfied (box 307). For example, the ML node 302 may require (a) that a minimum consensus pool population or size be pooled during the request for identification and (b) that the compiled responses of consensus pool meet a minimum confidence level or threshold. Once the ML node required training settings are achieved (box 309), the ML node 302 will then employ the new error corrected data to generate output (box 311) and to add the error corrected data to the system data 18 (box 313).

The user configuring the ML node 302 can define a minimum consensus pool population or size from which the ML node 302 will request identity confirmation and a minimum confidence level or threshold that must be obtained from the consensus pool for the error correction data generated from the consensus pool 304 to be integrated into the system data 18 and, hence, be employed to determine of the course of action 20 (FIG. 1).

Functionally, a subgraph is an element of a process that is linked or connected to other subgraphs and nodes within the same process. A Subgraph contains one or more nodes and one or more other subgraphs. For convenience, subgraphs are categorized into different types or groups. For example, with reference to FIG. 5, each service activated by a user will appear as a service subgraph 104 within the user's core service graph grid 114. Service subgraphs have ready-to-use settings and a service node inside that allows the user to make immediate connections with other nodes and subgraphs.

There are several sub-types of service subgraphs for use within specific services. For example, within the smart Infrastructure service subgraph, the sub-type service subgraphs include: an infrastructure subgraph that is automatically crated when an infrastructure is added to the service; a floor subgraph that is automatically created when a floor is added to the infrastructure; a station subgraph that is created when a station is added; and a controller subgraph that is created for a device added to a particular station.

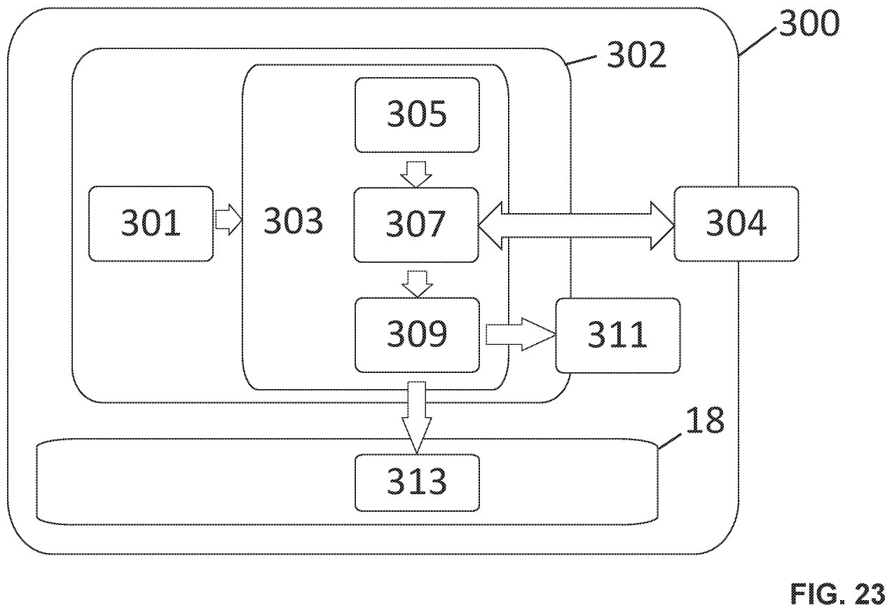

The process for adding a subgraph to a graph grid (process) is similar to process for adding a node to a graph grid (process) described herein. To add a subgraph to the graph table 114, a user selects the toolbox function 116 from the core service window 110 (FIG. 5) which opens or otherwise makes visible to the user a toolbox window 130, as shown in FIG. 23.

The toolbox window 130 presents the user with, among other options, a subgraph 254 which can be a subgraph template or a previously configured subgraph. The user is presented with an install subgraph function, for example a dropdown menu presented by selecting the ellipses 138 within the subgraph 254, that will place the subgraph within the user's graph table 114. Alternatively, the user may drag and drop the desired subgraph into the graph table 114.

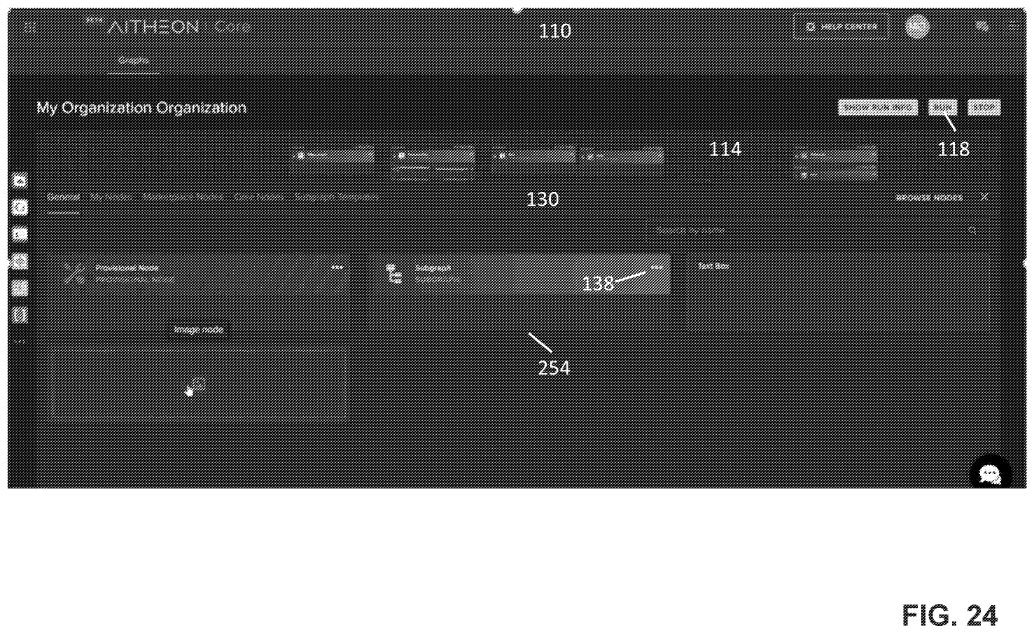

Also accessible to the user through, for example, the dropdown menu presented by selecting the ellipses 138 within the subgraph 254 (FIG. 23), are various user-customizable subgraph configuration functions. As shown in FIG. 24, from within a subgraph configuration window 256, the user can manipulate the subgraph parameters and input and output settings. Within an input and output function 258, the user is presented with functions, for example, (1) to enable single or multiple inputs 251; (2) to select or enter an input and output name 253; (3) to select the visual placement of the inputs or output on the graphical representation of the subgraph 255; and (4) to select a socket type for the inputs and outputs 257.

The present invention allows the user to deploy or run different levels of the functional processes graphically created within the core service user interface. For example, on an organizational level, as shown in FIG. 23, actuation of the run function 118 will deploy and run all nodes and subgraphs shown in the graph grid 114. Likewise, actuation of the stop function 118 will stop or terminate all nodes and subgraphs shown in the graph grid 114.

Alternatively, the user can specifically select one or more nodes or graphs within the in the graph grid 114 and select a play or stop/pause function 252 that serves to deploy or stop, respectively, each of the selected nodes or graphs, without running all nodes or graphs on the organizational level (FIG. 17).

During run, graph (process or automation) feedback is observable, for example, through the amount of DTOs exchanged between nodes and subgraph along connections or edges; through the internal node statistics, through logs, and through error status. In run, the graph is running on live production data of the organization, making live production changes to data, determining courses of action, and, if applicable, assigning tasks directed to achieving the graph or process objective(s).

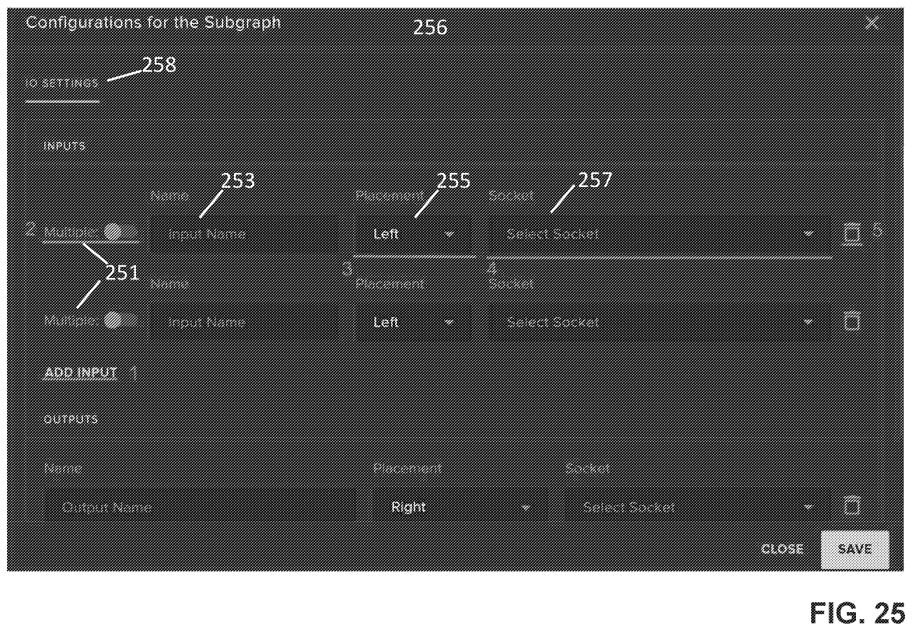

In certain embodiments of the present invention, as shown in FIG. 25, during configuration of the graph, the user is presented with a simulation setting function 260. The simulation function 260 enables the user to configure simulation settings for the graph, for example, enabling simulations 262; defining a data source 264 for the simulation; and defining a data receipt 266 rate, e.g. a value of Hz or milliseconds.

In simulation mode, the graph created by the user will deploy itself and begin to operate according to the principles previously described based upon data sources set in simulation settings. During operation, graph feedback is observable, for example, through the amount of data transfer objects exchanged between nodes along a connection or edge, through the internal node statistics, through logs, and through error status. In this mode, the graph is not running on live production data of the organization, not making live production changes to data, and not assigning tasks directed to achieving the graph objective(s).

When the graph is running, either in run or simulation mode, and a node or subgraph has a connection archiving function enabled, the data objects transferred between nodes and subgraphs are archived to storage. These archives can be later set as a data source in simulation mode or can be analyzed by the user.

In certain embodiments of the present invention, the graph build or deployment status is visually indicated to a user within the core service.

In certain embodiments, the digital ecosystem of the present invention further provides a data sources service. The data sources service allows a user to conveniently view archive data sources, to import data sources (e.g. csv data), and to prune and create new data sources from existing data sources with filters.

In certain embodiments of the platform of the present invention, a smart infrastructure (SI) service is provided. The smart infrastructure service provides the user with a graphical interface through which the user can easily create, operate and automate various processes employing devices, connected to the inventive platform, within a facility. For example, a user can easily create a process or automation for disinfecting a defined area of a facility with a disinfecting robot. In the context of the present invention, the term devices means all electronic equipment that work at the relevant infrastructure and that is connected or in data communication with the inventive platform services. For example, a robot is a device with an embedded controller. A camera and a switcher are devices that requires a controller device to manage them. However, the robot, the camera, and the switcher are all considered devices.

Generally speaking, to create a process for a robotic device within the SI service, a user defines an infrastructure to the service where the robot will operate; defines one or more floors to the infrastructure; defines work areas for the robot within the specified floor; identifies a device or robot to perform the desired task; defines a task for the robot; and deploys or runs the defined process to accomplish the desired task. For non-robotic devices or devices that require a controller device, within the SI service, the user can define stations to the infrastructure floor; define controllers to the station to operate the device at the station; assign an application to the controller to define the controller's function; and create automations to provide a user interface for the device controlled at the station.

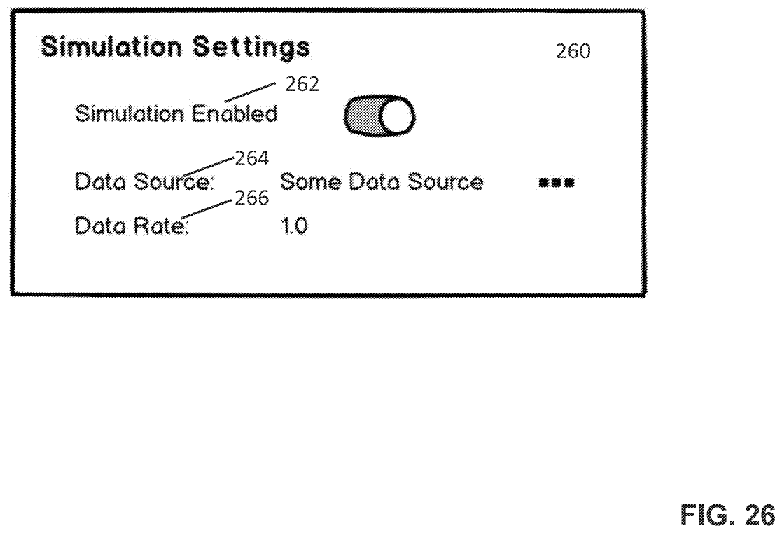

With reference to FIG. 26, to define an infrastructure 404 where a device will operate, the user accesses an all infrastructure window 402 within the SI service 400. The all infrastructure window 402 presents the user a search function 406 and sort and filter functions 408 for identifying available infrastructure 404 from repositories 410 buildings; warehouses; and factories. The user is also presented with a map window 412 that shows the locations of the infrastructures 404 available for the users selection.

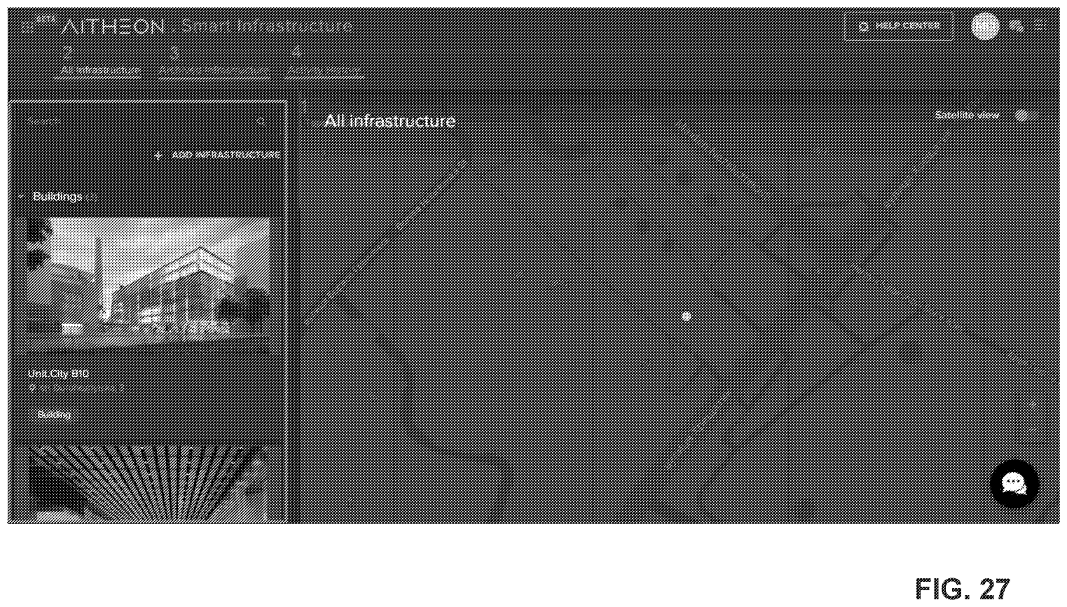

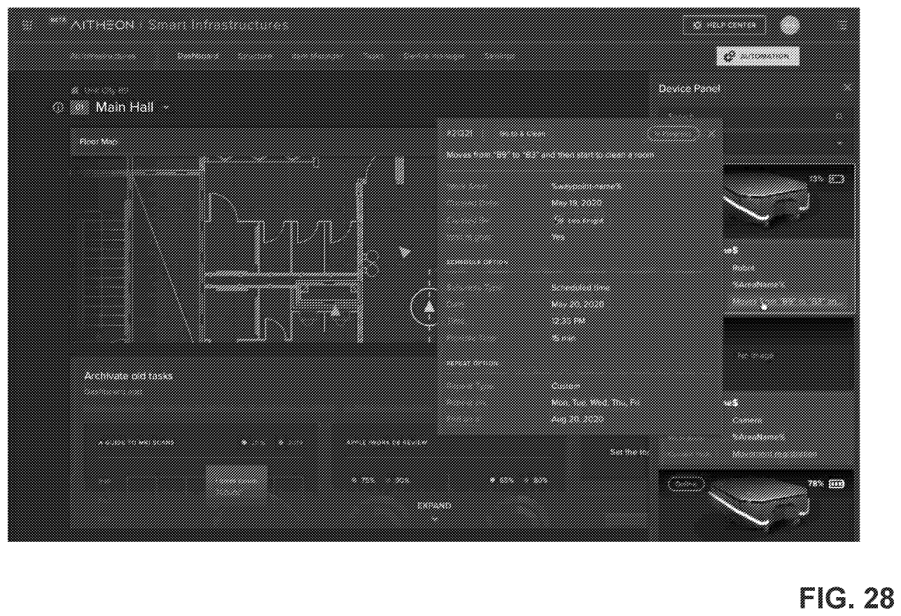

With reference to FIG. 27, once a user selects an infrastructure within the all infrastructure window 402, the user is presented with various other functions for managing the infrastructure, for example, a dashboard function 416; a structure function 418; a task function 420; and a device manager function 422.

Within the SI service 400 (FIG. 26), the user can access an archived infrastructure function 424. Once archived by a user, an infrastructure cannot be edited or otherwise modified unless the user un-archives the infrastructure from within an infrastructure setting function described herein.

Within the SI service 400 (FIG. 26), the user may also access an activity history function 426. With reference to FIG. 28, the activity tracker function provides the user with access to records of all completed tasks that have been assigned including each tasks date, status, device, infrastructure title, area. By selecting a specific task or group of tasks, the user is presented with a depiction of the floor structure 428 where the task was performed and the task activity in the area of the floor. The user can further search, filter, and sort the tasks records according to infrastructure, floors, areas, task type, task time, task day, task device, and user or combinations thereof.

In certain embodiments, a device is associated or in the possession of a human agent or other user performing a task. In such cases, the device can facilitate the performance of the task by the user, as well as record of the performed of the task by the user.

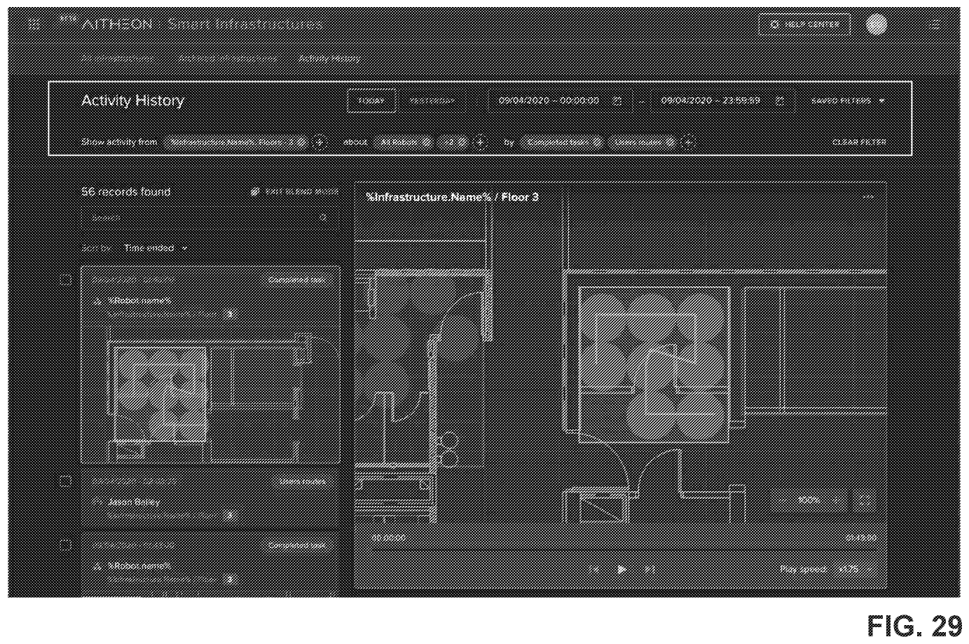

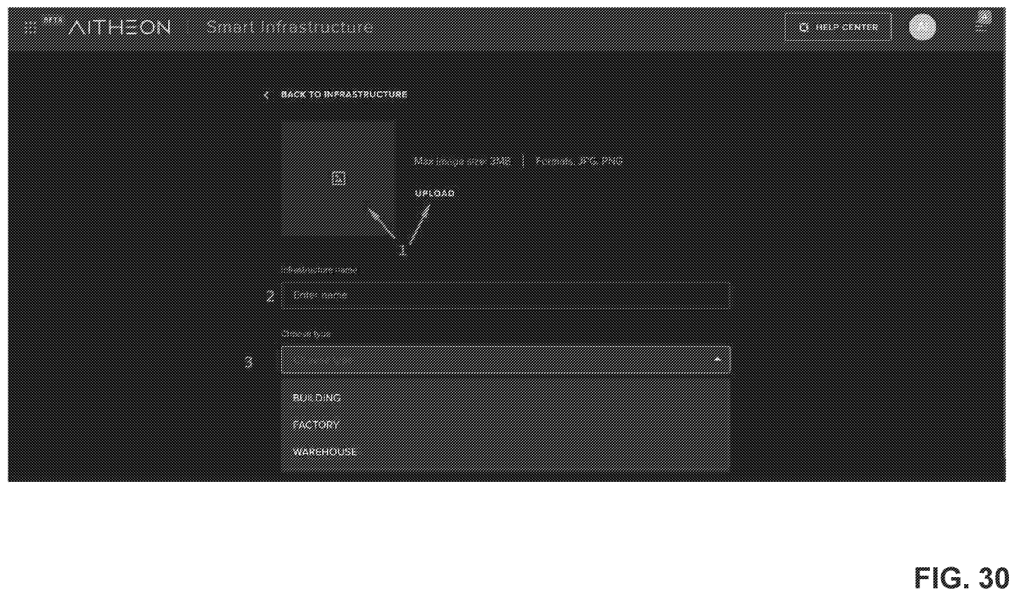

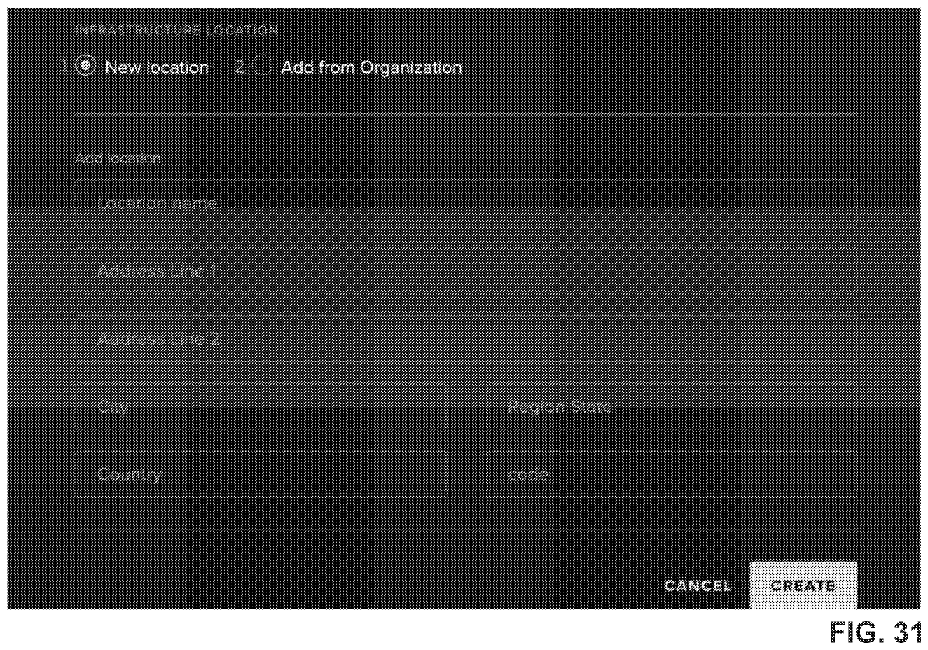

Should the user desire to add a new infrastructure to the repositories 410, i.e. add an infrastructure not already preset in the inventive platform, the user is presented with an add infrastructure function 414 (FIG. 26). With reference to FIG. 29, selection of the add infrastructure function 414 presents the user with add new infrastructure information window 458 from which the user defines, for example, a new infrastructure name; defines a new infrastructure type (e.g. building, factory, warehouse); and provides an image of the new infrastructure. With reference to FIGS. 30 and 31, the user is further presented with an infrastructure location window 460 within which the user defines the location of the new infrastructure. The user is presented with the option of defining the new infrastructure location by providing the name and physical address of the new infrastructure (FIG. 30) and the option of using another organization's location for the location of the new infrastructure (FIG. 31).

To create a process for a device within the SI service, after selection of an infrastructure, a user next defines a floor within an infrastructure within which the process will run or physically be performed.

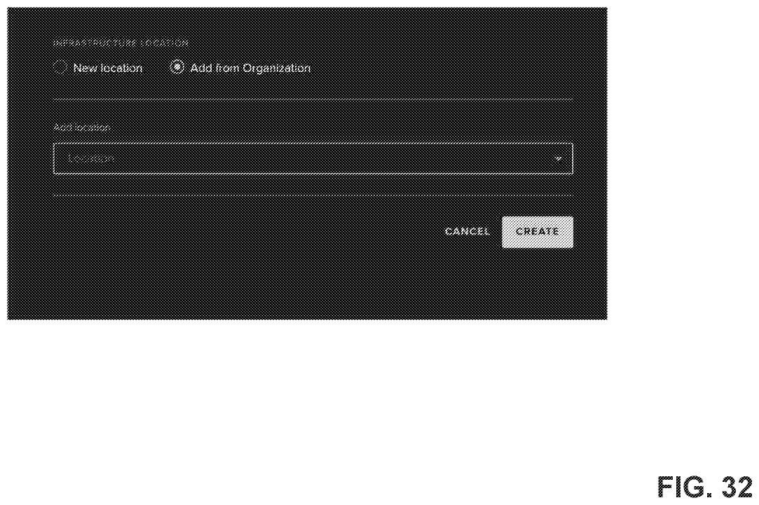

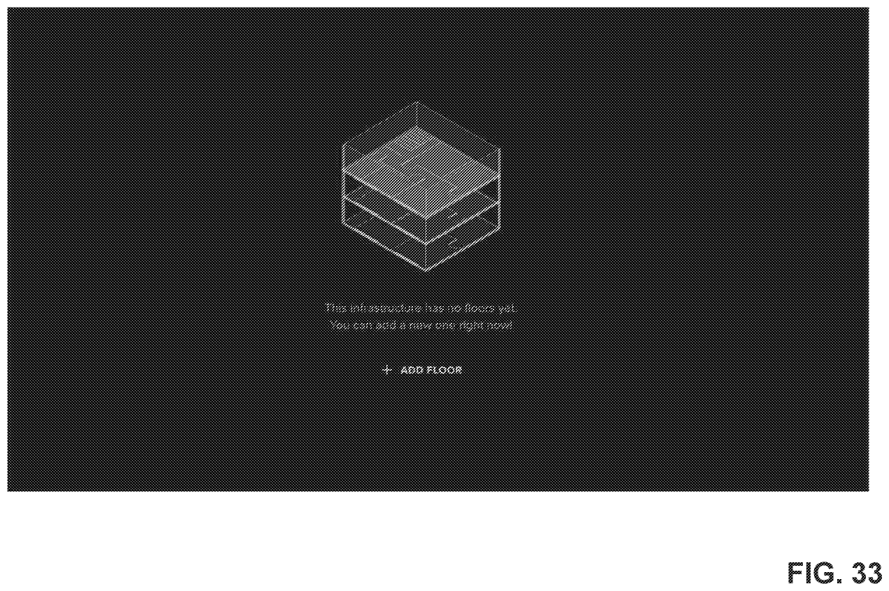

In the case of a newly added infrastructure, as shown in FIG. 32, the SI service presents the user with a visual prompt with an add floor function 462. Selectin of the add floor function 462 presents the user with a floor settings function 464, as shown in FIG. 33. Within the floor settings function 464, the user defines a floor number 466; defines a floor name 468; defines a type of floor map file type 470; links 472a floor map file to the SI service through a drag and drop, file brows and selection, or file scan process; and defines a scale for the linked floor map.

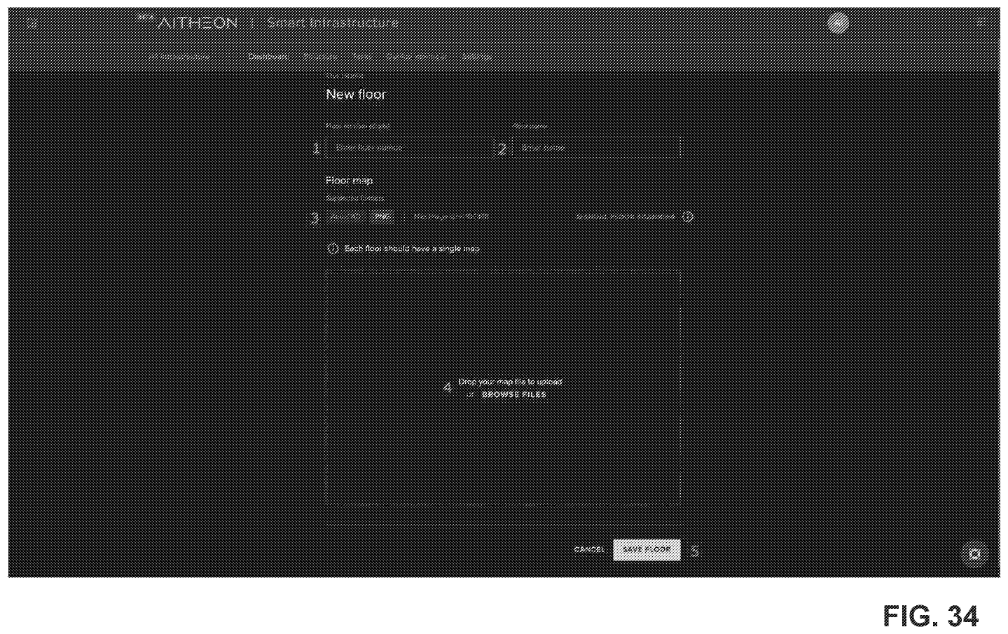

Alternatively, with reference to FIG. 34, selection of the structure function 418 (FIG. 27) presents the user with a floor function 430 from which the user can choose a floor, for example, from a drop-down menu or add a new floor function. Once a floor is selected, a corresponding floor map 431 is presented to the user.

Through the structure function 418 (FIGS. 27 and 34), the user is provided with tools to manage floors and working areas and to create tasks for devices. With reference to FIG. 34, a floor area toolbar 436 of the structure function 418, allows the user to create easy to use graphical representation of devices and functional links between devices, a structure's floor map 431, and other elements of the inventive platform. For example, from the floor area toolbar 436, the user can select a rectangle area tool 442 or a polygon area tool 444 that allows the user to graphically and functionally define rectangle-shaped or complex polygon shaped working areas 433, respectively, for a device, e.g. for a robot, within the floor map 431. A rectangle restricted area tool 446 and polygon restricted area tool 448 allows the user set rectangle-shaped and various complex polygon shaped restricted areas 435 that define where a device is not allowed to work within the floor map 431. The user can define areas 433 and 435 via tools 442, 444, 446, and 448 by, for example, employ a drag, drop and size process or a click to define corner process.

A charging station tool 449 allows the user to add a charging station for a robot device on the floor map 431 and to link the charging station to the specific robot. An anchor tool 450 allows for locating an anchor device on the floor map 431 to track devices tags or identities within a working. A station tool 452 allows for locating a station from the user's list of station on the floor map 431. A camera tool 454 allows for locating a camera, e.g. an IP camera, from the user's list of devices within device manager on the floor map 431.

Within the structure function 418, the user is also presented with the floor settings function 464 (described herein); a create task function 434 through which the user can create tasks for devices such as robots; a floor area toolbar 436; an area settings toolbar 438; and a floor layer function 440 through which the user can define the appearances of a floor map 431 to facilitate viewing.

To create a process for a device within the SI service, after selection of an infrastructure and defining of a floor within an infrastructure within which the process will run or physically be performed, the user employs the above described graphical tools to define the area of the floor within which the device will perform the intended process and the area in which the device is restricted from.

Once the user has defined the area of the floor within which the device will perform the intended process, the user is prompted to define the work area name and select a color or other visual indicator for the work area.

To more efficiently facilitate user process creation, once a work space is created, the SI service automatically creates default origin, entry, and exit points for mobile devices such as robots and presents such within the floor map. To change the default origin, entry, and exit points, the user can, for example, click on a dots present within the default route and drag or otherwise move the dot to a desired location. For example, the user can click on a dot representing the device's functional origin and drag the dot to an alternative location, thereby graphically and functionally changing the orgin location of the device within the work area.

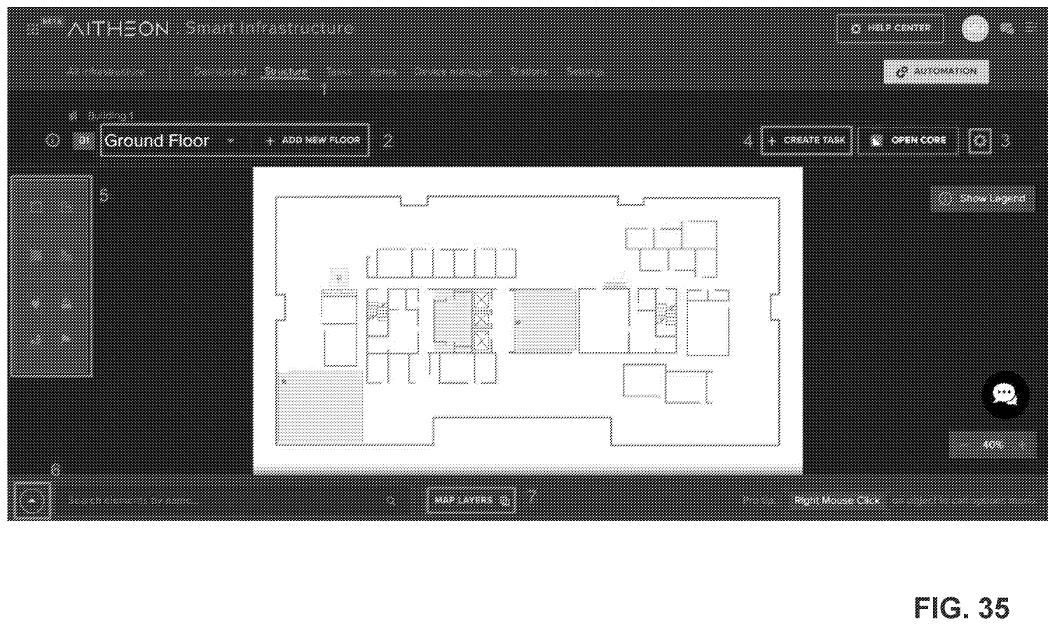

With reference to FIG. 35, the area settings toolbar 438 (shown in an expanded form) present the user with area icons 474 of the work area for the specific floor and present an options function 476 shown as, for example, ellipses 478 on the area icon 474, that presents, for example, a drop down menus with options to add a task, edit an area and remove an area 433 and 435. The area settings toolbar 438 further provides the user with a search field 480 to search for work and restricted areas 433, 435 within a selected floor.

The present invention further provides for graphically and functionally creating waypoints within a device process. A waypoint is a point or location on the floor map not connected to a specific work area. Waypoint are used if the user creates a go to task for the device such as a robot and needs to choose a location on a map, regardless of whether the point is within a work area.

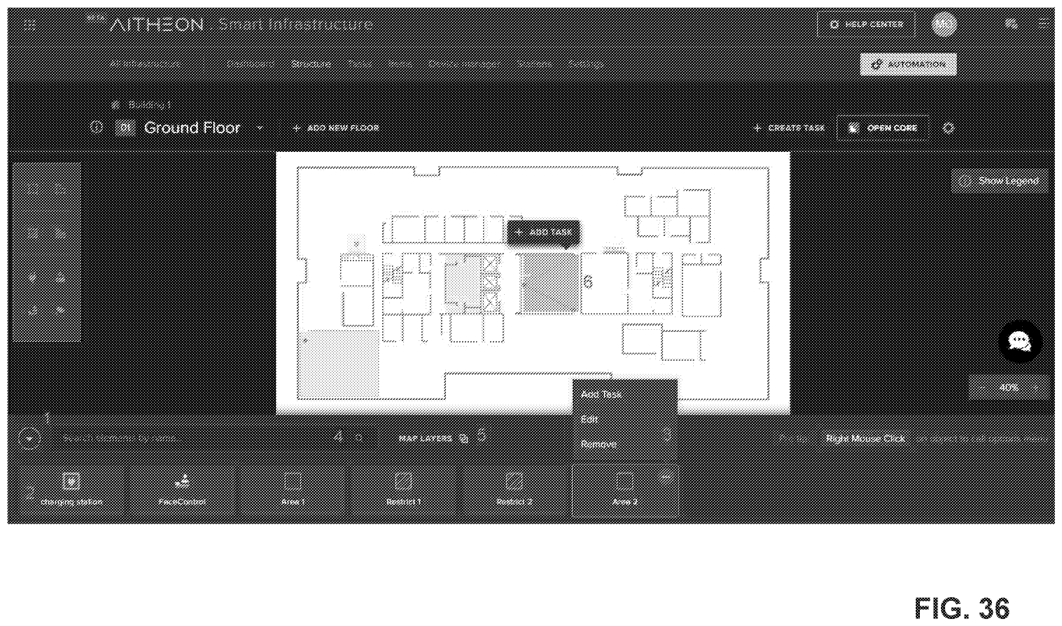

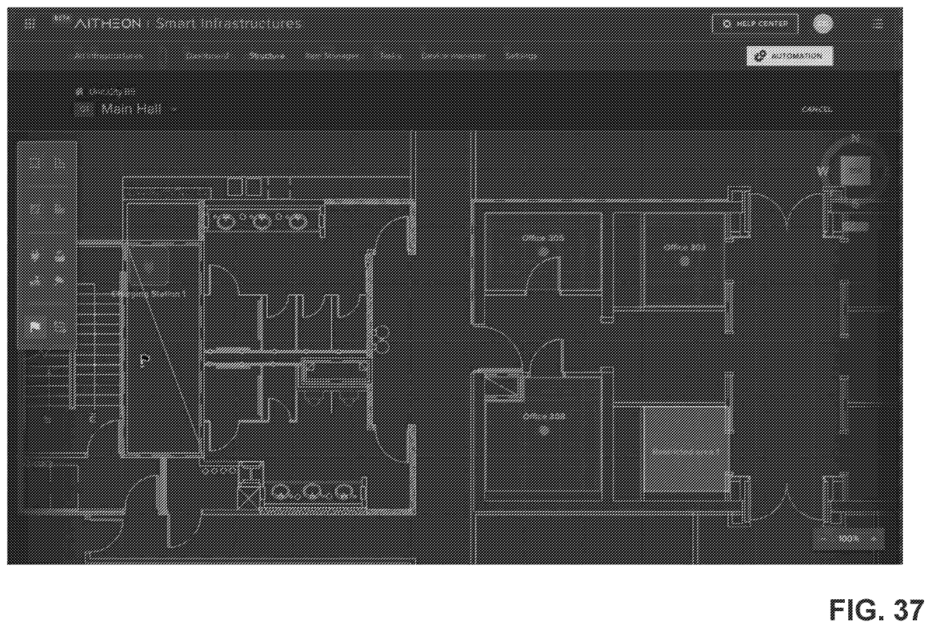

In certain embodiments, as shown in FIG. 36, the toolbar 436 further employs a waypoint tool 482 that the user can select and drag and drop or click to locate to graphically place and functionally program within the floor map 431. Upon confirming the waypoint location, the user will be prompted to name the waypoint and prompted to create a task associated with the new waypoint. Selection of the new task prompt by the user, presented the user with a waypoint task window 482, shown in FIG. 37. Within the waypoint task window 482, the user defines a task name; confirms the infrastructure and floor; defines a waypoint name; and defines a device associated with the waypoint. The user can optionally access the above functionality through a create task function described herein.

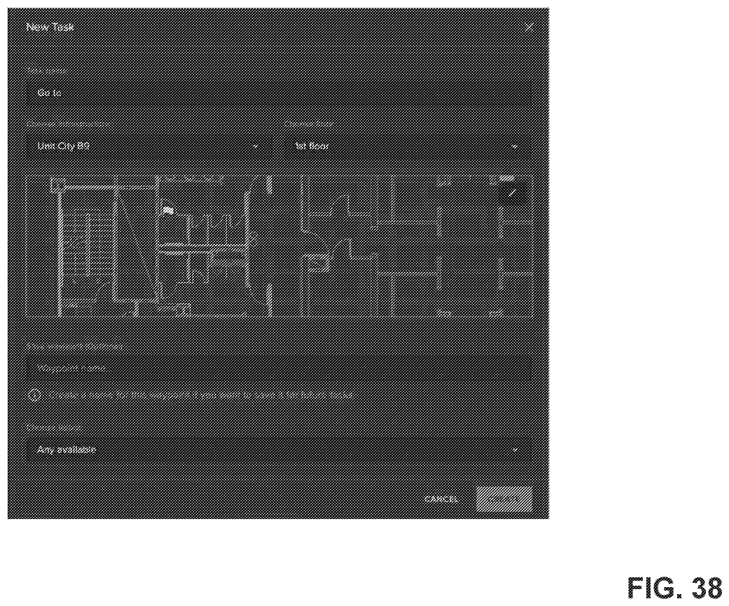

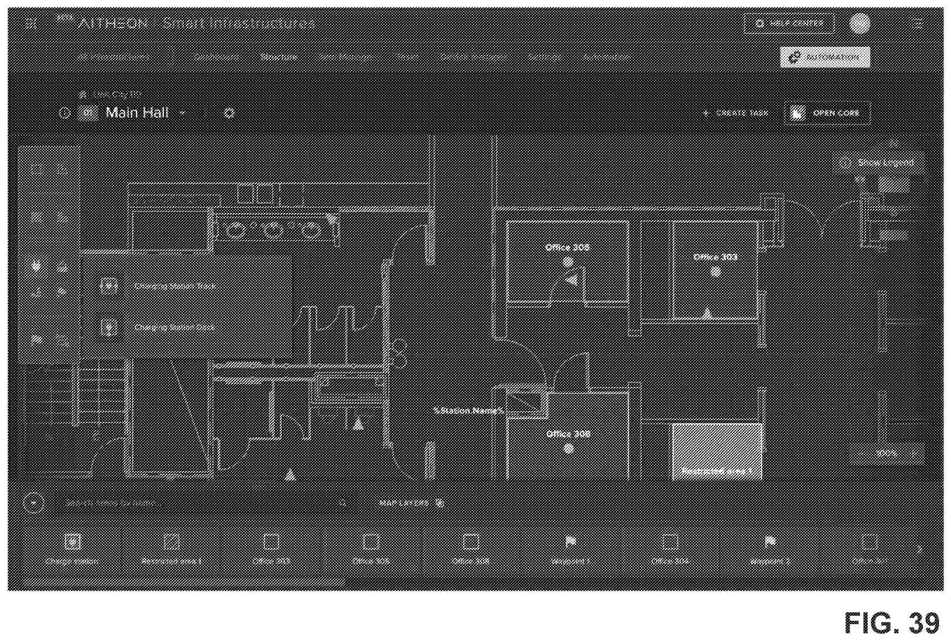

The present invention further provides the user the ability to include device charging station within an automation. A charging station gives a device such as a robot the ability to autonomously charge itself by docking with a charging station. The user can access the charging station tool 449 from the floor area toolbar 436 described herein. In certain embodiments, as shown in FIG. 38, by selecting the charging station tool 449, the user is presented with the option 484 to select a charging station track or a charging station dock. The user selects the desired type of charging station and then drags and drops or clicks to locate the charging station on the floor map 431. As shown in FIG. 39, within the floor map 431, the user can graphically rotate and edit the location of the charging station; add and edit an entry and exit point or points 486 for the robot to engage the charging station, depending on charging station type; and name the charging station prior to functionally deploying the charging station within the automation.

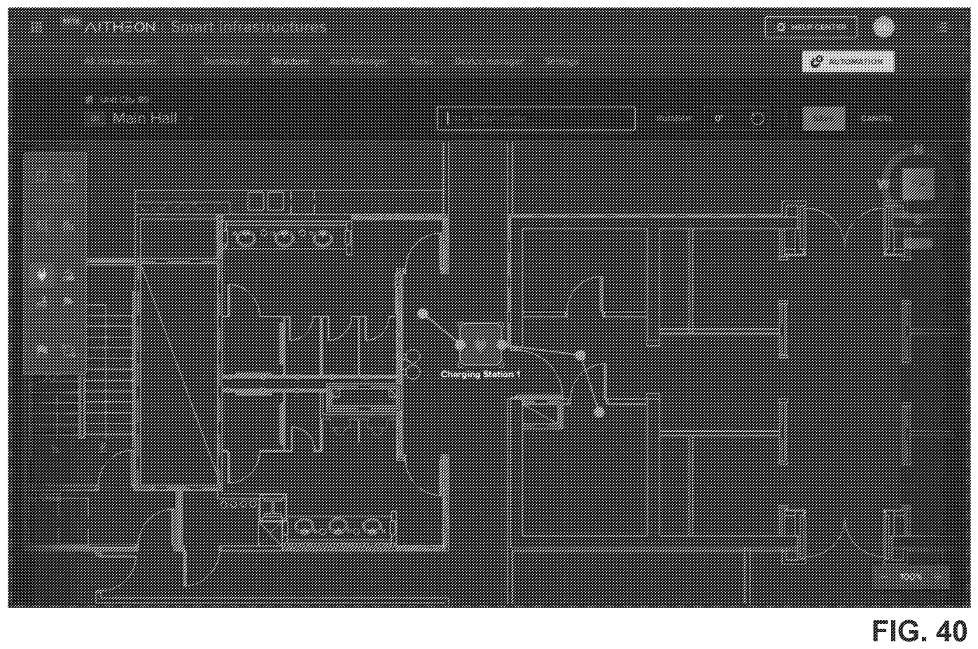

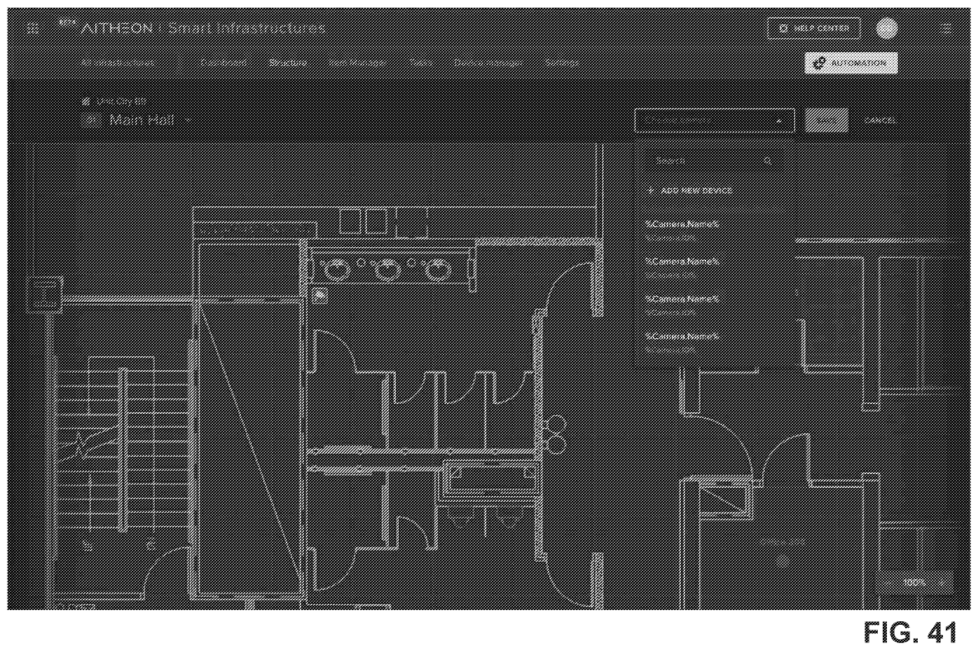

The present invention further provides the user the ability to graphically program a camera within the floor map of an infrastructure. The user can access the camera tool 454 from the floor area toolbar 436 described herein (FIG. 34). The user selects the camera tool 454 and then drags and drops or clicks to locate a camera 488 on the floor map 431. With reference to FIG. 40, upon location of the camera within the floor map 431, the user is prompted to define various device settings within, for example, a device or camera setting window, such as described with respect to other settings function herein.

The SI service further employs defined routes. A defined route is a route that robot will use for movement between to objects on a floor map. The inventive platform provides the user with the ability to create functional automations through graphical representations of defined routes within an infrastructure. Defined routes can be created between: two work area; a work area and a waypoint; two work stations; a work station and work area; a work station and waypoint; and two waypoints.

To create a defined route, the user selects a route tool 498 from floor area toolbar 436. With reference to FIG. 41, the user is then presented with visual prompts of an entry 494 and exit point 496 associated with objects on the floor map 431 which the user can edit or relocate as desired. A route line 492 is then presented to the user between the entry 494 and the exit point 496 and the user is provided with the ability to edit the route line 492 by, for example, clicking and dragging the route line 492 between points 494 and 496 to form the desired device route.

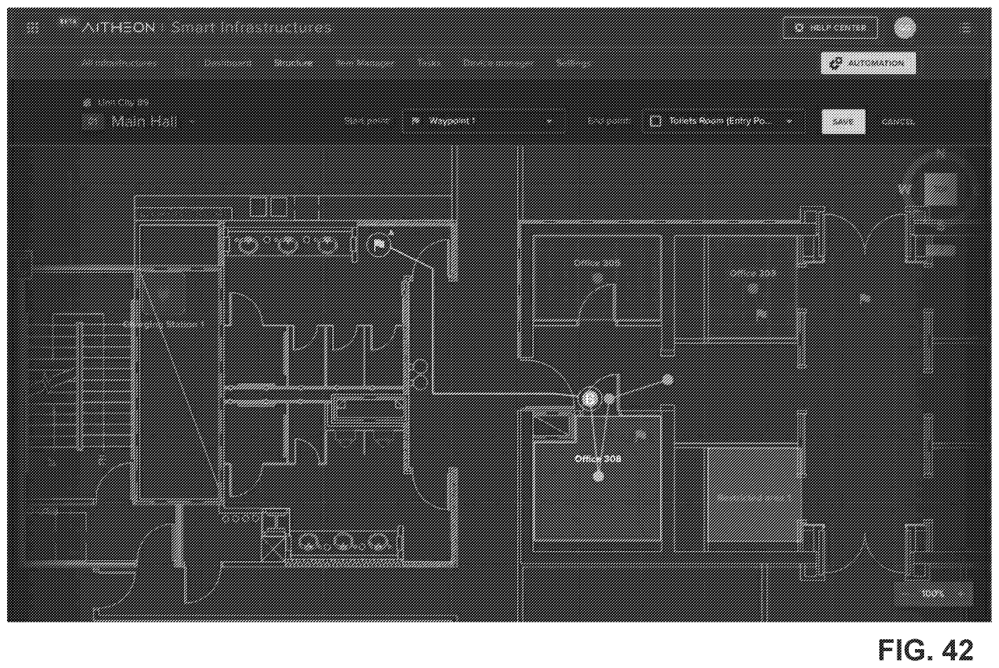

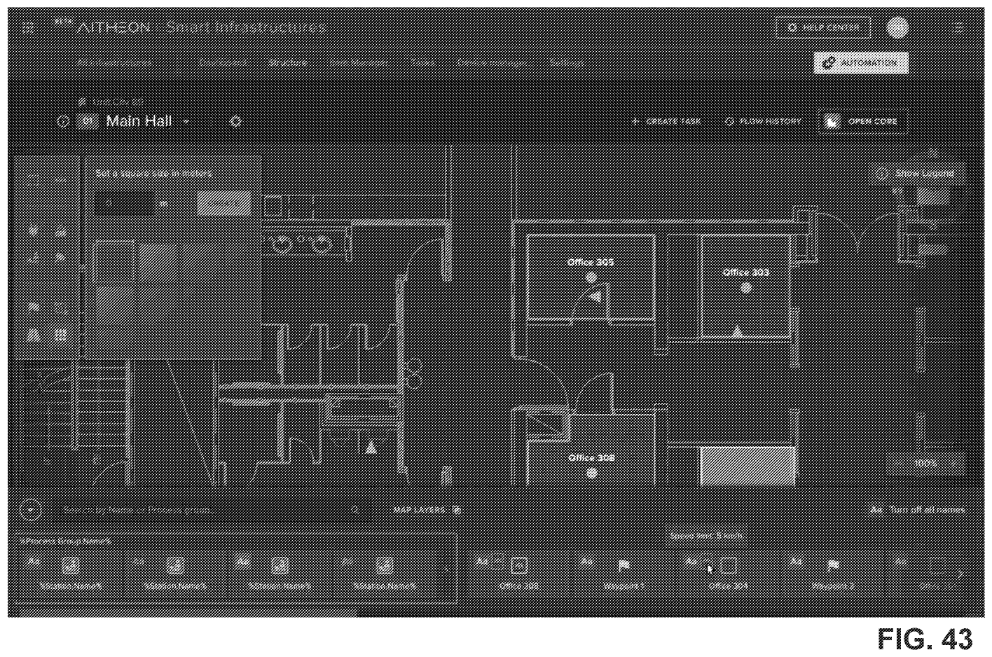

The SI service further employs a grids function that serves to form a grid of ordered waypoint within a desired portion of a floor map. To create a grid, the user selects a grid tool 500 from floor area toolbar 436. With reference to FIGS. 42 and 43, to create a grid, the user selects the grid tool 500 and is prompted to define a start point and a size of square that will form the grid. The user can then locate the first square of the grid on the floor map 431 and expand like squares over the desired portion of the floor map 431 by, for example, dragging the users cursor. The user is then presented with a uniform grid or array or squares, each square having a waypoint located at its center point. The user may deselect or exclude individual squares from the grid as desired. As different processes may necessitate different grid or grid sizes, the user can create multiple within a single floor map.

The SI service further employs a highways function that serves to bidirectional device route without reference to any objects (area, stations, waypoints) on a floor map. Highways function help to control traffic among device within a floor. Robots will use a highway when there are no defined routes between areas/stations.

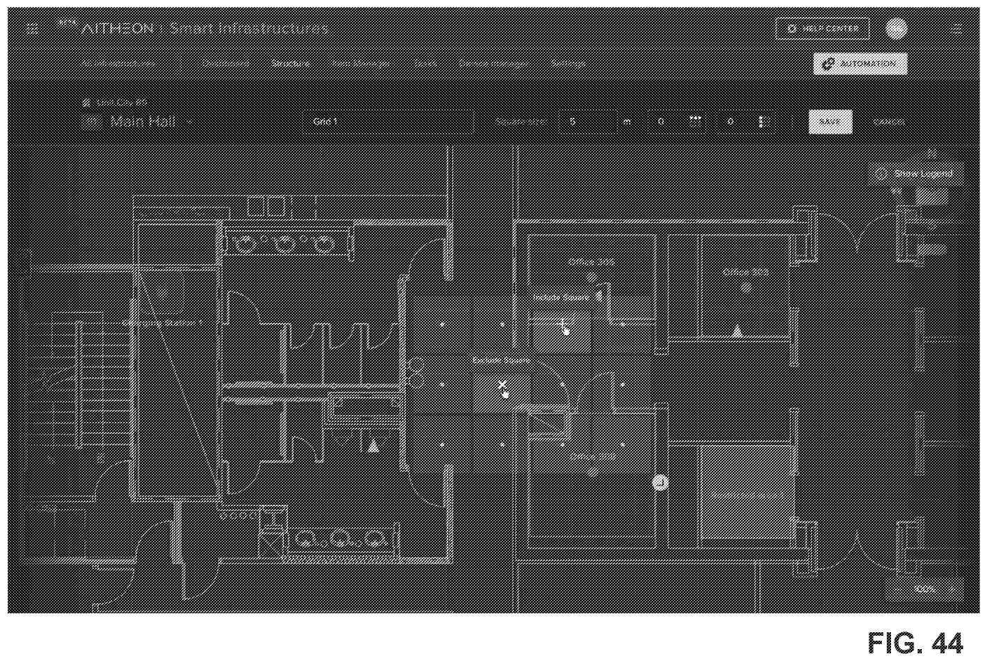

With reference to FIG. 44, to create a highway, the user selects a highway tool from, for example the floor area toolbar 436. The user then selects or clicks on a first point 502 within the floor map 431 and the first point of the highway is graphically presented and functionally created within the floor map 431. The use then selects or clicks a second point 504 within the floor map 431 and the second point of the highway is graphically presented and functionally created within the floor map 431. A highway 506 between the first point 502 and the second point 504 is then graphically displayed to the user within floor map 341. The user is also presented with a highway size function 508 through which the user can define, for example, a width of the highway. The user can then save or deploy the highway to create a functional device highway for use within a process.

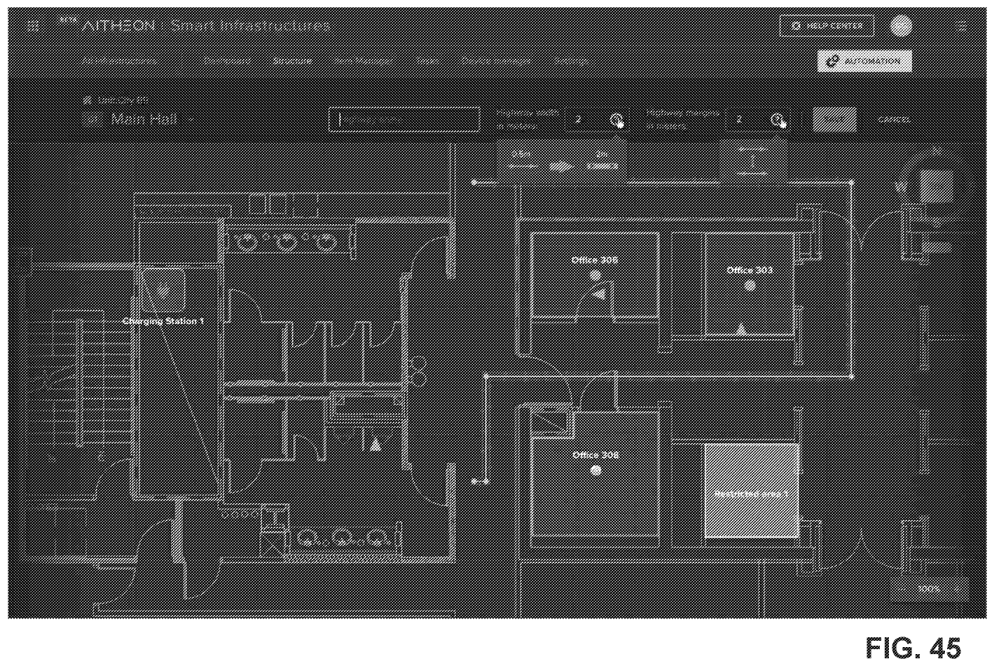

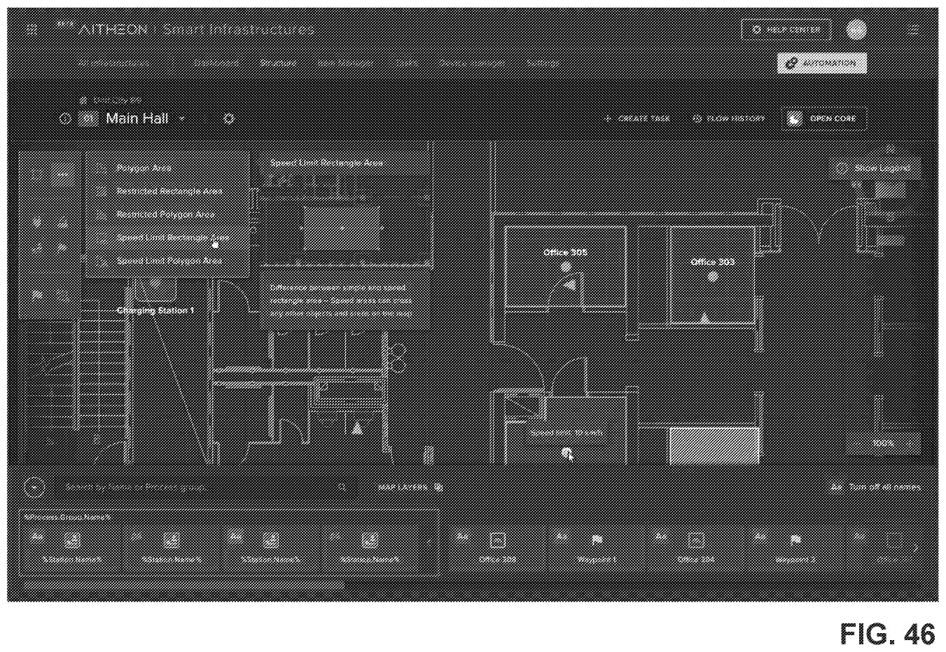

The SI service further employs a speed zone function that serves to define an speed limit, e.g. meters/second, for devices within a defined area of floor map. With reference to FIGS. 45, to create a speed zone, the user selects a speed zone area tool 510 from the floor area toolbar 436. With reference to FIG. 46, the user then define a speed zone 512 within the floor map 431 in the same manner described herein with respect to work areas and restricted area on floor maps.

Devices are all electronic gears that work or perform processes at an infrastructure and that can be connected and managed using the inventive platform and services. A robot is a device with an embedded controller. A camera or a switcher are devices that need a controller device to manage them. The device manager service allows the user to add and edit all devices at an infrastructure, check the devices' connections, and update drivers, and apps. The device manager service is accessed via the device manager function 422 (FIG. 27).

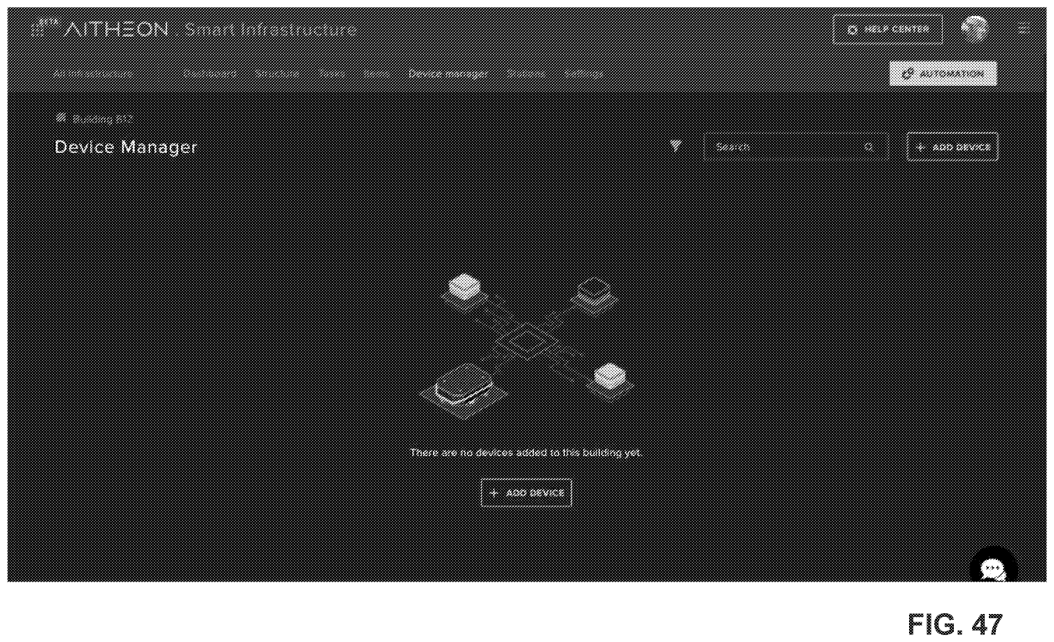

With reference to FIG. 46, upon selection of the device manager (DM) service or function 422, the user is presented with a device manager window 520. If no devices are present within the DM service, the user is prompted with an add device function 522. If devices are already present within the DM service, such devices 524 are presented to the user along with various device filter and search functions, as shown in FIG. 47.

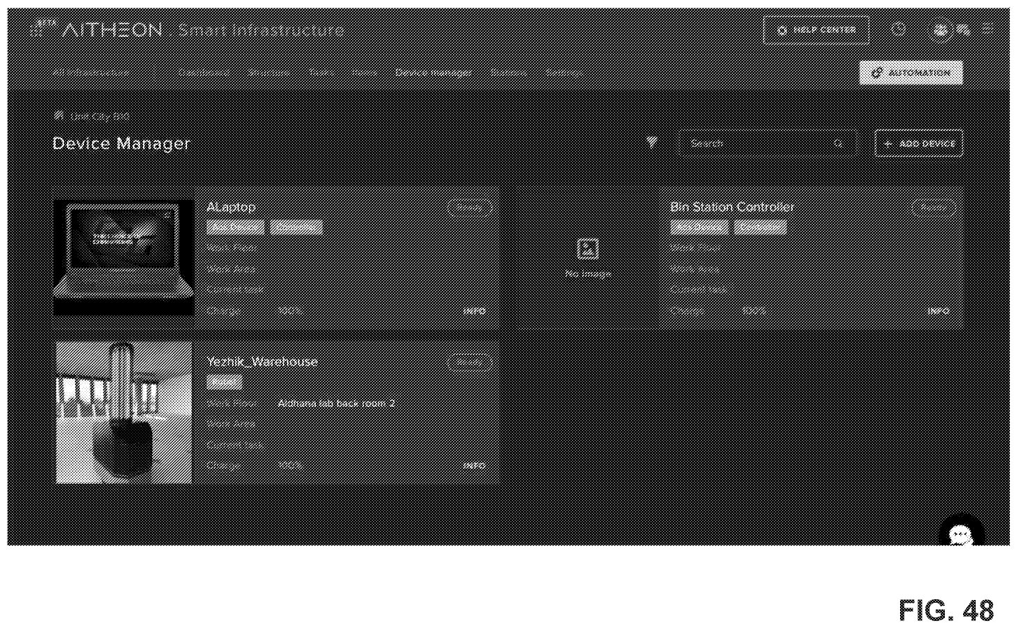

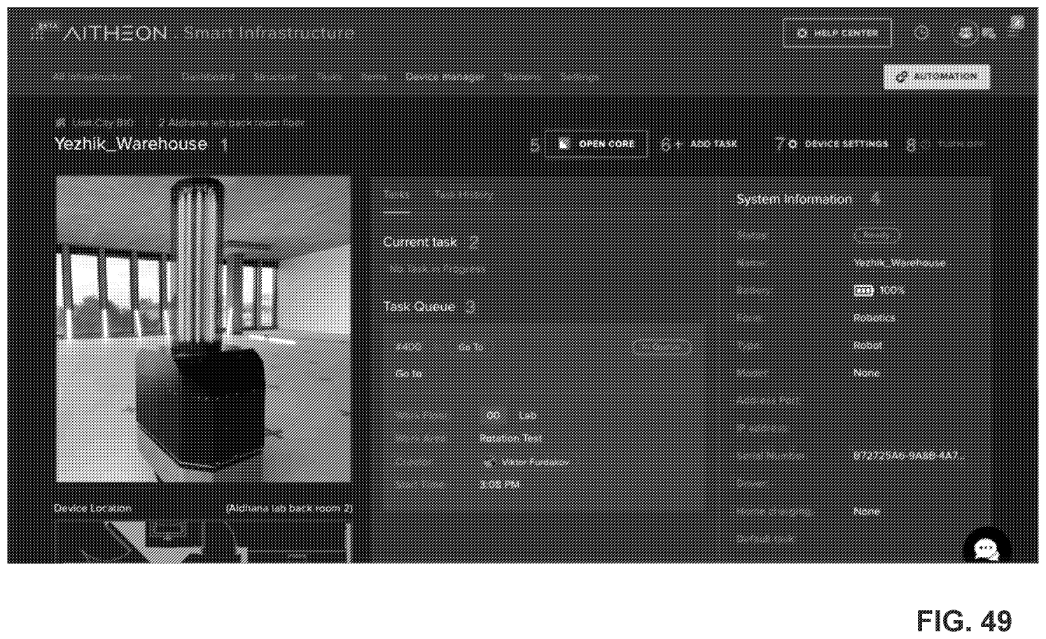

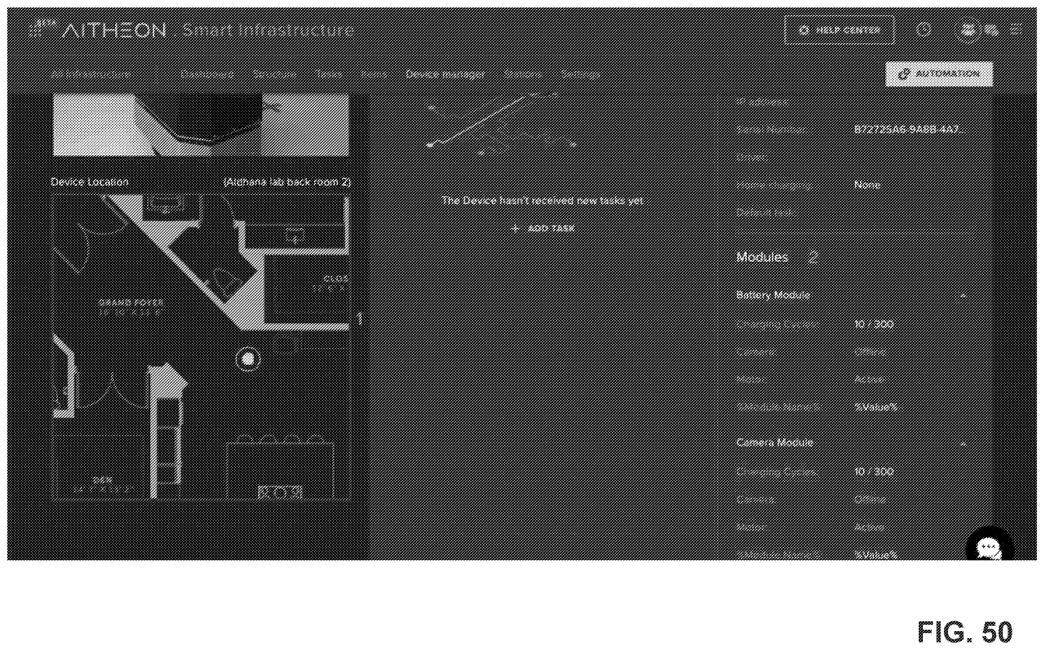

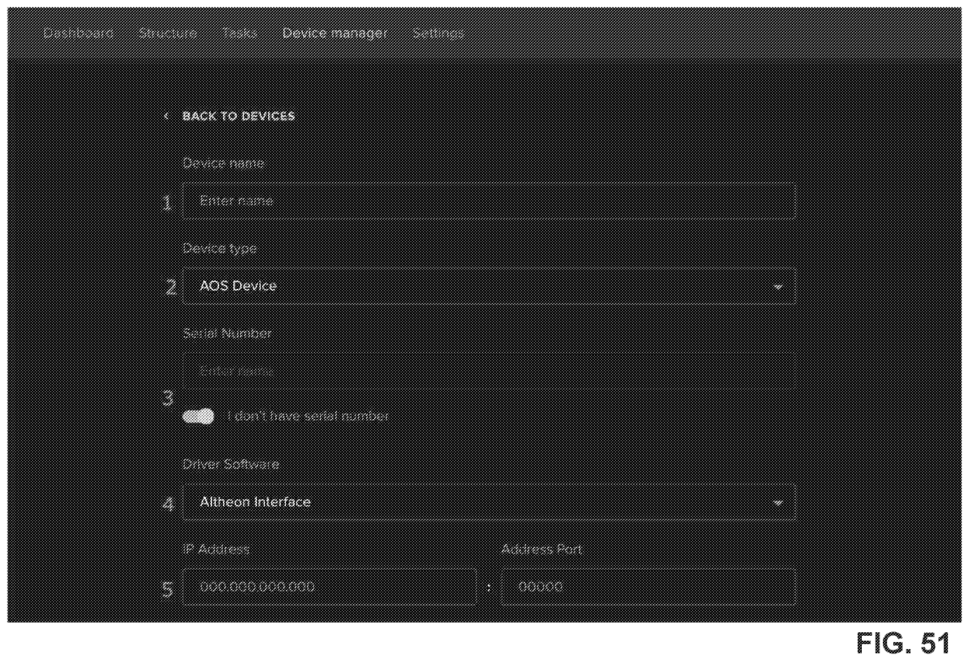

Selection of a device information function 526 from the device manager window 520 presents the user with a device window 528, shown in FIGS. 48 and 49. The device window 528 presents the user with a name of the device; an identification of a task the device is currently performing 530; a list of task in queue for the device to perform 532; a device location 534; a list of device module, e.g. batteries and cameras associated with the device; and technical information 536 relating to the device.

The device window 528 also presents the user with the open core function 102 that allows the user to access the core service and manage device nodes; an add task function 538; a device setting function 542 that allows the user to edit various device settings; and a turn off function 540 that allows a user to turn off the device.

Selection of the add device function 522 presents the user with a new device window 521. Within the add device window 521, the user can define a device name, type and serial number; define the software for the device; define the IP address and address port for the device (if applicable); define the infrastructure, floor, and charging station to which the device is associated; define a default task for the device; and define a go to location for the device. Selection of a deploy or register function will add the device to the DM service and any linked processes.

A station is a particular area where a device is run by a particular controller. For non-robotic devices or devices that require a controller device, within the SI service, the user can define stations to the infrastructure floor; define controllers to the station to operate the device at the station; assign an application to the controller to define the controller's function; and create automations to provide a user interface for the device controlled at the station. The user employs a station (and a controller) when the user wants one or more device to work in a particular place. For example, the user can employ a camera to estimate each employee's contributions at a place where some operation is performed and some sensors to estimate the employee's working conditions.

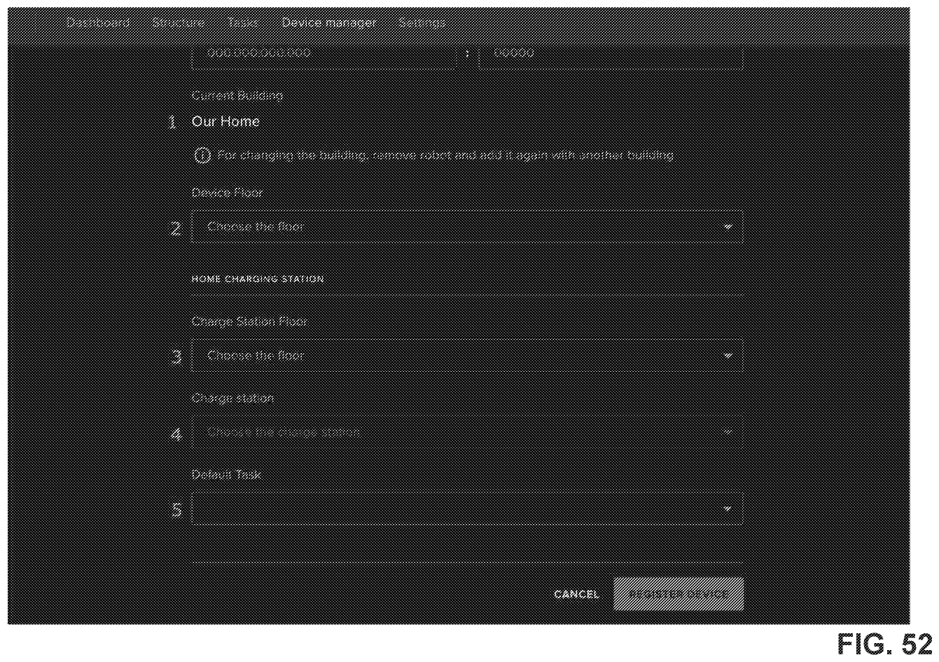

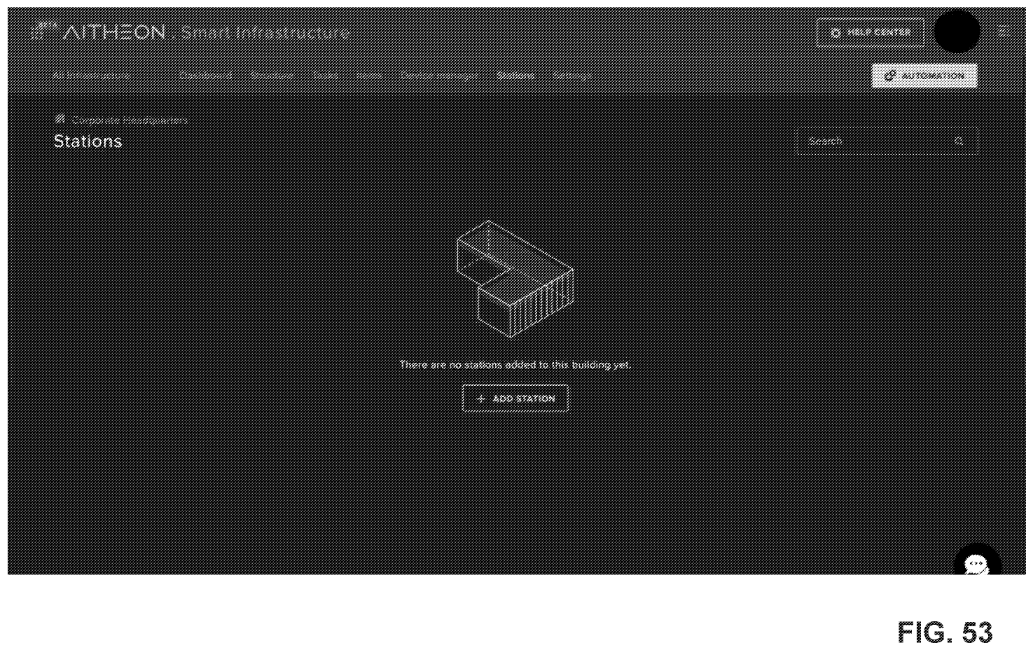

With reference to FIG. 52, within the SI service, the user is presented with a station function 542 selection of which presents the user with a station window 546. If no stations are present within the infrastructure, the user is prompted with an add stations function 544. If stations are already present within the infrastructure, such stations 524 are presented to the user along with various device filter and search functions, as shown in FIG. 53.

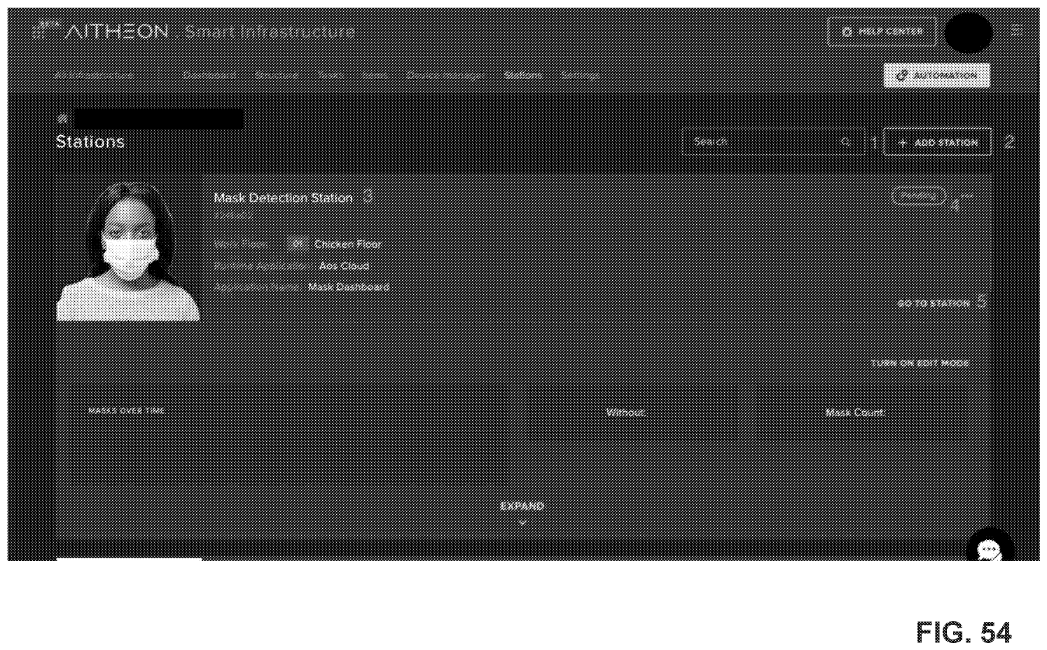

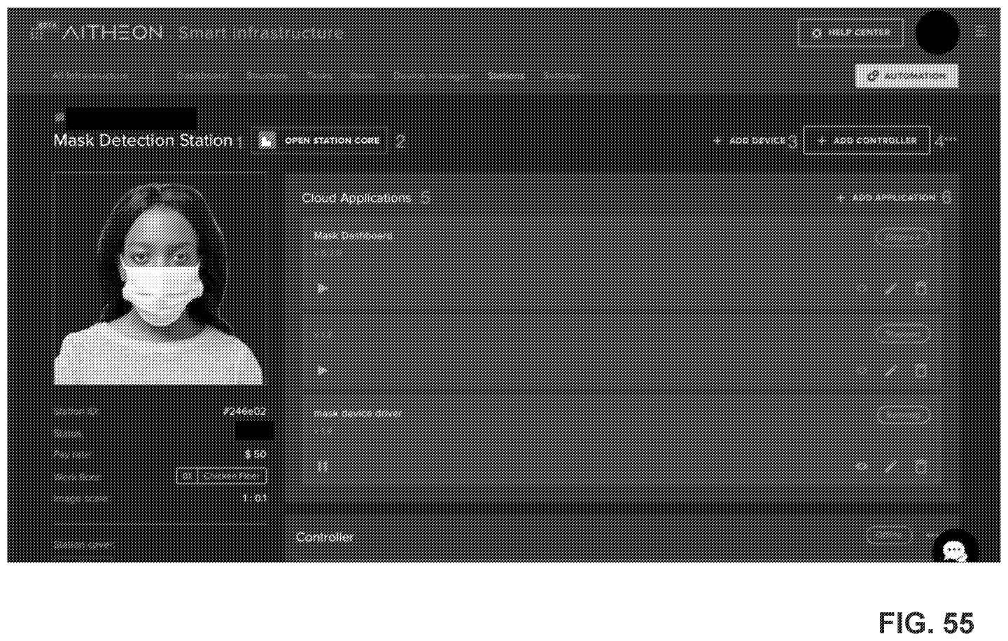

Selection of a station information function 548 presents the user with a station window 550, shown in FIGS. 54 and 55. The station window 550 presents the user with a name of the station; an add device function 552 that allows the user to add devices to the station; an add controller function 554 that allows the user to add controllers to the station; a cloud application window 556 that shows the application added to the station; an add application function 558 that allows the user to add application to the station; a controller window 560 that shows all the controllers associated with the station; and an add node function 562 that allows a user to add a node to the station. The station window 550 also presents the user with the open core function 102 that allows the user to access the core service and manage device nodes.

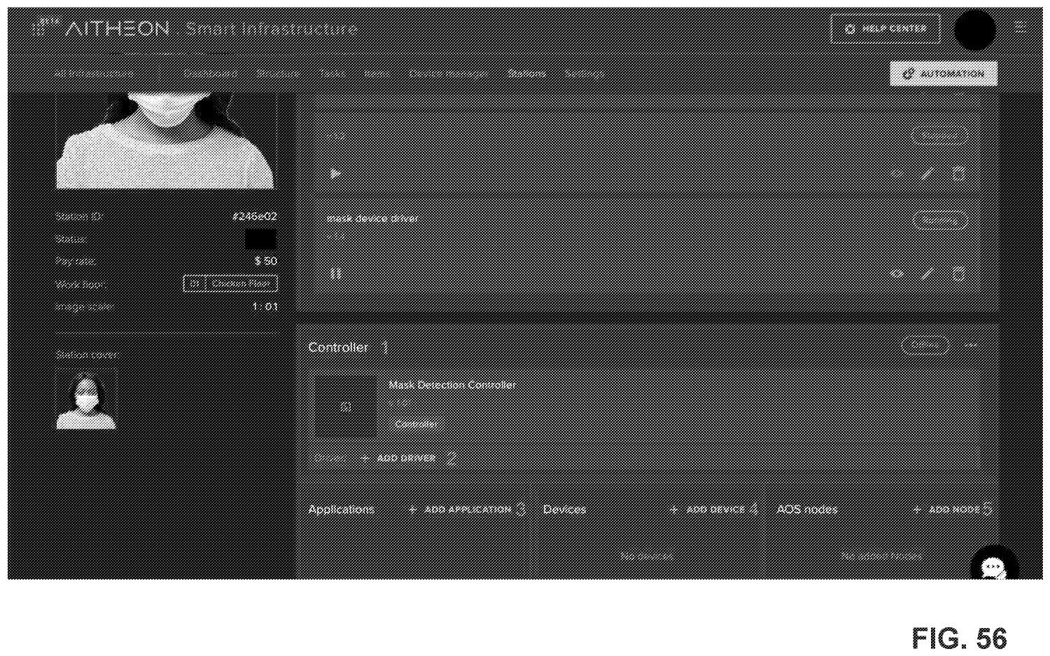

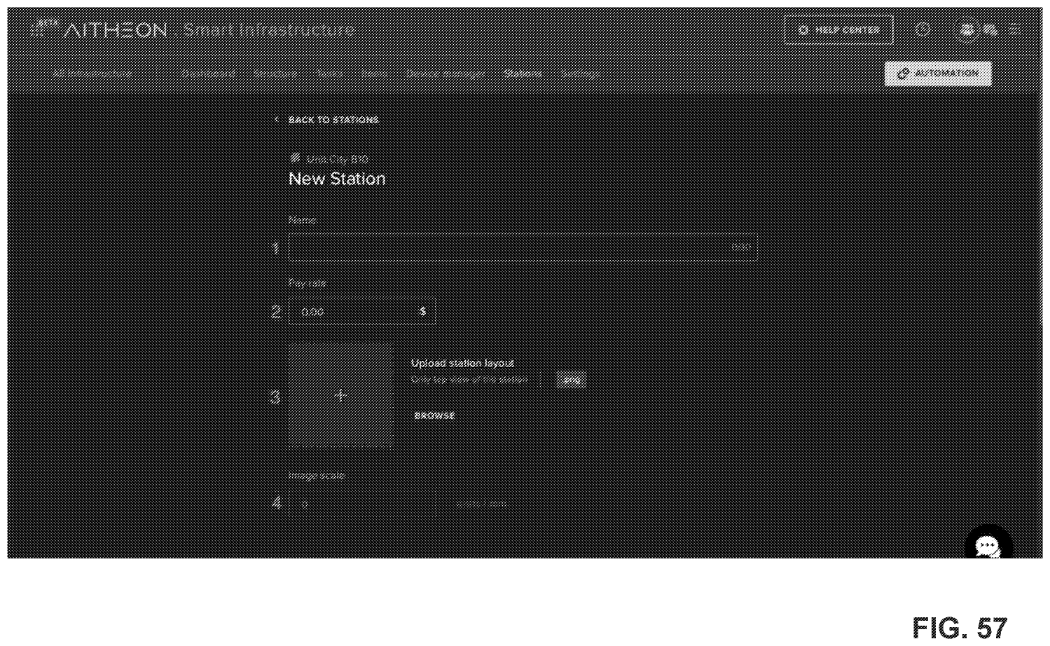

With reference to FIGS. 56-58. selection of the add station function 544 presents the user with a new station window 546. Within the new station window 546, the user can define a station name 548 and pay rate 550; upload a station lathe usert 552 and image 554; enter an image scale 556; select a controller from the list of previously added controllers 558 or add new controller 560 to add a new a new controller; define a controller name 562; and provide a controller serial number 564.

A controller is a device that performs some computing operations and controls periphery devices, e.g. controls cameras, scales, conveyor belts, manipulators, sensors, commutators, personal tags, etc., Alternatively stated, a controller is a computer appointed to run all the station programs, including dashboard applications for users. A minimum of one controller is required for each station.

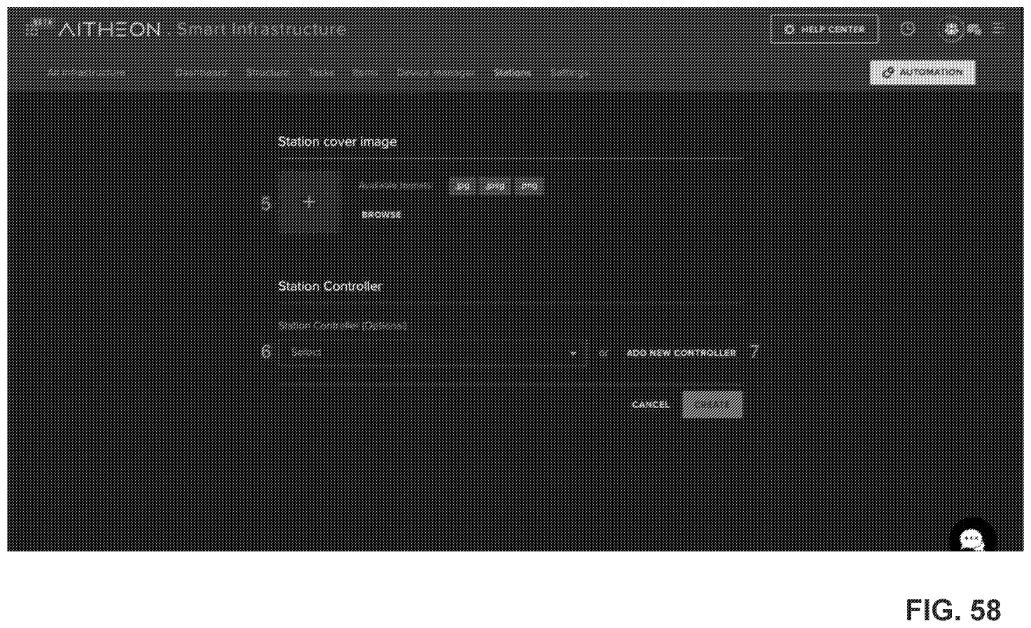

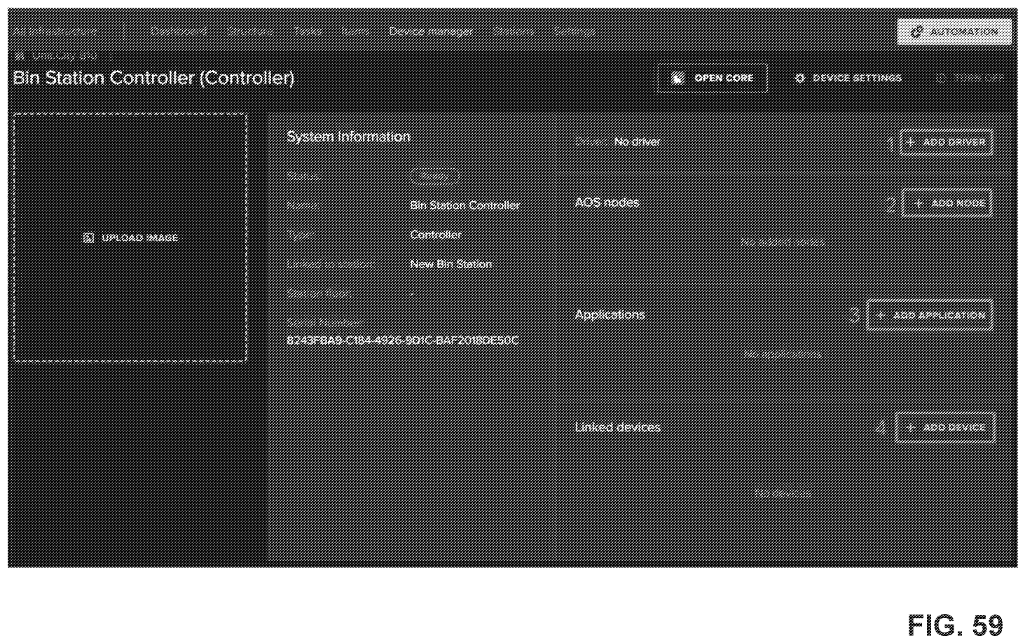

To add a new controller to the user's station, the user selects add new controller 560 (FIG. 58) and is presented with a controller window 566. With reference to FIG. 59, within the controller window 566, the user can add a driver 568 (a core program for the controller, e.g. from the marketplace service); add a AOS node 570 (an additional program (node) that runs on the controller); add an application 572 (an additional program, e.g. app node such as dashboard, application, automation); and add a device 574 to connect an additional device to the controller (e.g. camera, sensor, switcher) The controller will control these devices through the AOS nodes and the driver node and will communicate with users through application nodes.

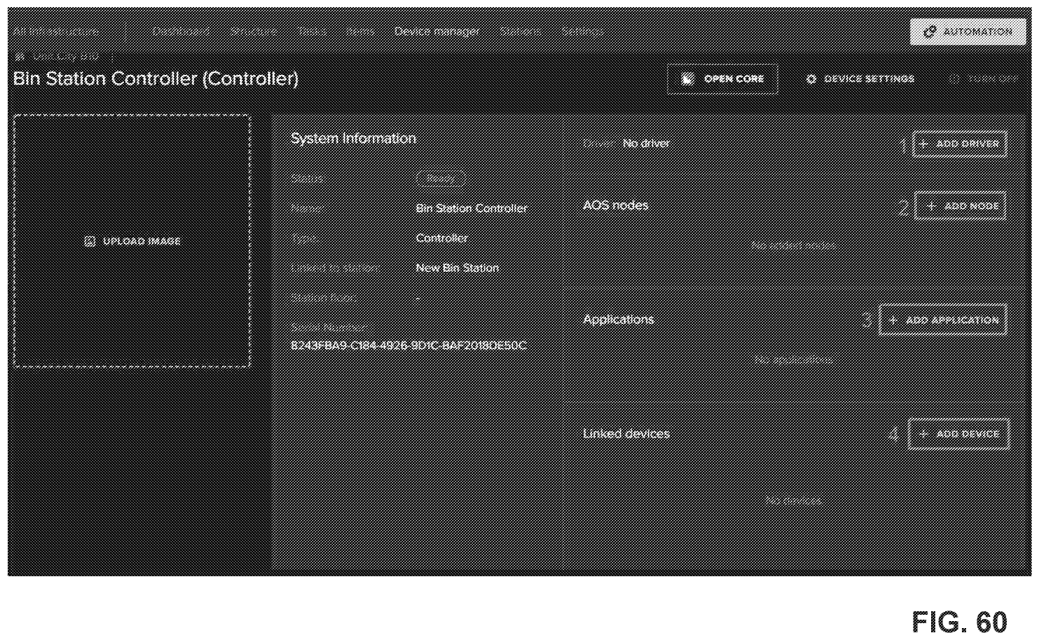

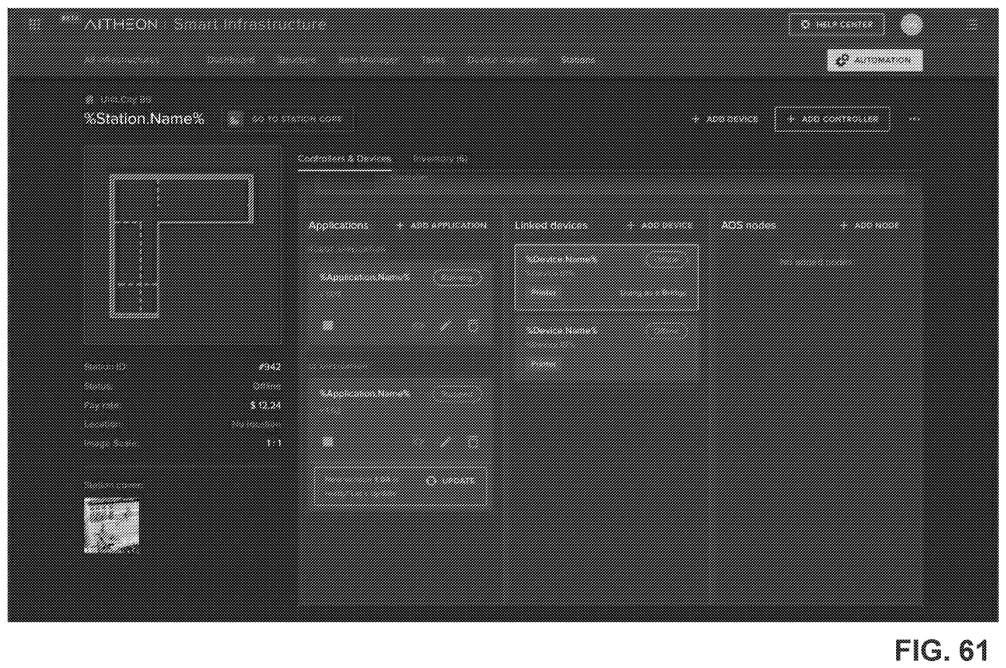

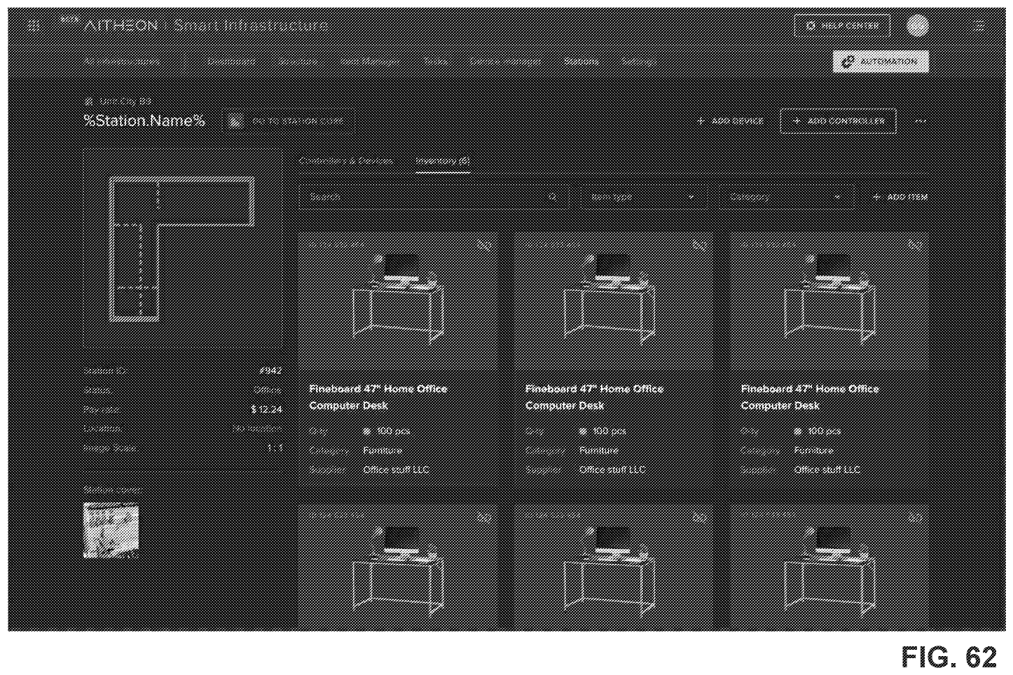

With reference to FIGS. 60-62, The present invention allows a user to create and manage stations on various manners and levels. Entry and exit routes for stations are optional. Work stations can have multiple origin points and draw entry and exit routes from each. Origin points and entry/exit routes are optional for work stations.

A user can define Process groups in Structure. For example: User goes to Structure; User clicks on Station in the toolbox; System shows a list of stations, grouped by process group; User chooses a station; User puts the station on the map and saves; System shows the process group in the floor's panel with the station inside (group as a folder). System shows other stations from the process group as Unplaced in Station tool.

Users can identify that stations on the map belong to one process group. Stations can be placed inside restricted areas

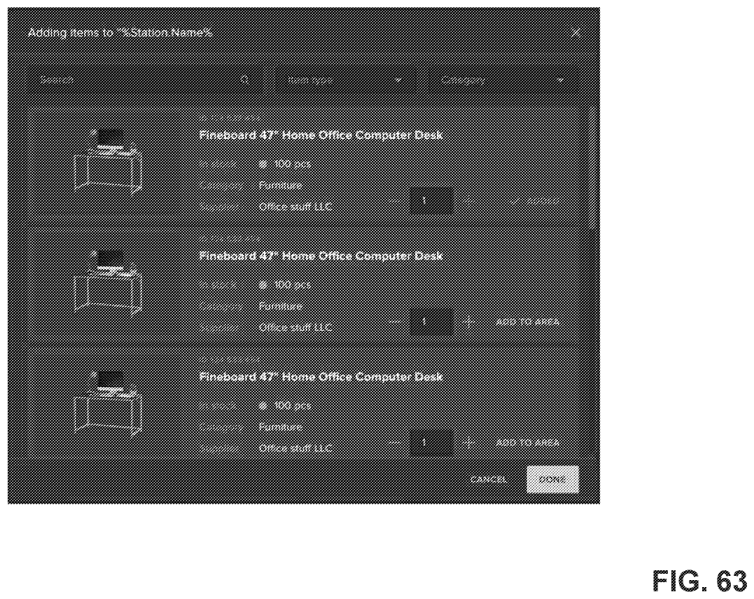

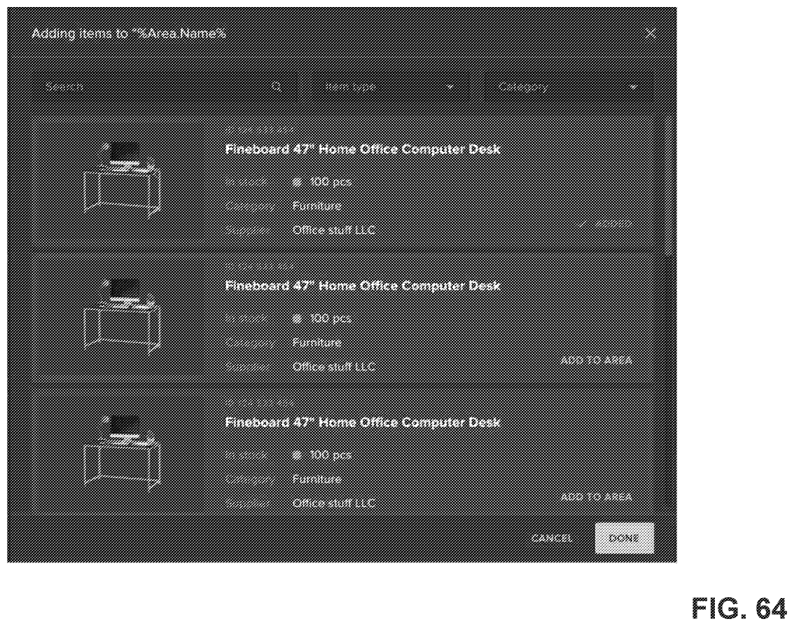

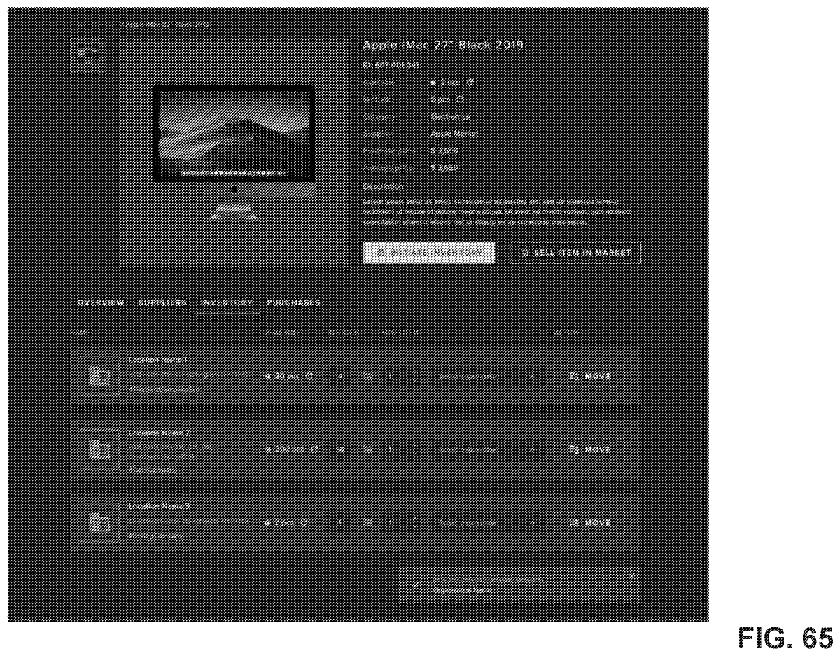

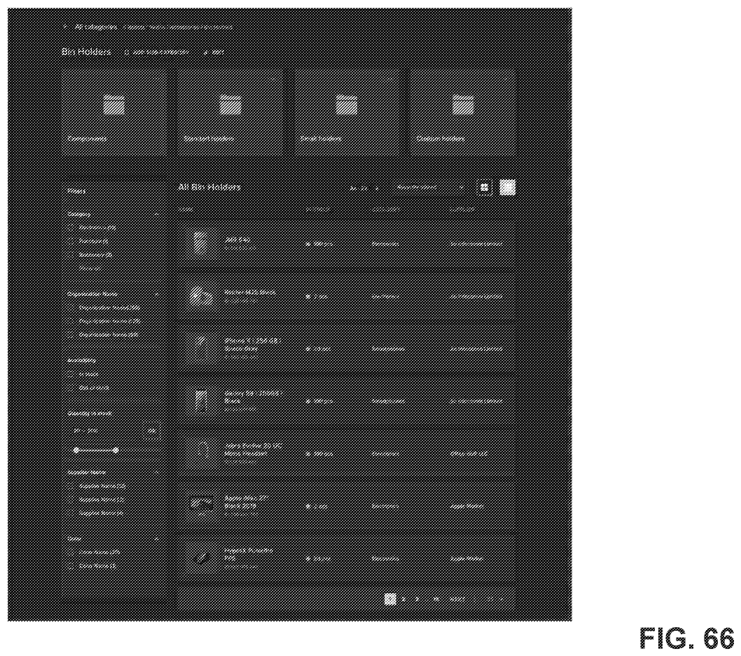

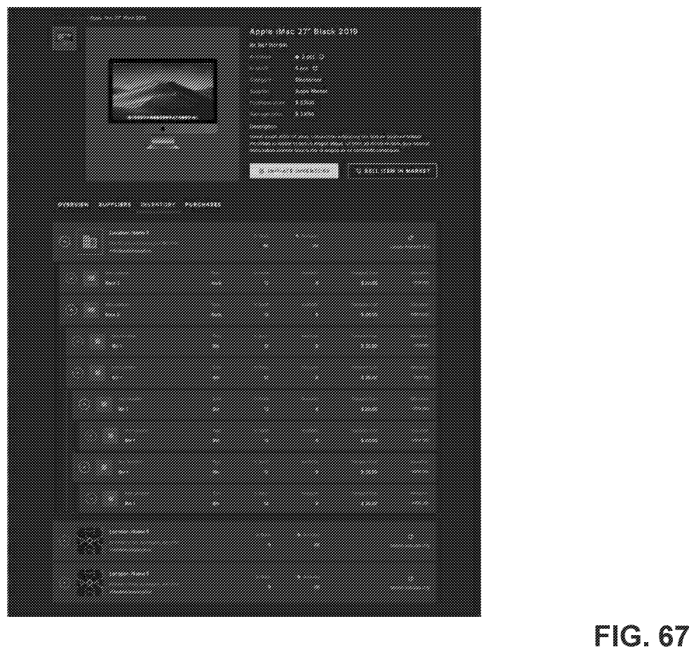

With reference to FIGS. 63-67, the SI service also employs an inventory or items manager (IM) function. Within the SI service, the user can add items from IM to an infrastructure to create and monitor a comprehensive list of items within an infrastructure as well as track items between infrastructures. IM presents all items inside infrastructure in 2 views: an item view and location view.

Within the location view or IM, each item is assigned one location types: free item (without location); area (item belong to area); station (item belong to station); location (item belong to location); and sublocation (item belong to sublocation).

User can create locations and sublocation for items from within an IM window. Sublocation can be located inside location or work areas and can be moved by the user.

In location view, the IM shows a tree of items including: areas (if an area has an option ‘Can have items inside’ the area is displayed in IM window); locations; sublocations; stations; items. Items will by default be assigned to a sublocation if one is created within a location with which items are already assigned.

The IM tracks all activities related to items that are checked-in, checked-out and moving and by who, when, and from where to where.

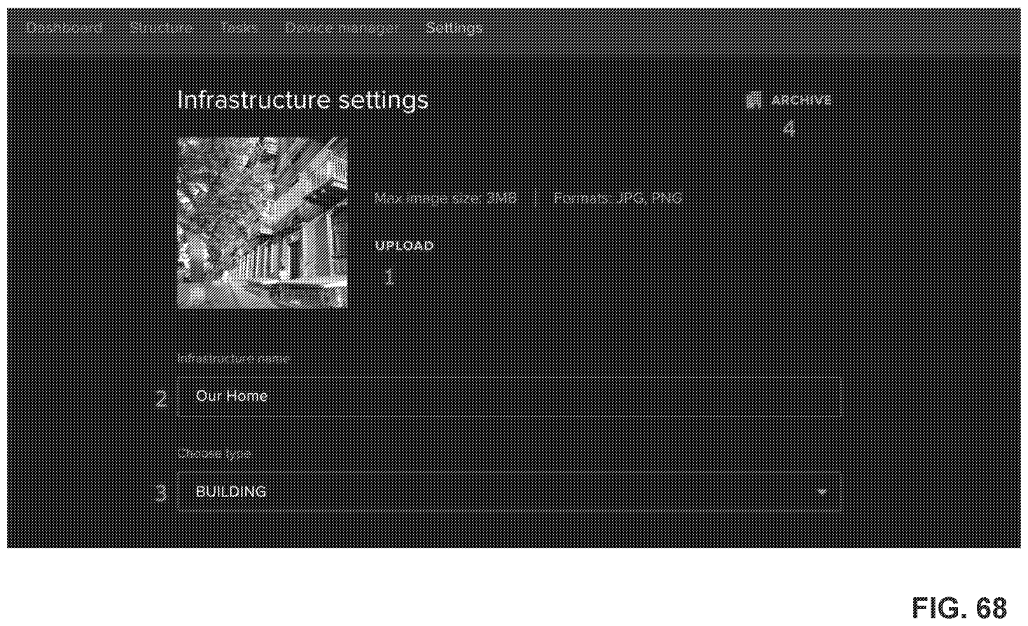

With reference to FIG. 68, within the SI service, the user is presented with a settings function 576 selection of which presents the user with an infrastructure settings window 578. Within the settings window 578, the user can change infrastructure settings or archive an infrastructure. For example, an upload function 580 allows the user to change the structure image; an infrastructure name function 582 allows the user to change the name of the infrastructure; a type function 584 allows the user to change the type of the infrastructure (it will appear as a different group of structures in the All Infrastructures menu); and a location function 586 allows the user to edit the location of the infrastructure.

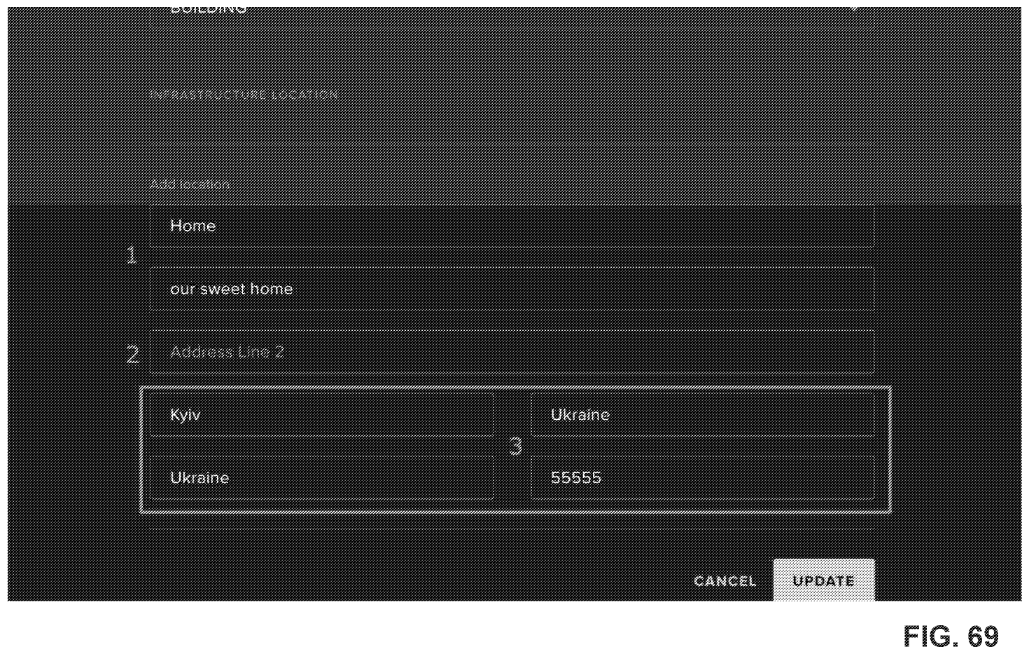

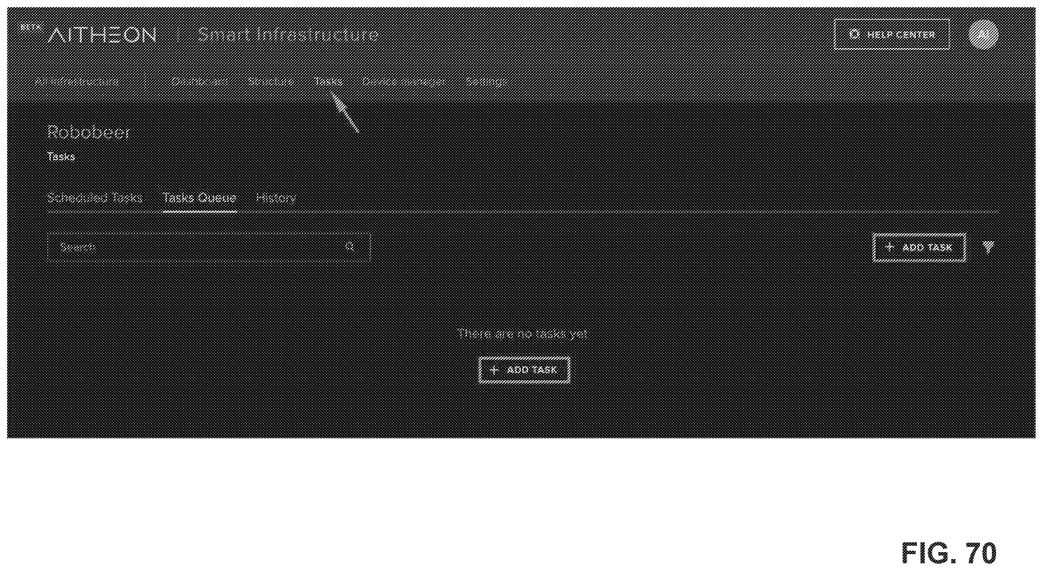

From withing the SI service, a task for a robot or any other device can be created after everything else is set-up and saved within the service. With reference to FIG. 69, within the SI service, the user is presented with a task function 588 selection of which presents the user with a task window 590. Within the task window 590, the user can define a task name 592; define an infrastructure, floor and area 594 where tasks will be executed (Buildings, Warehouses, Factories, etc.); define a waypoint 596 that allow the user to attach a one-time task to this point; define a device or robot 598 to execute the task; define a wait at goal function 600 that allows the user to the robot to switch to a stand-by mode upon the completion of the task; and define a schedule 602 to the task.

Upon the user selecting a create or deploy function, the graphical user representation of the task will be programmatically deployed as a process executed by the inventive platform. The task the user created appears in the relevant menu on the tasks page, depending on the chosen schedule of the task.

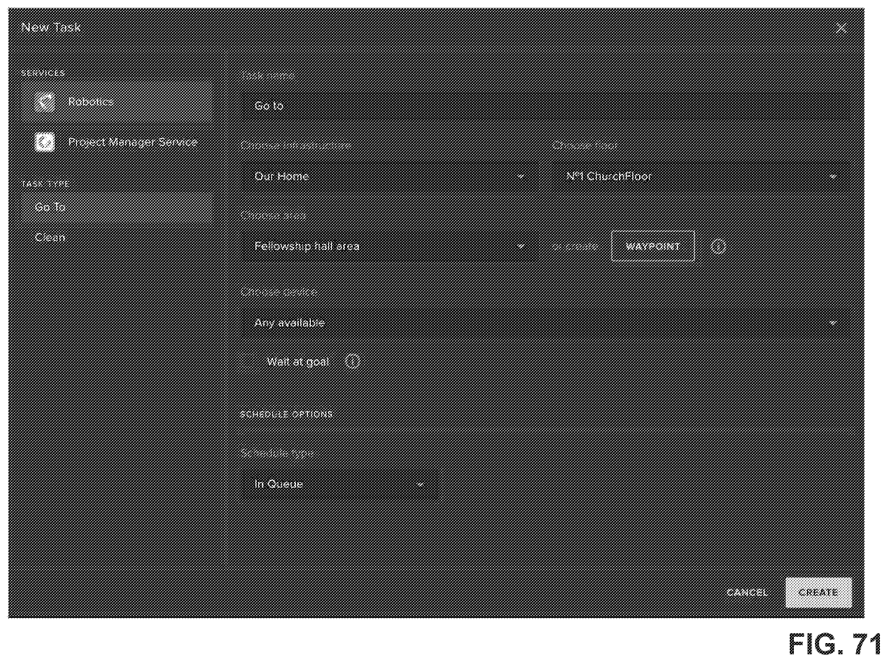

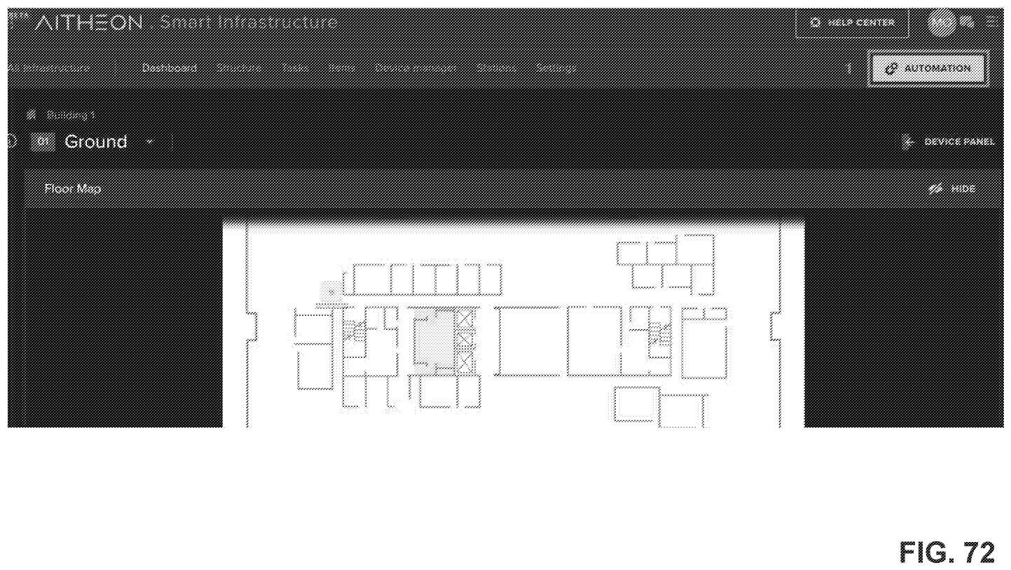

Within the SI service, the user is provided with an automation application to monitor and control all the processes in services of the user organization. With reference to FIGS. 71 and 72, selection of an automation function 604 presents the user with an automation window 608. From the automation window 608, the user can select an active function 610 that displays the user's automation apps; a most popular function 612 that displays popular automations for purchase; and a my requests function 614 that functions as a hub for placing requests for the creation of automation apps (such as described herein regarding provisional nodes).

The user can test the user's operations and robot's work within the simulation software of the inventive platform, which is embedded in the SI service and provides a type of digital playground. This functionality is referred to as a digital twin and allows the user to make a prototype and test the user's infrastructure with the inventive platform and simulated hardware and robots prior to building a facility and actually buying or purchasing robots for use within the facility.

The general flow for setting up the simulation includes: loading a CAD designed robot model into the platform; defining properties for its parts as physical objects; defining joints between immovable and movable parts; defining sensors; and defining a scene for the simulation. The following example is by way or example and is not intended to limit the invention described. The exemplary description employs the Yezhik (Aitheon) and all example property values described are particular to such model.

General steps to create a digital twin: Import a robot model; Create a collision scene; Set up physics scene; Prepare robot to reflect physics; Set up robot's joint; Add sensors and measurements; Create and link camera; Debug; Add a robot to a scene; Give task and test.

1. Import a Robot Model:

To load a CAD software designed robot model (STEP format):

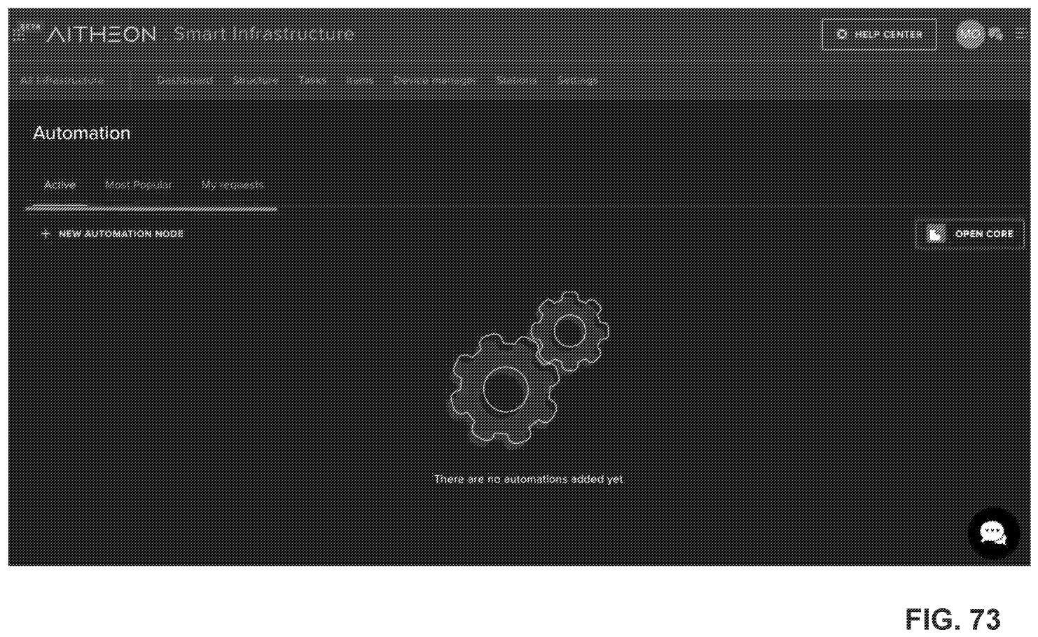

1) Go to menu Window->Isaac->Step importer and pick a .stp file. (FIG. 73)

2) When a Step import window appears, scroll it down and click Finish Import and choose a directory to save converted model objects. (FIG. 73)

3) Go to menu File->Save As and save the model as a single USD—this is the 3-d model format that the simulator uses. After that, the user can easily open this model by loading this file: menu File->Open. (FIG. 73)

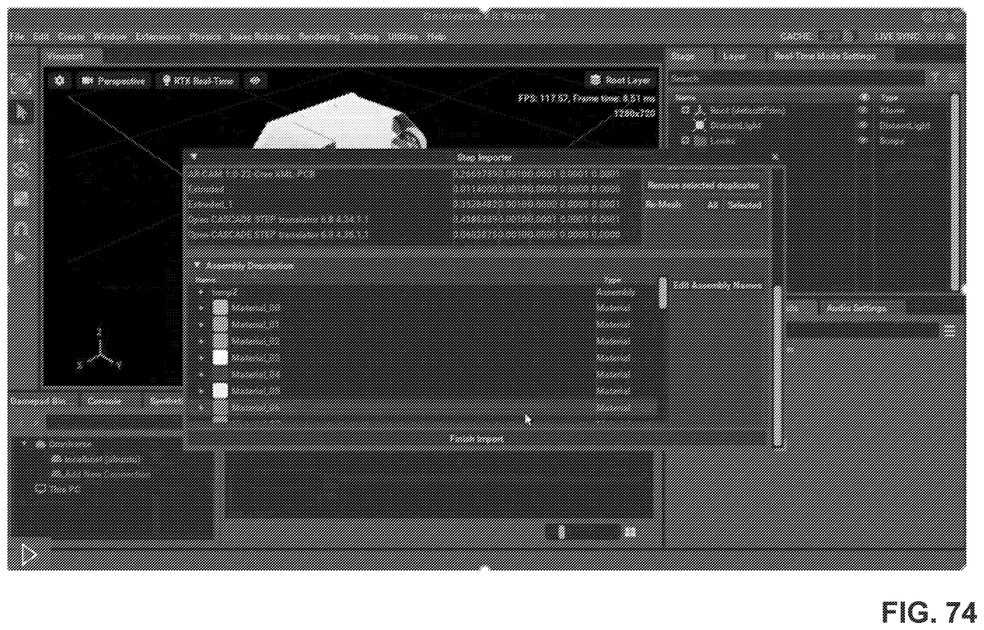

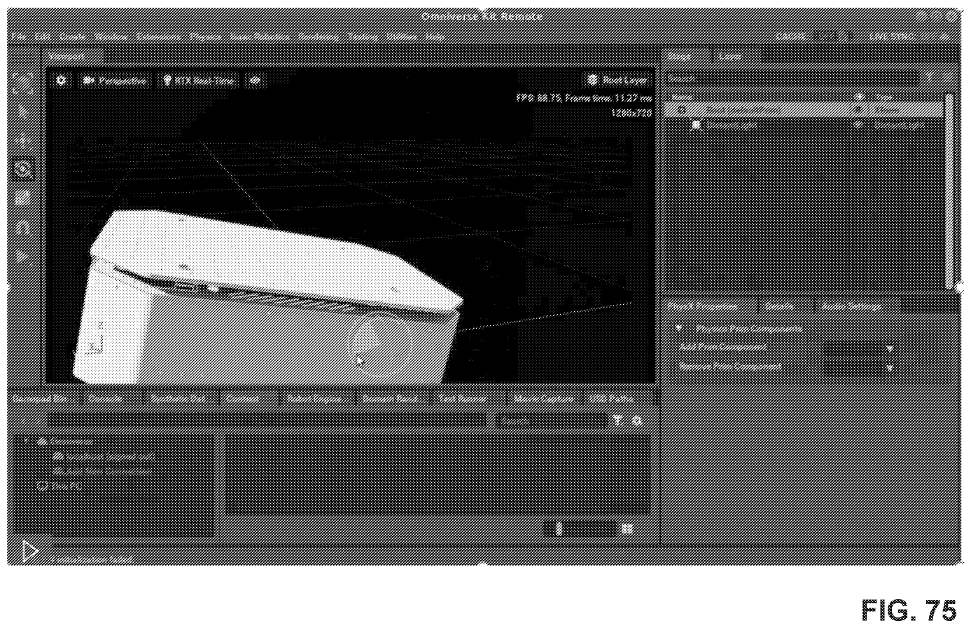

The right Stage tab contains all the objects in the tree. The imported robot is the Root object in this instance. (FIG. 74)

4) Change the view if needed: toggle Perspective to Top, Front, or Right view in Viewport. Drag the view with the right mouse button pressed and hit F after these moves to center the view back to the chosen object (part). The mouse wheel zooms the view in and out. (FIG. 74)

5) Change the position if needed: switch to Rotate selection mode in Viewport and drag the sphere or go to the Details tab and change rotation and position numbers. (FIG. 74)

6) Group minor parts into bigger containers. Choose parts holding Ctrl, right-click, and hit Group Selected. All immovable parts can be joined in the chassis group, for example. Also, the user can drag-n-drop elements to a group. (FIG. 74)

7) Also, for the user's convenience right-click and rename parts and groups of the object. (FIG. 74)

2. Create a Collision Scene:

Add a physical scene that imitates a real scene.

1) Go to menu Physics->Add->Physics Scene. (FIG. 75)

In the Stage tab, the World object will appear.

2) In the same way add ground: Physics->Add->Ground Plane. (FIG. 75)

It's a basic plane for the robot's collision with the environment.

Note: ground plane appears at the Stage tab in the Root object (the robot model object name in our example) and is called staticPlaneActor. So when the user manipulate the robot model, the ground plane will move with it. To unleash this plane and bind it to the World object—drag and drop staticPlaneActor from Root to World or the higher level (as Root and World).

Adjust Position: Choose an object (root or staticPlaneActor) in the Stage tab to adjust its position and in the Details tab specify needed coordinates.

3. Set Up Physics Scene:

A physics scene is needed in order to receive feedback from the simulator environment.

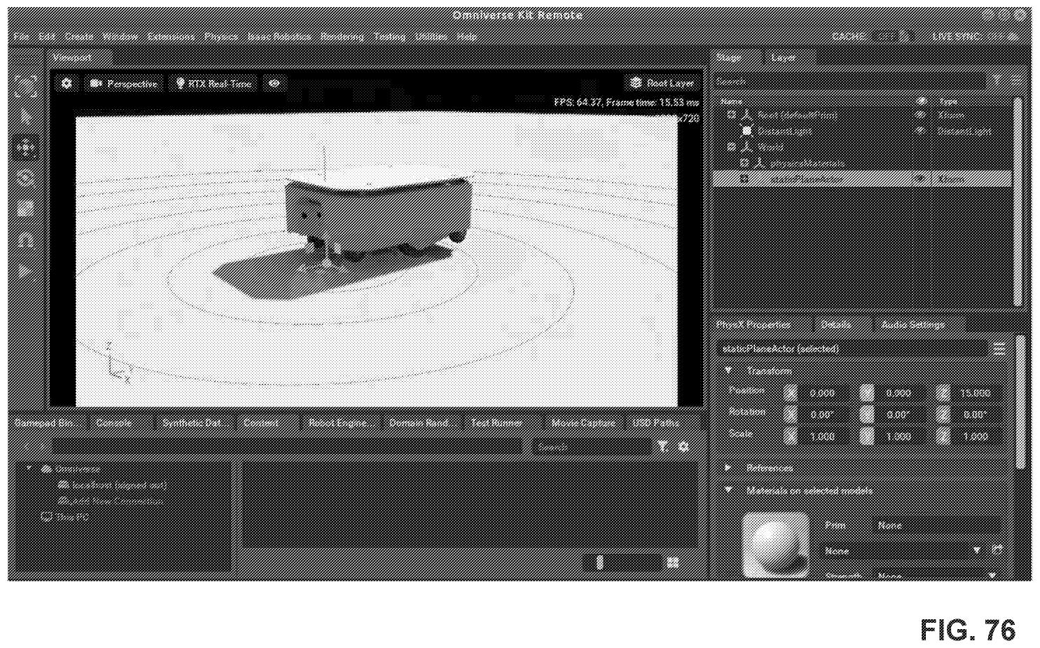

1) Expand the robot model object in the Stage tab (in our example it is called Root), find and click physicsScene. (FIG. 76)

2) Choose PhysX Properties lower-right tab. (FIG. 76)

3) Remove enableGPUDynamics flag. (FIG. 76)

4) Set collisionSystem: PCM, solverType: PGS, broadphaseType: MBP. (FIG. 76)

Usually, default presets are ok, but these settings work better.

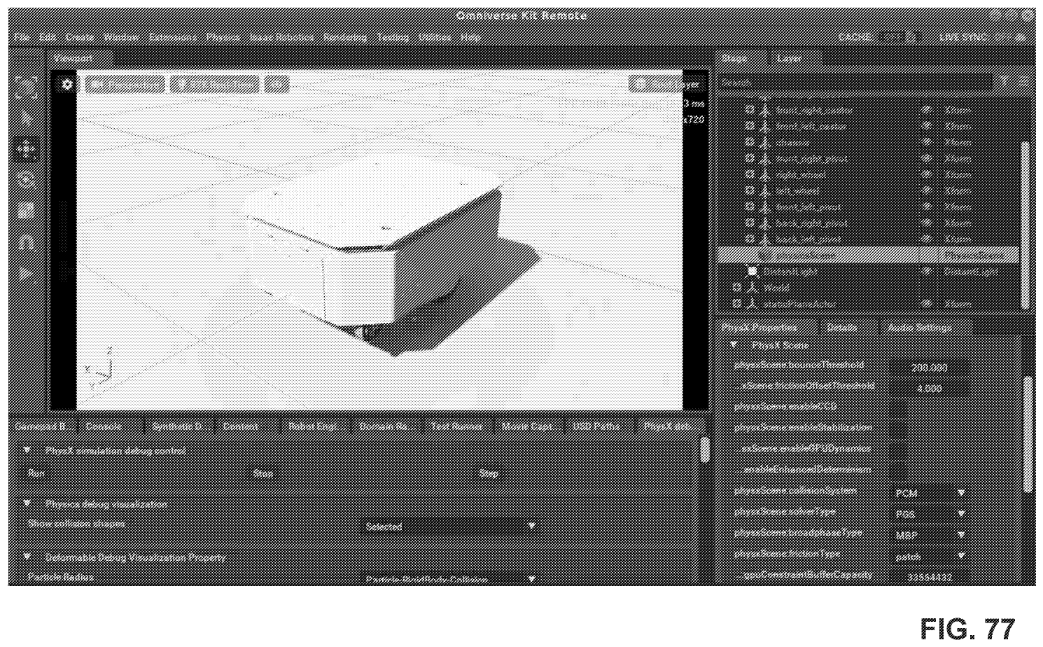

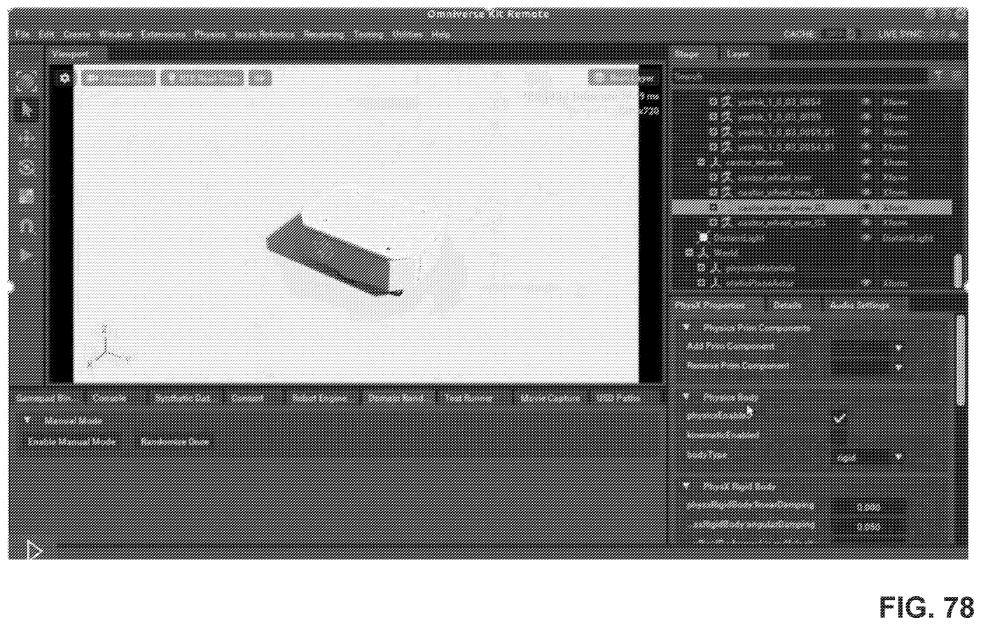

4. Prepare Robot to Reflect Physics (FIG. 77):

To reflect physics an object (robot model) should have RigidBodies properties. Apply these properties to every element (or group of elements) of the object, but not to the top wrapper (here called Root).

1) Click on each part (a group of parts) that will interfere with the environment and add the property: Physics->Set->Rigid Body. In the PhysX Properties tab new properties—Physic Body and PhysX Rigid Body—will appear.

Do it one by one with all the parts (or groups). It will not work for multi-selected parts (and groups) in most cases.

If the user first give all the parts Rigid Body properties and then group them, these parts will fall apart during the simulation, because the system treats them as separate. So it's better to group them first and then give Rigid Bodies to the whole group. Another solution: the user can add Fixed joints to these separate parts (see the Joints chapter).

2) In the PhysX Properties tab of each element that the user want to participate in collisions go to Physics Prim Components and Add Prim Components: CollisionAPI and MassAPI:mass.

MassAPI:mass will allow the user to specify the Mass Properties. Otherwise, the defaults will be used (the part's geometry multiplied by a density of 1000).

In the chassis part of the robot, there are a few elements that interact with the environment. So the user may want to delete the CollisionAPI from internal elements (this will make the simulation “lighter”):

3) Choose the chassis group and go to Physics->Remove->Collider. This will remove all the collision APIs.

4) Select and apply CollisionAPI in PhysX Properties to external elements one by one.

5. Set Up Robot's Joints:

Joints give the user the ability to connect rigid bodies in ways that are not entirely rigid. A good example is a car: the wheels of the car revolve around their respective axes, the suspension can slide up and down along an axis. The technical term for the former is “revolute joint”, the second is a “prismatic joint”.

To add a joint to the user's scene, first select the two objects to connect. It is also possible to select a single joint in order to connect it to the world frame. Then select Physics>Create>Joint. In a submenu, the user will be able to select the type of joint.

Articulations is an advanced, hierarchic mode of joints, useful for creating hierarchical mechanisms such as a vehicle or a robot. To use articulations, one should organize the joints of a mechanism and the objects they connect into a tree structure. For example, to create an articulated wheelbarrow, one would create the body (tray) object, which would have a child revolute joint for the wheel axis, and the joint would have a child wheel body. Articulated joint links parts starting from the articulation root to the last chained connection. The top tree wrapper should have ArticulationAPI in order to work correctly in the future.

The graph of joints connecting bodies will be parsed starting at this body, and the parts will be simulated relative to one another, which is more accurate than conventional jointed simulation.

There are several types of joints, mainly used are RevoluteJoint or just PhysicsJoint (it's a basic type of joint without additional API's).

PhysicsJoint is not listed here because there is no such type in the menu. This type is basic and concerns every other type. Usually, we use this type for a root joint with Articulation Joint in PhysX Properties.

Step 1. Apply ArticulationAPI to top tree wrapper

Add a method of building the joints chain with the model.

1) Select top tree wrapper (Root).

2) In the PhysX Properties tab and add ArticulationAPI. (FIG. 78)

3) Set solverPositioniterationCount in PhysiX Articulation properties to 64.

4) Set solverVelocitylterationCount to 16.

The user can set up these two parameters to higher numbers for better precision, but it will load the system a lot.

Step 2. Create ArticulatedRoot

Make a root object for all joints to connect to.

1) Select top tree wrapper (Root in our example).

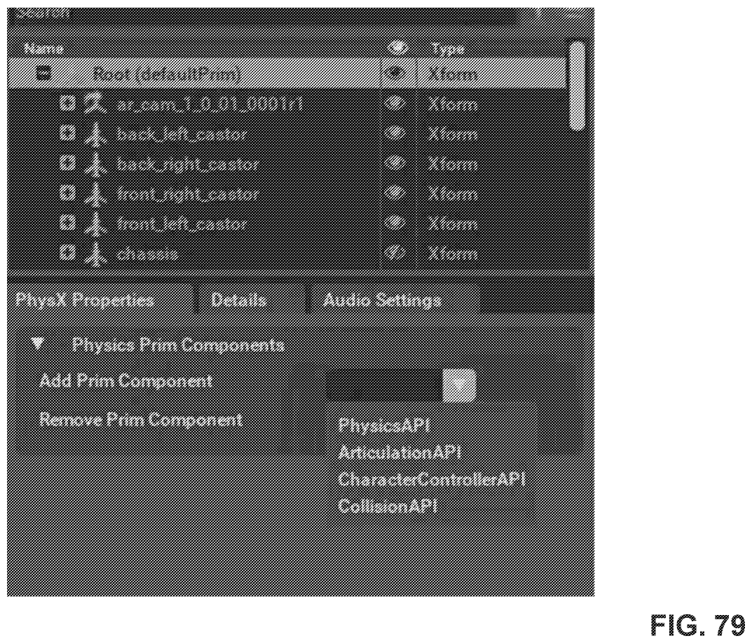

2) Go to Physics>Add>Joint>To World Space. (FIG. 79)

3) Select the newly created joint in the Stage tab.

4) Go to the PhysX Properties tab and Remove Join Component that is present there.

5) Add Joint Component named ArticulationJoint.

6) Scroll down to the Physics Articulation Joint property and change articulationType to articulatedRoot.

7) Add a tab to the editor: go to Window->Isaac->Relationship Editor.

8) A new Relationship Editor tab will appear, open body0, change the 0 path to the user's chassis object (for example, if the user grouped all the chassis parts to chassis group in Root, the path will be/Root/chassis), and click Modify. Now the root object is attached to the chassis.

Step 3. Create Joints for movable parts

Create all joints for all movable parts of the robot (model). If there is an immovable part that wasn't grouped with the rest immovable elements and got common Rigid Body properties the user should create a joint for it too. Choose Fixed type in this case. If the user don't do this the ungrouped and unjointed element will fall apart from the model during the simulation.

1) Select two Rigid Bodies: the primary one first, then the secondary one. A joint will be created as a part of the second component (and will appear in the second component's submenu in the Stage tab).

2) Make sure the user have the correct joint type set in Physics->Joint Attributes->Type—Prismatic (or maybe Fixed).

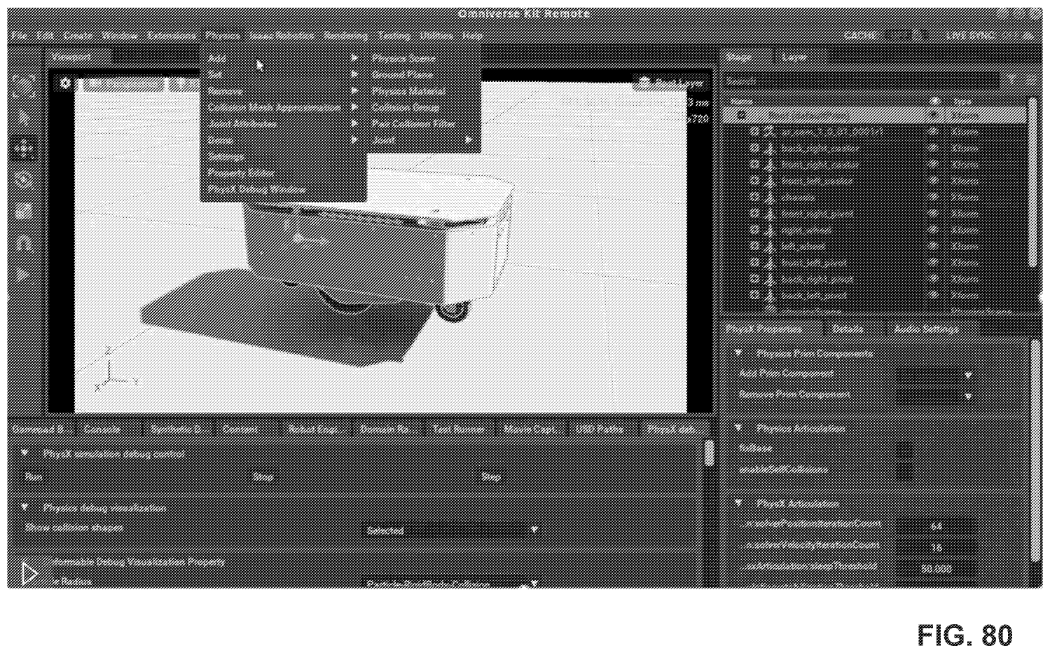

3) Choose the connection type: Physics>Add>Joint>Between Selected. (FIG. 80)

4) Select the new joint in Stage and in the PhysX Properties tab Add Joint Component—ArticulationJoint API.

5) When the user select the joint in Stage it gets visible on the Viewport tab. Move the joint to the correct place and apply the correct rotation (align its position and movement directions to actual elements of the model—use arrows dragging and Rotate mode sphere to move the joint). It doesn't have to be 100% precise, because the ArticulationJoint API will solve minor inaccuracies.

When the user move the joint element with the mouse button pressed and then release it, the selection highlighting will jump to another object. To switch back to the joint selection press Ctrl+Z. Or click the joint element on Stage again.

6) In the joint's PhysX Properties tab scroll to PhysX Joint and put a flag to enableCollision property.

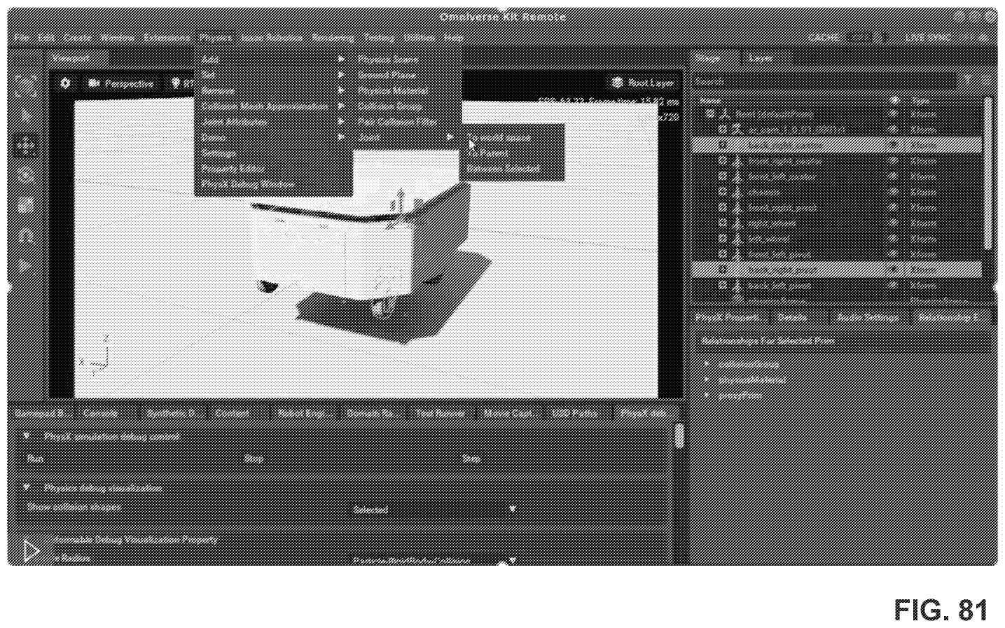

7) If this is a joint for a driving wheel: add Drive API in PhysX Joint Components properties, scroll to Joint Drive properties, and set angular:targetType to velocity, angular:type to acceleration, and angular:damping to 10000. (FIG. 81)

Step 4. Repeat Step 3 for all the movable parts.

6. Add Sensors and Measurements:

Add Lidar: Lidar is a special robot Sim component for measuring distances (though laser beam reflection measurements). Lidar beams in the simulation will ignore anything that doesn't have a collision API attached to it.

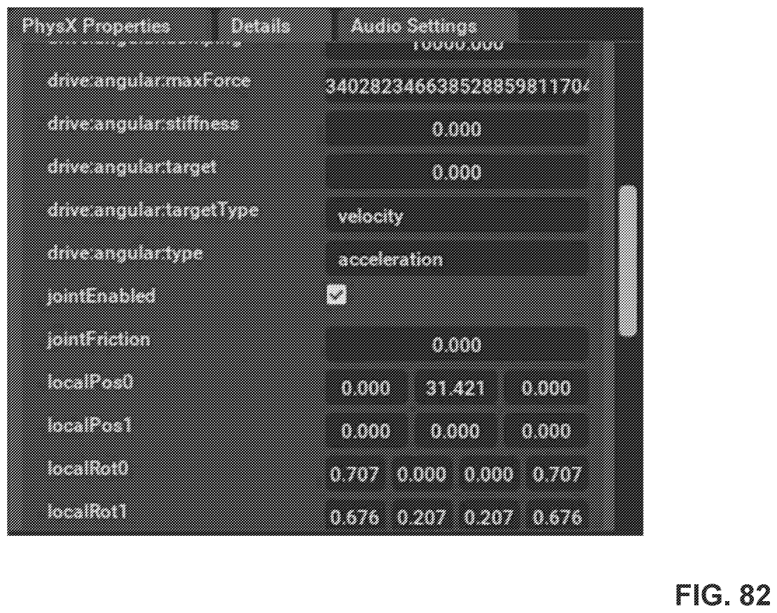

1) In Stage (or in Viewport) select an object that represents the lidar, then click Create>Isaac>Sensors>Lidar. (FIG. 82)

To hide an element choose it and press H. To unhide—press again or go to Edit->Unhide all.

2) In the Details tab set the Z-axis Position on 1.3 to move the lidar up.

3) In the Other section of Details enable drawLidarLines and drawLidarPoints. It's optional, but useful for debugging. For example, if the user start a simulation and don't see “laser beams” of the lidar, the user didn't set up minRange properly (see next).

4) In Others set maxRange to 16, minRange to 0.08, rotationRate to 12.

These parameters are for the example model of the Yezhic robot. Use the user's values for the user's devices.

Add IMU: An inertial measurement unit (IMU) is an electronic device that measures and reports a body's specific force, angular rate, and sometimes the orientation of the body.

In robot Sim, IMU can be represented as a simple cube shape with rigid body properties, but with disabled collision.

If the user already has IMU in the user's model, the user can apply Rigid Body property to it and go to step 5 at once.

1) Create a shape inside the root wrapper: right-click on Root (or another name the user gave to the root object), then Create>Shapes>Cube.

2) Select this Cube object and move it in the middle of the robot model in Viewport.

3) Scale it to the usual IMU size in the Details tab by changing Scale numbers on the X, Y, and Z axes.

The user can slide the numbers in the axes fields—left and right by holding the left mouse button.

4) Make it invisible: Details tab>Other>purpose: guide.

5) Create a joint between the IMU and the chassis: select the IMU and the chassis group, Physics>Add>Joint (choose any type of it), in the PhysX Properties tab Remove Joint Component a present API and Add Joint Component—ArticulationJoint.

Creating REB Components: The Robot Engine Bridge (REB) extension enables message communication between the two platforms over TCP to perform a robot simulation. These messages include simulated sensor data, drive commands, ground truth state of simulated assets, and scenario management.

Mainly used REB components are:

Differential Base—for wheels moves simulation.

Lidar—lidar simulation.

RigidBodies Sync—objects interaction for multi-robots simulation.

Differential Base REB:

1) Select the root object and go to Create>Isaac>Robot Engine>Differential Base. This will create REB_DifferentialBase in the Root object.

2) In the Relationship Editor tab set chassisPrim path to the top wrapper (/Root in our instance).

3) In Details set leftWheelJointName and rightWheelJointName accordingly (important: we type the wheels joints' names, but not wheels' names!) and press Enter after each to save.

4) In Details set the robot's direction vector robotFront to 1, −2, −1.

5) If there is a Proportional gain field, it should be set to 3.

6) Set WheelBase to 0.406, WheelRadius to 0.1.

These parameters are for the example model of the Yezhic robot. Use the user's values for the user's devices. Also, the user may want to change some default values, maxSpeed, for example.

Lidar REB: In Relationship Editor set the path for lidarPrim to the lidar component (created through Create>Isaac>Sensor>Lidar). Important: the lidar component in Stage must be Lidar type, not Mesh or else.

RigidBodies Sync REB

In Relationship Editor set path in rigidBodyPrims 0 to chassis, in rigidBodyPrims 1 to IMU.

7. Create and Link Camera:

The user can add extra points of view to the user's simulation by adding virtual cameras. For example, the user can add a camera to the robot model and switch to its view.

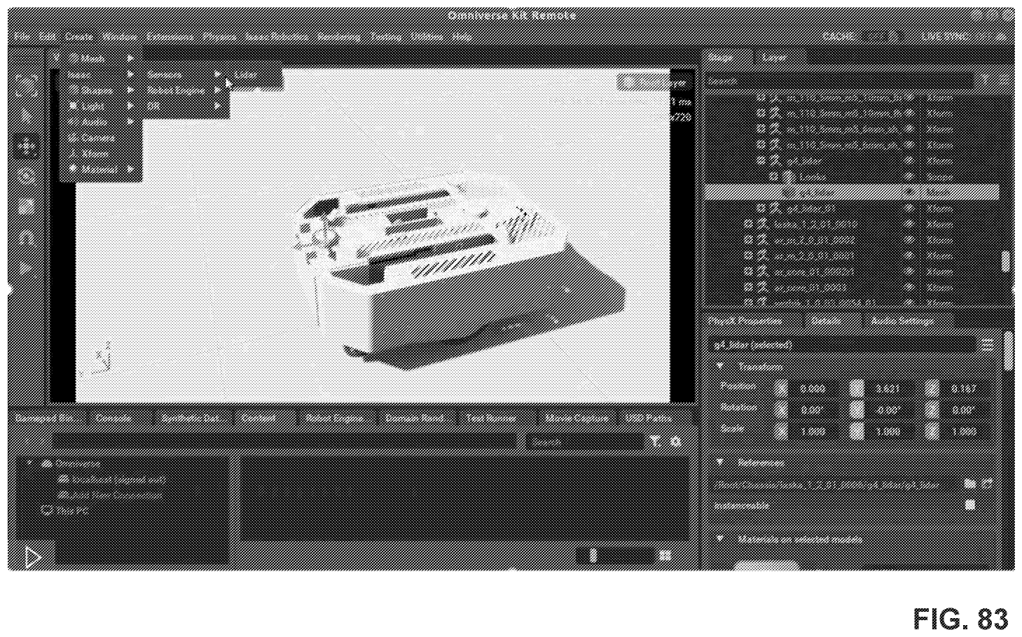

1) Choose the view for a new camera and create the camera through Create>Camera in the Perspective menu of Viewpoint. (FIG. 83)

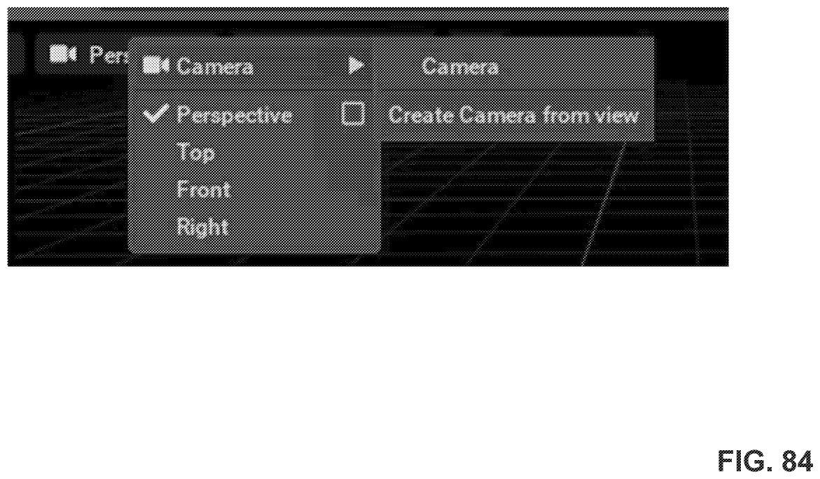

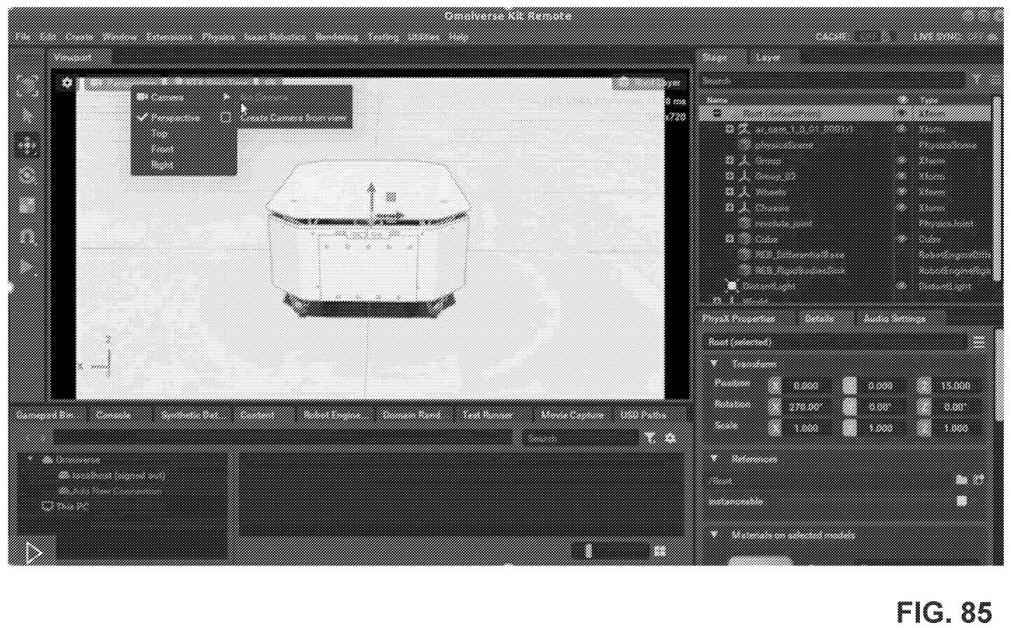

2) The user can switch to the created Camera by picking it in the Perspective menu. (FIG. 84)

3) If the user wants to change the camera's perspective, choose it, and move the point of view to the position from which the user want to observe the real-time scene (holding the right mouse button).

4) To bind the camera to the robot (so that the point of view will follow the robot moves): select the camera object in the Stage tab, right-click and create a new group (consist of one element—the camera). This is done because the Rigid Body property can be applied only to Xform elements (see in Stage)—groups.

Apply Rigid Body properties to the created group (Physics>Set>Rigid Body).

5) Create a physics joint like for IMU.

8. Debug:

In order to see collision shapes and debug this in real-time:

1) Go to Physics>PhysX Debug Window.

2) Move the tab to a convenient place for the user. (FIG. 85)

3) In Show collision shapes pick Selected. If the user choose All—the representation will become too “heavy”.

4) Collision shape movement is being shown only when the user press the Step button, even if the user run a scene from this window it won't be constantly showing the user collision form change.

9. Add a Robot to a Scene:

Presumably, the user wants to test the user's virtual robot model in some virtual environment.

After the user set up the user's robot virtual model and saved it in a .usd, create the scene, and add the robot to it:

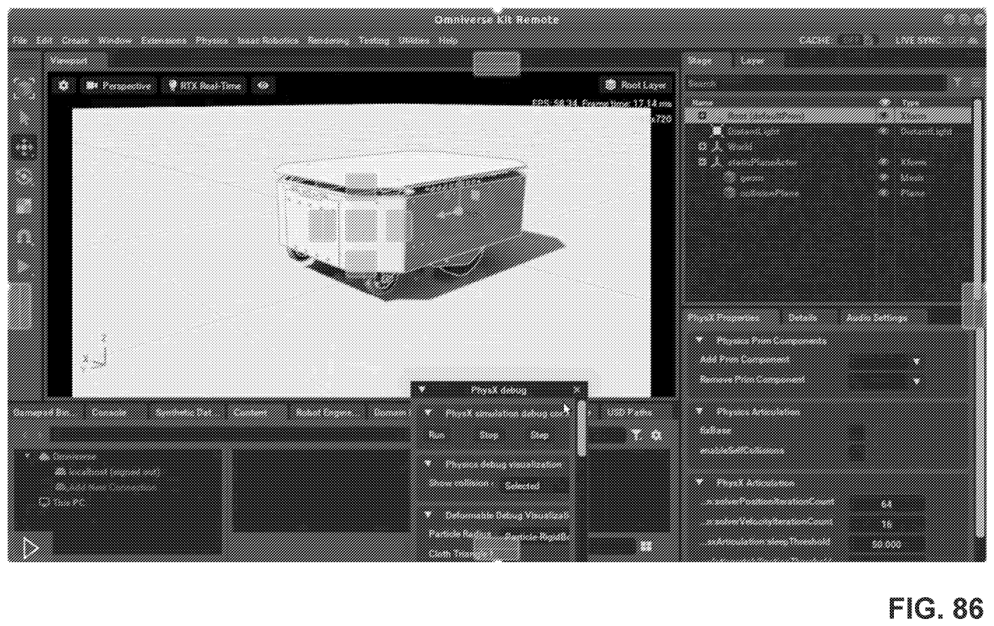

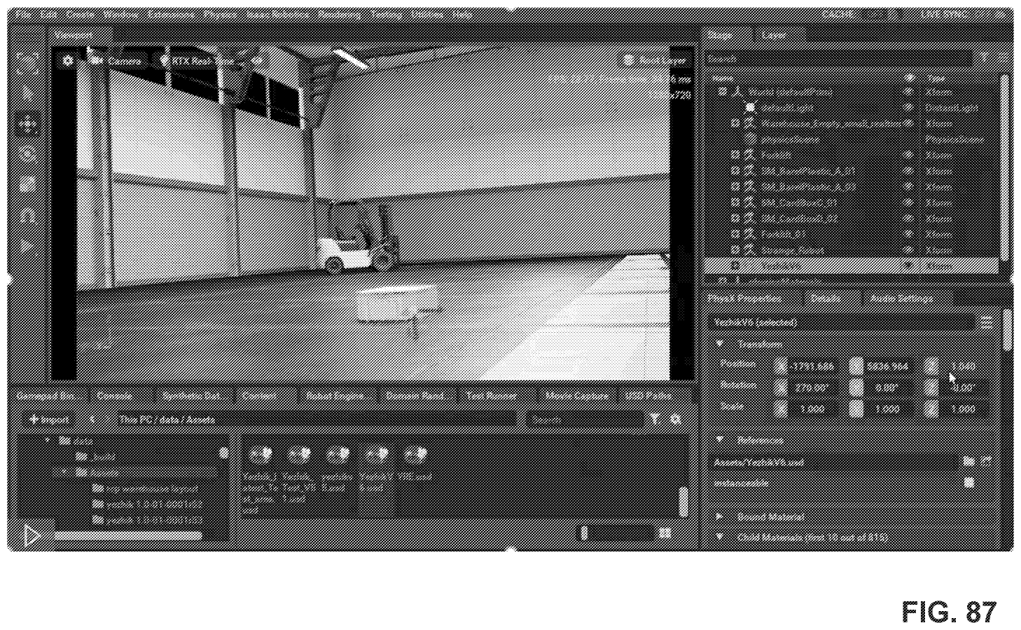

Go to the Content tab, choose the model file, drag and drop it to the scene. (FIG. 86)

To connect the simulation to Smart Infrastructure go to the Robot Engine Bridge (1) tab and press Create Application (2). Then click ‘play’ (3) to start the scene:

10. Give a Task and Test

Add the robot virtual model as a device, and a map of the virtual scene as a floor to the SI service (See Add Floor and Add Device described herein).

Launch an application to process the connection of the scene to the SI service.

Create a task (as described herein) and watch the execution.

The creators studio (CS) service provides the user with an interface through which the user can easily create, change and support logic of processes that control software and hardware, through both a full-code and a graphical, low-code experience. Alternatively stated, the CS service is a tool for creating and editing nodes within the inventive platform. It contains a convenient editor that supports different programming languages and provides everything the user needs to develop a node. Moreover, the CS service contains an application editor tool for a codeless experience of application development. Hence, advantageously a user can create processes without profound programming knowledge and make a useful application for a business process.

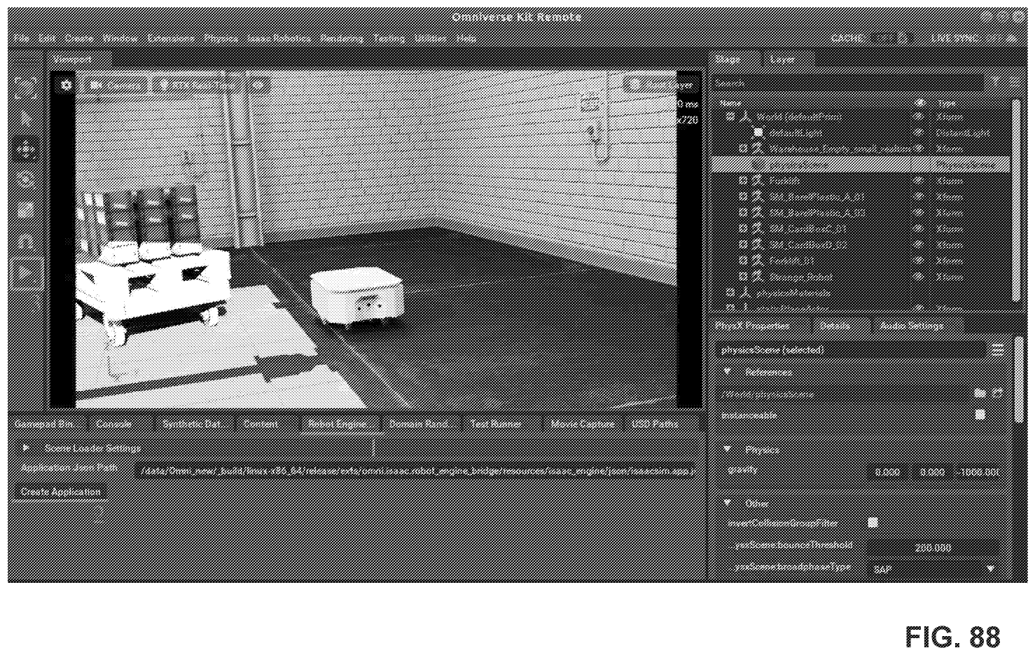

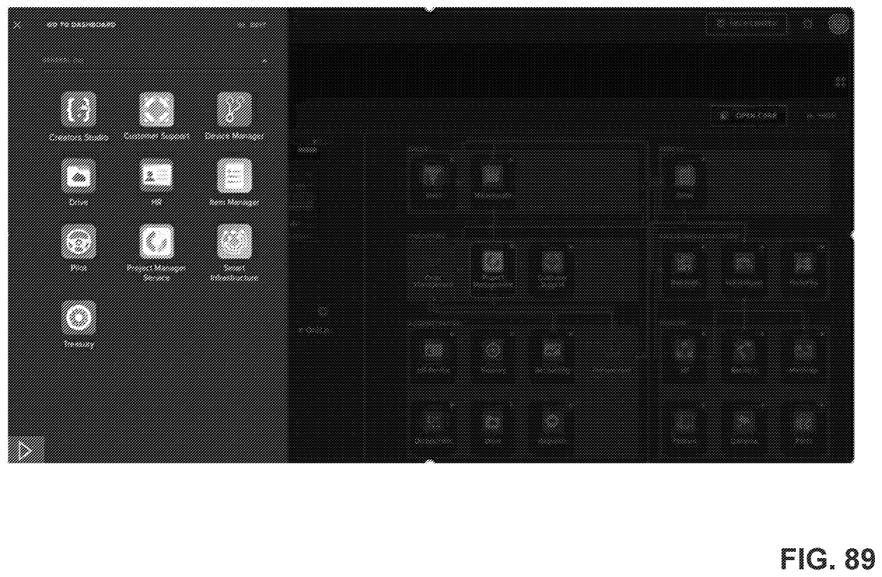

According to the present invention, a user accesses the inventive CS service through, for example, a user dashboard service window of the inventive platform. As shown in FIG. 88, within a dashboard 100, the user selects the CS service 700 which presents the user with a CS window 702 (FIG. 89). From CS window 702, the user can create a new project or application 704; select a recent project 706; view, filter and sort a repository of all of the user's projects; select a sandbox function. The sandbox is the main environment of the CS service in which apps are created and run in a virtual environment before deployment to the inventive platform.

The following is an example of a creation of an app within the SC service.

Build the app's logic first:

1) A user types their name in a UI field. For example, “Mark”.

2) The app makes a personalized greeting phrase.

3) The user sees “Hi, Mark!” on the same UI table.

Basically, the logic of most of the apps is the following: take some input data; do something with this data; and pass the result to output. The CS service Apps Editor will help the user do this with ease—using visual programming tools.

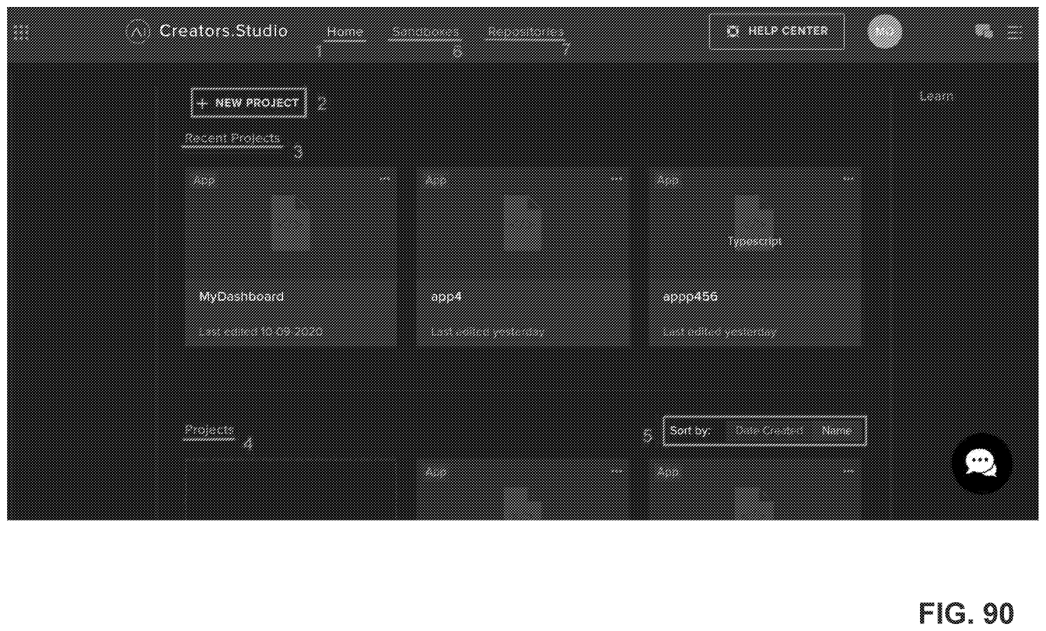

Create MyFirstApp Project: We'll create the project for the app from the very beginning of the Aitheon Services family—from the Services Map. If not already there—open Navigation Bar and click GO TO DASHBOARD. Scroll down and click CREATE DASHBOARD APP. Choose Create New Dashboard Application. (FIG. 90) Give a name and CONTINUE.

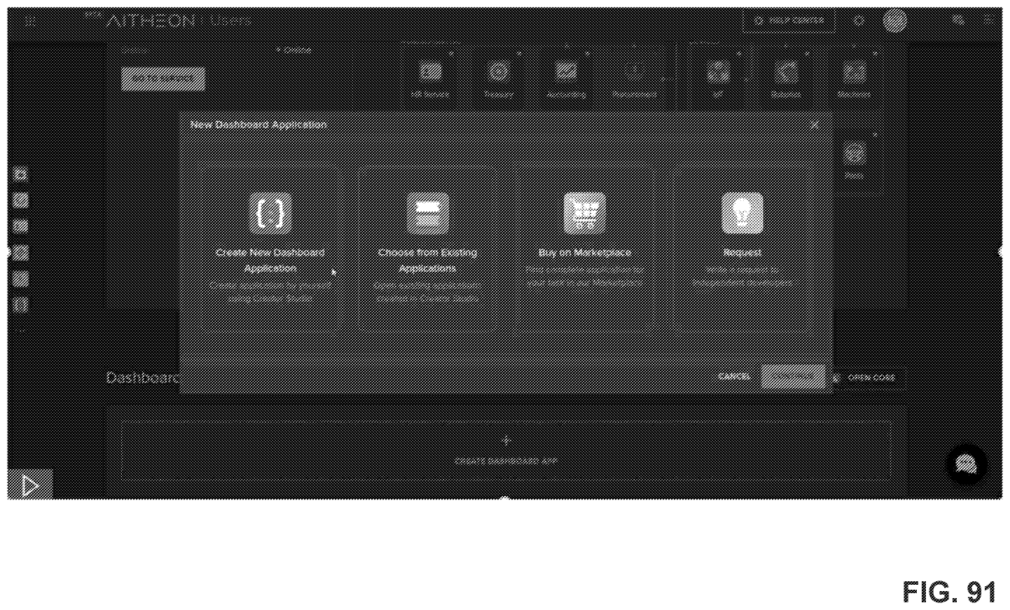

Compose MyFirstApp: Click .json file to open Apps Editor—the visual (codeless) programming tool. Find on the palette the common category and drag inject and debug components to the workspace. (FIG. 91)

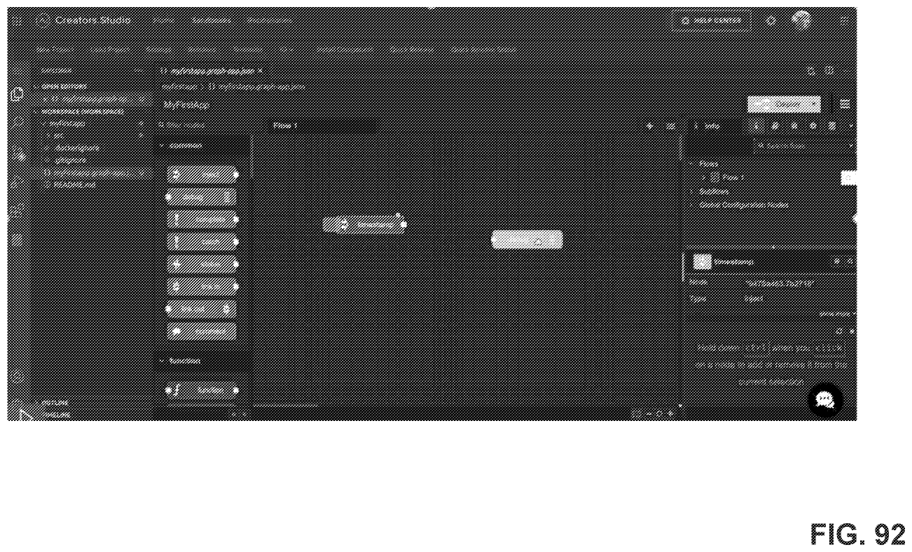

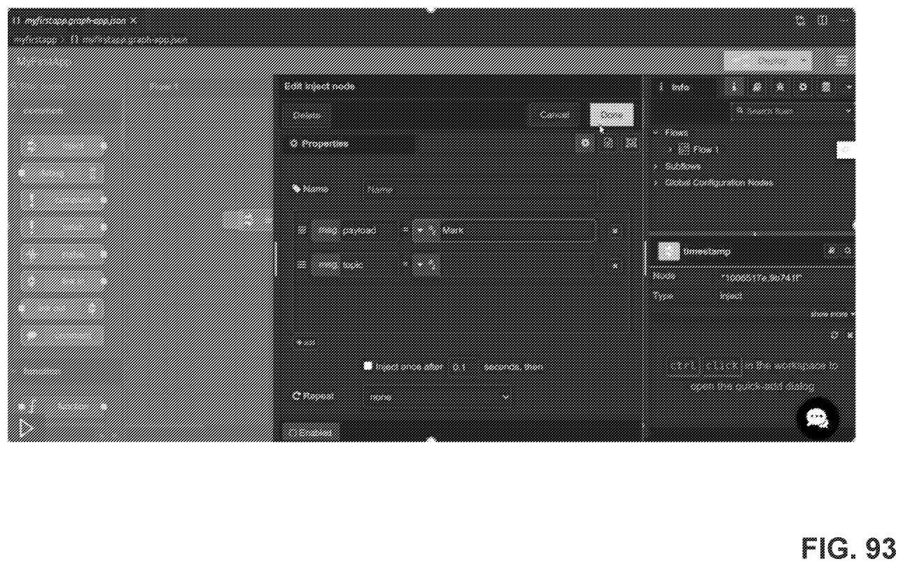

Inject a Name: The inject component allows injecting some data into the app flow. Here it will help us to imitate the real input—it will just send the word “Mark” every time we press the component button. Doubleclick the component and the Properties window will appear. Here we change the data type of the payload to string and put the value “Mark”. Now the component will send the message “Mark” each time we press the button. So, now we have a component to make the “Mark” input. (FIG. 92)

Debug the Result: The debug component shows the resulting message in any output point of the flow. In our instance, we have only one output point—the inject component output. Let's check, is it really “Mark”. Connect the inject component output to the debug component input. Deploy the flow. Switch the sidebar to the debug tab. (FIG. 93) Now press the inject button and watch the result in the sidebar. The debug component shows us whether the result corresponds to our expectations. If no—we debug the flow.

Change the Message: To change the phrase use the function component.

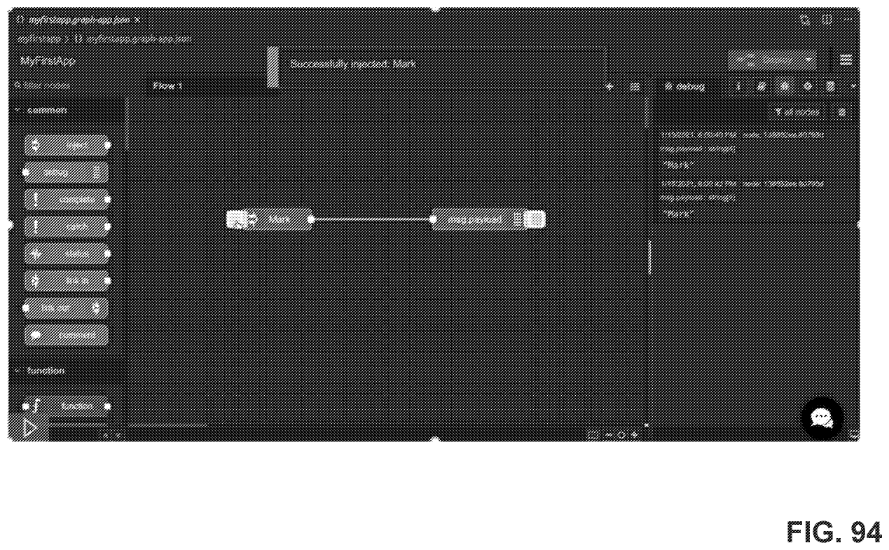

Drag it between the two others and double click. (FIG. 94) Copy and paste this code there:

msg.payload=“Hi,” + msg.payload + “!”;

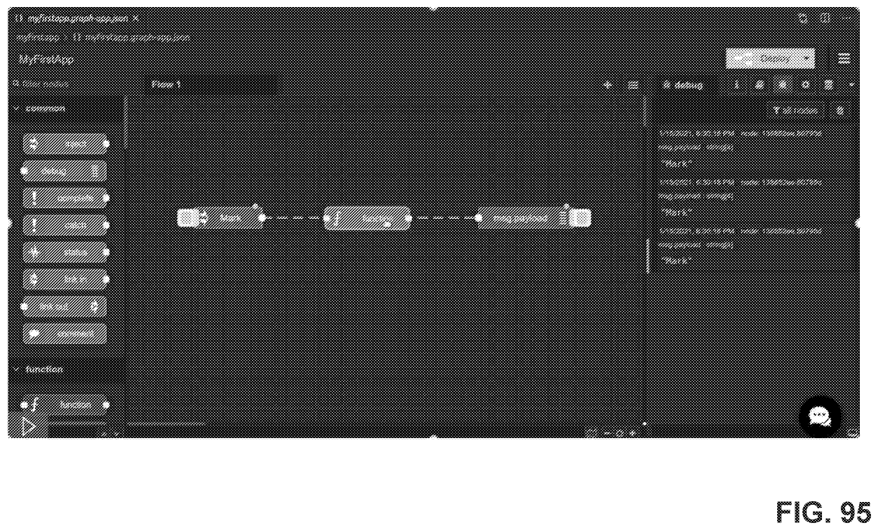

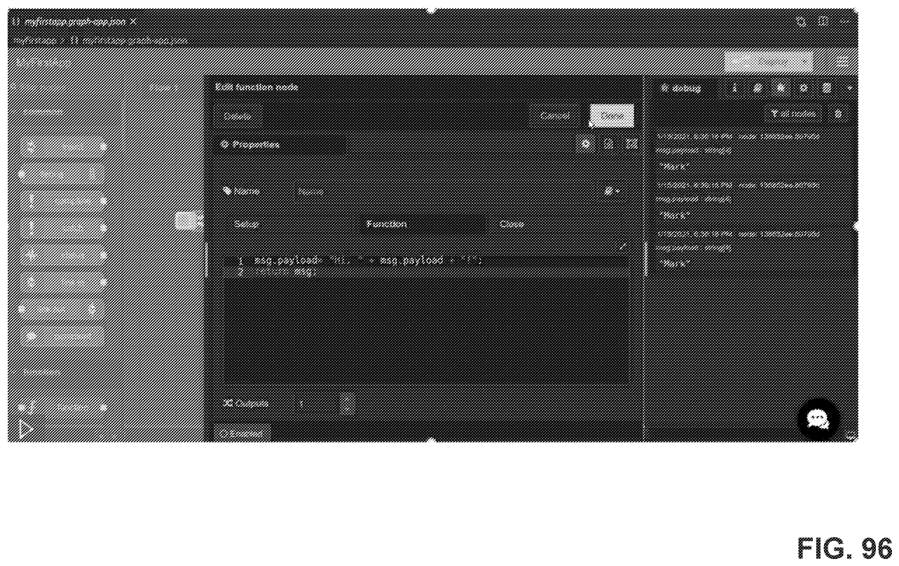

return msg; (FIG. 95)

This code updates the message putting it between “Hi,” and “!” so that the resulting message becomes “Hi, Mark!”. Click Deploy, inject our “Mark” message, and watch the result in the debug tab:

UI Input: Now we have a valid application. But it takes the input inside itself and shows the result inside itself (in the debug tab). Let's create a real user interface input field instead of the internal inject. The dashboard category contains components for UI. Drag a text input component to the workspace and connect it to function. Now we have two sources of input. (FIG. 96) Double click text input and set the delay before sending a message to 1000 ms—otherwise, the user are at risk of not finishing typing “Mark”. (Or set to 0 ms—to send a message by hitting Enter). Deploy: Right-click on the .json file and open a testing UI Viewer tab. Now we can test the real UI input.

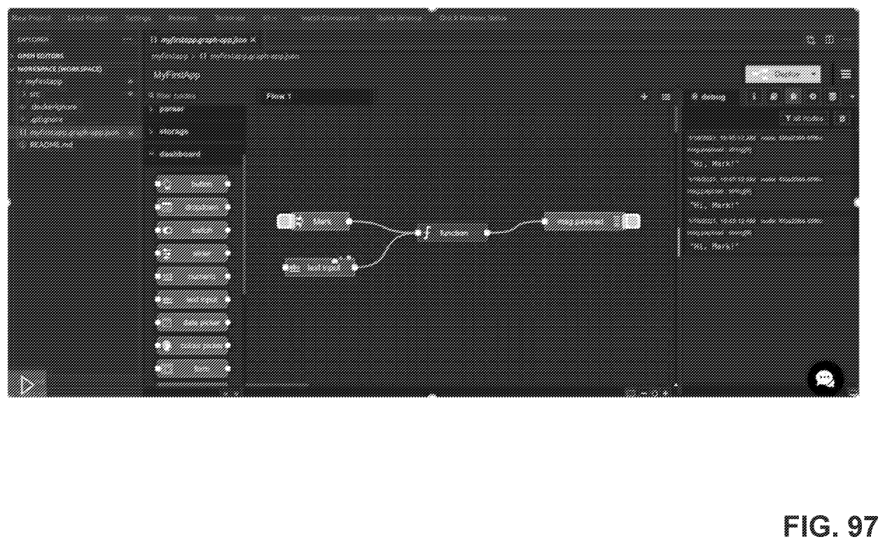

UI Output: Its time to make a real UI widget for the output. Drag a text component to the workspace and connect it with function. In the text component parameters change the label to “Greeting” and choose the lathe usert. (FIG. 97) Deploy and test in the UI Viewer tab.

Release MyFirstApp: We have to release the app to use it in platform services. Choose unnecessary components and hit Delete—we don't need inject and debug components anymore. (Optional) Adjust the appearance of the widgets. (Optional—we can do this later on the dashboard) Make Quick Release and wait until it Completed.

Add the Dashboard: Add the dashboard from the list in Choose from Existing Application.

Use MyFirstApp: Now the user can adjust the appearance and use the app.

The user can also create a project in Creators Studio, where the user will elaborate on the user's application. There are several ways to do this.

1. Create a Project from Another Service

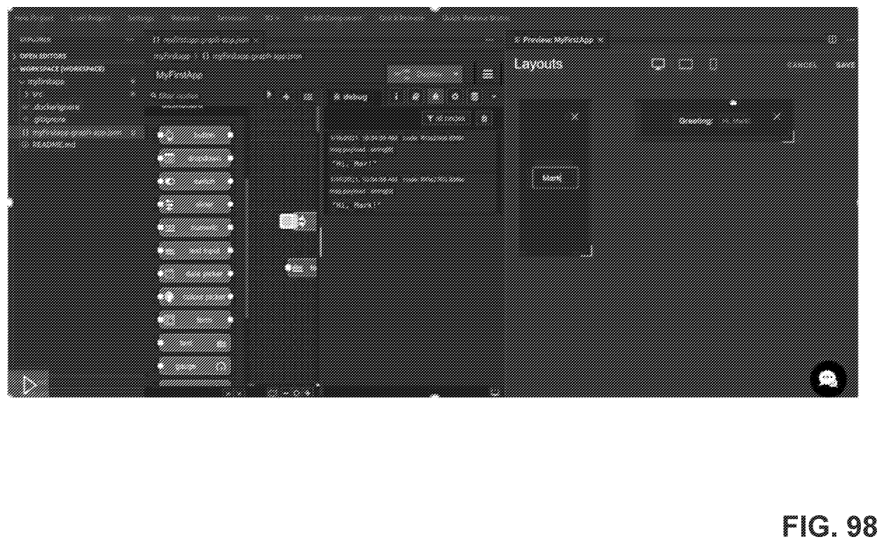

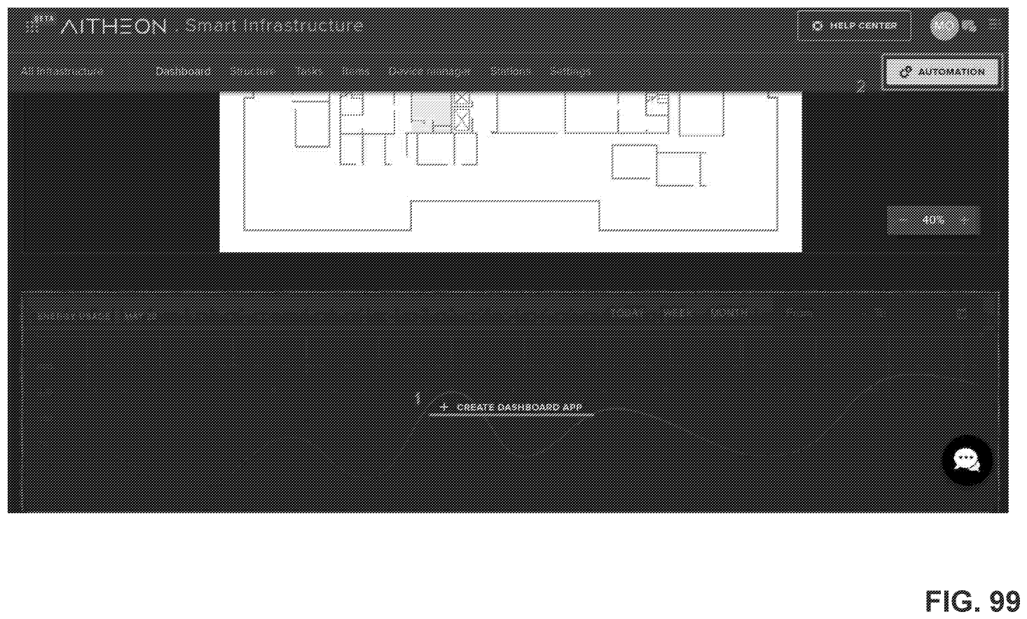

Every inventive platform service has an AUTOMATION button and Dashboard area to make and place an application there. The user may create a project and get to Creators Studio from some specific pages of Aitheon services. For example, open the Smart Infrastructure service and click one of the infrastructures. On a dashboard, click CREATE DASHBOARD APP (1) (or NEW AUTOMATION NODE in AUTOMATION (2)) and a window will pop up. (FIG. 98) Click Create New Dashboard Application and CONTINUE. Then give the dashboard application a name, choose Codeless Experience, and click CONTINUE. (FIG. 99) The user can also click the AUTOMATION button on the Dashboard tab and then click NEW AUTOMATION NODE on the Automation Page. The same steps will follow.

2. Open Creators Studio

Also, the user can create an application from the Creators Studio interface directly. Open Creators Studio from the top-left GO TO DASHBOARD menu on the platform (the user can open it from the left quick-access panel or main dashboard as well). A window with the user existing projects will appear. Maybe there are no projects yet. Click add New Project to make one.

3. Set New Project Parameters

In the New Project window, choose a type. (FIG. 101) The only type available for codeless composing is App (1). Give the Project a Name (2). The user can use it as the app's name later. Select runtime (3). AOS means that the app will run on a local device, AOS Cloud—on the cloud. If a device has its own computing capabilities, maybe the user want to deploy the application to AOS. Otherwise, the program should be executing on the cloud. Choose App type (4).

Project type App has three own types (or sub-types): Application—choose to make an app that defines a device's work and allows a user to manage it with UI. Usual runtime: AOS; Dashboard—choose to make an app that shows ongoing information for some processes. Usual runtime: AOS Cloud; Automation—choose to make an automation flow with some services and devices. Usual runtime: AOS Cloud. Type reasonable descriptions of a purpose and functions to the Project summary field (5). Click CREATE and add a description for the project. Then click CREATE. Now the userr project will appear:

4. Choose Sandbox

When the user clicks on the new project, a window with a sandboxes choice pops up. (FIG. 102) A sandbox will be that virtual place where the user will compose and test the app before releasing it. Depending on the app's complexity, the user will need a more or less powerful sandbox for smooth running. Choose a sandbox type and click CONTINUE. Creators Studio will open in a new window.

5. In Composing Environment

In a Visual Code Studio window, click the { } . . . .json file to open a workspace for the app's visual composing. A workspace with Node-RED interface (visual flows editor) will be loaded: (FIGS. 103 and 104)

For codeless applications creating, Creators Studio has Apps Editor, where the user can add needed components onto a grid and connect them as a graphical representation of the actual processing logic of the app.

1. Add components

Choose from the palette (1) a component needed and drag it onto the workspace (2). Components on the palette are ordered in groups. Click a component to see its description on the sidebar (3). To delete a component from the workspace click it once and hit Delete on the keyboard. (FIG. 105)

2. Set Up Properties

Double-click on a component at the workspace to open the component's properties. (FIG. 106) A window will appear (1). In this example, a window for an Inject component (“inject node”). Each node (component) has its own properties, depending on the function of the node. But there are common ones. For any component, the user can set up its name (2)—it will be shown on it for better reading of the flow.

The main purpose of many components is to do something with a message object. The simplest message object contains an empty topic and some payload (3). In this example, msg.payload is timestamp—just the number of seconds from a particular moment. The user may change the type of data and the data.

Different components bear different functions and properties. Explore Standard Components and Aitheon Components. Enable and disable the component (4)—it may be useful for testing the app flow. Open the second tab of properties (5) to add a description for the component or the third tab (5) to adjust its appearance on the workspace. A component with a lack of obligatory properties set up will have a red triangle mark (6), a component with undeployed changes has a yellow circle mark (7). (FIG. 107)

Set up all needed properties. Notes near proprieties fields and the sidebar with info will help the user. Click Done to save and close the window. Click Delete to delete the component from the workspace.

3. Add Connections

To wire these components, click an output point of one component (1), drag to an input point of another (2), and release the mouse button. (FIG. 108) There is no need to be precise here—if the user release the button above any part of another component (3)—still the connection establishes. To wire a row of components, start with clicking the first point and Ctrl pressed. Holding Ctrl, just click the row components one by one. The user can create multiple connections from one output or to one input point. To delete a connection, click it once and press Delete on the keyboard.

4. Deploy

Before deploying, exist the flow only in the editor. A component with undeployed changes will have a yellow circle mark (1). Click the Deploy button (2) to save all the changes in the userr flow and run it. (FIG. 109) Click the arrow on this button to choose a deploy option (3): Full—runs by default when one clicks the Deploy button; Modified Flows—in our example, we have only Flow 1, but if the user have more, this option will affect only flows with changed nodes (aka components); Modified Nodes—affects components with the blue marks: Restart Nodes—affects already deployed flows.

To use the app the user must make a release. To sell the app, the user must publish it as a request for Marketplace first. To release, click Releases menu (1). (FIG. 10) Choose the project and click the Builds tab (2). (FIG. 111) In this tab, click CREATE BUILD (3) and wait for a little. When the build status switches from IN PROGRESS (4) to SUCCESS—the userr build is ready to be released. SHOW LOGS (5) at that moment will change to the CREATE RELEASE button. Click it and fill the form of New Release: Tag—give the userr application a version number; Name—give a good name that reflects the purpose of the userr app; Description—put here a short but essential description of the app; Visibility—choose if the user want the app to be available for other users (Production option) or just for the user (Development option). (FIG. 112) Click SAVE.

In several minutes the application will appear in TOOLBOX, My Nodes tab (if it's a node project), in the Install Component menu (if it's a component), or other appropriate places of the Platform (depending on the project type).

Don't forget to click Terminate to stop using a sandbox. It will terminate in 15 minutes automatically.

Quick Release

Click Quick Release (1). (FIG. 113) Choose a project the user want to release and click RELEASE. Creators Studio will take the project name for an app and will give it the version number automatically. The app will appear in the My nodes tab of TOOLBOX in several minutes. Click Quick Release Status near Quick Release on the menu. When Status switches from In Progress to Completed, the app is ready to use. (FIG. 114)

To sell the app within the marketplace service, the user will need to send a request for publishing it there. Click Settings and choose the project with an app the user wants to submit to Marketplace.

Set up application properties: Name—type a good name that represents the essence of the app; UPLOAD IMAGE—this image will attract the attention of buyers at Marketplace; Category—buyers can filter apps by categories at Marketplace; Product URL—shows how it will look at the address line. Type a word, and the user will see the result above this field; Description—describe the purpose, functions, use cases of the app for the buyers; Screenshots—add screenshots of the appearance of the application; PRICING—choose how do the user want to charge for the application; Amount—and note how much it will cost. Click NEXT to customize the appearance of the app on the graph table: Add a good Logo and colors for the application node. The user will see the preview immediately. Click SAVE to submit the userr request.

After moderation, the app will appear at Marketplace so that the user can buy it. The user will get a notification about successful submitting and successful moderation pass—check the Control panel of the platform. Or the request may be declined for some reason. The user will get a notification eitherway.

To remove the application from Marketplace, open the relative project in the Creators Studio Home menu, and click UNPUBLISH. Confirm unpublishing.

Another way to do this: find the app at Marketplace, open it in My requests, and click Unpublish. Confirm unpublishing.

Home page (1) of Creators Studio allows the user to: Create a NEW PROJECT (2). Start here to create an application; Choose one of the Recent Projects (3). Three last edited projects showed; Choose from all the userr Projects (4); Sort the userr projects by Date and Name (5); Go to Sandboxes (6). (FIG. 15) The sandbox is the main environment of Creators Studio and contains editors for apps creating and runs in a sandbox—virtual environment where the userr app safely exists before using on the inventive platform. Creators Studio also allows the user to Go to Repositories (7); a place where files of the projects are stored. When the user chooses a project or to create a new one, the user will choose a sandbox to work in. (FIG. 116)

If there is no running sandbox, the user will be prompted to choose one (FIG. 116). Once a Sandboxes is chosen, a sandbox window will open. This main work environment and will contain: Creators Studio tabs (1); Sandboxes tab menu (2); Main Editor basis (3); and Apps Editor tool for visual programming (4) (FIG. 117).

Sandboxes menu contains (FIG. 118): New Project (1) opens a new project window; Load Project (2) allows the user to choose the existing project and open it in this sandbox (editor); Settings (3) allows the user to place a request with the userr app to Marketplace. The user needs to set up settings for the application; Releases (4) allows the user to make a release of the userr app manually; Terminate (5) terminates a sandbox (Click it when the user have done the work with a project); IO (6) shows a list of the app projects. Choose a project and in a pop-up window, choose sockets the application node needs (FIG. 119); Install Component (7) allows the user to add a new component to the palette; Quick Release (8) allows making a release of the userr app in one click. Creators Studio will take the project's name for an app and will give a build number automatically; Quick Release Status (9) shows the userr release status: when In Progress changes to Complete—the userr app is ready to use.

For development purposes, Creators Studio uses a common and clear Main Editor. On the left sidebar (1) (FIG. 120), the main tab the user need looks like a “two sheets of paper” pic. This button shows and hides all the EXPLORER column by right—(2), (4), (5); OPEN EDITORS field (2) contains a list of all opened files in Creators Studio. They open in browser-like tabs (3), and the user can manage them the same way; WORKSPACE field (4) is basically a folder/file explorer. When the user load (or create) a project, it appears here as a folder that the user can expand (and collapse) and choose a file the user need to edit. In the project FloorDashboard, we chose the { } floordashboard.graph-app.json file, and it opens in the editor. For visual (codeless) programming, the user need to open this { } . . . .json type of files in the main project folder.

OUTLINE and TIMELINE fields (5) are more useful for coding projects. As well as the bottom field (6). Right-click on a folder (7) shows another useful menu. The user can Remove Folder from Workspace, for example.

Right-click on the { } . . . .json file shows another useful menu. For example, the user can open a window with the user's app's user interface view (9), so the user may observe the appearance before the user release the app (FIG. c212).

Apps Editor functions for visual flow programming, which means the user can compose a functional application just by graphically dragging, wiring, and setting up visual components (nodes) on the editor's table. A flow represents logic that follows when a message (data) comes to the app's input. The app gives some result—it may be some output message or simply a widget that shows the user valuable information about the system that sends data.

The main features of the Apps Editor tool include: Header (1); Palette (2); Workspace (3); Sidebar (4). In the Header the user can see: A project name; Deploy button that runs the project and gives a list of deployment options; and Options menu button shows a list of options for the editor.

A subflow (FIG. 122) allows the user to fold some flow into one component that the user may use in other flows—it will appear on the palette (1). Click the Header's menu and choose Subflows (2). The user can Create a new Subflow (3) in a new flow tab or instantly transform selected components and connections in one subflow (4). Double-click a subflow tab to change its name and description. A subflow settings are at the top of the tab (5).

Palette is a list of components that the user can drag to a workspace and wire to compose an application. (FIG. 123) To filter nodes (components) (1), begin to type a node's name. Components are stored in categories (2) that the user can expand and collapse for convenience. Components (3) is the main part of the palette—the user can drag them from here to the workspace. Collapse or expand all the categories with the bottom arrows (4).

Workplace is a feature where the user can drag needed components, wire them, organize them to provide the logic of the app (FIG. 124). The workplace contains: The workspace table (1) to place components on; Tabs (2) for different flows of the app. Work alike tabs in browsers; Tabs control buttons (3) (Add a Flow and a List of Flows to choose and switch); Table control buttons (4) (Toggle Navigator (for dragging the table), Zoom Out, Reset Zoom, and Zoom In the table).

Sidebar helps to understand particular components and flows features and contains info, help, debug, and other tabs (1). In FIG. 125, the information tab is shown with: Flows information field (2), where the user can easily find a needed component, change its properties, enable or disable it with one click; and a component information field (3) where the user choose a component on the workspace, its parameters are shown here.

The Help tab containing a list of components. Choose one to see help info about the component its properties and how to use it.

The debug tab (FIG. 126) that allows the user to see the result of some flow by using the Debug component in the table. The user may select the source of data (1), clear the log (2). This component and this tab on the sidebar very useful when the user want to see what result shows some piece of flow (or entire app) before releasing an app. The debug window shows the topic and current time. Hence, at any step of a flow, the user can examine the current message output.

In information technology, an application (app), application program or application software is a computer program designed to help people perform an activity. Depending on the activity for which it was designed, an application can manipulate text, numbers, audio, graphics and a combination of these elements (https://en.wikipedia.org/wiki/Application_software). In Creators Studio, three kinds of App Projects can be created. Basically, each application is a node on the graph table, but it varies visually and in purpose.

Use the application type of apps to operate a device or a distinct process. The user can create an application type project from Creators Studio by clicking New Project, choose App Project type and Application App type. Alternatively, the user can create an application type project from a device menu in the Smart Infrastructure service: This app's node has teal coloring and corresponding subtitle on the graph table (FIG. 127). The user can open the app in its user interface by clicking OPEN APP above the top-right corner.

Examples of application type apps or application nodes include: an application node that defines a machine tool behavior when carving an item; an application for an additional controller in a coffee machine to control coffee grinding; and an application for a robot-cleaner to define an everyday cleaning process.

An automation app allows a device or a system to react in different situations (different incoming data) with particular responses. The user can create a project for an automation app from the Creators Studio interface and from within every service, e.g. Smart Infrastructure:

Within Smart Infrastructure, select an infrastructure among All Infrastructure, and click the AUTOMATION button. The user will see the automation apps and the add NEW AUTOMATION NODE button. Then choose from: make it the the userrself, choose from existing, buy on Marketplace, or make a request for such app options.

The user may open the app in its user interface by clicking OPEN APP above the top-right corner. A new window will appear (FIG. 128). An automation app may have some user interface—to show data or to interfere in a process manually—but the user wouldn't be able to use this UI with other processes. For this purpose, use the Dashboard type app.

Examples of use of automation apps include: creating a task in the Project Management service when a robot can't finish the work; parsing an email if the topic contains a particular word; and a chat-bot that gives responses depending on requests.

The dashboard app does not define any work or automation but reflects their state in UI widgets. The user can easily reuse a dashboard for different processes and data flows. The user can create a project for a dashboard app from Creators Studio interface and from within every service, e.g. Smart Infrastructure. For example, go to Smart Infrastructure, select an infrastructure among All Infrastructure, and click the add CREATE DASHBOARD APP button (1) (FIG. 129). This is the place for the userr future dashboard app. Then choose: make it the userrself, choose from existing, buy on Marketplace, or make a request for such app.

The user can open the app (UI) in its user interface by clicking OPEN APP above the top-right corner. Examples of uses of dashboard apps include: robots' real-time statuses; energy consumption levels in some working facilities; and working station load level over time.

Note that the user can add a dashboard app only to dashboards, an automation app only to automation. If the user makes an application type application with UI, the user go to a graph table of core service, find the app's node, and open the UI from there.

So, if an application that manages a device needs some UI controls, the user may desire to make a dashboard type and connect it with the device's application.

Flow is a graphical representation of an app's functional logic. A flow begins with some message that incomes (or it may be produced inside the flow), then some logic that processes it and gives some result message (or shows it in user interface charts, for example). Alternatively stated, a flow is a set of connected components (FIG. 125).

Tabs in the Application Builder editor called Flow are employed as well. Each tab may carry a flow (set of connected components) or, maybe, several flows. But for a clearer view, usually, it's better to divide flows by tabs (which are called Flows for that reason). Double-click a Flow tab to add its name and description.

The user can make the flow more readable if the user organizes components vertically, horizontally, by groups (FIG. 130). The user may add a comment component onto the Workplace to make a piece of flow clearer. Double-click the comment component to add a name and description. The user may connect flows between tabs with the link in and link out components from the palette (FIG. 131). The user may compose some logic in one tab and wire it through these components to multiple other tabs.

Another way to make a reusable part of logic is to create a subflow (FIG. 132). The user does the same: compose a piece of logic in a separate tab, but connects it not with links in and out, but simply creating a new “component” of it. Open Menu (1), choose Create Subflow in Subflows (2). A new Subflow tab will appear (3). Here the user can compose that piece of logic that the user wants to use as a subflow. It will be available as a component on the palette—in the subflows category (4). Double-click a Subflow tab (3) to change its name and description. The user can add inputs and outputs for the userr subflow at the top of its tab.

Another way to create a subflow: choose a piece of logic and click Selection to Subflow in the Subflows menu (2). A new subflow will replace this part of the flow.

The following are examples of different components available to the user for creating processes and components within creator studio. These components are ready for use from the box (in the platform), but the user can also install other components obtained from Marketplace service. Most components have descriptions and Help information—click on a component and explore the right sidebar. A component's usual properties are described in the Set Up Properties chapter. Specific properties are described here by categories.

Common Components:

The inject component allows the user to inject a message into a flow. The user may inject it in the middle of the flow or initiate a new flow with this component. The user can specify time or time spans for repeating messages. The inject component is useful for repeated tasks: backups initiation, dashboard info updating, etc. and for starting time setting up. For example, the user may want lights to turn off at 9 am. It is also useful to imitate some input to test a flow.

Properties: Most components have common properties. However, the inject component has some specific properties (FIG. 133):

msg.payload (1)—the main part of a message object that the component sends. Exists nearly in any component (as well as msg.topic) by default. Usually bears the main information in the message object.

msg.topic (2)—the part of the message object.

add (3)—this button allows the user to add more parameters to the message object. Click add, give it a name and value. For example, ‘msg.password’ with ‘QWERTY’ value.

A message object property msg.payload value (4)—by default, this is timestamp—the number of seconds from a particular moment in 1970 till now. Click an arrow and choose a needed data type, then set a value to the parameter.

A message object property msg.topic value (5)—by default is empty, but it's useful sometimes to name the userr message object, especially when the user have more than one.

Inject once after checkbox (6)—allows the user to postpone the first message sending.

Repeat option (6)—allows the user to choose intervals of message sending, including the None option.

The debug component allows the user to understand what exactly happens at any step of the flow. Say the user is composing an app that allows an operator to update some information in a database by clicking a button on a tablet after some event happens: “Hit the button when a basket is full.” The user composes an app but needs to check whether the message that goes to a file is correct before releasing the application. Add a debug component to a certain place at the flow, deploy, and examine the debug window's result. For example, we use a user interface previewer (UI Viewer—right click on the { } . . . .json file) to press a button that sends the message to the function component. Using the debug component, we see the result message of the function component.

Properties (FIG. 134): The user may choose (1) whether to show the complete message object (with all properties) or just the main property—payload (default).

For example, first we use msg.payload to be shown, second—complete message object. In the complete message object, we see all the message properties (_msgrid id, payload, and topic). Clicking the arrow to expand the message object.

Another debug property shows the result in the status under the component (2).

The complete component monitors other components' tasks completion and passes their output to a triggered component. Useful for components without output sockets—such as http response or even debug component.

Properties (FIG. 135): The component's properties are different ways to choose the flow components to monitor. The user can Select nodes (components) (1) right in the flow tab, seek by name (2), or choose from the list (3); give names to components in the flow—the user will find them easily in complete component properties. The complete component sends each monitored component's output without changes in turn.

The catch component catches exceptions in a flow.

Properties (FIG. 136): There are two modes for this component (1): all nodes, when the catch component monitors all the components in the flow for errors, and the user can choose to Ignore errors handled by other Catch nodes (components); and selected nodes when it monitors selected ones. In this second mode, the selection options are the same as in a complete component.

When the component catches an error it stores the relevant information to a message object in the form of attached attributes: error.message—the error message; error.source.id—the id of the component that threw the error; error.source.type—the type of the component that threw the error; error.source.name—the name, if set, of the node that threw the error. If the user chooses the complete msg object output option in the wired debug component, the user will see these attributes in the debug tab. If we choose the msg.payload output option, we will see an error message.

The status component reports status messages from other components.

Properties (FIG. 137): There are two sources for this component reports: all nodes and selected nodes. In this second mode, the selection options are the same as in a complete component.

When the component status info it stores the report to a message object in the form of attached attributes: status.text—the status text; status.source.type—the type of the node that reported status; status.source.id—the id of the node that reported status; status.source.name—the name, if set, of the node that reported status.

If the user choose the complete msg object output option in the wired debug component, the user will sees these attributes in the debug tab.

The link in and link out components allow the user to divide the flow into two or more flow tabs. Just connect a link out component with a link in on another flow tab, and it will be considered one flow.

The comments component carries an inscription and does not connect to other components. Use it to add some information for developers to a flow appearance.

Function Components:

The user used the function component when the user can't find another one with the needed function. The user can write this function to the function component.

<Change>

The change component provides changing a message.

Properties: The user can change the payload value or topic in four ways. 1. Set—set a value to a message payload or topic just by setting a new one. The user can see that the first debug component shows the payload value ‘1’, when the second one that goes after the change component shows ‘2’. 2. Change—change a message due to a specific condition. 3. Delete—delete a message or a part (a parameter) of the message object. 4. Move—move a value to a new message property, removing the previous one at the same time. (Note: to show explicitly how we moved the value ‘Start’ from ‘topic’ to a new property ‘name’, we changed the output method in the debug components).

The function-switch component builds different paths due to conditions.

For example, we imitate two kinds of messages from a sensor—‘1’ and ‘23’. Using the change components, we set ‘Ok’ to the payload after the message ‘1’, and ‘Alarm!’ after the message ‘23’. Imagine that it's Ok when the sensor sends ‘1’. For any other number, we have to send an ‘Alarm!’ message. The switch component may take a message and send it to a route depending on different conditions. In our example—if ‘1’ then to the ‘Ok’ route, if ‘not 1’- to the ‘Alarm!’ one.

Properties (FIG. 138): Many condition options in the component properties allow specifying conditions for a message's further path. Each condition will make a new connection port on the component in turn.

The range component maps the payload number due to properties set up. If the payload is not numeric, the component tries to convert it—for example, string type ‘1’ to numeric type ‘1’.

Properties (FIG. 139): Choose the msg Property to scale (1).(by default, ifs msg.payload); Choose Action—the type of mapping (2); Scale the message property—the number will be scaled due to input and target range ratio (for example, if the target range is ×10 to the input range so the payload number will change to ×10. ‘5’ becomes ‘50’ etc.; Scale and limit to target range—the number scales the same way, but the result will be in the target range. E. g. ‘12’ becomes ‘120’, but the result will be ‘100’ due to the range maximum; Scale and wrap within the target range—the result will be wrapped within the target range. So ‘12’ becomes ‘120’, but only ‘20’ is wrapped within the target range; Specify the input range (3); Specify the target range (4); the user can round the result to the nearest integer (5).

The component can be used for percent converting, for example. Just choose the target range 0 to 100 and Scale the message property action type.

The template component sets the payload by embedding input values to a template. It is useful for composing messages, emails, HTML pages, etc.

Properties (FIG. 140): Choose the message context (from the component, the flow, or the global context variable) and the message object Property (1) to extract the data from; In the Template field (2), specify the template for the output message (By default, it proposes the user to use a simple expression with dynamic adding of the payload value. E.g., if the user write Hello, {{payload}}! and send Bob payload to the component, the result will be Hello, Bob!. Double curly braces are the Mustache syntax for taking a corresponding variable. The template field also takes other valid syntax and allows the user to Highlight the Syntax); Choose Format (3)—if the user choose Plain text, the output message will ignore template syntax; Choose the Output format (4)—the user may use the template for generating JSON or YAML content.

The delay component delays each message passing through the node or limits the rate at which they can pass.

Properties: There are two modes (Action types) for the component's properties. The first mode (FIG. 141) is Delay each message (1). Allows to set up a delay span for each message that comes through. For example, to avoid flooding the userr email or a dashboard with messages. The user can set a Fixed delay interval, a Random one between some numbers, or use the msg.delay of each message (2). Set up the delay interval for each message (3).

The second mode (FIG. 142) is Rate Limit mode (4). In this mode the component limits the number of messages that come through at an interval. Choose to rate the limit for All messages or For each msg.topic (5). For this second option, the user can choose to release the most recent message for all topics or release the most recent message for the next topic. Set up the Rate (6). The user can optionally discard intermediate messages as they arrive (7).

The trigger component sends a message when triggered and then sends the second one on some conditions.

Properties (FIG. 143): Choose a message value to Send (1). By default, it's a string type ‘1’. If the user want it to send a message that arrived as a trigger, choose the existing msg object. There are three modes for the component behavior after the first message sent (2): wait for—the mode when the user specify the time span (3) for the next message (5) release; wait to be reset—when triggered, the component sends a message and blocks all subsequent ones before receives a reset (7) command. Then sends the message again and so on; resend it every—when triggered, the component resends the same message in specified intervals (3).

In the wait for mode, the user can choose to extend the delay if a new message arrives (4). E.g., the trigger node will ‘stay calm’ until it receives signals, and it sends an ‘alarm’ when signals vanish—as it works in watchdog devices. The interval may be set up by an incoming msg.delay (4).

Specify a second message (5). The user may choose to send the second message to a separate output (6). There are two types of the reset command (7): incoming msg.reset with any value, or the user can define the msg.payload value that resets the trigger component. Choose whether it handles all messages or each one (8).

The exec component allows the user to execute system commands or scripts and take their outputs. For example, the user can run a copy command (for Windows) to copy a file to another directory.

Properties (FIG. 144): Enter a system Command (1). The user may use the msg.payload as the command parameters (2); otherwise, the user can write them in extra input parameters (3). The user can also use extra input parameters (3) to add some flags (extra parameters) to the command.

Choose the Output mode (4). In the exec mode, the user can see the output after the command is completed; in the spawn mode, the user will see the results line by line as the command runs. Set up Timeutout to limit a command execution time (5).

The exec component has 3 outputs: for a payload (the result of a command execution), for an error information if any, and for execution code (0 for success and any other for failure).

The rbe component is a reports by exception (rbe) component and passes on data only if the payload changes. For example, the user send to a motor the command “on”, and the rbe component will block all following “on's” but will pass the “off” command.

Properties (FIG. 145): Choose the blocking Mode (1)—there are several of them. The additional blocking properties will appear if the user choose other modes.Choose the Property (2) of the message object that the component passes (and blocks). By default, its payload.

Dashboard Components:

This is the category of components for a user interface. Main common appearance properties are described for the button component (and UI element), so explore it first.

The button component creates a user interface button so that a human will be able to send a command to the system. For example: open the door, stop working immediately, turn on the light, reset all the tasks, etc.

Properties (FIG. 146): On a UI the user can group the elements—by using Groups (1) and Tabs. Choose the size of the button on UI (2). To add an Icon (3) to the button appearance the user may use, for example, the Font Awesome library. Type fa- and an icon name from the site (try fa-fire). Or Angular Material Icons library—type mi- and an icon name (e.g. mi-work). Label the button (4) to show its function to a user. For example, ‘Empty Bin’.

Specify the tip (5) that will appear when a user hovers the button with a mouse cursor. Change the default color (6) of button text and icon (FIG. 147). The user may simply type a color name (‘blue’, ‘yellow’, etc.) or use hex-color codes (from Color Hex Color Codes, for example). Change the background color (7) with a hex color code, or the user can simply type a color name (‘blue’, ‘yellow’, etc.)

Specify the payload of the message object (8) and its topic (9). The user can make the button get pressed each time when the component receives a message (10)—and the user won't need to use UI to test its work. Give a name to the component (11). This name will appear on the workspace, but on the UI the button will show the Label (4) name.

The dropdown component creates a UI element with a dropdown list. Multiple options can be added.

Properties (FIG. 148): The Placeholder (1) is an inscription on the field, that a user clicks to expand the list of options. By default, it's Select option. Options (2)—the list of labels from which a user chooses. The chosen label carries a message payload value. For example, the user chooses ‘Use 1 robot’ and the component sens the value ‘1’.

The user can add as many options as the user need (3) (FIG. 149). The user can allow choosing multiple options (4). There is a possibility (5) to pass a message from input to output without changes.

The dashboard switch component creates a UI element, that allows a user to switch between two modes. For example, ‘Turn On’ and ‘Turn Off’.

Parameters (FIG. 150): Although the component makes a UI switcher for manual switches, the user can set up switching through the appropriate incoming payload (1). For example, if the component receives the payload value numeric ‘1’ and it equals the On Payload setting (2), so the component will pass the message ‘1’ and the user'll see ‘On’ mode on the UI. The user may set payload values for ‘On’ and “Off’ modes (2). By default, it's boolean true and false correspondingly.

The text input component creates a UI field for a user's text input.

Properties (FIG. 151): Add a Tooltip (1) that pops up when the user hover above. Choose the input Mode (2)—and it will color in red if it is not a valid address and will return undefined. Choose the Delay in milliseconds—the time delay before sending the output. If the user set 0, it will be sent after the user hits Enter or Tab. The user may preset the component to pass the message through to the output with no typing by the user.

The color picker component allows the user to pick colors.

Properties (FIG. 152): Choose the output color Format (1)—hex (in string) by default. The color picker widget can be square and round shape (2). Choose to display or not the hue (3) and lightness (4) sliders.

The color picker widget has elements that appear only on hover (FIG. 153). But if the widget will be large enough the user can choose to always show the swatch (5), the picker (6), and the value field (7). The component can Send (9) the output each time when the user click the picker, choose the color in the color field, and close the field by clicking the picker. Or it can sand the outputs many times while the user are clicking the colors on the color field. The user can choose to send the Payload value (10) as a string or an object.

The text component displays a non-editable text UI field.

Properties (FIG. 154): Specify the Value format (1)—what property of a message object to show in the text field. It must be in double curly braces. For example, {{msg.topic}} or {{msg.payload.facility}}. By default ifs {{msg.payload}}. Choose Lathe usert for the field (2).

The gauge component creates a gauge UI element that shows the numeric payload values.

Properties (FIG. 155): Choose the UI representation Type (1)—Gauge, Donut, Compass, or Level. Specify the Value representation format (2)—by default, it's just a number. See more in Help on the sidebar. By default, the numbers will be market as units, but the user can specify it (3)—for example, as kg or mins. Establish the Range of numbers' representation (4). Choose the colors (5) of gradient changes when numbers go from a lower to a higher level. Also, the user can set scopes for colors (6)—for example, to signalize about some system state.

The chart component plots the input numeric values on a UI chart. If the message payload is not numeric the component tries to convert it (for example, string type ‘1’ to numeric type ‘1’), and if it fails, the message is ignored.

Properties: Choose the Type of UI representation (1) (FIG. 156). To emphasize points on the chart—enlarge points (2). Specify the length of the X-axis (3)—in time units or points. Choose the X-axis Label format (4). The user can set up the scope of the numbers on the Y-axis (5). If the user didn't, the chart will be adjusted automatically.

If the user chooses to show Legend (6) the topics of all messages will appear above the chart (FIG. 157). For example, the user have two sources of data, and the user want to see them both on the chart. To do this the user have to specify msg.topic for each of them. Then choose Show Legend (6) and the user will see which color a source got on the chart. The Interpolate option (7) specifies which type of connections (lines) will be on the chart. The user can choose the color of lines (or bars) on the chart (8). The chart component will use them in turn: the first color for the first source (topic) and so on. The user may place some text on the chart to be there before the data arrives (9).

In certain embodiments of the present invention, the user can access various other platform components useful for core service integration.

For example, the graph output component to allow the user to make application node output ports on the graph table. Open the aitheon category on the palette and drug graph output component (1) to the flow tab (2). In this particular example shown in FIG. 158, a simple application sends a command to an item after a user hits a tablet.

The button component (described herein) adds a button to the app. The function component (described herein) describes a command for an item when the button is being pressed. The graph output component defines how to send this command to the item.

Properties: When double-clicking on the graph output component at the flow tab, the properties window appears (FIG. 159). Here the user can give the component a Name (1). Select a proper Socket Group (2) and a Socket (3) that corresponds to an item's node input (or another node that the user is going to wire with).

The user next connects the flow components, click Deploy, and after making a release, the user can add the application node to the graph table and build a process (FIG. 160).

The graph input component allows making an input point on the application node (FIG. 161). Drag the graph input component (1) onto the flow tab table (2) to make an input point for the application node (FIG. 162). Set parameters as in graph output, and after release, the user will see an input port on the application node.

Various custom components of the inventive platform are described below.

The Aitheon app editor component is a flow-based visual programming tool in Creators Studio. Allows a user to create and edit applications for Aitheon Platform even without deep programming knowledge.

An application is a computer program that provides a user with needed functionality. There are three types of applications employed in the inventive platform that a user can create in Creators Studio (described herein).

Broadly speaking, a component is distinct part of programming logic that performs some function in an Apps Editor project flow. E.g. http in that takes a message from a particular http, or chart that creates a UI chart widget. Components are placed on Apps Editor's palette and divided by categories. One can use standard components, create a custom component, purchase needed components on Marketplace. Creating an application in Apps Editor is building visual flows with components.

Applications and components can be purchased or sold on Aitheon Marketplace. A released application or a component has to be published so that other users (from other organizations) could buy it.

A node is representations of any application program on the core service. Since Core is a visual automation tool (as Apps Editor is a visual programming tool), a user can operate nodes (apps) on Core visually moving and connecting them.

A release is a ready-to-use version of an application or component after the development stage. A developer may edit an app in the Creators Studio project, but a user can use the update after the developer makes a release. In Creators Studio there are two options for releases: common Release and Quick Release. In Quick Release the name and version number of the app release are made automatically.

A runtime is an execution environment of an app. When creating an app project one should choose the runtime environment properly: apps for devices usually run on the device's controllers (AOS runtime), automation, or dashboard apps usually run on a cloud (AOS Cloud).

For a one-time purpose, the user may want to use the function component and combinations of other core components in the Apps Editor. If the user are familiar with JavaScript follow this tutorial to create a new component for the Applications Editor.

When creating a new component app project the user get three basic files in its folder: config.json—a configuration file; component.js—a component logic file; and component.html—a component appearance settings file. Plus the Apps Editor will add: app-component.json—a file that allows the user to test the user component before releasing it. If the project contains more than one component it should have a separate folder for each of them.

FIG. 163 shows a folder of a new components project: toupper. It contains the src subfolder. There are config.json and app-component.json files in it, plus the next subfolder: components. We have two components in this project so we have subfolders for each of them (the user can use the same folder for all components files in the project if the user want). On that level, there are component.html and component.js files.

In each component's folder, there is a folder for an icon file. The user don't need separate component folders if the user has only one in the project. And the user may have no need in the icon folder and file if the user use Font Awesome pics (see New Component Style Guide).

Follow these general principles to provide convenience and clearness. Make components:

purpose focused—It's better to create several components with clear properties for specific tasks than one general multitask component with confusing options;

simple to use—Provide clear naming, sufficient help explanations, avoid complexity;

prepared—The component must adequately handle all types of message properties data—boolean, number, string, buffer, object, array, or null;

predictable—Document and make the component to provide documented doings with message properties—the result must comply with the promises;

controlled—The component must catch errors or register error handlers for any asynchronous calls it makes, wherever possible.

config.json:

With reference to FIGS. 164 and 165, each component is wrapped as a Node.js module and this file describes a Node.js module's content. List all the components in the project to the components array of objects. In this instance, we have two components. One of them has UI—and a .vue file in the ui folder.

component.js:

The file shown in FIG. 166 describes the function that the Node.js module exports. So, this is a file that sets the component's runtime behavior (functionality). The function is called with an APPS argument that gives the module access to the Apps Editor's runtime API. The component itself is set up by the function ToUpperComponent that calls the APPS.nodes.createNode function to initialize the features shared by all components. After that, the component-specific code lives.

In this example, the component registers the listener to the ‘input’ event (on( )) that rises each time a message arrives. And within the listener, it changes the message payload to uppercase: toUpperCase( ), then passes the message on in the flow with the send function. Then the ToUpperComponent function is registered with the runtime using the name “example-uppercase”. If the component has any external module dependencies, include them in the dependencies section of the config.json file.

Error Handling

With reference to FIG. 167, if the component gets an error during execution it should send the details to the done function. This will allow a user to spectate errors with a catch component and build flow to handle the error.

Sending Messages

If the component is for the start of a flow and reacts to an external event, it should use the send function on the Node object (FIG. 168A).

If the component responds to an input message, it should use the send function from inside the listener function (FIG. 168B).

If msg is null, no message is sent.

If the component responds to an input message, the output one should reuse the received msg rather than create a new message object to ensure the existing msg properties to be reserved for the rest of the flow.

Multiple Outputs

The user may pass an array of messages to send, and each message will be sent to a corresponding output (FIG. 169A). Make sure that the user described all inputs and outlets in the component.html file.

Multiple Messages

The component may send multiple messages through a particular output. To do that, pass the array of massages within the array (FIG. 169B).

Closing the Component

The user can register a listener on the close event to perform the component state reset—in such situations as, for example, disconnection from an external system (FIG. 169C).

If the component needs to do any asynchronous work to complete the reset, the registered listener should accept an argument which is a function to be called when all the work is complete (FIG. 169D).

If the registered listener accepts two arguments, the first will be a boolean flag that indicates whether the component is being closed because it has been fully removed, or that it is just being restarted. It will also be set to true if the component has been disabled (FIG. 170A).

Timeout Behavior

The runtime waits for 15 secs a done function to be called. If it takes longer, the runtime timeouts the component, logs an error, and continues to operate.

Logging Events

The following function allows logging something to the console (FIG. 170B). The warn and error messages also will be available in the debug tub of Apps Editor.

Component Context

A component can store data within its context object. There are three scopes of context available to a component: Node—only visible to the node that set the value; Flow—visible to all nodes on the same flow (or tab in the editor); Global —visible to all nodes. Unlike the Function component which provides predefined variables to access each of these contexts, a custom component must access these contexts for itself (FIG. 171A). Each of these context objects has the same get/set functions described in the Writing Functions guide.

Components Workspace Status

A component may have a status mark on the workspace. This is done by calling a status function (FIG. 171B). A status object consists of three properties: fill, shape, and text. The first two define the appearance of the status icon and the third is an optional short piece of text (under <20 characters) to display alongside the icon. The shape property can be ring or dot. The fill property can be: red, green, yellow, blue, or grey. This allows for the icons shown in FIG. 171C to be used. If the status object is an empty object, { }, then the status entry is cleared from the component.

Custom Component Settings

A component may want to expose configuration options in a user's settings.js file. The name of any setting must follow the following requirements: the name must be prefixed with the corresponding component type; the setting must use camel-case—see below for more information; and the component must not require the user to have set it—it should have a sensible default. For example, if the component type sample-component wanted to expose a setting called color, the setting name should be sampleComponentColour.

Within the runtime, the component can then reference the setting as RED.setting.sampleComponentColour.

Exposing Settings to the Editor

In some circumstances, a component may want to expose the value of the setting to the editor. If so, the component must register the setting as part of its call to registerType (FIG. 172): value specifies the default value the setting should take; and exportable tells the runtime to make the setting available to the editor.

As with the runtime, the component can then reference the setting as RED.settings.sampleComponentColour within the editor.

If a component attempts to register a setting that does not meet the naming requirements an error will be logged.

component.html:

This file is laying out the component's appearance in the Apps Editor: main component's properties definitions; properties edit dialog; and help text for the help tab.

Each part wrapped in distinct <script> tags (FIG. 173).

Main Definitions

Placed within JS script tag. A component must be registered with the editor by the APPS.nodes.registerType( ) function that takes two arguments: the type of component and its definitions object (FIG. 174A).

Component Type

The component type is used to identify the component in the editor. It must be equal to the APPS.nodes.registerType call value in the corresponding .js file.

Component Properties

A component's properties are listed in the default object. In the new component template, it's only name, but the user can add as many as the user need (FIG. 174B). Each entry includes a default value to be used when a component is dragged onto the workspace.

After adding the property to the defaults list, add a corresponding entry to the edit dialog <script> (FIG. 174C). It should contain an <input> element with node-input-<propertyname> in id.

The editor uses this template when the edit dialog is opened. It looks for an <input> element with an id set to node-input-<propertyname>, (or node-config-input-<propertyname> for the Configuration components). This input is then automatically populated with the current value of the property. When the edit dialog is closed, the property takes whatever value is in the input.

See more in Properties Edit Dialog.

To use this property edit the component.js function (FIG. 175A). See component.js description.

Property Definitions

The entries of the default object must be objects and can have these attributes: value: (any type) the default value the property takes; required: (boolean) optional whether the property is required. If set to true, the property will be invalid if its value is null or an empty string; validate: (function) optional a function that can be used to validate the value of the property; type: (string) optional if this property is a pointer to a configuration node, this identifies the type of the component.

Property Names

There are reserved property names that are not available to use: single characters—x, y, z, and so on; id, type, wires, inputs, outputs. The user can add outputs to the default object to configure multiple outputs of the component.

Property Validation

Editor attempts to validate a property with the required attribute—the property must be non-blank and non-null. For more specific validation the validate function is used. It is called within the context of the component which means this can be used to access other properties of the component. This allows the validation to depend on other property values. While editing a component the this object reflects the current configuration of the component and not the current form element value. The validate function should try to access the property configuration element and take the this object as a fallback to achieve the right user experience.

Ready-to-use validator functions: APPS.validators.number( )—check the value is a number; APPS.validators.regex(re)—check the value matches the provided regular expression. In this instance custom property is only valid if its length is greater than the current value of the minimumLength property or the value of the minimumLength form element (FIG. 175B). If a property doesn't pass the validation check (by required or validate methods both) the red highlighting of the input field will appear.

Component Definition

It's an object with all properties the editor needs, including defaults.

category: (string) the palette category the component appears in. Notice, it's better to create a specific category for new projects, than using an existing one.

defaults: (object) the editable properties for the component.

credentials: (object) the credential properties for the component.

inputs: (number) how many inputs the component has, either 0 or 1.

outputs: (number) how many outputs the component has. Can be 0 or more.

color: (string) the background color to use.

paletteLabel: (string|function) the label to use in the palette.

label: (string|function) the label to use in the workspace.

labelStyle: (string|function) the style to apply to the label.

inputLabels: (string|function) optional label to add on hover to the input port of a component.

outputLabels: (string|function) optional labels to add on hover to the output ports of a component.

icon: (string) the icon to use.

align: (string) the alignment of the icon and label.

button: (object) adds a button to the edge of the component.

onpaletteadd: (function) called when the component type is added to the palette.

onpaletteremove: (function) called when the component type is removed from the palette.

Custom Edit Behavior

Sometimes there is a need to define some specific behavior for a component. For example, if a property cannot be properly edited as a simple <input> or <select>, or if the edit dialog content itself needs to have certain behaviors based on what options are selected.

A component definition can include two functions to customize the edit behavior.

oneditprepare: (function) called when the edit dialog is being built.

oneditsave: (function) called when the edit dialog is okayed.

oneditcancel: (function) called when the edit dialog is canceled.

oneditdelete: (function) called when the delete button in a configuration component's edit dialog is pressed.

oneditresize: (function) called when the edit dialog is resized.

For example, when the Inject component is configured to repeat, it stores the configuration as a cron-like string: 1, 2 * * * . The component defines an oneditprepare function that can parse that string and present a more user-friendly UI. It also has an oneditsave function that compiles the options chosen by the user back into the corresponding cron string.

Component Credentials

A component may define a number of credential properties that are stored separately to the main flow file and are not included in the flow export from the editor.

The entries take a single option—text or password (FIG. 176A).

In the edit template <script> regular conventions for id are used (FIG. 176B).:

To use the credentials the component.js function must be updated too (FIG. 176C):

Runtime Use of Credentials

Within the runtime, a component can access its credentials using the credentials property (FIG. 177A).

Credentials within the Editor

Within the Apps Editor, a component has restricted access to its credentials. Any that are of type text are available under the credentials property—just as they are in the runtime. But credentials of type password are not available. Instead, a corresponding boolean property called has_<property-name> is present to indicate whether the credential has a non-blank value assigned to it (FIG. 177B).

Advanced Credential Use

Whilst the credential system outlined above is sufficient for most cases, in some circumstances it is necessary to store more values in credentials than just those that get provided by the user.

For example, for a component to support an OAuth workflow, it must retain server-assigned tokens that the user never sees. The Twitter component provides a good example of how this can be achieved.

Properties Edit Dialog

In this dialog, a user can configure the component's behavior. The properties available in the edit dialog are described in this section. The <script> tag must have a text/html type to prevent the browser from treating it like common HTML and to provide appropriate syntax highlighting in the editor (FIG. 177C).

The tag's data-template-name should be set to the component's type otherwise the editor won't be able to show appropriate content in the edit dialog. The edit dialog should be intuitive and consistent with other components. For example, among all components' properties should be a Name field.

The edit dialog consists of a number of rows, each has its label and input.

Each row described in a <div> tag with a form-row class.

A row usually has a <label> (name of an editable component property) that contains an icon defined in <i> tag with class took from Font Awesome.

The form element containing the property must have an id of node-input-<propertyname>. In the case of Configuration nodes, the id must be node-config-input-<property-name>.

The <input> type can be either text for string/number properties or checkbox for boolean properties. Alternatively, a <select> element can be used if there is a restricted set of choices.

Buttons

To add a button to the edit dialogue use the <button> HTML tag with settings-ui-button class.

Plain Button

(figure)

Small Button

(figure)

To toggle the selected class on the active button, the user will need to add code to the oneditprepare function to handle the events.

Note: avoid whitespace between the <button> elements as the button-group span does not currently collapse whitespace properly. This will be addressed in the future.

(figure)

oneditprepare

Inputs

Plain HTML Input

(figure)

Is done with <input> tag.

(figure)

TypedInput

String/Number/Boolean

HTML:

(figure)

oneditprepare definition:

(figure)

When the TypedInput can be set to multiple types, an extra component property is required to store information about the type. This is added to the edit dialog as a hidden <input>.

TypedInput JSON

(figure)

HTML:

(figure)

oneditprepare definition:

(figures)

TypedInput msg/flow/global

(figures)

HTML:

(figures)

oneditprepare definition:

(figure)

Multi-line Text Editor

A component may contain a multi-line text editor with syntax highlighting and errors check based on Ace web code editor.

(figure)

Hover the error mark to see the error description.

In the following example, the component property that we will edit is called exampleText.

In the userr HTML, add a <div> placeholder for the editor. This must have the node-text-editor CSS class. The user will also need to set a height on the element.

(figure)

In the component's oneditprepare function, the text editor is initialized using the APPS.editor.createEditor function:

(figure)

The oneditsave and oneditcancel functions are also needed to get the value back from the editor when the dialog is closed and ensure the editor is properly removed from the page.

(figure)

Help Text

When a user selects a component help information appears in the Apps Editor help tab.

It should contain concise info about what the component does, what properties of input and output messages are available to set up.

(figure)

Structure

The information in the help tab should be structured and formatted for convenient use.

(figure)

The first (1) section is for general component description. It should be no more than 2 or 3<p> tags long. The first <p> will pop up as a tooltip when a user hovers over the component in the palette.

If a component has input, in the (2) section should be a description of its' properties and their expected types. Keep it short, if more information is needed—put it in the Details.

If the component has an output put the information about its' properties in the third (3) section. It can be multiple outputs' descriptions if needed.

The showed instance was made by this part of the HTML file:

(figure)

The user can add details and references if needed:

(figure)

The Details section (4) provides more specific information about inputs and outputs and everything a user needs to know and that can be contained in this short form.

If much larger explanations are needed, place links to them in the References section (5).

The part of HTML used for this:

(figure)

Section Headers

Use <h3> header marks for each section and <h4> for subsections.

(figure)

Message Properties

The <dl> list of properties must have the message-properties class attribute. Each property in the list must consist of the <dt> and <dd> tag pairs.

Each <dt> must contain the property name and, optionally, <span class=“property-type”> with the expected type of the property. If the property is optional, it should have the optional class attribute.

Each <dd> is a description of the property.

(figure)

If the user describe a property outside the list of properties (in Details, for example), make sure the user prefixed it with msg. and wrapped it in <code> tags.

(figure)

Multiple Outputs

For a single output, it's enough of the <dl> list.

But multiple outputs will consist of <ol> list of <dl> lists. The <ol> list must have the node-ports class attribute.

Each output (aka <dl> list) must be wrapped in <li> tags with its short description.

(figure)

General Approach

No other styling tags (e.g. <b>, <i>) should be used within the help text.

The help text should be useful for a non-experienced user. Remember that Apps Editor is made for codeless experience in the first place.

app-component.json

By default, an app-component.json file is added to each project. This file opens a flow to test the user's new component before the release.

This file already embraces all the project files—component.html, component.js, and config.json. When the user is done with some editions in these files, open app-component.json, Apply Changes (to apply changes in the project files), build a flow, hit Deploy (to apply changes in the flow), and test the component's appearance and behavior.

(figure)

The user should remove and drag a component that the user changed on the workspace again after hitting the Apply Changes button—otherwise, the component will remain obsolete.

Deploying will not save the flow for future work with the project. To save the flow in app-component.json click Apply Changes, even if the user didn't change the project files and just played with the flow after the last saving.

Vue.js for UI Components Creation

Vue.js is a JavaScript framework that is very convenient for UI components creation in Aitheon Apps Editor.

The editor uses the v2 version of the framework. Discover the native Vue.js tutorial before we go through the sample component content.

Sample Specifics

The sample UI component creates a simple button, that passes on a string type message (The standard button doesn't do this—it works differently).

The sample project, which the user can use as a template, contains two components folders: example-button (a UI component sample) and example-uppercase.

The difference in a UI component example—two files that provide the UI element appearance and visual behavior rules: the example-button folder contains a ui sub-folder with an ExampleButton.vue file and a helpers.js file.

(figure)

The rest of the files—.html and .js—and icons subfolder are the same as in the example-uppercase instance.

helpers.js

This is a file with some modules that are used in the ExampleButton.vue file. One of them—JSONProp—is an object for the input string. Second—parseJSON—is a function that converts a JSON object to JS object.

ExampleButton.vue

The file with the Vue.js framework content. It is built in the one-file style —see ExampleButton.vue overview lower here.

This file defines the appearance behavior of the button.

example-button.js

The file contains a specific part for the UI component. (Explore the part after a corresponding note there: ‘// call this only for UI Component’).

ExampleButton.vue overview

The Vue.js framework lets the user group the userr <template>, corresponding <script>, and CSS <style> all together in a single file ending in .vue.

In a template for a UI element component the ExampleButton.vue file follows the one-file style.

The user can still separate JavaScript and CSS into separate files if the user want, and import them to a .vue like this: <script src=“./my-component.js”></script> and <style src=“./my-component.css”></style>.

<template>

Contains all the markup structure and display logic of the userr component. The userr template can contain any valid HTML, as well as some Vue-specific syntax.

By setting the lang attribute on the <template> tag, the user can use Pug template syntax instead of standard HTML—<template lang=“pug”>.

In the instance two Vue.js directives are used: v-if—conditional rendering (see the v-if documentation), and v-on—event handling (see the v-on documentation).

(figure)

v-if directive renders the block if config returns ‘true’.

v-on directive calls the widgetChangeHandler method when a click happens. (See the <script> block).

Styles for the widget are defined lower in the <style> block of this file.

<script>

Contains all of the non-display logic of the userr component. Most importantly, the userr <script> tag needs to have a default exported JS object. This object is where the user locally register components, define component inputs (props), handle local state, define methods, and more. The userr build step will process this object and transform it (with the userr template) into a Vue component with a render( ) function.

If the user want to use TypeScript syntax, the user need to set the lang attribute on the <script> tag to signify to the compiler that the user’re using TypeScript—<script lang=“ts”>.

In the instance here defined data, methods, watchers, and props (inputs).

(figure)

import

The first part of this block is the import of two objects from the helpers.js module (1).

from ‘./helpers’ will look for a file called helpers.js in the same directory as the file the user are requesting the import from. There is no need to add the .js extension. Moreover, when the module file is in the same directory, the user can even use the form from ‘helpers’.

export default

export default{ } (2) is a component object, the .vue files' syntax that makes the following object definition available for use.

data

The data( ) function (3) describes variables that we can use in the <template>.

methods

Then the methods block. Methods are closely interlinked to events because they are used as event handlers. Every time an event occurs, that method is called.

(figure)

In the <template> the widgetChangeHandler method (4) is called on click (v-on directive) to emit the value to the application that uses the button component.

Notice, we don't have to use this.data.config, just this.config. Vue does provide a transparent binding for us. Using this.data.config will raise an error.

watch

Watchers are defined in the watch block (5):

(figure)

Watchers ‘spy’ on one property of the component state, and run a function when that property value changes.

props

(figure)

The props block (6) defines variables, that are used in the Vue locally.

<style>

<style> is where the user write the userr CSS for the component. If the user add a scoped attribute <style scoped> Vue will scope the styles to the contents of the userr SFC. This works similar to CSS-in-JS solutions but allows the user to just write plain CSS.

If the user select a CSS pre-processor, the user can add a lang attribute to the <style> tag so that the contents can be processed by Webpack at build time. For example, <style lang=“scss”> will allow the user to use SCSS syntax in the userr styling information.

In the template project, we used SCSS syntax to define the button's appearance (see CSS Properties Reference):

Widget padding

(figure)

All the CSS is defined in the button-widget class. If the user want the widget field occupies the entire cell on the dashboard—set width and height to 100%. A user will be able to adjust the widget field in the previewer or on the dashboard. Also, choose the background color.

(figure)

Button field

Inside the button-widget the button appearance is nested:

(figure)

Here the user can define the button text color, font-size, and others (see CSS Properties Reference).

Note that nested definition is made with underscores and a reference to the nested part of the style definition looks like button-widget_button. See the <template> block.

Cursor and hover

Depper in nesting:

(figure)

The first selector defines the cursor appearance over the button (See CSS Selectors Reference).

medium custom property defines minimal height and padding of the button.

contained defines the button's background-color and the color on hover (again, nested in contained).

Note how to call these nested definitions using the nesting path: button-widget_button—contained. See the <template> block.

< >

Configuration Components

Some components need to share configuration. For example, the MQTT In and MQTT Out components share the configuration of the MQTT broker, allowing them to pool the connection. Configuration components are scoped globally by default, this means the state will be shared between flows.

Defining a Config Component

A configuration component is defined in the same way as other components. There are two key differences:

its category property is set to config;

the edit template <input> elements have ids of node-config-input-<propertyname>.

remote-server.html

(figure)

remote-server.js

(figure)

In this example, the component acts as a simple container for the configuration—it has no actual runtime behavior.

A common use of config components is to represent a shared connection to a remote system. In that instance, the config component may also be responsible for creating the connection and making it available to the components that use the config component. In such cases, the config component should also handle the close event to disconnect when the component is stopped.

Using a Config Component

Components register their use of config components by adding a property to the defaults array with the type attribute set to the type of the config component.

(figure)

As with other properties, the editor looks for an <input> in the edit template with an id of node-input-<propertyname>. Unlike other properties, the editor replaces this <input> element with a <select> element populated with the available instances of the config component, along with a button to open the config component edit dialog.

(figure)

The component can then use this property to access the config component within the runtime.

(figure)

< >

Component Styling Guide

When publishing the user new component to Marketplace, it's essential to customize the appearance properly.

If the appearance does not meet the requirements, a Marketplace moderator will not approve the publication.

Component Category

The user may add the user new component to an existing category, but it may confuse users. So it's better to take as a rule:

to consider each new project as a new category (and label it respectively);

to put related components to one project (and category);

to create a new project (and category) for components that provide other purposes.

Background Color

The component category defines its' color on the palette.

When the user create a new category component the user should set up its workspace color properly.

The main idea is that the user component in the workspace should reflect its purpose. If the component works as a function it should have #8c58e9 hex code color.

If a component creates a dashboard widget—it must be #1ac0c9 (like dashboard category elements).

(figure)

In this instance, we create a converters category for a new component (in its definitions). And this category will contain a “function-like” colored component.

Use these colors:

| Component's Category | Hex Code |
|---|---|
| common | # |
| dashboard | #1ac0c9 |
| storage | #589be9 |
| parser | #21c144 |
| sequence | #ca58e9 |
| network | #ed9438 |
| function | #8c58e9 |

If the user make a category that doesn't refer to any of these core categories, please use non-confusing colors for components.

Font Awesome Icons

An icon on the component reflects its functionality.

The user can use Font Awesome icons in the form font-awesome/fa-address-card, where address-card is the icon name.

(figure)

Font Awesome icons look this way:

(figure)

Custom Icon

If the user wants to use a custom icon, it must be on a transparent background, with 20×30 size in .png format.

(figure)

Place an icon file to a directory called icons alongside component's .js and .html files.

These directories get added to the search path when the editor looks for a given icon filename. Because of this, the icon filename must be unique.

Component Label

When specifying the component's label (name in the workspace), consider its potential users' convenience. Let it reflect the component's function or purpose. And keep it short.

The label value can be a string or a function.

A string value will be used as the workspace name. If the value is a function, it shows a label the user put in it by default but will switch to the name a user places in the Name property.

(figure)

Insufficient naming: test component, function1, dsfdsgfas, the primary process' silent observer.

Sufficient naming: uppercase, convert, duplicate, form filler.

Palette Label

By default, the component's type is used as its label within the palette. To override this the user can use paletteLabel property.

As with label, this property can be either a string or a function. If it is a function, it is evaluated once when the node is added to the palette.

(figure)

Label style

The workspace label style can be set dynamically. Use the labelStyle property. It identifies the CSS class to apply. There are two predefined classes: node_label (default) and node_label_italic.

In this example, we apply the italic style to a component's name if it is set.

(figure)

Alignment

Icons and labels are left-aligned by default. But the convention is to make them right-aligned for the end-flow components (for example, mqtt out in the network category or gauge in the dashboard one)

The user can do it with the align property of a component definition.

(figure)

Appearance in the workspace:

(figure)

Port labels

The user can set labels on the component's ports. They appear when hovering over.

(figure)

A user can change the labels in the Appearance properties of the component.

Appearance in the workspace:

(figure)

Widget styling

There are no strict rules for the UI component representation (the dashboard category).

The main idea is to make it simple and minimalistic. A user can change the appearance but pay attention to the default view.

Consider these two examples, less and more handy:

(figure)

and

(figure)

Don't forget about headers, default colors, placeholders, etc. To sell the userr component on Marketplace, the user may want to make its appearance clear and compelling.

FIGS. 178, 179, and 180 are portions of a diagram of a computing platform 800 and example process according to certain embodiments of the present invention. For the sake of viewing, FIGS. #A, #B, and #C are shown as separate figures. Broadly speaking, a platform 800 employing, a core service 802 and a smart infrastructure service 804, a physical server cluster 806, and a physical system 808.

The core service 802 and smart infrastructure service 804 employ a graphical user interface 820. The core service 802 and smart infrastructure service 804 are in data communication 822 with the physical server cluster 806 and the physical system 808.

The physical system 806 employs, for example, a robotic assembly line.

The physical server cluster 806 employs virtual machines 810 upon which various nodes and services 812 execute logic. The virtual machines 810 run on distributed physical servers 814 and are controlled by a hypervisor 816. The networking or linking of the virtual machines 810, the physical servers 814 and the hypervisor 816 is facilitated through a communication fabric or transport layer 808. The physical server cluster 806 is in data communication 824 with the physical system 806.

Within the core service 802 and smart infrastructure service 804 user interface 820, a user graphically identifies, creates, and configures, for example, process compute nodes 830; device apps 832; automation apps 824; ML node 826; dashboard application nodes 834; and data connections 838 between the same to create graphical representations 836 of functional processes, e.g. robotic manufacturing. Upon deployment or running of the graphical representations of functional processes 836 created in the user interface 820, the functional process represented by the graphical representations 836 is deployed to nodes 812 on the virtual machines 810 via data communication 822. Likewise, software deployment to the physical system 806 is facilitated via data communication 822. A transport communication layer is then established between physical server cluster 806 and the physical system 806 via data communication 824.

With reference to FIG. 181, according to certain embodiments of the present invention, a method 850 for creating a process and deploying or running the process includes, but need not necessarily include all of the following steps. Graphically selecting various nodes (box 852). Graphically creating connections between certain of the selected nodes to form a process graph (box 854). Graphically configuring parameters of the nodes (box 856). Deploying the graphically represented process within the inventive platform (box 858).

The present invention provides a digital platform or system that graphically interconnect services, processes automation, applications, and hardware that are either internal and external to the system to execute AI/ML AI/ML augmented functional process.

The present invention further provides a method to graphically connect data inputs and outputs of services, processes automation, applications, hardware that upon deploying, autonomously remaps said data inputs and outputs to optimize the process runtime.

The present invention further provides a system and method that provides for remote piloting of robot through the digital platform.

The present invention further provides a system and method that provides for manually controlling a machine through the digital platform.

The present invention further provides a system and method that provides a user to build (coded or codeless) automation and dashboard applications that contain business logic and running processes that are embedded directly into the services for a seamless user experience.

The present invention further provides a system and method that updates and deploys new version control for the process and the components employed in the process.

The present invention further provides a system and method for general version control of the digital platform and all of its subparts, services, processes, applications interconnections. The present invention further provides a system and method operabel to roll back an entire digital system and redeploy services, processes applications, and interconnections to a previous running version.

The present invention further provides a system and method operable to replay the entire digital platform in time series on different versions of the digital platform.

The present invention further provides a system and method graphically interconnect internal and external services, remap data types, and add and connect processes, and AI/ML nodes.

The present invention further provides a system and method to graphically connect inputs and outputs of services, processes, applications, hardware etc to have inputs and outputs that can then be connected graphically.

The present invention further provides a system and user interface employing a graphical system having sub layers of connection to group functionality that represent sub systems, external or internal hardware systems.

The present invention further provides a system and method operable to manages deployment of services, processes, applications, to centralized and decentralized servers, remote or nonremote hardware, and creates a communication layer across the servers and/or hardware in the system.

The present invention further provides a system and method operable to create automation or processes coded or codeless that can be incorporated into the system to be graphically connected.

The present invention further provides a system and method operable to create AI/ML coded or codeless nodes that can be incorporated into the systems to be graphically connected.

The present invention further provides a system and method operable for the services, processes, applications, to be viewable and usable in different ways mediums such as webpages, mobile applications, desktop applications.

The present invention further provides a system and method for general version control of the deployed digital system and all of its subparts services, processes, applications interconnections and operable to roll back an entire digital system and redeploy services, processes applications, and interconnections to a previous running version.

The present invention further provides a system and method employing multiple digital systems each consisting of the above but managed and controlled separately.

The present invention further provides a system and method operable to replay infrastructure activities of a whole business, e.g. Traceability/Users History (Activity Timeline).

The present invention further provides a system and method employing workstations (e.g. humans/robots/machines) in a connected digital system.

The present invention further provides a system and method operable to assign the station as task to a humans/robots/machines for processes or activities to be completed.

The present invention further provides a system and method operable to build (coded or codeless) automation and dashboard applications in a station (physical and cloud based) that contain business logic and running processes that are embedded directly into the station for a seamless user experience and update and deploy new, version control.

The present invention further provides a system and method operable to define entry and exit points for a station that can be used in robot/machine process/task/movement planning.

The present invention further provides a system and method operable to manage connected hardware in station and manage Inventory in station, manage inputs and outputs incorporated in the station that can then be connected graphically to other services, processes automation, applications, hardware, stations in the system; update processes automation, applications running in the station representation or on hardware that is a part of the station representation.

The present invention further provides a system and method operable to manage infrastructure level inventory; Areas based inventory; Location-based inventory; and Inputs on outputs to connect to core to adjust change inventory.

The present invention further provides a system and method operable to define working areas for processes or activities by humans/robots/machines; to assign the area as task to a humans/robots/machines for processes or activities to be completed; to generate feedback and reporting from hardware/robots/systems and map overlay in 2d or 3d, in different forms as a heatmap, path etc.

The present invention further provides a system and method operable build and execute Robot planning; Speed Limit Areas; Grids; Highways; Routes; Waypoints and One-time tasks; and Repetitive or Manually Scheduled multitype tasks.

The present invention further provides a system and method operable to build and run Multiple Infrastructure UI Applications & Dashboard Application; Station UI Applications & Dashboard Application; UI Applications & Dashboard Application Widgets Immediate Editing; Core relations: Instant UI Applications & Dashboard Application redeployment or release update on the same page.

The present invention further provides a system and method operable to connect infrastructures, stations, robots, machines, IoT devices and controllers with each other to create automations or connect them with other external applications.

The present invention further provides a system and method operable to connect infrastructures, stations, robots, machines, IoT devices and controllers with each other to create automations or connect them with other external applications.

The present invention further provides a system and method operable to Test business' operations and robot work in simulation software, which is a digital playground embedded in Smart Infrastructure. Make a prototype and test infrastructure with Core service and simulated hardware and robots even in it prior to building a facility and actually buying robots for it.

The present invention further provides a system and method operable to test and simulate robots/machines performance, set their key parameters, and build a forecast of efficiency/productivity, within a virtual environment based upon a real world environment, e.g. actual factory floor.

The present invention further provides a system and method operable to release/run newly created nodes and apps directly from within platform service.

The present invention further provides a system and method operable to build dynamic (coded or codeless) remote control applications for robots and machines consisting of a video view feed(s) and automation and or dashboard applications that contain business logic and running processes that are embedded directly into the remote control User Interface for a seamless user experience and Update and deploy new, version.

The present invention further provides a system and method operable to deploy multiple of these dynamic remote control applications on one robot/machine for concurrent multiple user control for complex robots machines.

The present invention further provides a system and method operable to remotely control multiple robots from these dynamic remote control applications at the same time by one or more users concurrently.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A method of creating and deploying a functional process, comprising:
performing, by one or more computing devices:
receiving a graphical input to select one or more computing nodes;
receiving a graphical input to form connections between certain of the selected computing nodes to form a process graph; and
receiving a graphical input to configure parameters of the one or more computing nodes; and
deploying the process graph to the one or more computing devices to perform the functional process.

2. The method of claim 1, wherein the one or more computing devices comprise a communication network employing weighted relationships between the one or more computing devices.

3. The method of claim 1, wherein the one or more computing devices comprise a distributed network of computing devices.

4. The method of claim 1, wherein the one or more computing nodes comprise a machine learning node.

5. The method of claim 1, wherein receiving a graphical input to form connections between certain of the selected computing nodes to form a process graph comprises receiving a graphical input to form connections between computing nodes employing different socket types.

6. The method of claim 1, wherein receiving graphical input to form connections comprises receiving graphical input to form a connection via a mapping node.

7. The method of claim 1, further comprising autonomously remapping the connections between certain of the selected computing nodes while performing the functional process.

8. The method of claim 1, further comprising autonomously remapping data within the connections between certain of the selected computing nodes while performing the functional process.

9. A system, comprising:
one or more computing devices configured to:
receive graphical input to select one or more computing nodes;
receive graphical input to form connections between certain of the selected computing nodes to form a process graph; and
receive graphical input to configure parameters of the one or more computing nodes; and
deploy the process graph to one or more computing devices to perform the functional process.

10. The system of claim 9, wherein the one or more computing devices comprise a communication network employing weighted relationships between the one or more computing devices.

11. The system of claim 9, wherein the one or more computing nodes comprise a mapping node.

12. The system of claim 9, wherein the one or more computing nodes comprise a machine learning node.

13. The system of claim 9, wherein the one or more computing nodes comprise a robot nodes.

14. The system of claim 9, wherein the parameters of the one or more computing nodes comprises a defining a data socket type on the one or more nodes.

15. The system of claim 9 wherein the graphical input received is generated by dragging and dropping a graphical representation of a component of the process graph.

16. The system of claim 9, wherein the connections between certain of the selected computing nodes form a subgraph process.

17. The system of claim 9, wherein the connections between certain of the selected computing nodes is dynamically remapped while performing the functional process.
